(19) United States
(12) Patent Application Publication
(10) Pub. No.: US 2026/0034550 A1
(43) Pub. Date: Feb. 5, 2026

(54) SURFACE CLEANING APPARATUS

(71) Applicant: Omachron Intellectual Property Inc., Hampton (CA)

(72) Inventor: Wayne Ernest Conrad, Hampton, CA (US)

(21) Appl. No.: 19/351,056

(22) Filed: Oct. 6, 2025

Related U.S. Application Data
(63) Continuation-in-part of application No. 18/829,577, filed on Sep. 10, 2024.
Application No. 18/829,577 is a continuation of application No. 18/640,881, filed on Apr. 19, 2024, now Pat. No. 12,251,717.
Application No. 18/640,881 is a continuation of application No. 18/220,167, filed on Jul. 10, 2023, now Pat. No. 11,992,848.
Application No. 18/220,167 is a continuation of application No. 17/694,362, filed on Mar. 14, 2022, now Pat. No. 11,745,190.

(51) Int. Cl. B04C 5/08; A47L 9/10; A47L 9/12; A47L 9/16; A47L 9/20; A47L 9/32; B04C 5/187; B04C 9/00

(52) U.S. Cl. CPC B04C 5/08; A47L 9/1608; A47L 9/1691; B04C 5/187; B04C 9/00; A47L 9/106; A47L 9/122; A47L 9/1625; A47L 9/165; A47L 9/1675; A47L 9/1683; A47L 9/20; A47L 9/325; B04C 2009/005

(57) ABSTRACT

A hand vacuum has an air flow passage extending from a dirty air inlet to a clean air outlet and a motor and fan assembly provided in the air flow passage. The hand vacuum has an air treatment chamber having a front end, a rear end, a treatment chamber axis extending in a forward/rearward direction between the front and rear ends, an air inlet, an air outlet, a dirt outlet and a treatment chamber door rotatably mounted about an axis that is parallel to the treatment chamber axis. The hand vacuum has a dirt collection chamber external to the air treatment chamber. The dirt collection chamber has a collection chamber door rotatably mounted about another axis that extends in a different direction to the forward/rearward direction and extends in an emptying plane. When the collection chamber door is open, an emptying port is provided in the emptying plane.

### CROSS-REFERENCE TO RELATED APPLICATIONS

This application is a continuation-in-part of U.S. patent application Ser. No. 18/829,577, filed on Sep. 10, 2024, which is a continuation of U.S. patent application Ser. No. 18/640,881, filed on Apr. 19, 2024 and issued as U.S. Pat. No. 12,251,717 on Mar. 18, 2025, which is a continuation of U.S. patent application Ser. No. 18/220,167, filed on Jul. 10, 2023 and issued as U.S. Pat. No. 11,992,848 on May 28, 2024, which is a continuation of U.S. patent application Ser. No. 17/694,362, filed on Mar. 14, 2022 and issued as U.S. Pat. No. 11,745,190 on Sep. 5, 2023, the entirety of which is incorporated herein by reference.

### FIELD

This disclosure relates generally to surface cleaning apparatuses.

### INTRODUCTION

The following is not an admission that anything discussed below is part of the prior art or part of the common general knowledge of a person skilled in the art.

Various constructions for surface cleaning apparatuses, such as vacuum cleaners, are known. Air may be drawn into the surface cleaning apparatus through a dirty air inlet and conveyed to an air treatment member, such as, for example, a cyclonic air treatment member. Within the air treatment member, some of the particulate matter (i.e., debris) captured within the air flow may be disentrained from the air flow. This disentrained debris may then be collected in a dirt collection chamber. When the dirt collection chamber is full of debris, a user of the surface cleaning apparatus may empty the dirt collection chamber into, for example, a garbage bin.

### SUMMARY

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

In accordance with one aspect of this disclosure, which may be used by itself or in combination with one or more other aspects disclosed herein, a hand vacuum cleaner has:
(a) an air flow passage extending from a dirty air inlet, which is provided at a front end of the hand vacuum cleaner, to a clean air outlet;
(b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and a first air treatment chamber door that is rotatably mounted about a first air treatment chamber opening axis that is parallel to the air treatment chamber axis;
(c) a dirt collection chamber that is external to the air treatment chamber wherein, in operation, dirt travels through the dirt outlet from the air treatment chamber to the dirt collection chamber, the dirt collection chamber having a dirt collection chamber door that is rotatably mounted about a dirt collection chamber opening axis that extends in a different direction to the forward/rearward direction, wherein the dirt collection chamber opening axis extends in a dirt collection chamber emptying plane and, when the dirt collection chamber door is open, a dirt collection chamber emptying port is provided in the dirt collection chamber emptying plane; and,
(d) a motor and fan assembly provided in the air flow passage.

In accordance with this aspect, a hand vacuum cleaner has:
(a) an air flow passage extending from a dirty air inlet, which is provided at a front end of the hand vacuum cleaner, to a clean air outlet;
(b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and a first air treatment chamber door that is moveable in a first direction from a closed position to an open position;
(c) a dirt collection chamber that is external to the air treatment chamber wherein, in operation, dirt travels through the dirt outlet from the air treatment chamber to the dirt collection chamber, the dirt collection chamber having a dirt collection chamber door that is moveable in a second direction from a closed position to an open position wherein the second direction is different to the first direction, wherein, when the dirt collection chamber door is open, a dirt collection chamber emptying port is provided; and,
(d) a motor and fan assembly provided in the air flow passage.

In accordance with another aspect of this disclosure, which may be used by itself or in combination with one or more other aspects disclosed herein, a hand vacuum cleaner has:
(a) an air flow passage extending from a dirty air inlet, which is provided at a front end of the hand vacuum cleaner, to a clean air outlet;
(b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet, a first air treatment chamber door that is rotatably mounted about a first air treatment chamber opening axis that is parallel to the air treatment chamber axis and a second air treatment chamber door that is rotatably mounted about a second air treatment chamber opening axis that is parallel to the air treatment chamber axis;
(c) a dirt collection chamber that is external to the air treatment chamber wherein, in operation, dirt travels through the dirt outlet from the air treatment chamber to the dirt collection chamber, the dirt collection chamber having a dirt collection chamber door that is rotatably mounted about a dirt collection chamber opening axis that extends in a different direction to the forward/rearward direction, wherein the dirt collection chamber opening axis extends in a dirt collection chamber emptying plane and, when the dirt collection chamber door is open, a dirt collection chamber emptying port is provided in the dirt collection chamber emptying plane; and,
(d) a motor and fan assembly provided in the air flow passage.

In accordance with this aspect, a hand vacuum cleaner has:
(a) an air flow passage extending from a dirty air inlet, which is provided at a front end of the hand vacuum cleaner, to a clean air outlet;
(b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet, a first air treatment chamber door that is moveable in a first direction from a closed position to an open position and a second air treatment chamber door that is moveable in a second direction from a closed position to an open position, wherein the second direction is opposed to the first direction and wherein, when the first and second air treatment chamber doors are open, an air treatment chamber emptying port is provided;
(c) a dirt collection chamber that is external to the air treatment chamber wherein, in operation, dirt travels through the dirt outlet from the air treatment chamber to the dirt collection chamber, the dirt collection chamber having a dirt collection chamber door that is moveable in a third direction from a closed position to an open position wherein the third direction is different to the first and second directions wherein, when the dirt collection chamber door is open, a dirt collection chamber emptying port is provided in a dirt collection chamber emptying plane; and,
(d) a motor and fan assembly provided in the air flow passage.

In accordance with another aspect of this disclosure, which may be used by itself or in combination with one or more other aspects disclosed herein, a hand vacuum cleaner has:
(a) an air flow passage extending from a dirty air inlet, which is provided at a front end of the hand vacuum cleaner, to a clean air outlet;
(b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and at least a first air treatment chamber door, the first air treatment chamber door is rotatably mounted about a first air treatment chamber opening axis that is parallel to the air treatment chamber axis, the first air treatment chamber axis extends in an air treatment chamber emptying plane, wherein, when the at least a first air treatment chamber door is open, an air treatment chamber emptying port is provided in the air treatment chamber emptying plane;
(c) a dirt collection chamber that is external to the air treatment chamber wherein, in operation, dirt travels through the dirt outlet from the air treatment chamber to the dirt collection chamber, the dirt collection chamber having a dirt collection chamber door that is rotatably mounted about a dirt collection chamber opening axis, wherein the dirt collection chamber opening axis extends in a dirt collection chamber emptying plane and, when the dirt collection chamber door is open, a dirt collection chamber emptying port is provided in the dirt collection chamber emptying plane, wherein the dirt collection chamber emptying port has a larger cross-sectional area than a cross-sectional area of the air treatment chamber emptying port; and,
(d) a motor and fan assembly provided in the air flow passage.

In accordance with this aspect, a hand vacuum cleaner has:
(a) an air flow passage extending from a dirty air inlet, which is provided at a front end of the hand vacuum cleaner, to a clean air outlet;
(b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet, at least a first air treatment chamber door, the first air treatment chamber door is moveable in a first direction from a closed position to an open position wherein, when the at least a first air treatment chamber door is open, an air treatment chamber emptying port is provided;
(c) a dirt collection chamber that is external to the air treatment chamber wherein, in operation, dirt travels through the dirt outlet from the air treatment chamber to the dirt collection chamber, the dirt collection chamber having a dirt collection chamber door that is moveable in a second direction from a closed position to an open position wherein the second direction is different to the first direction wherein, when the dirt collection chamber door is open, a dirt collection chamber emptying port is provided in a dirt collection chamber emptying plane, wherein the dirt collection chamber emptying port has a larger cross-sectional area than a cross-sectional area of the air treatment chamber emptying port; and,
(d) a motor and fan assembly provided in the air flow passage.

In accordance with another aspect of this disclosure, which may be used by itself or in combination with one or more other aspects disclosed herein, a hand vacuum cleaner has:
(a) an air flow passage extending from a dirty air inlet, which is provided at a front end of the hand vacuum cleaner, to a clean air outlet;
(b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and a first air treatment chamber door that is rotatably mounted about a first living hinge which has an axis that is parallel to the air treatment chamber axis;
(c) a dirt collection chamber that is external to the air treatment chamber wherein, in operation, dirt travels through the dirt outlet from the air treatment chamber to the dirt collection chamber, the dirt collection chamber having a dirt collection chamber door that is openable; and,
(d) a motor and fan assembly provided in the air flow passage.

In accordance with this aspect, a combination includes the hand vacuum cleaner and a dock wherein the dock has an actuator and, as or subsequent to the hand vacuum cleaner being docked to the dock, the actuator causes the first air treatment chamber door to open.

In accordance with this aspect, a hand vacuum cleaner has:
(a) an air flow passage extending from a dirty air inlet, which is provided at a front end of the hand vacuum cleaner, to a clean air outlet;
(b) an air treatment chamber having an air treatment chamber air inlet, an air treatment chamber air outlet, a dirt outlet and a first air treatment chamber door that is rotatably mounted about a first living hinge;
(c) a dirt collection chamber that is external to the air treatment chamber wherein, in operation, dirt travels through the dirt outlet from the air treatment chamber to the dirt collection chamber, the dirt collection chamber having a dirt collection chamber door that is openable; and,
(d) a motor and fan assembly provided in the air flow passage.

In accordance with another aspect of this disclosure, which may be used by itself or in combination with one or more other aspects disclosed herein, a hand vacuum cleaner has:
(a) an air flow passage extending from a dirty air inlet, which is provided at a front end of the hand vacuum cleaner, to a clean air outlet;
(b) an air treatment chamber having a first end, an axially spaced apart second end, an air treatment chamber axis that intersects the first and second ends, an air treatment chamber air inlet, an air treatment chamber air outlet provided at the second end, a dirt outlet and a first air treatment chamber door that is rotatably mounted about a first air treatment chamber opening axis that is parallel to the air treatment chamber axis wherein the first air treatment chamber door defines at least a portion of a perimeter of the dirt outlet;
(c) a dirt collection chamber that is external to the air treatment chamber wherein, in operation, dirt travels through the dirt outlet from the air treatment chamber to the dirt collection chamber, the dirt collection chamber having a dirt collection chamber door that is openable; and,
(d) a motor and fan assembly provided in the air flow passage.

In accordance with this aspect, a hand vacuum cleaner has:
(a) an air flow passage extending from a dirty air inlet, which is provided at a front end of the surface cleaner, to a clean air outlet;
(b) an air treatment chamber having a first end, an axially spaced apart second end, an air treatment chamber axis that intersects the first and second ends, an air treatment chamber air inlet, an air treatment chamber air outlet provided at the second end, a dirt outlet, a first air treatment chamber door that is moveable in a first direction from a closed position to an open position and a second air treatment chamber door that is moveable in a second direction from a closed position to an open position, wherein the second direction is opposed to the first direction and wherein each of the first and second air treatment chamber doors defines at least a portion of a perimeter of the dirt outlet;
(c) a dirt collection chamber that is external to the air treatment chamber wherein, in operation, dirt travels through the dirt outlet from the air treatment chamber to the dirt collection chamber, the dirt collection chamber having a dirt collection chamber door that is openable; and,
(d) a motor and fan assembly provided in the air flow passage.

In accordance with another aspect of this disclosure, which may be used by itself or in combination with one or more other aspects disclosed herein, a hand vacuum cleaner has:
(a) an air flow passage extending from a dirty air inlet to a clean air outlet;
an air treatment chamber axis which intersects the first and second ends, an air treatment chamber sidewall extending between the first and second ends, an air treatment chamber air inlet, an air treatment chamber air outlet, a dirt outlet and a first air treatment chamber door that is moveable between an open position and a closed position;
(c) a dirt collection chamber that is external to the air treatment chamber wherein, in operation, dirt travels through the dirt outlet from the air treatment chamber to the dirt collection chamber, the dirt collection chamber having a dirt collection chamber door that is openable;
(d) a motor and fan assembly provided in the air flow passage; and,
(e) an actuator whereby, upon actuation by the actuator, the first air treatment chamber door is moved between the open position and the closed position, wherein the actuator comprises a first magnet that is exterior to the air treatment chamber.

In accordance with this aspect, a hand vacuum cleaner has:
(a) an air flow passage extending from a dirty air inlet, which is provided at a front end of the hand vacuum cleaner, to a clean air outlet;
(b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and a first air treatment chamber door that is rotatably mounted about an axis that is parallel to the air treatment chamber axis;
(c) a dirt collection chamber that is external to the air treatment chamber wherein, in operation, dirt travels through the dirt outlet from the air treatment chamber to the dirt collection chamber, the dirt collection chamber having a dirt collection chamber door that is openable;
(d) a motor and fan assembly provided in the air flow passage; and,
(e) an actuator that is drivingly connected to the first air treatment chamber door by a linkage whereby, upon actuation by the actuator, the first air treatment chamber door is moved between an open and a closed position, wherein the actuator comprises a first magnet that is exterior to the air treatment chamber.

In accordance with this aspect, a combination includes:
(a) a hand vacuum cleaner comprising:
   i. an air flow passage extending from a dirty air inlet to a clean air outlet;
   ii. an air treatment chamber having a first end, an axially spaced apart second end, an air treatment chamber axis which intersects the first and second ends, an air treatment chamber sidewall extending between the first and second ends, an air treatment chamber air inlet, an air treatment chamber air outlet, a dirt outlet and a first air treatment chamber door that is moveable between an open position and a closed position;
   iii. a dirt collection chamber that is external to the air treatment chamber wherein, in operation, dirt travels through the dirt outlet from the air treatment chamber to the dirt collection chamber, the dirt collection chamber having a dirt collection chamber door that is openable; and,
   iv. a motor and fan assembly provided in the air flow passage,
(b) a dock comprising a receptacle, the combination is operable in a docking mode in which dirt from the dirt collection chamber is transferred to the receptacle; and,
(c) an actuator comprising a first magnet wherein, upon actuation by the actuator, the first air treatment chamber door is moved between the open position and the closed position.

In accordance with another aspect of this disclosure, which may be used by itself or in combination with one or more other aspects disclosed herein, a surface cleaner has:
(a) an air flow passage extending from a dirty air inlet to a clean air outlet;
(b) an air treatment chamber axis which intersects the first and second ends, an air treatment chamber sidewall extending between the first and second ends, an air treatment chamber air inlet, an air treatment chamber air outlet, a dirt outlet and a first air treatment chamber door that is moveable between an open position and a closed position;
(c) a dirt collection chamber that is external to the air treatment chamber wherein, in operation, dirt travels through the dirt outlet from the air treatment chamber to the dirt collection chamber, the dirt collection chamber having a dirt collection chamber door that is openable;
(d) a motor and fan assembly provided in the air flow passage; and,
(e) a transmission comprising at least a first gear whereby, upon actuation by the actuator, the first air treatment chamber door is moved between the open position and the closed position.

In accordance with this aspect, a combination includes the surface cleaner and a dock wherein the transmission is actuated as the surface cleaner is docked with the dock.

In accordance with this aspect, a hand vacuum cleaner has:
(a) an air flow passage extending from a dirty air inlet, which is provided at a front end of the hand vacuum cleaner, to a clean air outlet;
(b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and a first air treatment chamber door that is rotatably mounted about a first air treatment chamber opening axis that is parallel to the air treatment chamber axis;
(c) a dirt collection chamber that is external to the air treatment chamber wherein, in operation, dirt travels through the dirt outlet from the air treatment chamber to the dirt collection chamber, the dirt collection chamber having a dirt collection chamber door that is openable;
(d) a motor and fan assembly provided in the air flow passage; and,
(e) a transmission comprising at least a first gear whereby, upon actuation by the actuator, the first air treatment chamber door is moved between the open position and the closed position.

In accordance with this aspect, a combination includes the hand vacuum cleaner and a dock wherein the transmission is actuated as the hand vacuum cleaner is docked with the dock.

In accordance with another aspect of this disclosure, which may be used by itself or in combination with one or more other aspects disclosed herein, a hand vacuum cleaner has:
(a) an air flow passage extending from a dirty air inlet, which is provided at a front end of the hand vacuum cleaner, to a clean air outlet;
(b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and a first air treatment chamber door that is rotatably mounted about a first air treatment chamber opening axis that is parallel to the air treatment chamber axis;
(c) a dirt collection chamber that is external to the air treatment chamber wherein, in operation, dirt travels through the dirt outlet from the air treatment chamber to the dirt collection chamber, the dirt collection chamber having a dirt collection chamber door that is rotatably mounted about a dirt collection chamber opening axis, wherein the dirt collection chamber door is drivingly connected to the first air treatment chamber door whereby opening the dirt collection chamber door opens the first air treatment chamber door; and,
(d) a motor and fan assembly provided in the air flow passage.

In accordance with this aspect, a hand vacuum cleaner has:
(a) an air flow passage extending from a dirty air inlet, which is provided at a front end of the hand vacuum cleaner, to a clean air outlet;
(b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and a first air treatment chamber door that is moveable in a first direction from a closed position to an open position;
(c) a dirt collection chamber that is external to the air treatment chamber wherein, in operation, dirt travels through the dirt outlet from the air treatment chamber to the dirt collection chamber, the dirt collection chamber having a dirt collection chamber door that is moveable from a closed position to an open position wherein the dirt collection chamber door is drivingly connected to the first air treatment chamber door whereby opening the dirt collection chamber door opens the first air treatment chamber door; and,
(d) a motor and fan assembly provided in the air flow passage.

In accordance with another aspect of this disclosure, which may be used by itself or in combination with one or more other aspects disclosed herein, a hand vacuum cleaner has:
(a) an air flow passage extending from a dirty air inlet, which is provided at a front end of the hand vacuum cleaner, to a clean air outlet;
(b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and a first air treatment chamber door that is rotatably mounted about a first air treatment chamber opening axis that is parallel to the air treatment chamber axis;
(c) a dirt collection chamber that is external to the air treatment chamber wherein, in operation, dirt travels through the dirt outlet from the air treatment chamber to the dirt collection chamber, the dirt collection chamber having a dirt collection chamber door that is rotatably mounted about a dirt collection chamber opening axis that is parallel to the air treatment chamber axis; and,
(d) a motor and fan assembly provided in the air flow passage.

In accordance with this aspect, a surface cleaner has:
(a) an air flow passage extending from a dirty air inlet to a clean air outlet;
(b) a cyclone chamber having a cyclone axis of rotation, a cyclone chamber air inlet, a cyclone chamber air outlet, a dirt outlet and a first cyclone chamber door that is rotatably mounted about a first air treatment chamber opening axis that is parallel to the cyclone axis of rotation;
(c) a dirt collection chamber that is external to the air treatment chamber wherein, in operation, dirt travels through the dirt outlet from the cyclone chamber to the dirt collection chamber, the dirt collection chamber having a dirt collection chamber door that is rotatably mounted about a dirt collection chamber opening axis that is parallel to the cyclone axis of rotation; and,
(d) a motor and fan assembly provided in the air flow passage.

In accordance with another aspect of this disclosure, which may be used by itself or in combination with one or more other aspects disclosed herein, a hand vacuum cleaner has:
(a) an air flow passage extending from a dirty air inlet, which is provided at a front end of the hand vacuum cleaner, to a clean air outlet;
(b) an air treatment chamber having a front end comprising a front wall, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet wherein the front wall of the air treatment chamber translates forwardly from a closed position to an open position;
(c) a dirt collection chamber that is external to the air treatment chamber wherein, in operation, dirt travels through the dirt outlet from the air treatment chamber to the dirt collection chamber, the dirt collection chamber having a dirt collection chamber door that is rotatably mounted about a dirt collection chamber opening axis that extends at an angle to the air treatment chamber axis; and,
(d) a motor and fan assembly provided in the air flow passage.

In accordance with another aspect of this disclosure, which may be used by itself or in combination with one or more other aspects disclosed herein, a hand vacuum cleaner has:
(a) an air flow passage extending from a dirty air inlet, which is provided at a front end of the hand vacuum cleaner, to a clean air outlet;
(b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and a first air treatment chamber door;
(c) a dirt collection chamber that is external to the air treatment chamber wherein, in operation, dirt travels through the dirt outlet from the air treatment chamber to the dirt collection chamber, the dirt collection chamber having a dirt collection chamber door that is openable; and,
(d) a motor and fan assembly provided in the air flow passage.
wherein at least one of the first air treatment chamber door and the dirt collection chamber door is rotatably mounted about an opening axis that is parallel to the air treatment chamber axis and,
wherein a lock secures the at least one of the first air treatment chamber door and the dirt collection chamber door in a closed position, wherein the lock comprises an axially extending member.

In accordance with another aspect of this disclosure, which may be used by itself or in combination with one or more other aspects disclosed herein, a hand vacuum cleaner has:
(a) an air flow passage extending from a dirty air inlet, which is provided at a front end of the hand vacuum cleaner, to a clean air outlet;
(b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet a first air treatment chamber door that is rotatably mounted about a first air treatment chamber opening axis that is parallel to the air treatment chamber axis and a second air treatment chamber door that is rotatably mounted about a second air treatment chamber opening axis that is parallel to the air treatment chamber axis, wherein, the air treatment chamber is ovaloid in a transverse plane transverse to the air treatment chamber axis.

In accordance with this aspect, a hand vacuum cleaner has:
(a) an air flow passage extending from a dirty air inlet, which is provided at a front end of the hand vacuum cleaner, to a clean air outlet;
(b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet, a first air treatment chamber door that is moveable in a first direction from a closed position to an open position and a second air treatment chamber door that is moveable in a second direction from a closed position to an open position, wherein, the air treatment chamber is ovaloid in a transverse plane transverse to the air treatment chamber axis.

It will be appreciated by a person skilled in the art that an apparatus or method disclosed herein may embody any one or more of the features contained herein and that the features may be used in any particular combination or sub-combination.

These and other aspects and features of various embodiments will be described in greater detail below.

### BRIEF DESCRIPTION OF THE DRAWINGS

For a better understanding of the described embodiments and to show more clearly how they may be carried into effect, reference will now be made, by way of example, to the accompanying drawings in which:

FIG. 1A is a front perspective view of a hand vacuum cleaner;

FIG. 1B is a rear perspective view of the hand vacuum cleaner of FIG. 1A;

FIG. 1C is a bottom perspective view of the hand vacuum cleaner of FIG. 1A, shown with an openable portion in an open position;

FIG. 1D is a cross-sectional view of the hand vacuum cleaner of FIG. 1A, taken along line 1D-1D;

FIG. 1E is a cross-sectional view of the hand vacuum cleaner of FIG. 1A, taken along line 1E-1E, shown with an openable portion in a closed position;

FIG. 1F is a cross-sectional view of the hand vacuum cleaner of FIG. 1A, taken along line 1E-1E, shown with an openable portion in an open position;

FIG. 1G is a cross-sectional view of the hand vacuum cleaner of FIG. 1A, taken along line 1G-1G, shown with an openable portion shown in a closed position;

FIG. 1H is a cross-sectional view of the hand vacuum cleaner of FIG. 1A, taken along line 1G-1G, shown with an openable portion shown in an open position;

FIG. 2A is a front perspective view of another example of a hand vacuum cleaner;

FIG. 2B is a cross-sectional view of the hand vacuum cleaner of FIG. 2A, taken along line 2B-2B, shown with an openable portion in a closed position;

FIG. 2C is a cross-sectional view of the hand vacuum cleaner of FIG. 2A, taken along line 2B-2B, shown with an openable portion in an open position;

FIG. 3A is a front perspective view of another example of a hand vacuum cleaner, shown with an openable portion in a closed position;

FIG. 3B is a top perspective view of the hand vacuum cleaner of FIG. 3A, shown with the openable portion in an open position;

FIG. 3C is a cross-sectional view of the hand vacuum cleaner of FIG. 3B, taken along line 3C-3C;

FIG. 4 is a perspective view of another example of a hand vacuum cleaner; shown with an openable portion in an open position;

FIG. 5A is a front perspective view of another example of a hand vacuum cleaner;

FIG. 5B is a rear perspective view of the hand vacuum cleaner of FIG. 5A;

FIG. 5C is a perspective view of the hand vacuum cleaner of FIG. 5A, shown with an openable portion in an open position;

FIG. 5D is a cross-sectional view of the hand vacuum cleaner of FIG. 5A, taken along line 5D-5D, shown with an openable portion in a closed position;

FIG. 5E is a cross-sectional view of the hand vacuum cleaner of FIG. 5A, taken along line 5D-5D, shown with an openable portion in an open position;

FIG. 6A is a front perspective view of another example of a hand vacuum cleaner;

FIG. 6B is a front perspective view of the hand vacuum cleaner of FIG. 6A, shown with an openable portion in an open position;

FIG. 6C is a front bottom perspective view of the hand vacuum cleaner of FIG. 6A, shown with an openable portion in an open position;

FIG. 7A is a front perspective view of another example of a hand vacuum cleaner;

FIG. 7B is a rear perspective view of the hand vacuum cleaner of FIG. 7A, shown with an openable portion in an open position;

FIG. 7C is a cross-sectional view of the hand vacuum cleaner of FIG. 7B, taken along line 7C-7C;

FIG. 8A is a front perspective view of another example of a hand vacuum cleaner;

FIG. 8B is a perspective view of the hand vacuum of FIG. 8A, shown with an openable portion in an open position;

FIG. 8C is a cross-sectional view of the hand vacuum cleaner of FIG. 8B, taken along line 8C-8C;

FIG. 9 is a perspective view of another example of a hand vacuum cleaner, shown with an openable portion in an open position;

FIG. 10A is a front perspective view of another example of a hand vacuum cleaner;

FIG. 10B is a perspective view of the hand vacuum cleaner of FIG. 10A, shown with an openable portion in an open position;

FIG. 11 is a front perspective view of another example of a hand vacuum cleaner, shown with an openable portion in an open position;

FIG. 12A is a front perspective view of another example of a hand vacuum cleaner;

FIG. 12B is a rear perspective view of the hand vacuum cleaner of FIG. 12A;

FIG. 12C is a front perspective view of the hand vacuum cleaner of FIG. 12A, shown with an openable portion in an open position;

FIG. 12D is a cross-sectional view of the hand vacuum cleaner of FIG. 12A, taken along line 12D-12D;

FIG. 12E is a cross-sectional view of the hand vacuum cleaner of FIG. 12A, taken along line 12E-12E;

FIG. 13 is a cross-sectional view of another example of a hand vacuum cleaner;

FIG. 14A is a front perspective view of another example of a hand vacuum cleaner;

FIG. 14B is a rear perspective view of the hand vacuum cleaner of FIG. 14A;

FIG. 14C is a perspective view of the hand vacuum cleaner of FIG. 14A, shown with an openable portion in an open position;

FIG. 14D is a cross-sectional view of the hand vacuum cleaner of FIG. 14A, taken along line 14D-14D;

FIG. 15A is a front perspective view of another example of a hand vacuum cleaner;

FIG. 15B is a perspective view of the hand vacuum cleaner of FIG. 15A, shown with an openable portion in an open position;

FIG. 16A is a front perspective view of another example of a hand vacuum cleaner;

FIG. 16B is a perspective view of the hand vacuum cleaner of FIG. 16A, shown with an openable portion in an open position;

FIG. 17 is a cross-sectional view of another example of a hand vacuum, shown with an openable portion in an open position;

FIG. 18A is a front perspective view of another example of a hand vacuum cleaner;

FIG. 18B is a rear perspective view of the hand vacuum cleaner of FIG. 18A, shown with a first openable portion in a closed position and a second openable portion in a closed position;

FIG. 18C is a front view of the hand vacuum cleaner of FIG. 18A shown with a first openable portion in an open position and a second openable portion in a closed position;

FIG. 18D is a front perspective view of the hand vacuum cleaner of FIG. 18C;

FIG. 18E is a rear perspective view of the hand vacuum cleaner of FIG. 18A, shown with a first openable portion in an open position and a second openable portion in an open position;

FIG. 18F is a front view of the hand vacuum cleaner of FIG. 18E;

FIG. 18G is a front perspective view of the hand vacuum cleaner of FIG. 18E;

FIG. 19 is a front perspective view of another example of a hand vacuum cleaner;

FIG. 20 is a front perspective view of another example of a hand vacuum cleaner;

FIG. 21A is a front perspective view of another example of a hand vacuum cleaner;

FIG. 21B is a cross-sectional view of the hand vacuum cleaner of FIG. 21A, taken along line 21B-21B;

FIG. 22A is a front perspective view of another example of a hand vacuum cleaner;

FIG. 22B is a rear perspective view of the hand vacuum cleaner of FIG. 22A;

FIG. 22C is a side view of the hand vacuum cleaner of FIG. 22A;

FIG. 22D is a cross-section view of the hand vacuum cleaner of FIG. 22A, taken along line 22D-22D;

FIG. 23 is a cross-section view of another example of a hand vacuum cleaner;

FIG. 24 is a cross-section view of another example of a hand vacuum cleaner;

FIG. 25 is a cross-section view of another example of a hand vacuum cleaner;

FIG. 26A is a front perspective view of another example of a hand vacuum cleaner;

FIG. 26B is a rear perspective view of the hand vacuum cleaner of FIG. 26A;

FIG. 26C is a side view of the hand vacuum cleaner of FIG. 26A;

FIG. 26D is a top view of the hand vacuum cleaner of FIG. 26A;

FIG. 26E is a cross-sectional view of the hand vacuum cleaner of FIG. 26A, taken along line 26E-26E;

FIG. 27 is a cross-sectional view of another example of a hand vacuum cleaner;

FIG. 28 is a cross-sectional view of another example of a hand vacuum cleaner;

FIG. 29A is a cross-sectional view of another example of a hand vacuum cleaner;

FIG. 29B is a front view of the hand vacuum cleaner of FIG. 29A, shown with an openable portion in an open position;

FIG. 30A is a cross-sectional perspective view of another example of a hand vacuum cleaner;

FIG. 30B is a cross-sectional view of the hand vacuum cleaner of FIG. 30A;

FIG. 31A is a cross-sectional perspective view of another example of a hand vacuum cleaner;

FIG. 31B is a cross-sectional view of the hand vacuum cleaner of FIG. 31A;

FIG. 32A is a front perspective view of another example of a hand vacuum cleaner;

FIG. 32B is a cross-sectional view of the hand vacuum cleaner of FIG. 32A, taken along line 32B-32B;

FIG. 33 is a perspective view of a porous member;

FIG. 34 is a perspective view of another example of a porous member;

FIG. 35A is a cross-sectional view of another example of a hand vacuum cleaner;

FIG. 35B is a cross-sectional view of the hand vacuum cleaner of FIG. 35A;

FIG. 35C is a cross-sectional view of the hand vacuum cleaner of FIG. 35A, taken along line 35C-35C;

FIG. 36A is a front perspective view of another example of a hand vacuum cleaner;

FIG. 36B is a rear perspective view of the hand vacuum cleaner of FIG. 36A;

FIG. 36C is a side view of the hand vacuum cleaner of FIG. 36A;

FIG. 36D is a top view of the hand vacuum cleaner of FIG. 36A;

FIG. 36E is a cross-sectional view of the hand vacuum cleaner of FIG. 36A, taken along line 36E-36E;

FIG. 37A is a side perspective view of another example hand vacuum cleaner;

FIG. 37B is a schematic side view of the hand vacuum cleaner of FIG. 37A;

FIG. 37C is a schematic front view of the hand vacuum cleaner of FIG. 37A;

FIG. 37D is a schematic side cross-sectional view of the hand vacuum cleaner of FIG. 37A, taken along line 37D-37D, with a first openable portion in an open position;

FIG. 37E is a schematic front cross-sectional view of the hand vacuum cleaner of FIG. 37A, taken along line 37E-37E, with the first openable portion in the open position;

FIG. 37F is a schematic side cross-sectional view of the hand vacuum cleaner of FIG. 37A, taken along line 37D-37D, with a second openable portion in an open position;

FIG. 38A is a schematic front view of an example actuator for the first openable portion of the hand vacuum cleaner of FIG. 37A;

FIG. 38B is a schematic front view of the actuator of FIG. 38A, with the first openable portion in the open position;

FIG. 39A is a schematic side view of the hand vacuum cleaner of FIG. 37A docking to a docking station;

FIG. 39B is a schematic side cross-sectional view of the hand vacuum cleaner of FIG. 37A docked to the docking station;

FIG. 40A is a side perspective view of another example hand vacuum cleaner;

FIG. 40B is a schematic side view of the hand vacuum cleaner of FIG. 40A;

FIG. 40C is a schematic side cross-sectional view of the hand vacuum cleaner of FIG. 40A, taken along line 40C-40C;

FIG. 40D is a schematic front cross-sectional view of the hand vacuum cleaner of FIG. 40A, taken along line 40D-40D;

FIG. 40E is a schematic side cross-sectional view of the hand vacuum cleaner of FIG. 40A, taken along line 40C-40C, with a first openable portion in an open position;

FIG. 40F is a schematic front cross-sectional view of the hand vacuum cleaner of FIG. 40A, taken along line 40D-40D, with the first openable portion in the open position;

FIG. 40G is a schematic side cross-sectional view of the hand vacuum cleaner of FIG. 40A, taken along line 40C-40C, with a second openable portion in an open position;

FIG. 41A is a side perspective view of another example hand vacuum cleaner;

FIG. 41B is a schematic side view of the hand vacuum cleaner of FIG. 41A;

FIG. 41C is a schematic front view of the hand vacuum cleaner of FIG. 41A;

FIG. 41D is a schematic side cross-sectional view of the hand vacuum cleaner of FIG. 41A, taken along line 41D-41D, with a first openable portion in an open position;

FIG. 41E is a schematic front cross-sectional view of the hand vacuum cleaner of FIG. 41A, taken along line 41E-41E, with the first openable portion in the open position;

FIG. 41F is a schematic side cross-sectional view of the hand vacuum cleaner of FIG. 41A, taken along line 41D-41D, with a second openable portion in an open position;

FIG. 42A is a side perspective view of another example hand vacuum cleaner;

FIG. 42B is a schematic side cross-sectional view of the hand vacuum cleaner of FIG. 42A, taken along line 42B-42B;

FIG. 42C is a schematic front cross-sectional view of the hand vacuum cleaner of FIG. 42A, taken along line 42C-42C;

FIG. 42D is a schematic side cross-sectional view of the hand vacuum cleaner of FIG. 42A, taken along line 42B-42B, with a first openable portion in an open position;

FIG. 42E is a schematic front cross-sectional view of the hand vacuum cleaner of FIG. 42A, taken along line 42C-42C, with the first openable portion in the open position;

FIG. 42F is a schematic side cross-sectional view of the hand vacuum cleaner of FIG. 42A, taken along line 42B-42B, with a second openable portion in an open position;

FIG. 42G is a schematic front cross-sectional view of the hand vacuum cleaner of FIG. 42A, taken along line 42C-42C, with the second openable portion in the open position;

FIG. 43A is a side perspective view of another example hand vacuum cleaner;

FIG. 43B is a schematic side cross-sectional view of the hand vacuum cleaner of FIG. 43A, taken along line 43B-43B;

FIG. 43C is a schematic front cross-sectional view of the hand vacuum cleaner of FIG. 43A, taken along line 43C-43C;

FIG. 43D is a schematic side cross-sectional view of the hand vacuum cleaner of FIG. 43A, taken along line 43B-43B, with a first openable portion in an open position;

FIG. 43E is a schematic front cross-sectional view of the hand vacuum cleaner of FIG. 43A, taken along line 43C-43C, with the first openable portion in the open position;

FIG. 43F is a schematic side cross-sectional view of the hand vacuum cleaner of FIG. 43A, taken along line 43B-43B, with a second openable portion in an open position;

FIG. 43G is a schematic front cross-sectional view of the hand vacuum cleaner of FIG. 43A, taken along line 43C-43C, with the second openable portion in the open position;

FIG. 44A is a side perspective view of another example hand vacuum cleaner;

FIG. 44B is a schematic side cross-sectional view of the hand vacuum cleaner of FIG. 44A, taken along line 44B-44B;

FIG. 44C is a schematic front cross-sectional view of the hand vacuum cleaner of FIG. 44A, taken along line 44C-44C;

FIG. 44D is a schematic side cross-sectional view of the hand vacuum cleaner of FIG. 44A, taken along line 44B-44B, with a first openable portion in an open position;

FIG. 44E is a schematic front cross-sectional view of the hand vacuum cleaner of FIG. 44A, taken along line 44C-44C, with the first openable portion in an open position and a second openable portion in an open position;

FIGS. 45A to 45E are a schematic front cross-sectional views of example air treatment members of the hand vacuum cleaner of FIG. 44A having different combinations of first and second openable portions;

FIG. 46A is a schematic front cross-sectional view of another example air treatment member of the hand vacuum cleaner of FIG. 44A with the second openable portion using a living hinge;

FIG. 46B is a schematic front cross-sectional view of the air treatment member of FIG. 46A the first openable portion in an open position and the second openable portion in the open position;

FIG. 46C is a schematic front cross-sectional view of the air treatment member of FIG. 46A with the first openable portion in an open position and an alternate second openable portion in the open position;

FIG. 46D is a schematic side cross-sectional view of the hand vacuum cleaner of FIG. 44A having the air treatment member of FIG. 46A being docked to a docking station;

FIG. 46E is a schematic side cross-sectional view of the hand vacuum cleaner of FIG. 46D docked to the docking station;

FIG. 47A is a schematic front cross-sectional view of another example air treatment member of the hand vacuum cleaner of FIG. 44A with the second openable portion using living hinges;

FIG. 47B is a schematic front cross-sectional view of the air treatment member of FIG. 47A with the first and second openable portions in the open position;

FIG. 47C is a schematic front cross-sectional view of the air treatment member of FIG. 47A with the first openable portion in an open position and an alternate second openable portion in the open position;

FIG. 47D is a schematic side cross-sectional view of the hand vacuum cleaner of FIG. 44A having the air treatment member of FIG. 47A being docked to a docking station;

FIG. 47E is a schematic side cross-sectional view of the hand vacuum cleaner of FIG. 47D docked to the docking station;

FIG. 48A is a schematic front cross-sectional view of another example air treatment member of the hand vacuum cleaner of FIG. 44A with an ovaloid second openable portion;

FIG. 48B is a schematic front cross-sectional view of the air treatment member of FIG. 48B with the first openable portion and the ovaloid second openable portion in the open position;

FIG. 49A is a schematic front cross-sectional view of another example air treatment member of the hand vacuum cleaner of FIG. 44A with an ovaloid second openable portion using living hinges;

FIG. 49B is a schematic front cross-sectional view of the air treatment member of FIG. 49A with the first openable portion and the ovaloid second openable portion in the open position;

FIG. 50A is a schematic front cross-sectional view of another example air treatment member of the hand vacuum cleaner of FIG. 44A with a lateral dirt collection chamber;

FIG. 50B is a schematic front cross-sectional view of the air treatment member of FIG. 50A with an openable portion in an open position;

FIG. 51A is a schematic front cross-sectional view of another example air treatment member of the hand vacuum cleaner of FIG. 44A with a lateral dirt collection chamber;

FIG. 51B is a schematic front cross-sectional view of the air treatment member of FIG. 51A with a first openable portion and a second openable portion in an open position;

FIG. 52A is a schematic front cross-sectional view of another example air treatment member of the hand vacuum cleaner of FIG. 44A with a lateral dirt collection chamber;

FIG. 52B is a schematic front cross-sectional view of the air treatment member of FIG. 52A with a first openable portion and a second openable portion in an open position;

FIG. 53A is a schematic front cross-sectional view of another example air treatment member of the hand vacuum cleaner of FIG. 44A with an example gear transmission;

FIG. 53B is a schematic front cross-sectional view of the air treatment member of FIG. 53A with a first openable portion and a second openable portion in an open position;

FIG. 53C is a schematic side cross-sectional view of the hand vacuum cleaner of FIG. 44A having the air treatment member of FIG. 53A docked to a docking station;

FIG. 54A is a schematic front cross-sectional view of another example air treatment member of the hand vacuum cleaner of FIG. 44A with another example gear transmission;

FIG. 54B is a schematic front cross-sectional view of the air treatment member of FIG. 54A with a first openable portion and a second openable portion in an open position;

FIG. 54C is a schematic side cross-sectional view of the hand vacuum cleaner of FIG. 44A having the air treatment member of FIG. 54A docked to a docking station;

FIG. 55A is a schematic front cross-sectional view of another example air treatment member of the hand vacuum cleaner of FIG. 44A with an example magnetic actuator;

FIG. 55B is a schematic front cross-sectional view of the air treatment member of FIG. 55A with a first openable portion and a second openable portion in an open position;

FIG. 55C is a schematic side cross-sectional view of the hand vacuum cleaner of FIG. 44A having the air treatment member of FIG. 55A docked to a docking station;

FIG. 56A is a schematic front cross-sectional view of another example air treatment member of the hand vacuum cleaner of FIG. 44A with another example magnetic actuator;

FIG. 56B is a schematic front cross-sectional view of the air treatment member of FIG. 56A with a first openable portion and a second openable portion in an open position;

FIG. 56C is a schematic side cross-sectional view of the hand vacuum cleaner of FIG. 44A having the air treatment member of FIG. 56A docked to a docking station;

FIG. 57A is a schematic front cross-sectional view of another example air treatment member of the hand vacuum cleaner of FIG. 44A with another example magnetic actuator;

FIG. 57B is a schematic front cross-sectional view of the air treatment member of FIG. 57A with a first openable portion and a second openable portion in an open position;

FIG. 57C is a schematic partial side cross-sectional view of the hand vacuum cleaner of FIG. 44A having the air treatment member of FIG. 57A;

FIG. 57D is a schematic partial side cross-sectional view of the hand vacuum cleaner of FIG. 44A having the air treatment member of FIG. 57A with the first and second openable portions in the open position;

FIG. 57E is a schematic side cross-sectional view of the hand vacuum cleaner of FIG. 44A having the air treatment member of FIG. 57A docked to a docking station;

FIG. 58A is a schematic side cross-sectional view of another example air treatment member of the hand vacuum cleaner of FIG. 44A with an example pulley transmission;

FIG. 58B is a schematic front cross-sectional view of the air treatment member of FIG. 58A, taken along line 58B-58B;

FIG. 58C is a schematic side cross-sectional view of the air treatment member of FIG. 58A with a first openable portion and a second openable portion in an open position;

FIG. 58D is a schematic front cross-sectional view of the air treatment member of FIG. 58A, taken along line 58D-58D in FIG. 58C;

FIG. 59A is a schematic side cross-sectional view of another example air treatment member of the hand vacuum cleaner of FIG. 44A with another example pulley transmission;

FIG. 59B is a schematic front cross-sectional view of the air treatment member of FIG. 59A, taken along line 59B-59B;

FIG. 59C is a schematic side cross-sectional view of the air treatment member of FIG. 59A with a first openable portion and a second openable portion in an open position;

FIG. 59D is a schematic front cross-sectional view of the air treatment member of FIG. 59A, taken along line 59D-59D in FIG. 59C;

FIG. 60A is a schematic side cross-sectional view of another example air treatment member of the hand vacuum cleaner of FIG. 44A with another example pulley transmission;

FIG. 60B is a schematic side cross-sectional view of the air treatment member of FIG. 60A with a first openable portion and a second openable portion in an open position;

FIG. 61A is a schematic side cross-sectional view of another example air treatment member of the hand vacuum cleaner of FIG. 44A with another example pulley transmission;

FIG. 61B is a schematic front cross-sectional view of the air treatment member of FIG. 61A, taken along line 61B-61B;

FIG. 61C is a schematic side cross-sectional view of the air treatment member of FIG. 61A with a first openable portion and a second openable portion in an open position;

FIG. 61D is a schematic front cross-sectional view of the air treatment member of FIG. 61A, taken along line 61D-61D in FIG. 61C;

FIG. 62A is a schematic top cross-sectional view of another example hand vacuum cleaner with an example lock in a locked position;

FIG. 62B is a schematic top cross-sectional view of the hand vacuum cleaner of FIG. 62A with the lock in an unlocked position;

FIG. 62C is an expanded view of section 62C of FIG. 62A;

FIG. 62D is an expanded view of section 62D of FIG. 62B;

FIG. 63A is a schematic top cross-sectional view of another example hand vacuum cleaner with another example lock in a locked position;

FIG. 63B is a schematic top cross-sectional view of the hand vacuum cleaner of FIG. 63A with the lock in an unlocked position;

FIG. 63C is an expanded view of section 63C of FIG. 63A;

FIG. 63D is an expanded view of section 63D of FIG. 63B;

FIG. 64A is a schematic top cross-sectional view of another example hand vacuum cleaner with another example lock in a locked position;

FIG. 64B is a schematic top cross-sectional view of the hand vacuum cleaner of FIG. 64A with the lock in an unlocked position;

FIG. 64C is an expanded view of section 64C of FIG. 64A;

FIG. 64D is an expanded view of section 64D of FIG. 64B;

FIG. 65A is a schematic side cross-sectional view of another example air treatment member of the hand vacuum cleaner of FIG. 44A;

FIG. 65B is a schematic side cross-sectional view of the air treatment member of FIG. 65A with a first openable portion and a second openable portion in an open position;

FIG. 65C is a schematic side cross-sectional view of the air treatment member of FIG. 65A with an alternate second openable portion docked to a docking station;

FIG. 65D is a schematic side cross-sectional view of the air treatment member of FIG. 65A with alternate first and second openable portions docked to a docking station;

FIG. 66A is a schematic side view of another example hand vacuum cleaner;

FIG. 66B is a schematic side cross-sectional view of the hand vacuum cleaner of FIG. 66A;

FIG. 66C is a schematic side cross-sectional view of the hand vacuum cleaner of FIG. 66A with a bottom door and a front door in an open position; and,

FIGS. 67A to 67D are schematic top cross-sectional views of another example air treatment member of the hand vacuum cleaner of FIG. 44A with alternate example dirt outlets.

The drawings included herewith are for illustrating various examples of articles, methods, and apparatuses of the teaching of the present specification and are not intended to limit the scope of what is taught in any way.

### DESCRIPTION OF VARIOUS EMBODIMENTS

Various apparatuses will be described below to provide an example of an embodiment of each claimed invention. No embodiment described below limits any claimed invention and any claimed invention may cover apparatuses that differ from those described below. The claimed inventions are not limited to apparatuses having all of the features of any one apparatus described below or to features common to multiple or all of the apparatuses described below. It is possible that an apparatus described below is not an embodiment of any claimed invention. Any invention disclosed in an apparatus described below that is not claimed in this document may be the subject matter of another protective instrument, for example, a continuing patent application, and the applicants, inventors or owners do not intend to abandon, disclaim or dedicate to the public any such invention by its disclosure in this document.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s),” unless expressly specified otherwise.

The terms “including”, “comprising”, and variations thereof mean “including but not limited to”, unless expressly specified otherwise. A listing of items does not imply that any or all of the items are mutually exclusive, unless expressly specified otherwise. The terms “a”, “an”, and “the” mean “one or more”, unless expressly specified otherwise.

As used herein and in the claims, two or more parts are said to be “coupled”, “connected”, “attached”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, or “directly fastened” where the parts are connected in physical contact with each other. As used herein, two or more parts are said to be “rigidly coupled”, “rigidly connected”, “rigidly attached”, or “rigidly fastened” where the parts are coupled so as to move as one while maintaining a constant orientation relative to each other. None of the terms “coupled”, “connected”, “attached”, and “fastened” distinguish the manner in which two or more parts are joined together.

Some elements herein may be identified by a part number, which is composed of a base number followed by an alphabetical or subscript-numerical suffix (e.g., 112a, or 112₁). Multiple elements herein may be identified by part numbers that share a base number in common and that differ by their suffixes (e.g., 112₁, 112₂, and 112₃). All elements with a common base number may be referred to collectively or generically using the base number without a suffix (e.g., 112).

It should be noted that terms of degree such as “substantially”, “about”, and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

### General Description of a Surface Cleaning Apparatus

Referring to the Figures, exemplary embodiments of a surface cleaning apparatuses are shown. The following is a general discussion of surface cleaning apparatuses which provides a basis for understanding several of the features which are discussed herein. As discussed subsequently, each of the features may be used individually or in any particular combination or sub-combination in this or in other embodiments disclosed herein.

In the illustrated embodiments, the surface cleaning apparatus is a hand vacuum cleaner 1000, which may also be referred to also as a “handvac” or “hand-held vacuum cleaner”. As used herein, a hand vacuum cleaner 1000 is a surface cleaning apparatus that can be operated to clean a surface generally one-handedly. That is, the entire weight of the hand vacuum cleaner 1000 may be held by the same one hand used to direct a dirty air inlet 1002 of the hand vacuum cleaner 1000 with respect to a surface to be cleaned. For example, the handle 1004 and the dirty air inlet 1002 may be rigidly coupled to each other (directly or indirectly) so as to move as one while maintaining a constant orientation relative to each other. This is to be contrasted with, for example, canister and upright vacuum cleaners, whose weight is typically supported by a surface (e.g., a floor) during use.

While the illustrated embodiments depict example hand vacuum cleaners 1000, it is to be understood that many of the features described herein may relate to, and be used with non-hand vacuum cleaners, such as, for example, canister vacuum cleaners, upright vacuum cleaners, stick vacuum cleaners, all-in-head vacuum cleaners, carpet extractors, wet/dry vacuum cleaner, etc.

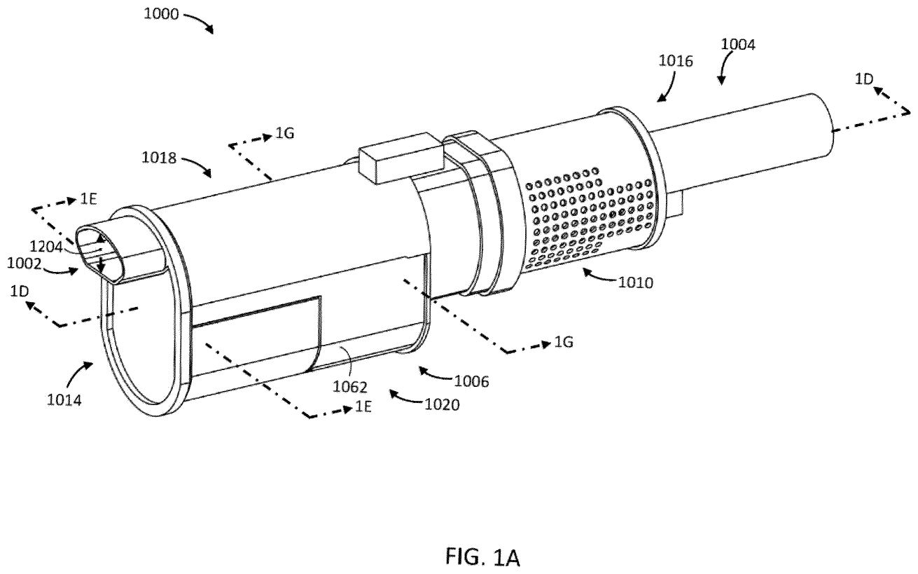

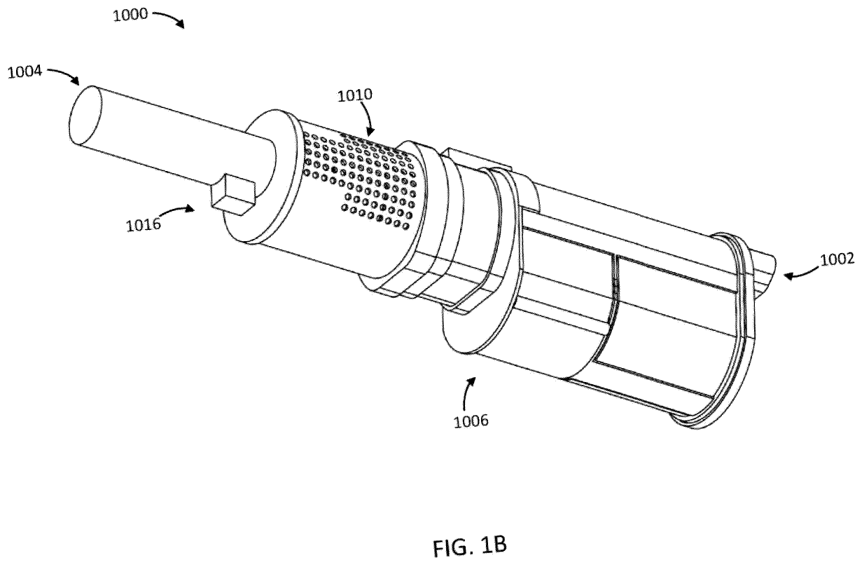

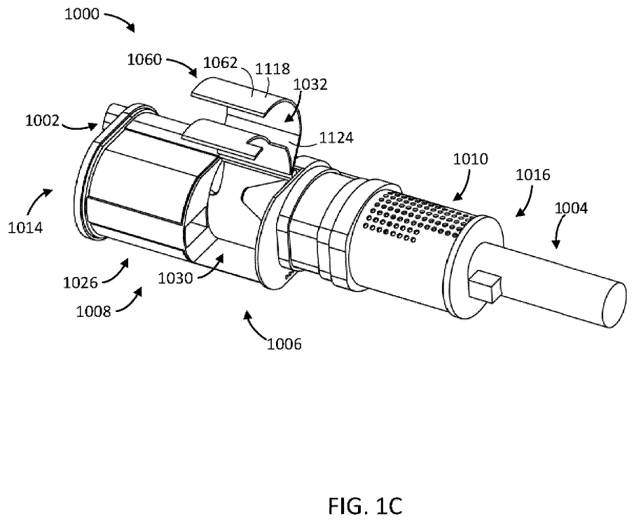

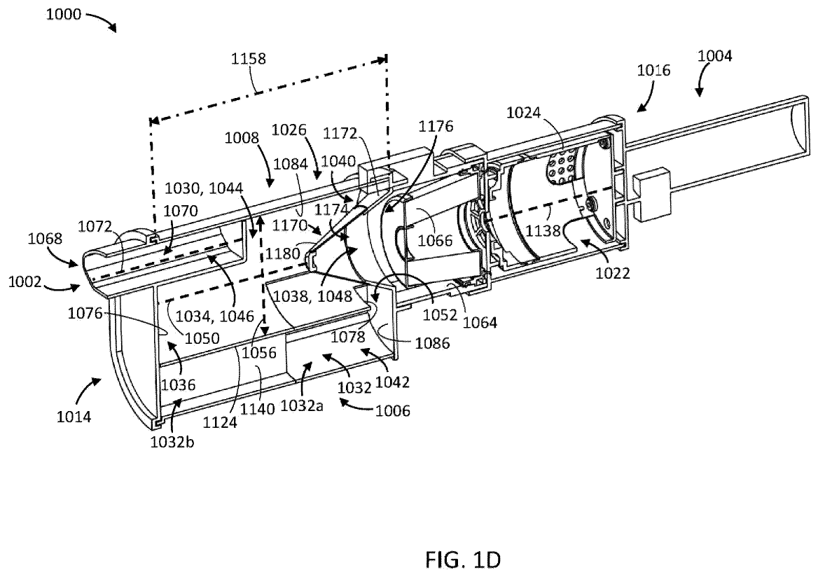

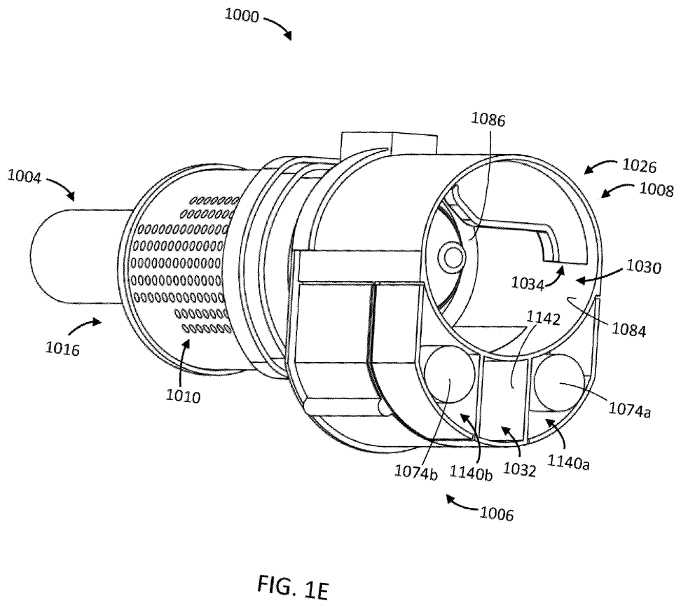

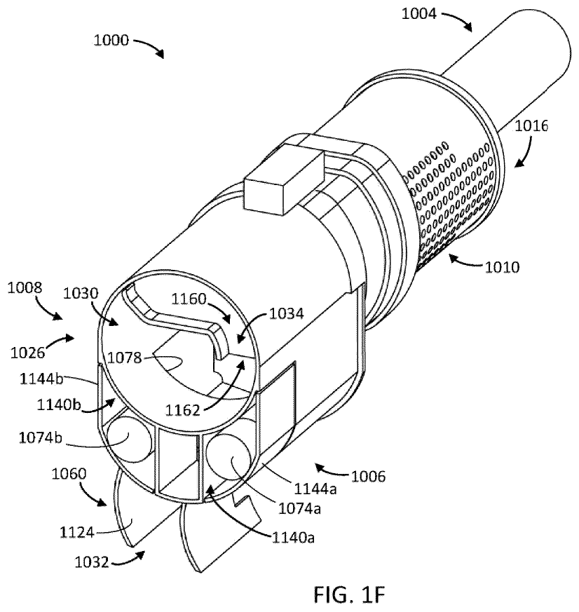

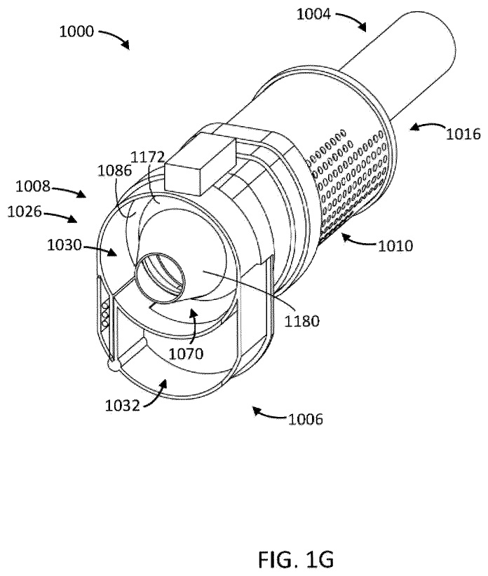

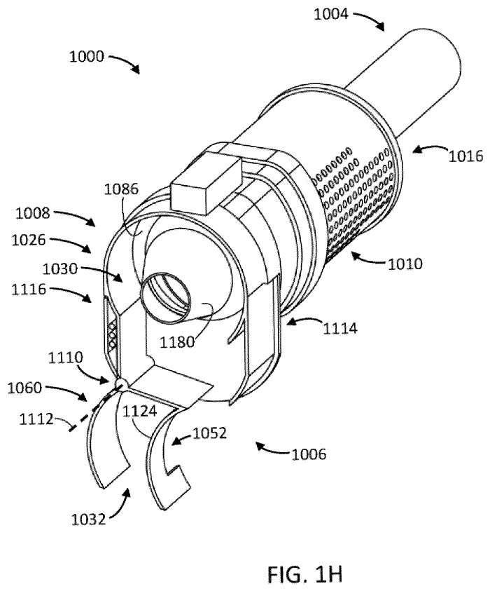

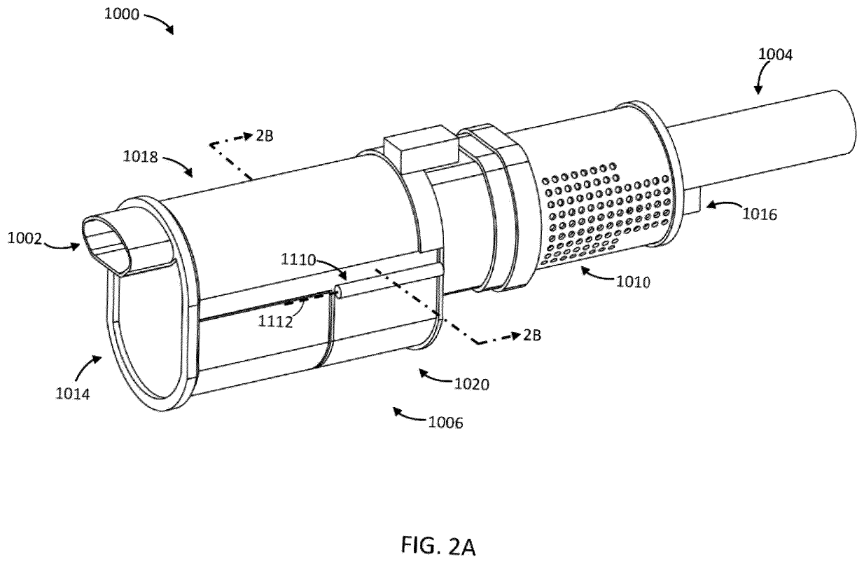

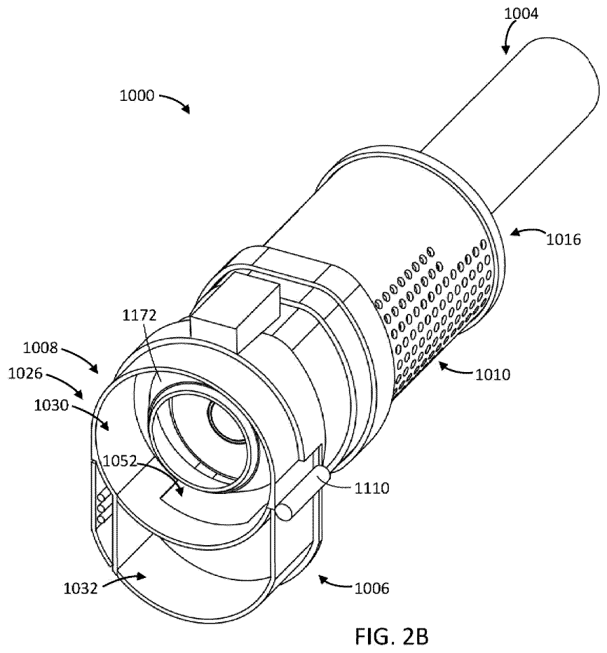

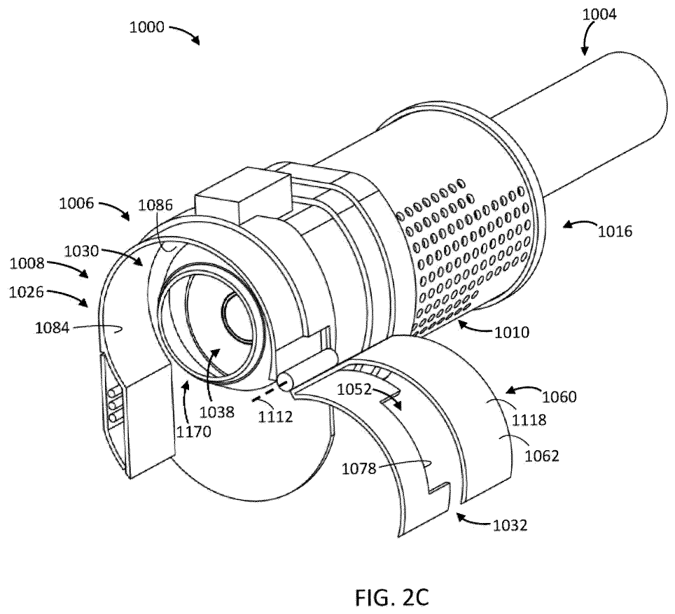

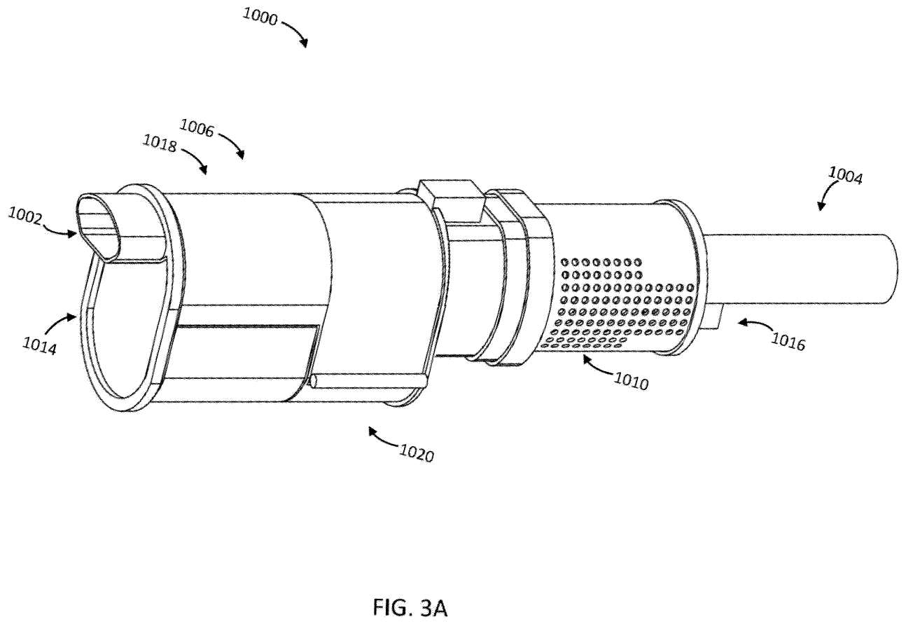

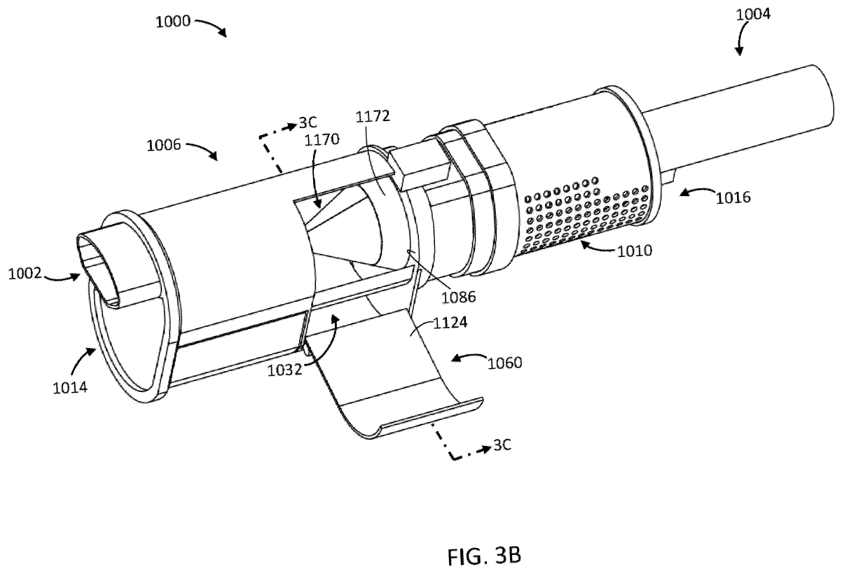

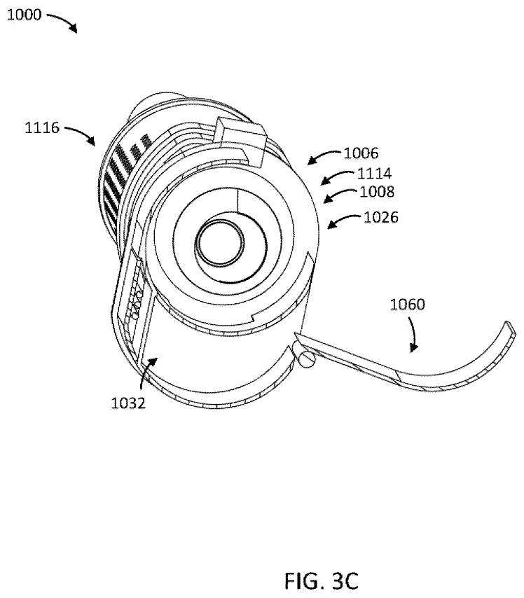

As exemplified in FIGS. 1A-1H, a surface cleaning apparatus may include a main body 1006, a handle 1004, an air treatment member 1008, a dirty air inlet 1002, a clean air outlet 1010, and an air flow path extending between the dirty air inlet 1002 and the clean air outlet 1010. The air treatment member 1008 is positioned in the air flow path between the dirty air inlet 1002 and the clean air outlet 1010.

As shown, the main body 1006 of the surface cleaning apparatus has a front end 1014, a rear end 1016, an upper end 1018 (i.e., top end), and a lower end 1020 (i.e., bottom end). As exemplified in the embodiment shown in FIG. 1A, the dirty air inlet 1002 may be at the upper end 1018 of the front end 1014 of the main body 1006 and the clean air outlet 1010 may be positioned intermediate the front end 1014 and the rear end 1016, or alternately at the rear end. It will be appreciated that the dirty air inlet 1002 and the clean air outlet 1010 may be provided in different locations.

A suction motor 1022 (i.e., motor and fan assembly) (see e.g., FIG. 1D) is provided within the main body 1006 to generate vacuum suction through the air flow path and may be positioned within a motor housing 1024. In the example illustrated, the suction motor 1022 is positioned downstream from the air treatment member 1008, although it may be positioned upstream of the air treatment member 1008 (e.g., a dirty air motor) in alternative embodiments. As exemplified, the motor housing 1024 may form part of the exterior surface of the hand vacuum cleaner.

The air treatment member 1008 is configured to remove particles of dirt and other debris from the air flow and/or otherwise treat the air flow. Any air treatment member 1008 known in the art may be used. As exemplified, the air treatment member 1008 may include an air treatment chamber 1044 and a dirt collection chamber 1032 that is external to the air treatment chamber 1044. Dirty air may enter the air treatment chamber 1044 via an air treatment chamber air inlet 1046 and exit the air treatment chamber 1044 as relatively cleaner air via an air treatment chamber air outlet 1048.

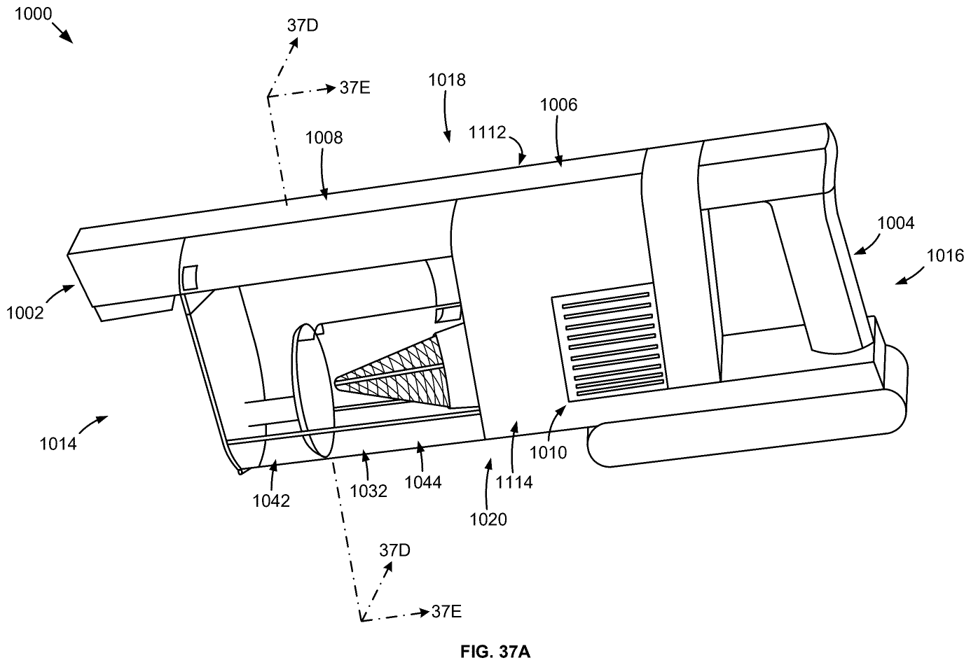

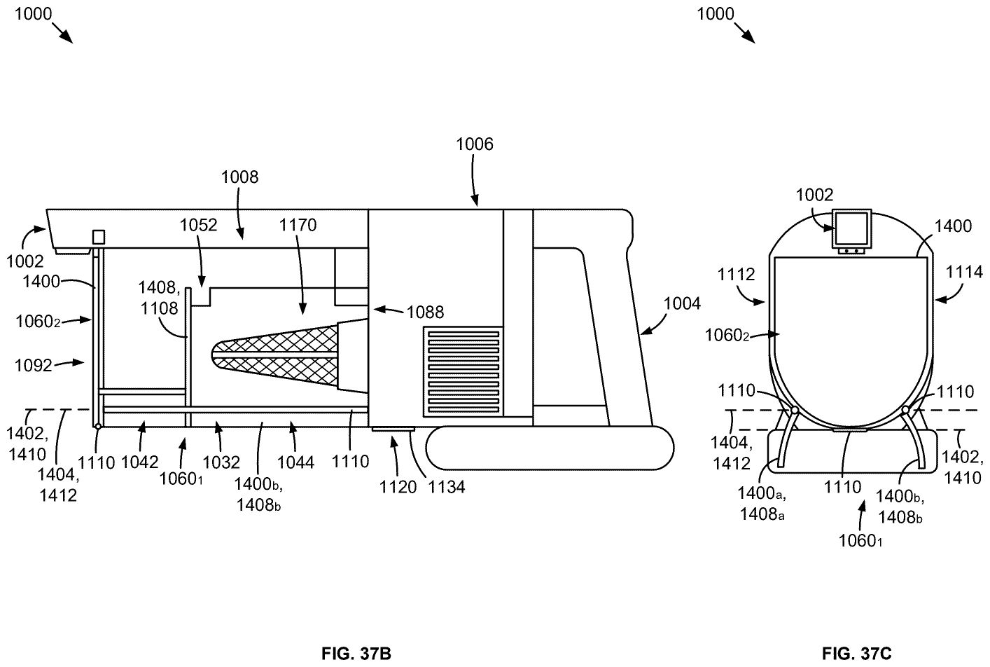

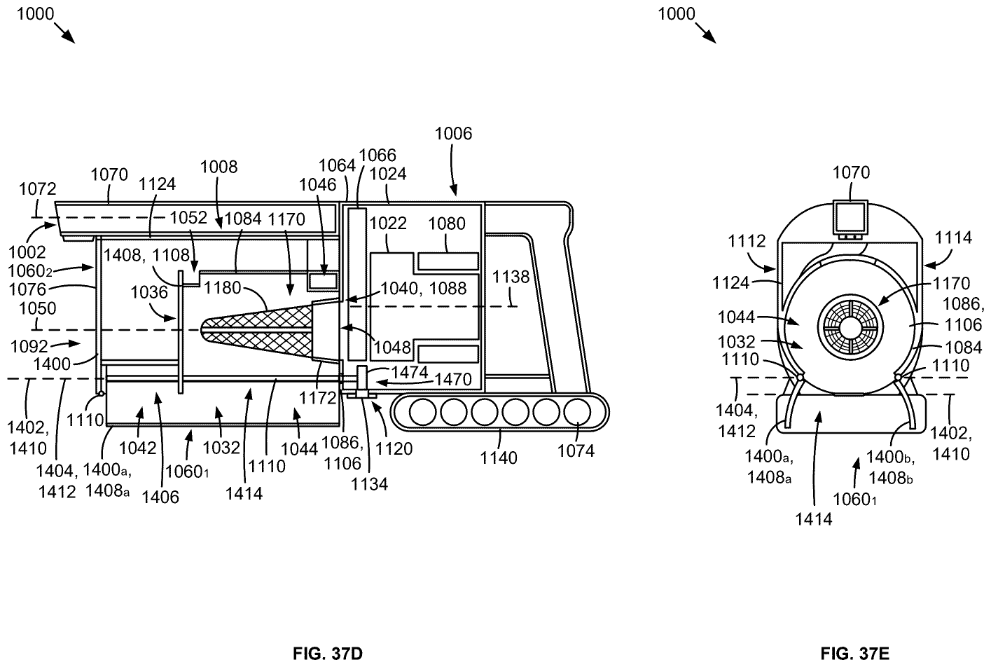

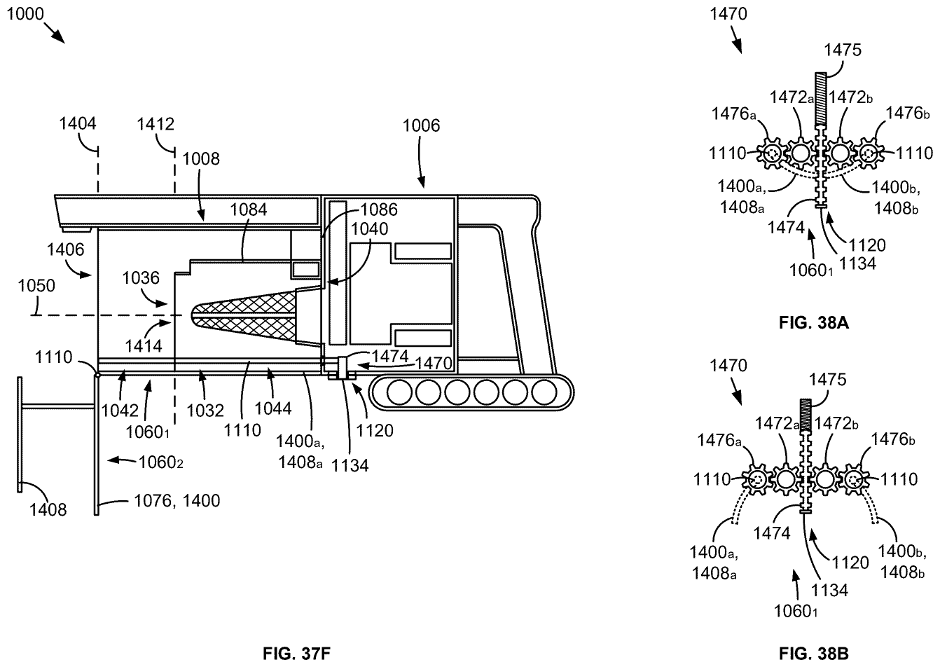

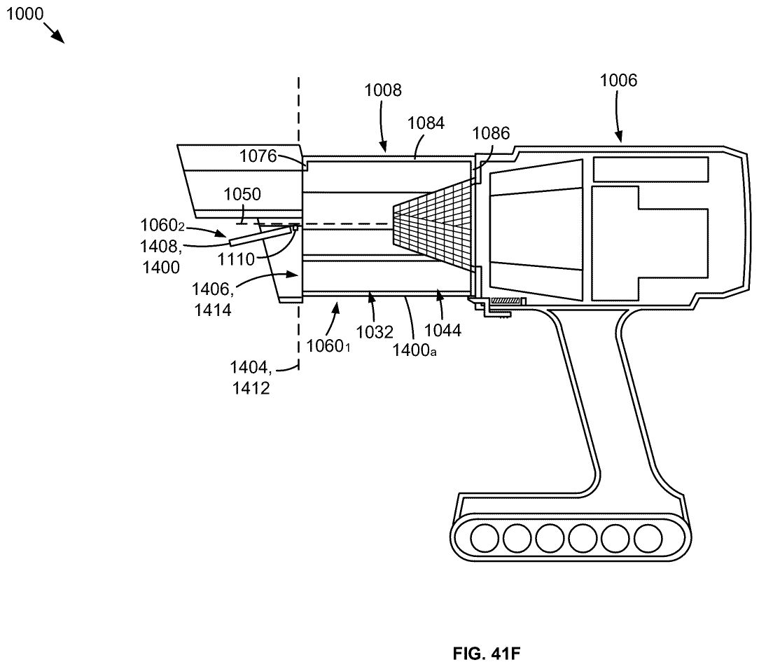

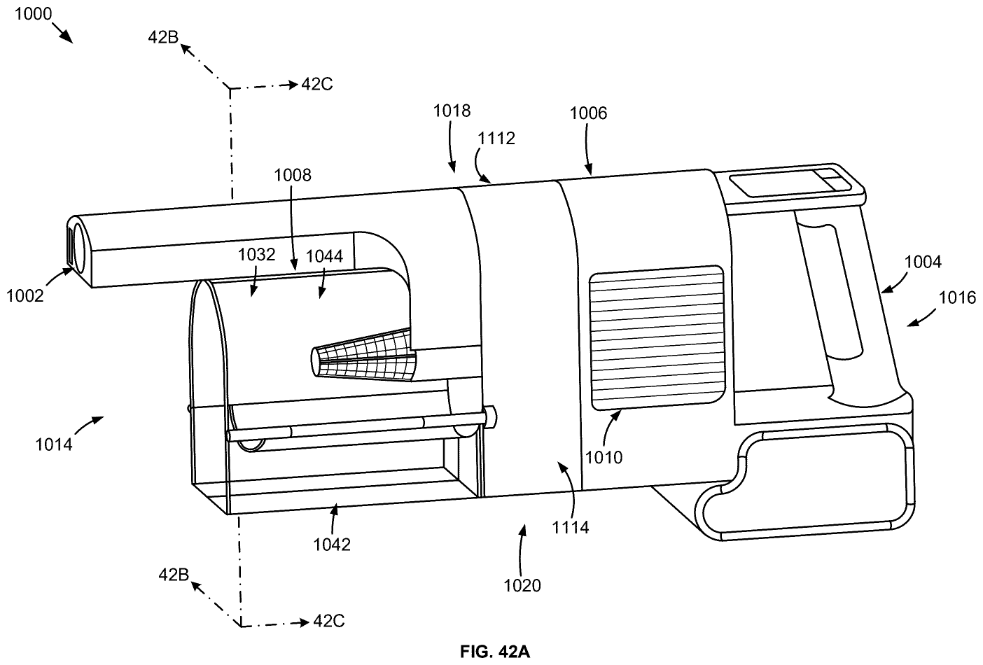

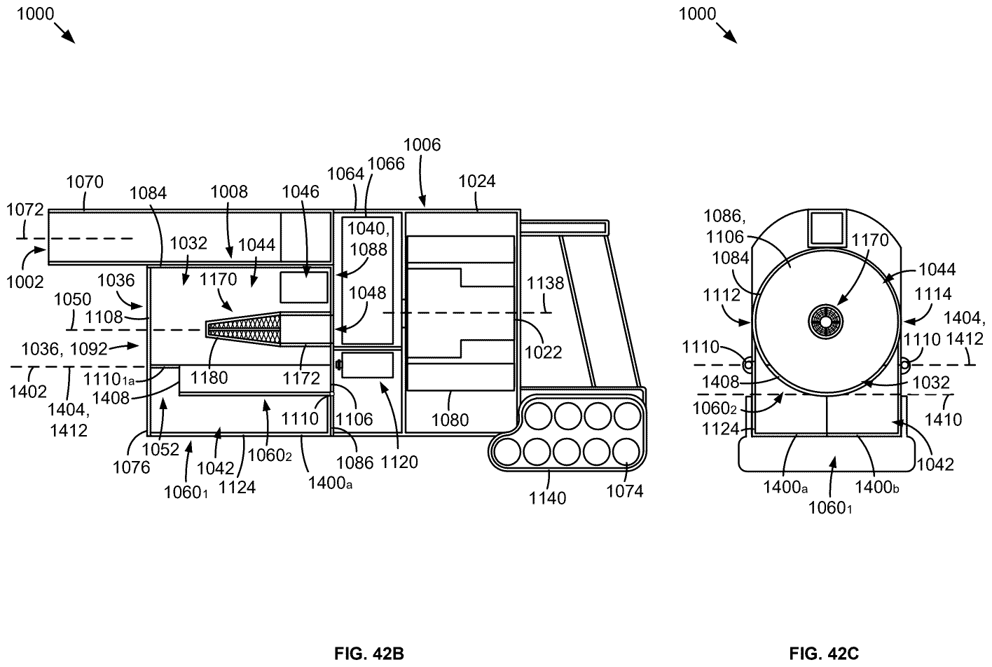

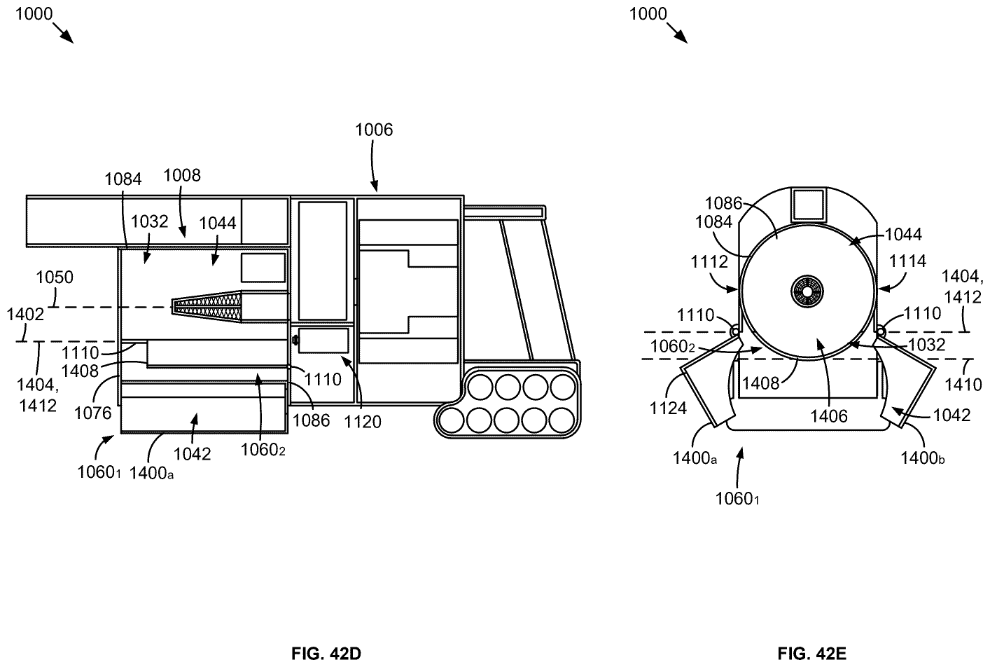

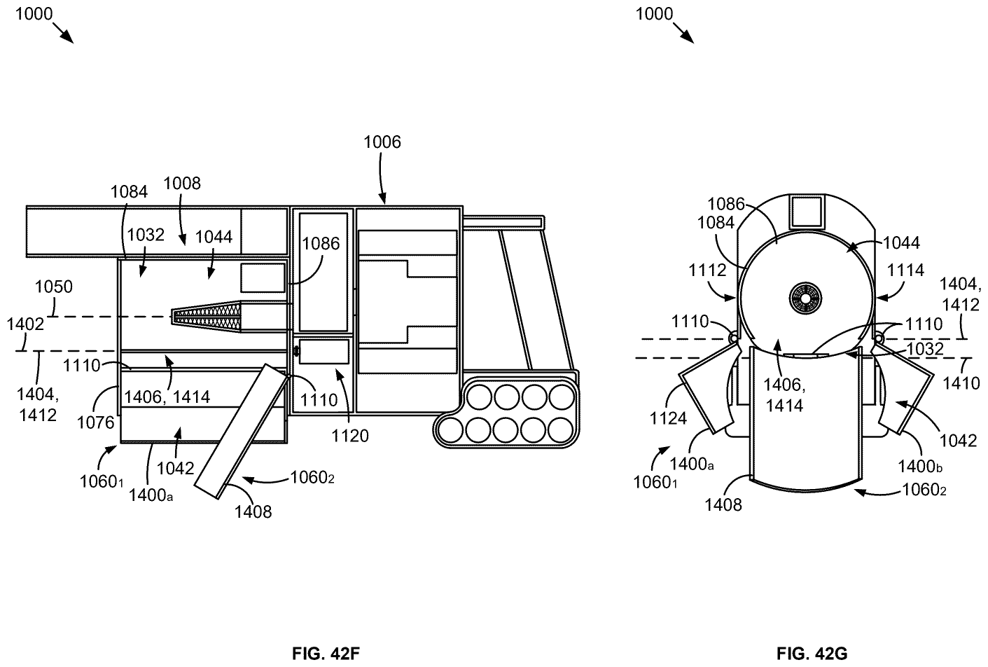

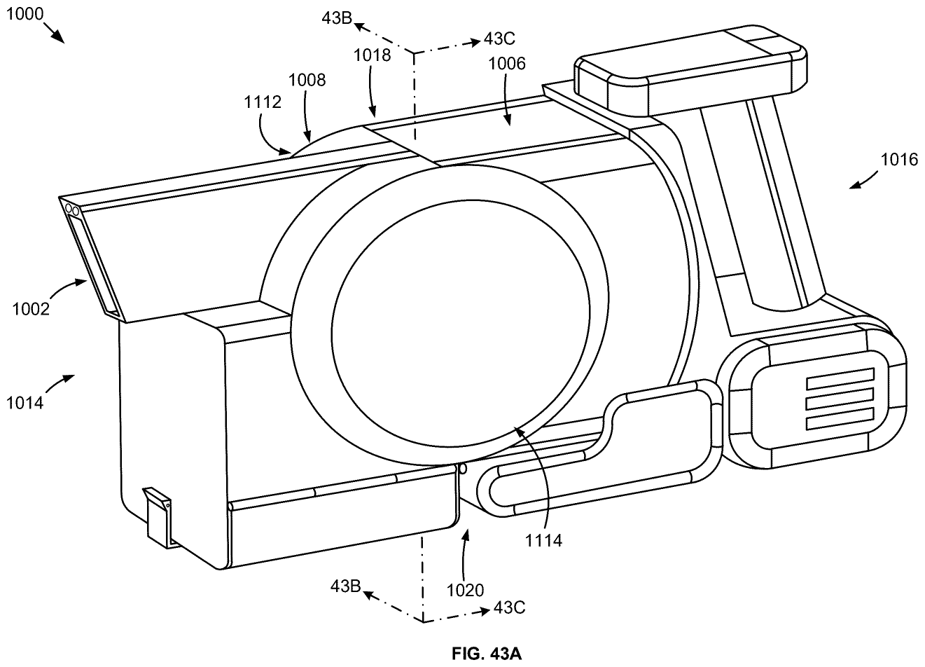

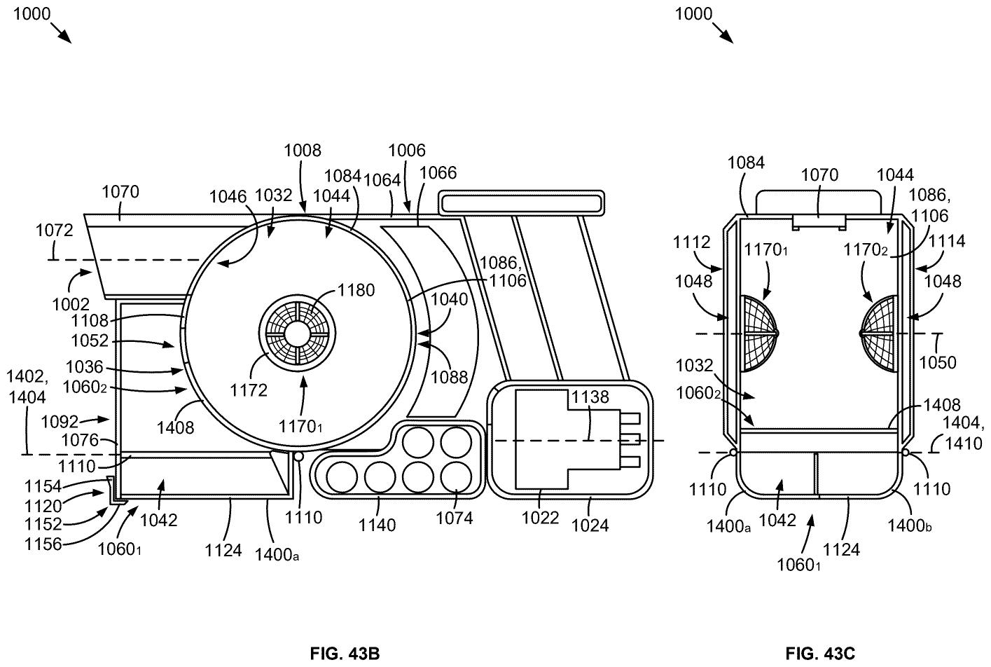

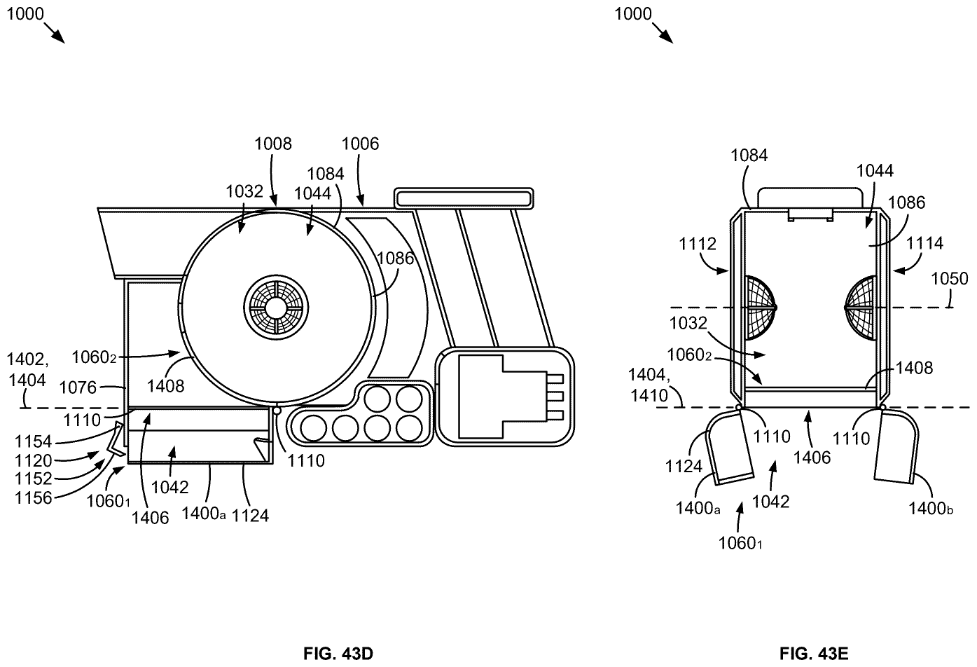

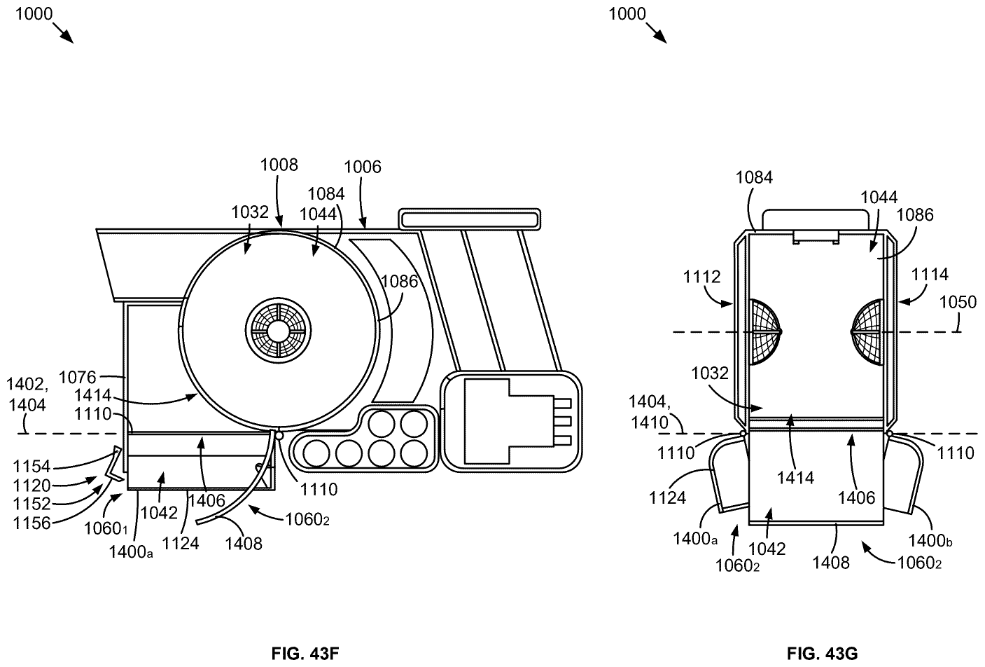

In the example illustrated in FIG. 1D, the air treatment member 1008 is a cyclone assembly 1026 having a single cyclone chamber 1030 and a dirt collection chamber 1032 external to the cyclone chamber 1030 (i.e., a single cyclonic cleaning stage). The cyclone chamber 1030 and dirt collection chamber 1032 may be of any configuration suitable for separating debris from an air flow and collecting the separated debris, respectively. In the example shown in FIG. 1D, the cyclone chamber 1030 is a uniflow cyclone (i.e., a cyclone with a unidirectional flow of air). As exemplified, a uniflow cyclone may have a cyclone air inlet 1034 at a first end (front end 1036 in the example illustrated) of the cyclone chamber 1030 and a cyclone chamber air outlet 1038 at an opposite end (rear end 1040 in the example illustrated) of the cyclone chamber 1030. In other examples, the cyclone chamber 1030 may not be a uniflow, and the cyclone air inlet 1034 and the cyclone chamber air outlet 1038 may be provided at the same end of the cyclone chamber 1030 (see e.g., FIGS. 37D and 42B). In other examples, the cyclone chamber 1030 may be a transverse cyclone, and the cyclone air inlet 1034 may be provided centrally between the laterally spaced apart ends of the cyclone chamber 1030 with a cyclone chamber air outlet 1038 provided in one or both of the laterally spaced apart ends (see e.g., FIGS. 43B and 43C). It will also be appreciated that separated dirt may be collected in a dirt collection region that is contiguous with the cyclone chamber.

The cyclone chamber 1030 may be oriented in any direction. For example, when surface cleaning apparatus is oriented with the upper end 1018 above the lower end 1020, e.g., positioned generally parallel to a horizontal surface, a central axis 1050, or axis of rotation, of the cyclone chamber 1030 may be oriented horizontally and extend between the front end 1014 and the rear end 1016, as exemplified in FIG. 1D, or may be oriented horizontally and extend between the first lateral side 1112 and the opposed second lateral side 1114, as exemplified in FIG. 43C. In alternative embodiments, the cyclone chamber 1030 may be oriented vertically, or at any angle between horizontal and vertical.

In alternative embodiments, the cyclone assembly 1026 may include two or more cyclonic cleaning stages arranged in series with each other. Each cyclonic cleaning stage may include one or more cyclone chambers 1030 (arranged in parallel or series with each other) and one or more dirt collection chambers 1032 of any suitable configuration. The dirt collection chamber(s) 1032 may be external to the cyclone chamber(s) 1030 (i.e., configured as an external dirt collection chamber 1042 with a dirt collection area or region exterior to the cyclone chamber(s) and in communication with the cyclone chamber by one or more dirt outlets) or may be internal the cyclone chamber(s) 1030 (i.e., configured as a dirt collection area or region 1032 within the cyclone chamber(s)). It will be appreciated that an air treatment assembly may have two or more stages, each of which may use one or more air treatment chambers.

Optionally, the external dirt collection chamber(s) 1042 may be positioned radially outward from the air treatment chamber 1044 of the air treatment member 1008. A dirt outlet may connect the air treatment chamber 1044 to the dirt collection chamber 1032. In the example illustrated in FIG. 1D, the external dirt collection chamber 1042 is positioned radially outward from the cyclone chamber 1030. As shown, when the dirt collection chamber(s) 1032 are external to the cyclone chamber(s) 1030, a dirt outlet 1052 or dirt outlets may fluidically connect the cyclone chamber(s) 1030 with the external dirt collection chamber(s) 1042.

Alternatively, the air treatment chamber 1044 of the air treatment member 1008 may not be a cyclonic cleaning stage. Such a non-cyclonic stage may be a non-cyclonic air treatment chamber or it may incorporate a bag, a porous physical filter media (such as foam or felt), or other air treating means. A combination of non-cyclonic and cyclonic treatment members may be used.

The air treatment member 1008 may include one or more openable portions 1060 that are moveable between an open position and a closed position. The openable portion(s) 1060 may, when in the open position, facilitate discharge of debris separated from the air flow by the air treatment member therefrom; and/or urge debris that may be compacted within the air treatment member 1008 to dislodge therefrom when moving from the closed position to the open position. The openable portion(s) 1060 may include a portion of an exterior surface 1062 of the main body 1006 of the surface cleaning apparatus so opening the openable portion 1060 may facilitate discharge of debris from the surface cleaning apparatus. Various configurations of the openable portion(s) 1060 are described in more detail subsequently.

As exemplified in FIG. 1D, the hand vacuum cleaner 1000 may include a pre-motor filter 1066. The pre-motor filter may be provided in a pre-motor filter housing 1064 provided in the air flow path downstream of the air treatment member 1008 and upstream of the suction motor 1022. The pre-motor filter housing 1064 may be of any suitable construction known in the art. A pre-motor filter 1066 may be positioned within the pre-motor filter housing 1064. The pre-motor filter 1066 may have a front end 1054 and a rear end 1058. The pre-motor filter 1066 may be formed from any suitable physical, porous filter media and have any suitable shape. For example, the pre-motor filter 1066 may be one or more of a foam filter, felt filter, HEPA filter, other physical filter media, electrostatic filter, and the like.

Optionally, the pre-motor filter housing 1064 may be openable to provide access to the interior of the pre-motor filter housing 1064.

The hand vacuum cleaner 1000 may also include a post-motor filter (see e.g., 1080 in FIG. 37D) provided in the air flow path downstream of the suction motor 1022 and upstream of the clean air outlet 1010. The post-motor filter may be formed from any suitable physical, porous filter media and having any suitable shape. The post-motor filter may be any suitable type of filter such as one or more of a foam filter, felt filter, HEPA filter, other physical filter media, electrostatic filter, and the like.

Still referring to FIG. 1D, in the example illustrated, the dirty air inlet 1002 of the surface cleaning apparatus is the inlet end 1068 of an inlet conduit 1070 provided at the front end 1014 of the surface cleaning apparatus. Optionally, inlet end 1068 of the inlet conduit 1070 can be used as a nozzle to directly clean a surface. The inlet conduit 1070 is, in this example, a generally linear hollow conduit that extends along an inlet conduit axis 1072 that is oriented in a longitudinal forward/backward direction and is generally horizontal when the hand vacuum cleaner 1000 is oriented with the upper end 1018 above the lower end 1020. Alternatively, or in addition to functioning as a nozzle, the inlet conduit 1070 may be connected or directly connected to the downstream end of any suitable accessory tool such as, for example, a rigid air flow conduit (e.g., an above floor cleaning wand), a crevice tool, a mini brush, and the like. As shown, the dirty air inlet 1002 is positioned forward of the air treatment member 1008, although this need not be the case.

As exemplified, power may be supplied to the suction motor 1022 and other electrical components of the hand vacuum cleaner 1000 from an onboard energy storage member 1074 which may include, for example, one or more batteries, capacitors or other energy storage devices. Optional battery positions and types are described subsequently in further detail herein. In alternative embodiments, in addition to the energy storage member 1074 or instead of the energy storage member 1074, power may be supplied to the hand vacuum cleaner 1000 by an electrical cord connected to the hand vacuum cleaner 1000 (not shown) and that can be connected to a standard wall electrical outlet.

A power switch (not shown) may be provided to selectively control the operation of the motor and fan assembly 1022 (e.g., either on/off or variable power levels or both), for example by establishing a power connection between the energy storage member 1074 and the motor and fan assembly 1022. The power switch may be provided in any suitable configuration and location, including a button, rotary switch, sliding switch, trigger-type actuator and the like. The power switch or an alternate controller may also be configured to control other aspects of the hand vacuum cleaner 1000 (brush motor on/off, etc.).

### Docking Station

A vacuum cleaner in accordance with any of the aspects of this disclosure may be used in combination with a docking station.

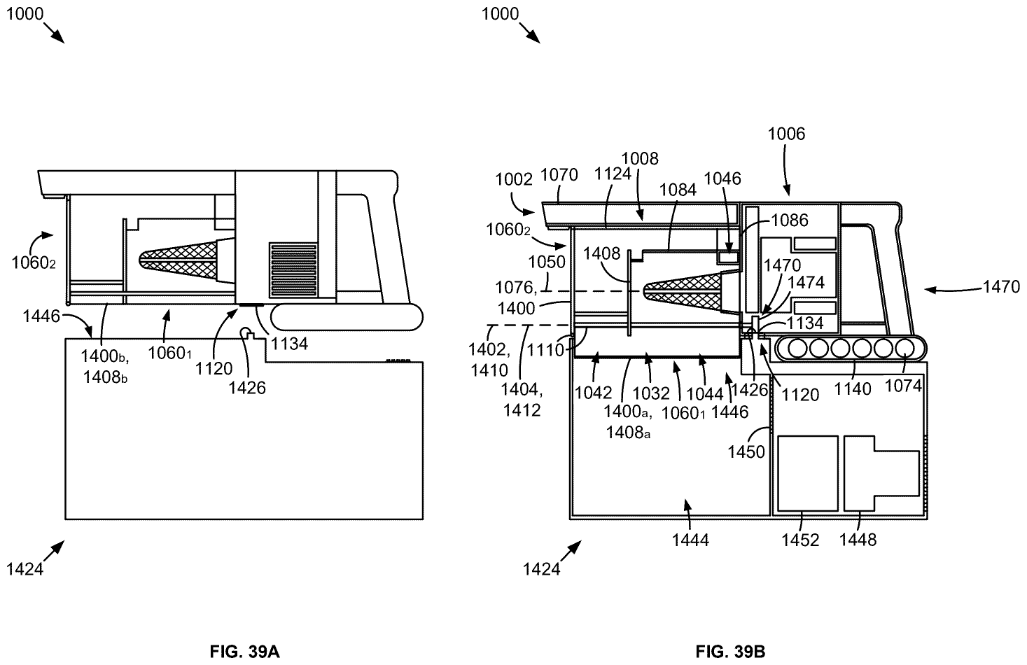

Referring to FIGS. 39A-39B, 46D-46E, 47D-47E, 53C, 54C, 55C, 56C, 57E, and 65C-65D, as exemplified, the hand vacuum cleaner 1000 may be docked at a docking station 1424 for emptying and/or recharging the energy storage members 1074 (if any). As exemplified, the docking station 1424 may include a station receptacle 1444 downstream from a station inlet port 1446. The hand vacuum cleaner 1000 may be docked to the docking station 1424 at the station inlet port 1446.

Once docked or upon docking, the openable portion(s) 1060 may automatically move from the closed position (see e.g., FIGS. 39A, 46D, and 47D) to the open position (see e.g., FIGS. 39B, 46E, 47E, 53C, 540, 550, 56C, 57E, 65C, and 65D). When the hand vacuum cleaner 1000 is docked to the docking station 1424 and the openable portion(s) 1060 is/are in the open position, the external dirt collection chamber 1042 and, optionally (as shown), the dirt collection region 1032 within the air treatment chamber 1044, may be placed in fluid communication with the station receptacle 1444. Subsequently, a motor and fan assembly, such as the suction motor of the vacuum cleaner or, as exemplified, a station suction motor 1448 may generate suction to draw dirt collected in the hand vacuum cleaner 1000 through the opening of the openable portion(s) 1060, through the station inlet port 1446, and into the station receptacle 1444.

The station suction motor 1448 may generate a station airflow path from the station inlet port 1446, through the station receptacle 1444, and to a station clean air outlet (not shown) downstream from the station suction motor 1448. The station airflow path may travel through a station air treatment member 1450 at a receptacle air outlet. Optionally, the station airflow path 288 may pass through a station pre-motor filter 1452 intermediate the station air treatment member 1450 and the station suction motor 1448. Optionally, the station airflow path may pass through a station post-motor filter (not shown) intermediate the station suction motor 1448 and the station clean air outlet.

The station air treatment member 1450 may be any air treatment member for separating particulate matter from the station airflow path. For example, the station receptacle 1444 may be any cyclonic air treatment chamber and the station air treatment member 1450 may be a vortex finder 1170 at the receptacle air outlet. Alternatively, the station receptacle 1444 may be non-cyclonic, and the station air treatment member 1450 may be a filter bag, a porous physical filter material (such as a screen, foam, or felt), or other air treating means. In the illustrated examples, the station receptacle 1444 is an air treatment chamber that is a non-cyclonic momentum separator and the station air treatment member 1450 is a porous physical filter material provided at or over the receptacle air outlet. The withdrawn dirt from the vacuum cleaner that is separated from air flowing through the station airflow path by the station air treatment member 1450 may collect in the station receptacle 1444. The station receptacle 1444 may be removed from the docking station 1424 for emptying.

### The Openable Portion

In accordance with this aspect of this disclosure, which may be used by itself or in combination with one or more other aspects of this disclosure, the air treatment member 1008 of the surface cleaning apparatus may include one or more openable portions 1060.

Each openable portion 1060 is movable between a first position (i.e., an open position) and a second position (i.e., a closed or operating or cleaning position). In some examples, when the openable portion 1060 is in the open position, debris separated from the air flow by the air treatment member 1008 may be discharged out from the air treatment member 1008 through the openable portion 1060. In the closed position, the openable portion 1060 may close the air treatment member 1008 for efficient operation of the air treatment member 1008. Optionally, the openable portion 1060 includes a portion of the exterior surface 1062 of the main body 1006 so that opening of the openable portion 1060 may facilitate discharge of debris from the surface cleaning apparatus and into, for example, a garbage bin.

Movement of the openable portion 1060 from the closed position to the open position may urge debris, which may have collected and may have compacted within corners and small openings within the air treatment member 1008, to dislodge by moving one of the walls that forms the corner with respect to another wall that forms the corner and/or moving one portion of the perimeter of an opening (e.g., dirt outlet) with respect to another portion of the opening. By separating walls that form a corner and/or moving a portion of a wall that defines a dirt outlet, compacted dirt, such as dirt that partially or fully bridges a dirt outlet, may be loosened and may therefore fall out under the influence of gravity when the openable portion is opened. In contrast, in known devices, operators may often be required to repeatably strike the surface cleaning apparatus, in particular the dirt collection chamber, to loosen and discharge the compacted collected debris.

An advantage of this aspect is that compacted debris which may impede air flow through the air treatment member 1008, and which may therefore lead to a decrease in cleaning efficiency (i.e., the ability to separate debris from an airflow and/or energy required to operate the surface cleaning apparatus), may be more easily removed.

For example, over time, the dirt outlet 1052 or an air treatment chamber may tend to clog with compacted debris. Movement of the openable portion 1060 from the closed position to the open position may cause a wall forming part, but not all, of the perimeter of the dirt outlet 1052 to move with respect to the rest of the perimeter of the dirt outlet, thereby opening the dirt outlet 1052, which may urge the compacted debris which may partially bridge the dirt outlet 1052 to be dislodged from the dirt outlet 1052.

It will be appreciated that a cleaning member may be provided which may moveable, e.g., axially or towards the opening when the openable portion 1060 is open, to assist is removing debris from the air treatment member 1008.

### Operation of the Openable Portion

In accordance with this aspect of this disclosure, which may be used by itself or in combination with one or more other aspects of this disclosure, if an openable portion is provided, then the openable portion 1060 may move between the closed position and the open position by any means known in the art.

For example, to open the dirt outlet 1052, the perimeter 1078 of the dirt outlet 1052 may be increased in size; and/or a wall defining a portion of the perimeter 1078 may be displaced, thereby opening the perimeter 1078.

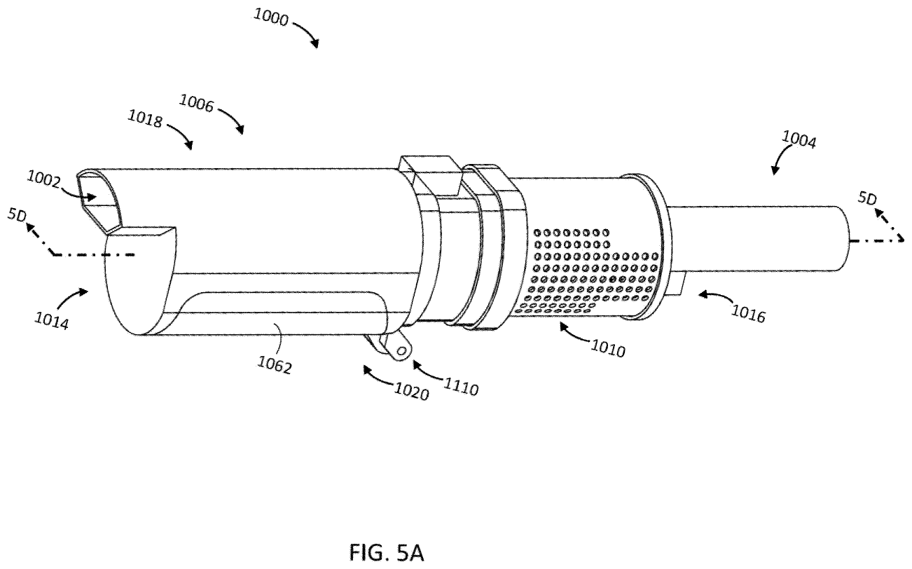

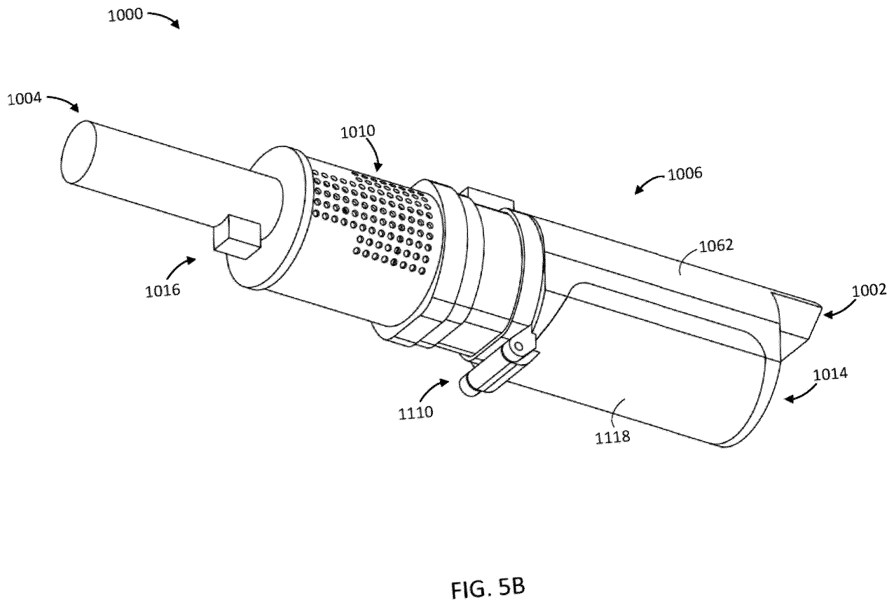

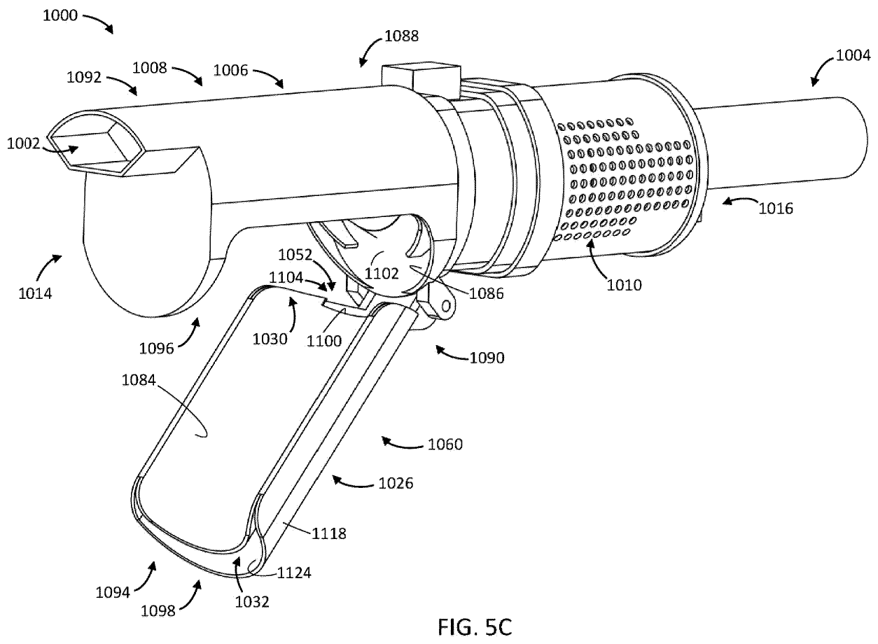

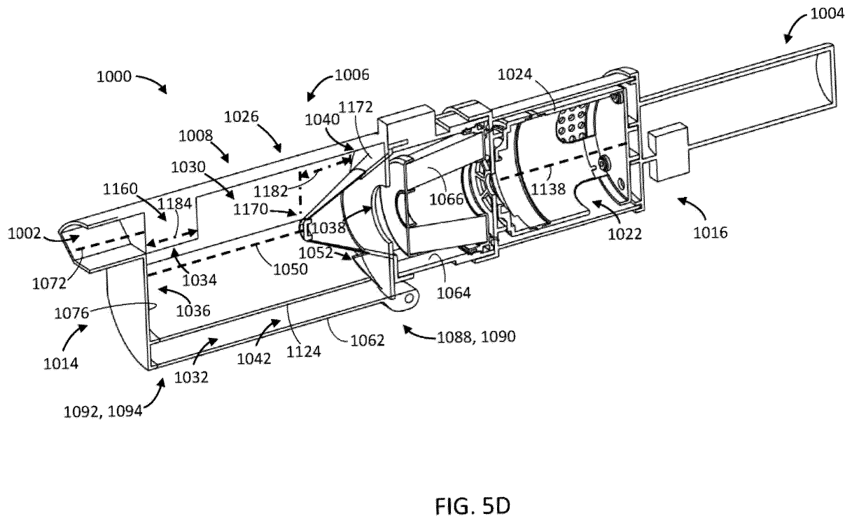

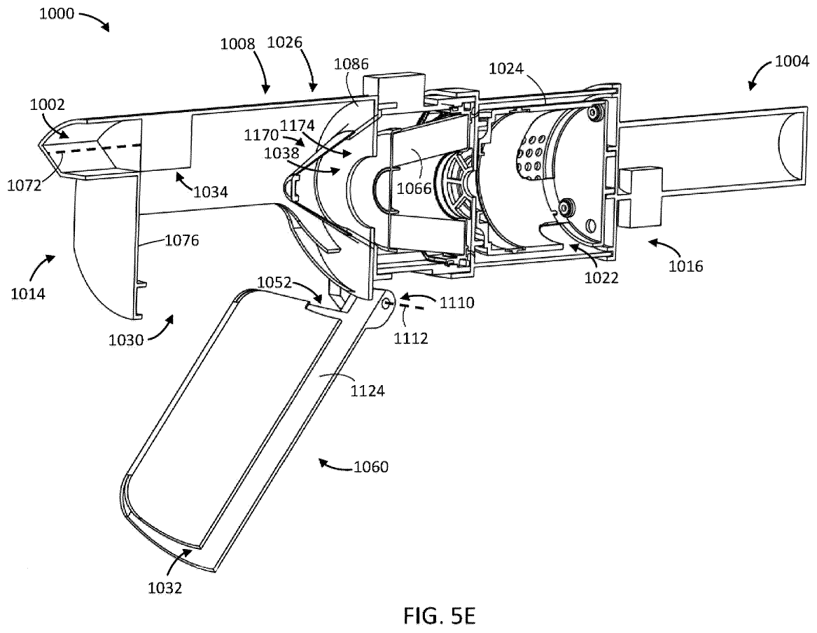

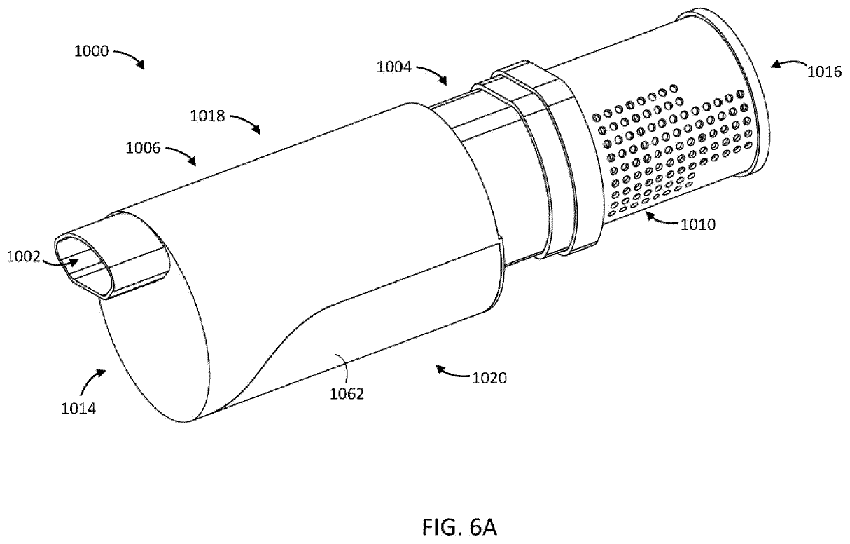

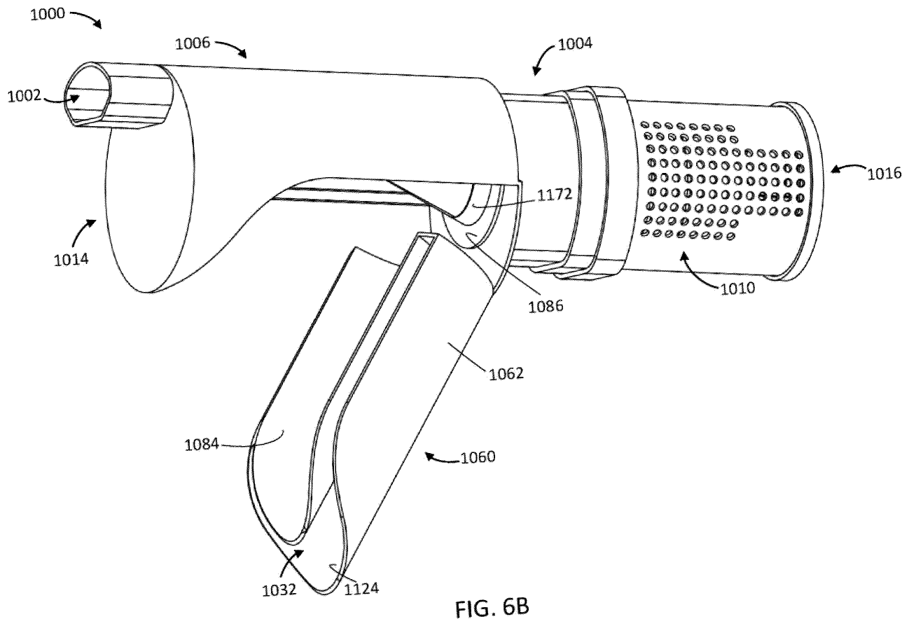

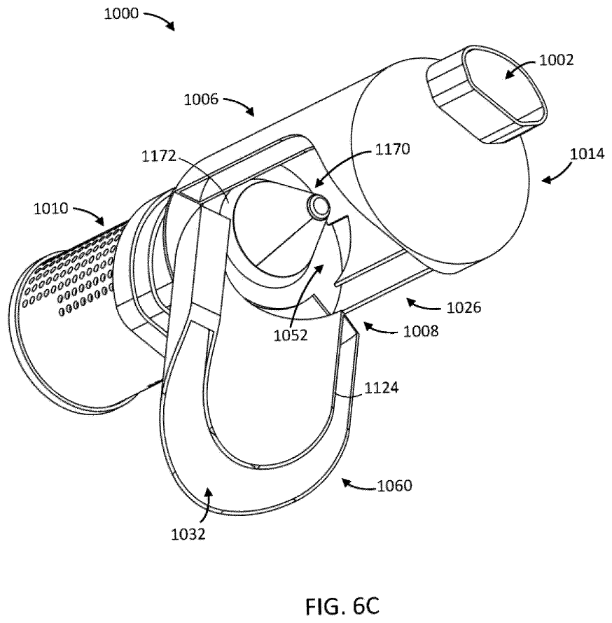

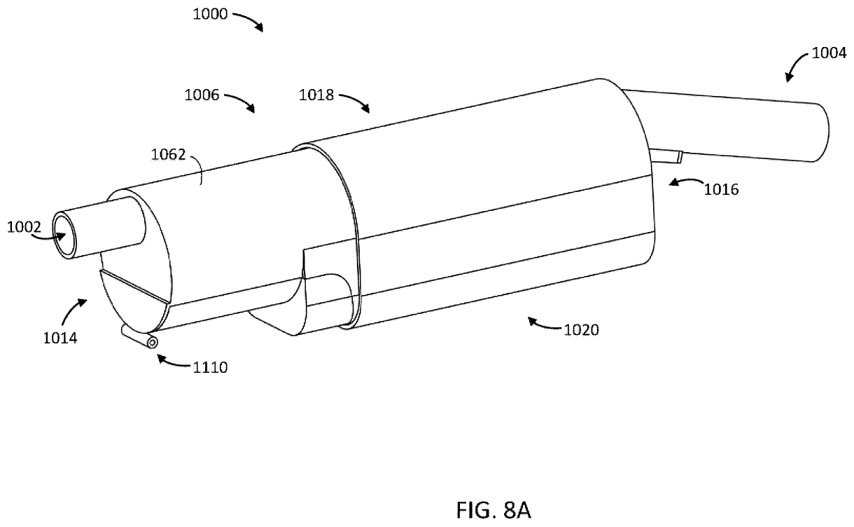

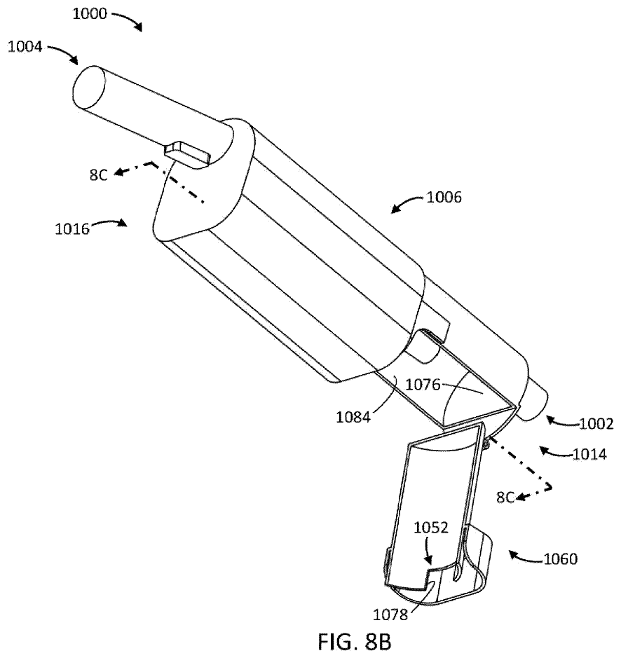

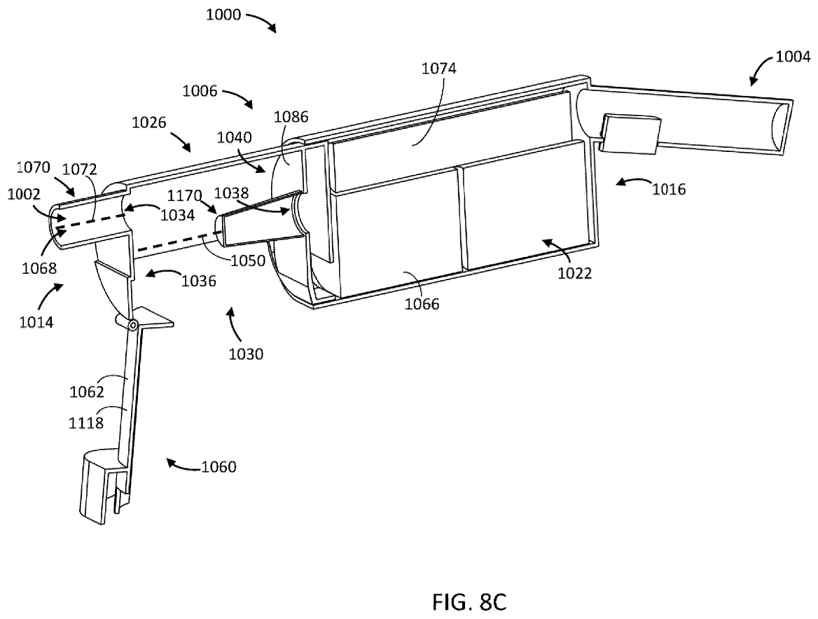

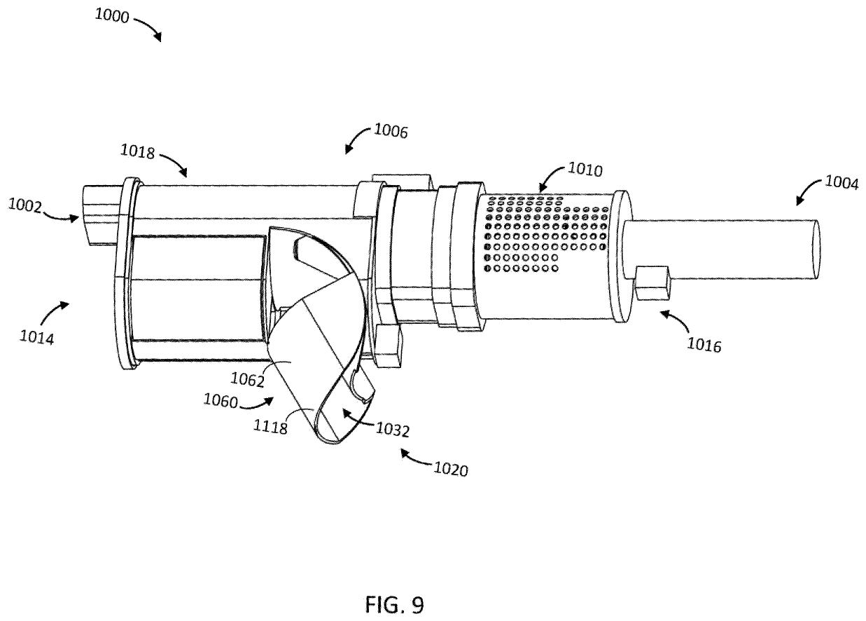

FIGS. 5D and 8C exemplify a first example wherein the dirt outlet 1052 may have a perimeter 1078 defined by a portion of the cyclone sidewall 1084 and a portion of the cyclone chamber rear end wall 1086 (it is to be understood that a portion of the perimeter 1078 of the dirt outlet 1052 is not shown as this is a cross-sectional view). As exemplified, the cyclone chamber rear end wall 1086 is a rear end wall of the air treatment member. As exemplified, the dirt outlet 1052 may be an opening in the cyclone chamber sidewall 1084, the dirt outlet 1052 may have a perimeter 1078, and the cyclone chamber sidewall 1084 may only include part of the perimeter 1078 of the dirt outlet 1052. As shown in FIGS. 1C and 1H, when the openable portion 1060 is moved to the open position, the dirt outlet 1052 is opened. More specifically, a portion the cyclone chamber sidewall 1084 (i.e., sidewall 1084 of the air treatment chamber 1044) containing the dirt outlet 1052 rotates away from the rear end wall 1086 which, when the openable portion 1060 is closed, defines a portion of the perimeter 1078 of the dirt outlet 1052. Accordingly, as shown, the dirt outlet 1052 may be opened when the openable portion 1060 is moved to the open position.

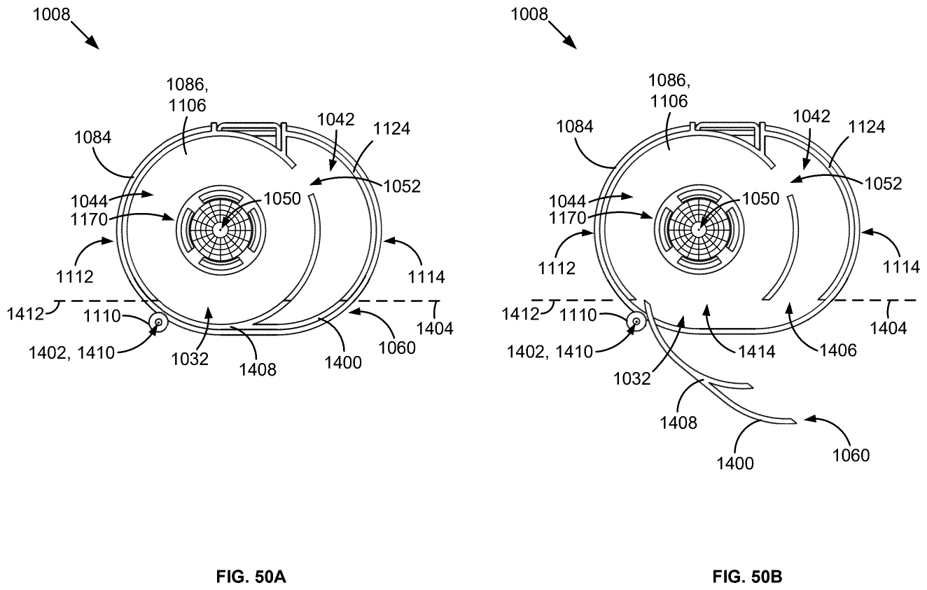

As a second example, referring now to FIGS. 5A-5E, a rear end 1088 of a portion of the air treatment member 1008 (specifically, a rear end 1090 of the lower portion of the cyclone assembly 1026) is rotationally mounted between a closed position and an open position, thereby defining an openable portion 1060. As shown in FIG. 50, when in the open position, a front end 1092 of the air treatment member 1008 (specifically, a front end 1094 of the cyclone assembly 1026) may be opened. In the example shown, opening the front end 1094 of the cyclone assembly 1026 opens the front end 1096 (and the lower end) of the cyclone chamber 1030 and a front end 1098 of the dirt collection chamber 1032. Still referring to FIG. 5C, the dirt outlet 1052 shown is an opening that has a perimeter 1078 with a first portion 1100 and a second portion 1102. In the example illustrated, the first portion 1100 of the perimeter 1078 is defined by a moveable portion of the air treatment chamber sidewall 1084 (i.e., the generally U-shaped portion 1104) and the second portion 1102 is defined in part by a stationary portion of the air treatment chamber rear end wall 1086. As shown in FIG. 5C, only the first portion 1100 of the perimeter 1078 may be moved when cyclone assembly 1026 is moved to the open position to thereby open the dirt outlet 1052.

It will be appreciated that any portion of the perimeter 1078 may be moveable and this portion may be any part of the air treatment member 1008. Accordingly, as exemplified, one portion of the perimeter 1078 may be moveable and one portion stationary. Accordingly, for example, the dirt outlet 1052 may be defined only by the sidewall 1084 of the air treatment chamber and that the openable portion may comprise only part of the sidewall 1084. This part of the sidewall may have the first portion 1100 of the perimeter 1078 while a second, non-moveable portion of the sidewall 1084 that has the second portion 1102 of the perimeter 1078. Accordingly, moving the openable portion may open the dirt outlet 1052.

It will also be appreciated that two or more portions of the perimeter 1078 may be moveable and the moveable portions may define part or all of the perimeter 1078. Accordingly, for example, two portions of the perimeter 1078 may be moveable and these portions may be any part of the air treatment member 1008.

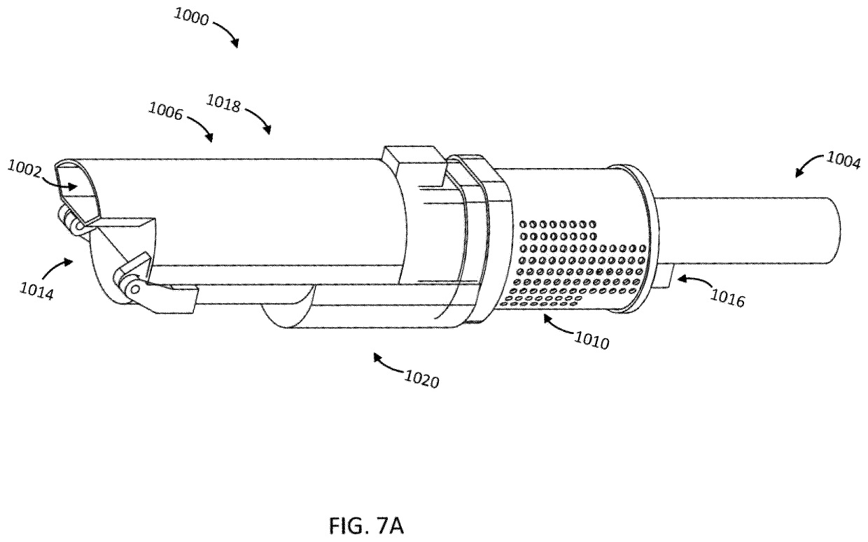

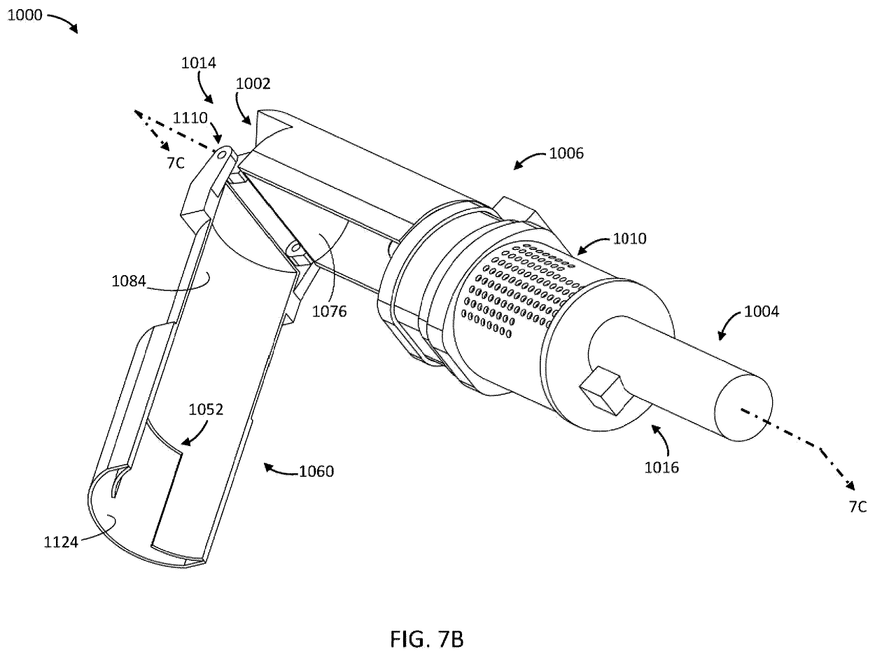

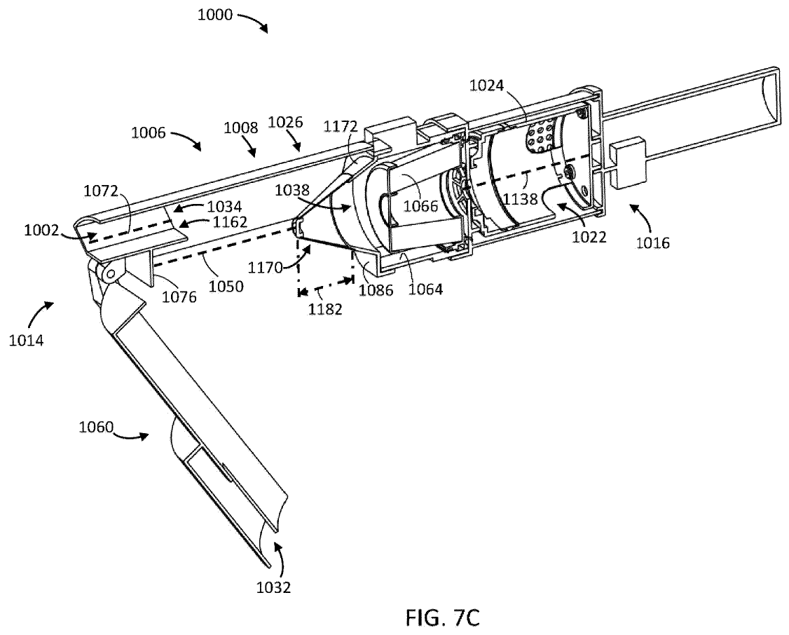

Optionally, as shown in the example illustrated in FIGS. 1C, 1H and 5C, the openable portion 1060 may be rotatable. More specifically, in the examples illustrated, the openable portion 1060 is pivotable about a hinge 1110. When the openable portion 1060 is rotatable, it may rotate in any direction relative to the main body 1006 of the surface cleaning apparatus. For example, the hinge 1110 may extend transverse to the axis 1050 and the hinge 1110 may be located at the rear end of the openable portion 1060 and the openable portion may rotate downwardly (see, e.g., FIG. 5C), the hinge 1110 may extend transverse to the axis 1050 and the hinge 1110 may be located at the front end of the openable portion 1060 and the openable portion 1060 may rotate downwardly (see, e.g., FIG. 7B), and/or the hinge 1110 may extend parallel to the axis 1050 and the hinge 1110 may be located at one lateral side of the openable portion 1060 and the openable portion 1060 may rotate laterally (see, e.g., FIG. 1H). As a specific example, in the example illustrated in FIG. 1H, the openable portion 1060 is rotatably mounted about an opening axis 1112 that is parallel to the axis of rotation 1050 of the cyclone chamber 1030. More specifically, in the example illustrated in FIG. 1H, the hand vacuum cleaner 1000 has a front end 1014 having the dirty air inlet 1002, a rear end 1016 and first and second laterally opposed sides 1114, 1116 extending in a forward/rearward direction and the opening axis 1112 is located on one of the laterally opposed sides 1114, 1116.

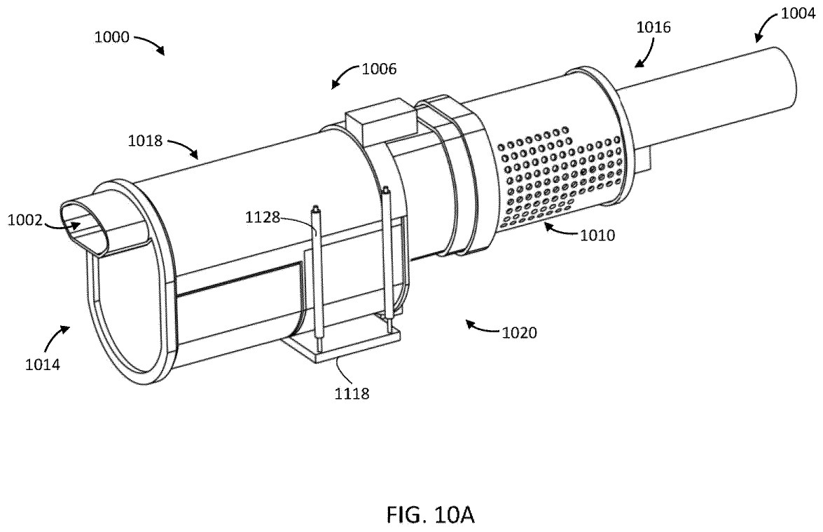

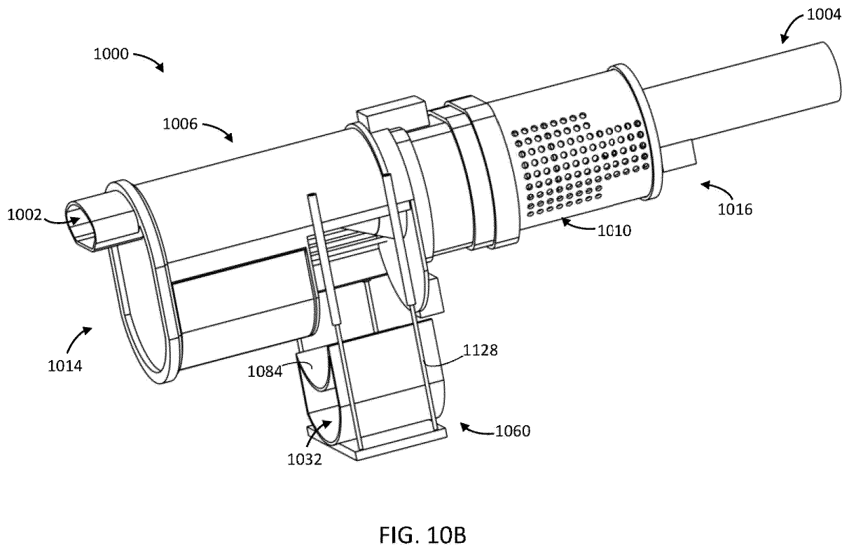

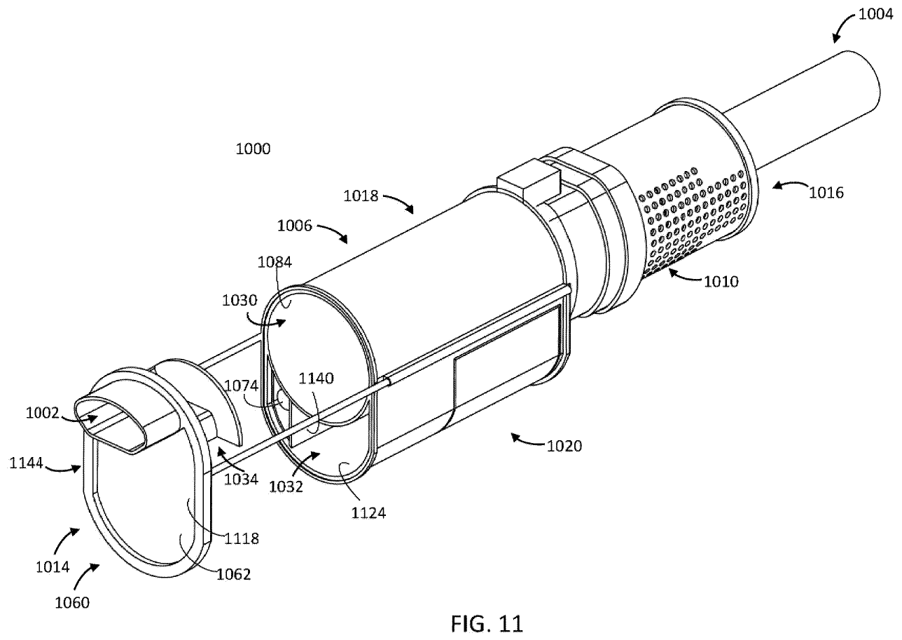

Alternatively, as shown in FIG. 10A, the openable portion 1060 may be translatably mounted to the main body 1006. Specifically, in the example illustrated, the openable portion 1060 slides along rails 1128 that are joined to the main body 1006 of the surface cleaning apparatus. When the openable portion 1060 is translatably mounted to the main body 1006, the openable portion 1060 may translate in any direction known in the art. For example, the openable portion 1060 may translate upwardly, downwardly (see, e.g., FIG. 10B), forwardly (see, e.g., FIG. 11A), rearwardly, and/or laterally.

It is to be understood that the openable portion 1060 may both rotate and translate or move in any other direction.

Movement of the openable portion 1060 from the closed position to the open position, and vice versa, may be controlled by any means known in the art. For example, there may be a handle (not shown) on an exterior surface 1118 of the openable portion 1060 for a user to grip. Alternatively, the openable portion 1060 may open when an actuator 1120 is actuated. The actuator 1120 may be mechanical or electromechanical.

Optionally, the openable portion 1060 may include a stop to limit the motion of the openable portion. For example, part of the openable portion 1060 may engage a portion of the main body 1006 of the surface cleaning apparatus to limit rotation of the openable portion 1060.

The openable portion 1060 may be held in the closed position by any means known in the art. For example, the openable portion 1060 may be held in the closed position by interengaging male and female engagement members (not shown). More specifically, the openable portion 1060 may include a tab which engages with a recess located on the main body in a friction fit to hold the openable portion 1060 in the closed position. In some examples, a mechanical lock or electromechanical lock may be used to hold the openable portion 1060 in the closed position. Optionally, the openable portion 1060 may be biased to the closed position. Any locking means known in the art may be used.

### Location of the Openable Portion

In accordance with this aspect of this disclosure, which may be used by itself or in combination with one or more other aspects of this disclosure, in an openable portion is provided, then the openable portion 1060 may be located at any position along the air treatment member 1008.

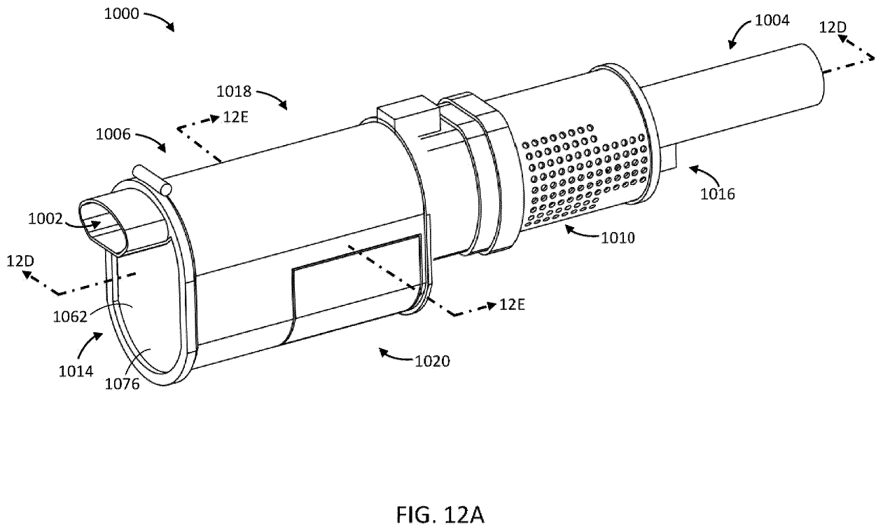

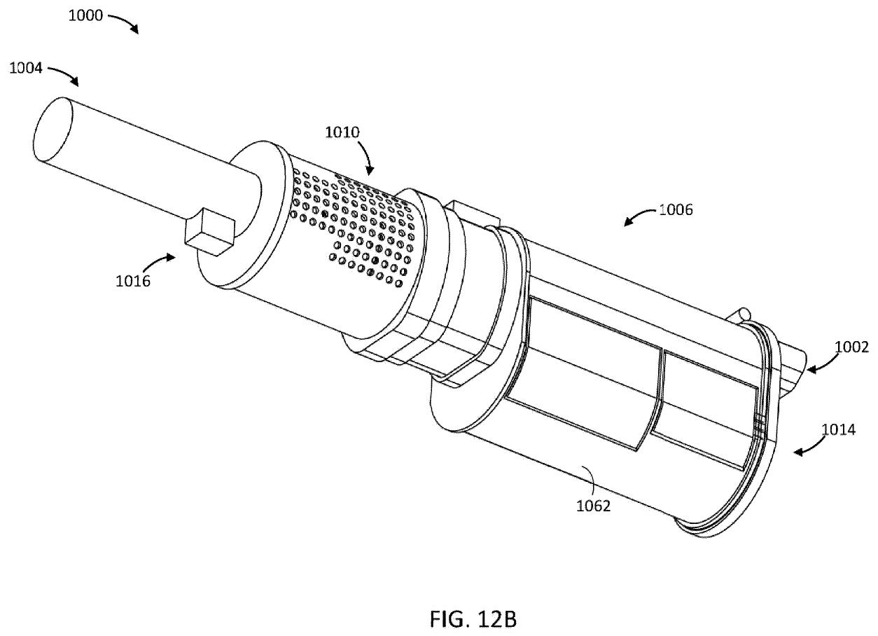

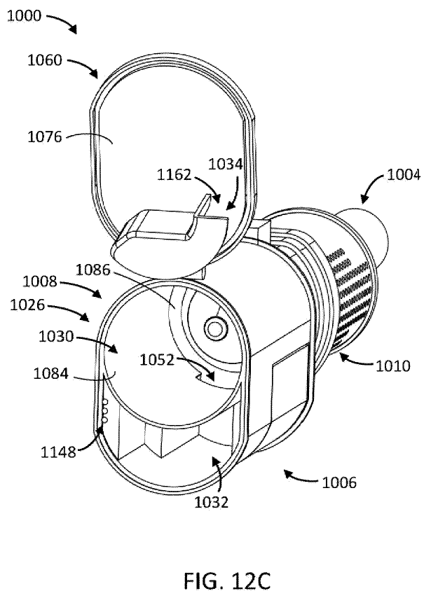

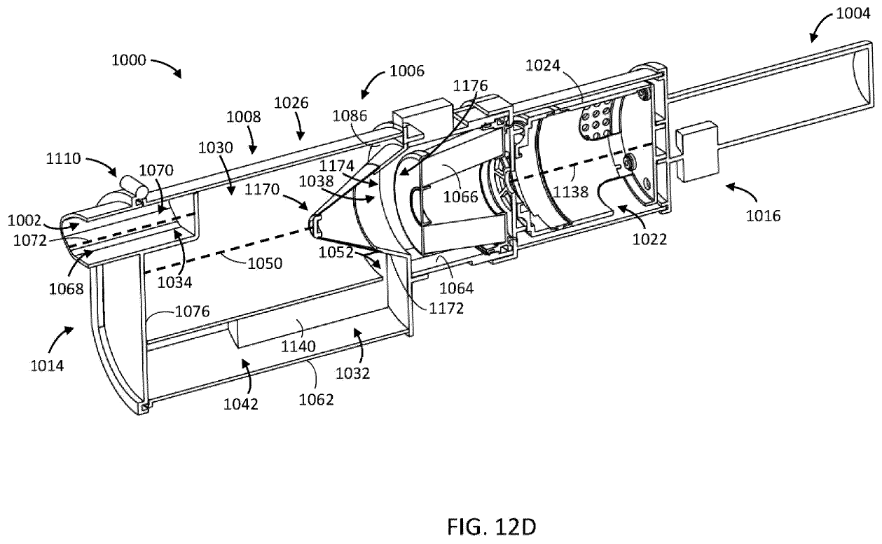

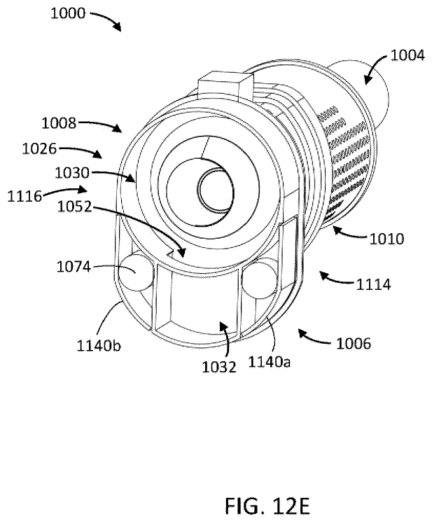

For example, the openable portion 1060 may be part or all of the sidewall 1084 of the air treatment member 1008 as shown in FIG. 1H. Alternatively, the openable portion 1060 may be part or all of a front end wall 1076 of the air treatment member 1008 as shown in FIG. 12C. It will be appreciated that the openable portion 1060 may be part or all of a rear end wall 1086 of the air treatment member 1008. In any such case, the openable portion 1060 may be at least partially located at an upper end 1018, a lower end 1020, and/or intermediate the upper and lower end 1018, 1020 of the surface cleaning apparatus.

It will be appreciated that if the openable portion 1060 is part or all of a front end wall 1076 and/or a rear end wall 1086, then the openable portion may also include a portion of the sidewall 1124 and/or 1184. Accordingly, the openable portion 1060 may open a front end and/or a rear end of the air treatment chamber and/or dirt collection chamber.

Not only may the openable portion 1060 be located at any position along the air treatment member 1008, but the openable portion 1060 may also include any portion of the air treatment member 1008. That is, the openable portion 1060 may include only a portion of the air treatment chamber 1044, only a portion of the dirt collection chamber 1032, or may include a portion of the air treatment chamber 1044 and a portion of the dirt collection chamber 1032. The openable portion 1060 may also include a portion of the exterior surface 1062 of the surface cleaning apparatus.

The openable portion 1060 may open both the air treatment chamber 1044 and the dirt collection chamber 1032. For example, in the example illustrated in FIG. 1H, the dirt collection chamber 1032 is an external dirt collection chamber 1042, the openable portion 1060 includes a portion of the sidewall 1084 of the air treatment chamber 1044 and a portion of the sidewall 1124 of the dirt collection chamber 1032. Accordingly, when the openable portion 1060 is moved to the open position, the openable portion 1060 opens both the air treatment chamber 1044 and the dirt collection chamber 1032. More specifically, in the example illustrated in FIG. 1H, the dirt collection chamber 1032 has a dirt collection chamber sidewall 1124 that is spaced from the cyclone chamber sidewall 1084. As shown, a portion of the dirt collection chamber 1032 may be positioned between the cyclone chamber sidewall 1084 and the dirt collection chamber sidewall 1124, and the openable portion 1060 comprises at least a portion of the dirt collection chamber sidewall 1124 and a portion of the cyclone chamber sidewall 1084.

Optionally, as is discussed in more detail subsequently, and as shown in FIG. 11, the openable portion 1060 may also open an energy storage chamber 1140 of the surface cleaning apparatus when moved from the closed position to the open position.

### Multiple Openable Portions

In accordance with this aspect of this disclosure, which may be used by itself or in combination with one or more other aspects of this disclosure, the air treatment member 1008 or air treatment chamber 1044 of the surface cleaning apparatus may include multiple openable portions 1060.

The two or more openable portions 1060 may open concurrently, sequentially (the second openable portion automatically opening after the first openable portion has partially or fully opened), or a user may select whether to open one or both of the first and second openable portions.

It will be appreciated that each openable portion 1060 may have its own handle or actuator. Alternately, a single handle or actuator may be operable to open each of the of the openable portions 1060. That is, operation of a single actuator 1120 may open multiple openable portions 1060. For example, a first openable portion 1060a may be drivingly connected to a second openable portion 1060b, and therefore, opening the first openable portion 1060a may drive the second openable portion 1060b towards or to the open position.

In some examples, when the first openable portion 1060a is in the closed position, the first openable portion 1060a may hold the second openable portion 1060b in the closed position. That is, an actuator 1120 may be operatively connected to the first openable portion 1060a and the first openable portion 1060a may be operatively connected to the second openable portion 1060b such that when the actuator 1120 is moved to an open position, the first openable portion 1060a is opened and opening the first openable portion 1060a opens the second openable portion 1060b.

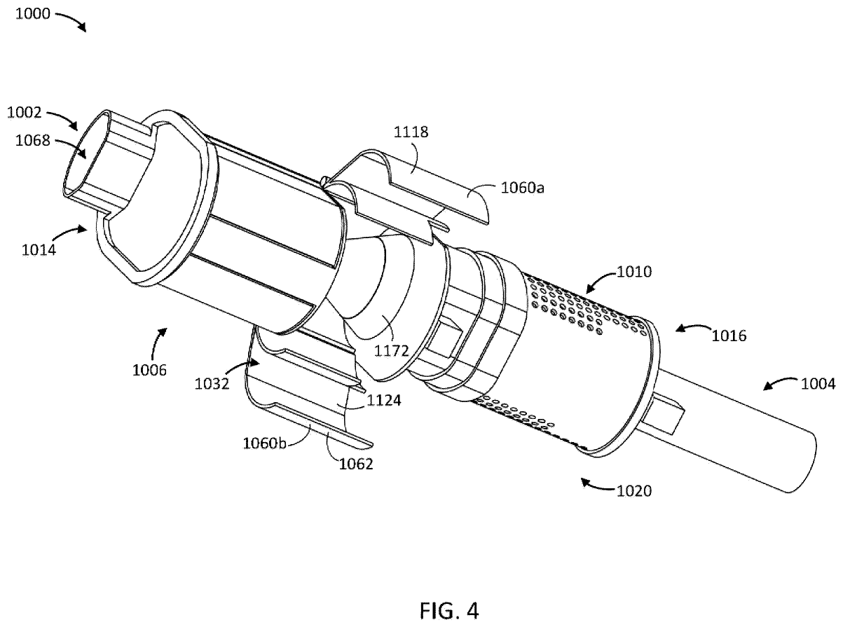

For example, as shown in FIG. 4, the surface cleaning apparatus illustrated has a first openable portion 1060a and a second openable portion 1060b. The first openable portion 1060a and the second openable portion 1060b move like bomb bay doors (i.e., which rotate away from each other when moving from the closed position to the open position). In the example illustrated in FIG. 4, each of the first and second movable portions 1060a and 1060b are concurrently openable. It will be appreciated that a first portion (e.g., a male portion) of a locking member may be provided on first moveable portion 1060a and a second portion (e.g., a female portion) of a locking member may be provided on second moveable portion 1060b. Therefore, unlocking the locking member will enable both openable portions 1060a, 1060b to open concurrently. One or both of the openable portions 1060a, 1060b may be biased to the open position by a biasing member, e.g., a spring.

As discussed above, the openable portion 1060 can be moved to an open position to facilitate the discharge of debris from the air treatment member 1008 (i.e., from the air treatment chamber 1044 and/or the dirt collection chamber 1032); and/or (b) be moved to an open position to urge compacted debris within the air treatment member 1008 to be dislodged.

Accordingly, a surface cleaning apparatus may have a first openable portion 1060a which may facilitate the discharge of debris from the air treatment member 1008 and/or an external dirt collection chamber and a second openable portion 1060b which may urge or enable compacted debris (e.g., compacted debris in a corner or blocking a dirt outlet 1052) to dislodge when moved from the closed position to the open position.

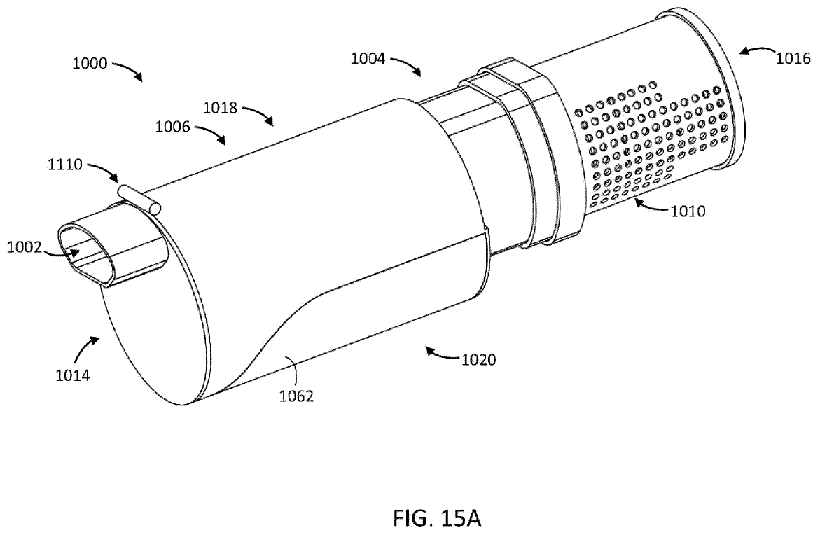

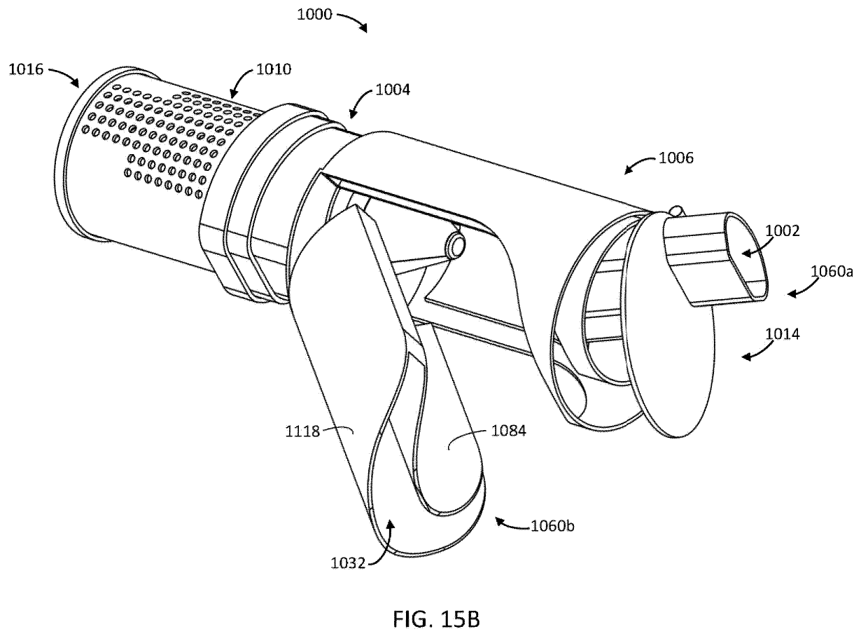

An example of a surface cleaning apparatus with a first openable portion 1060a that facilitates the discharge of debris from the air treatment member 1008 and a second openable portion 1060b, which comprises part of the perimeter 1078, that opens a dirt outlet 1052 thereby urging compacted debris to be dislodged when moving from the closed position to the open position is shown in FIGS. 15A and 15B.

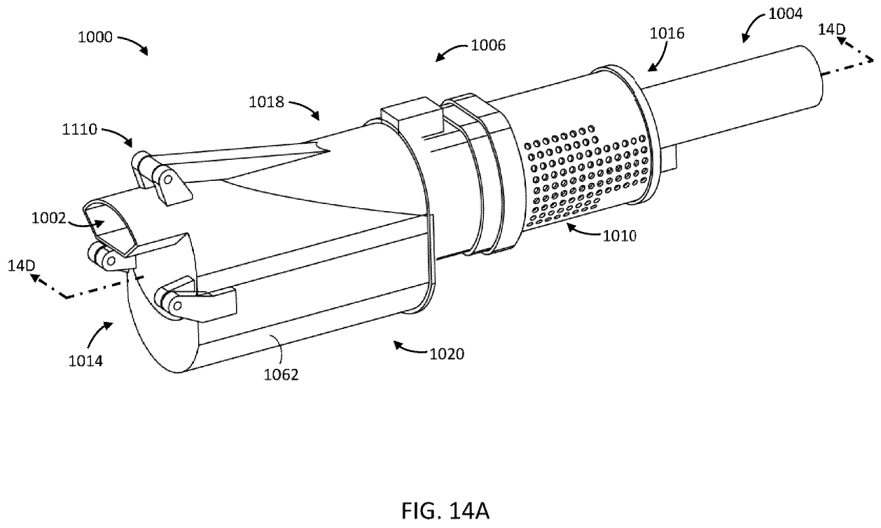

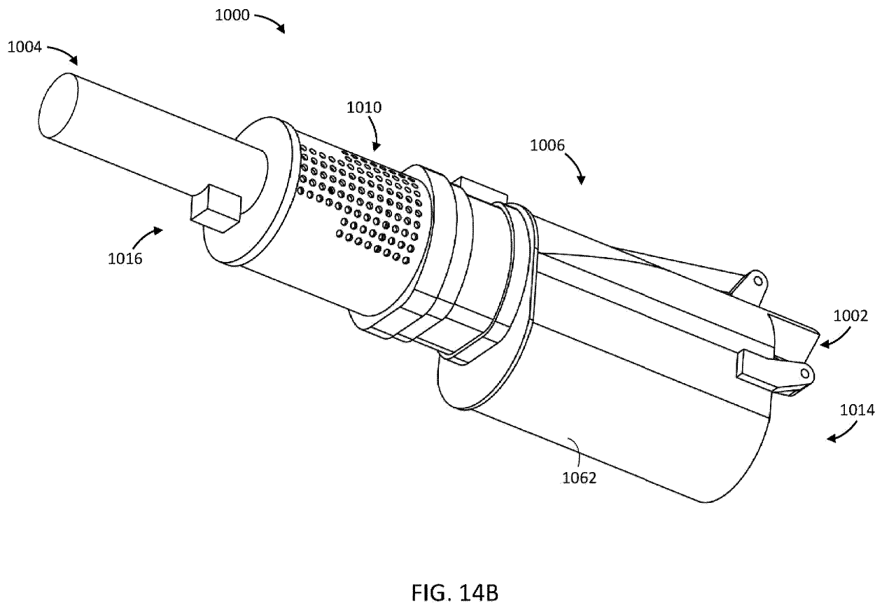

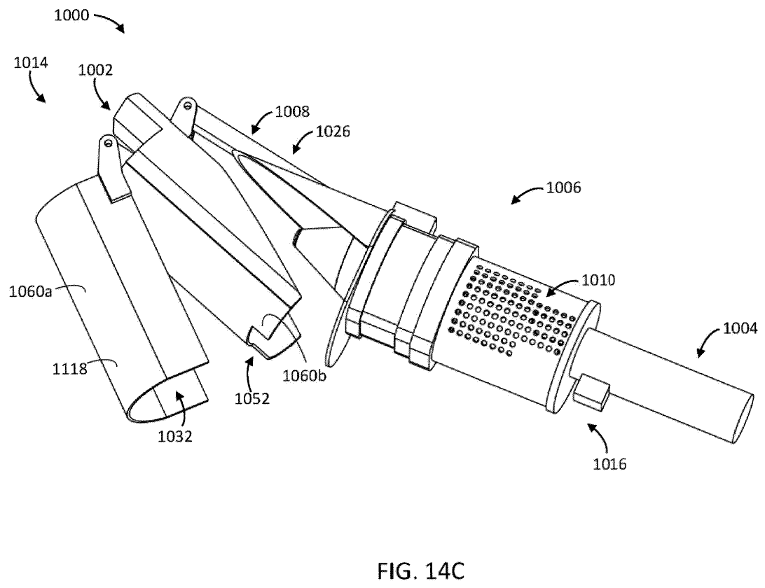

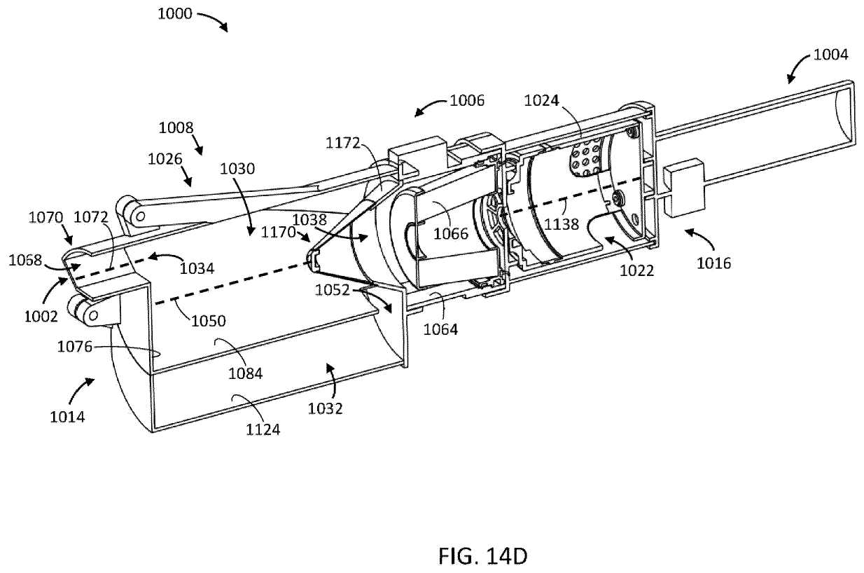

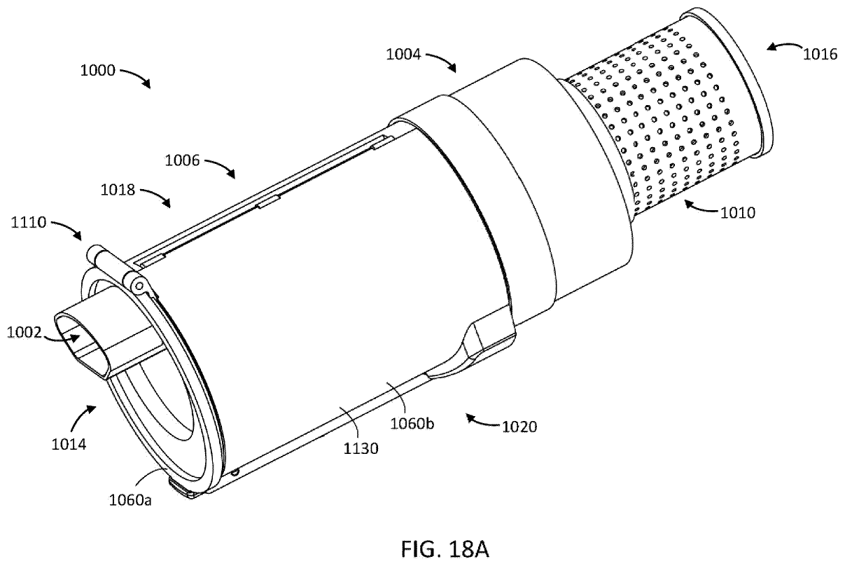

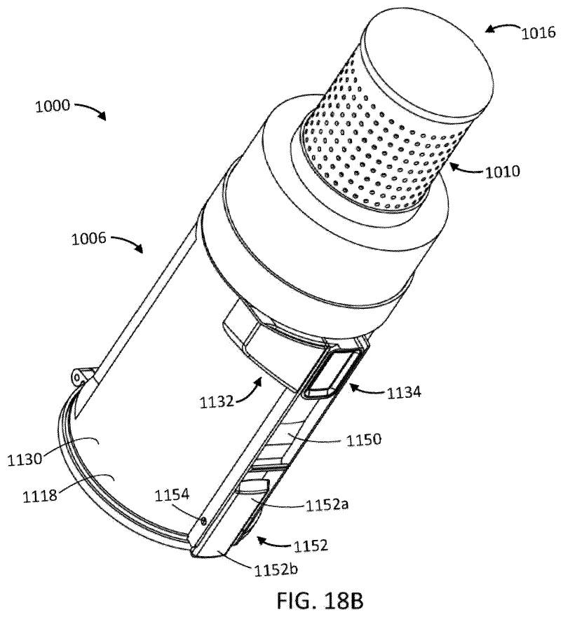

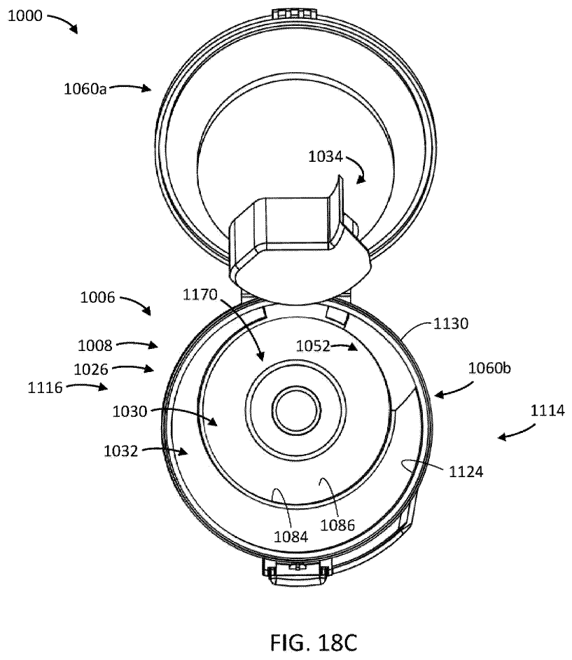

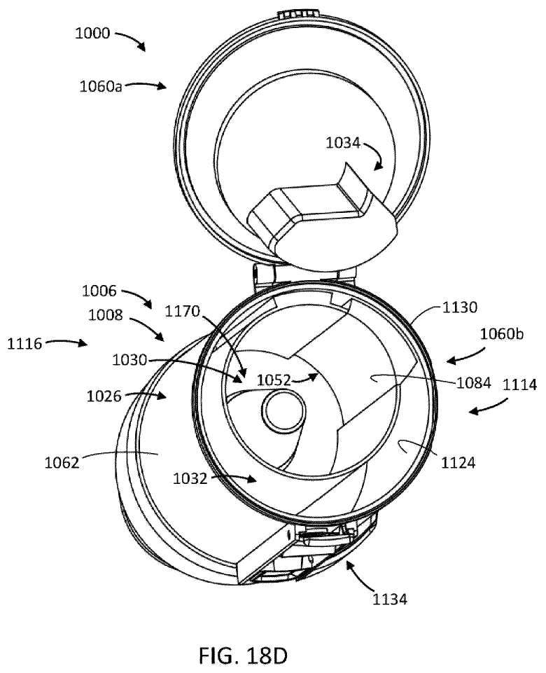

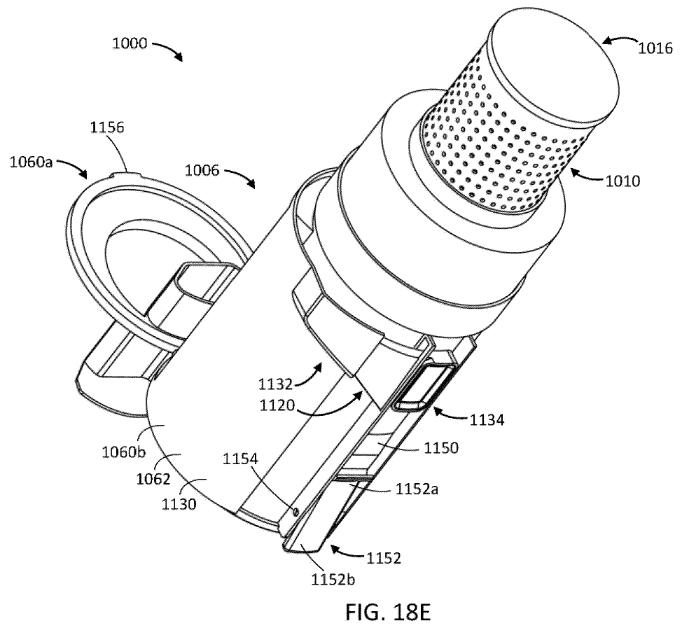

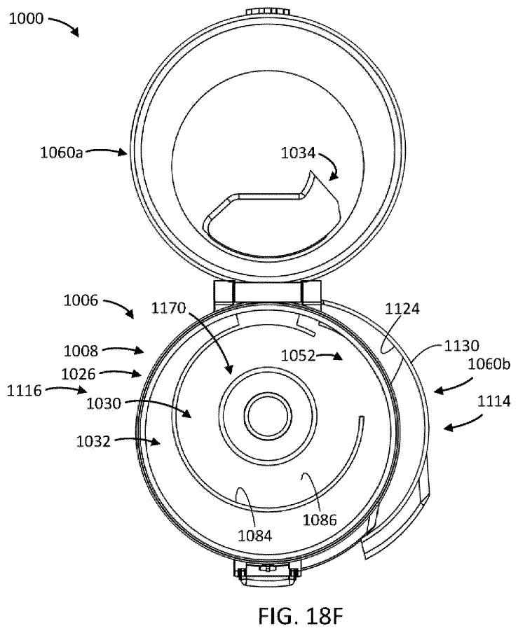

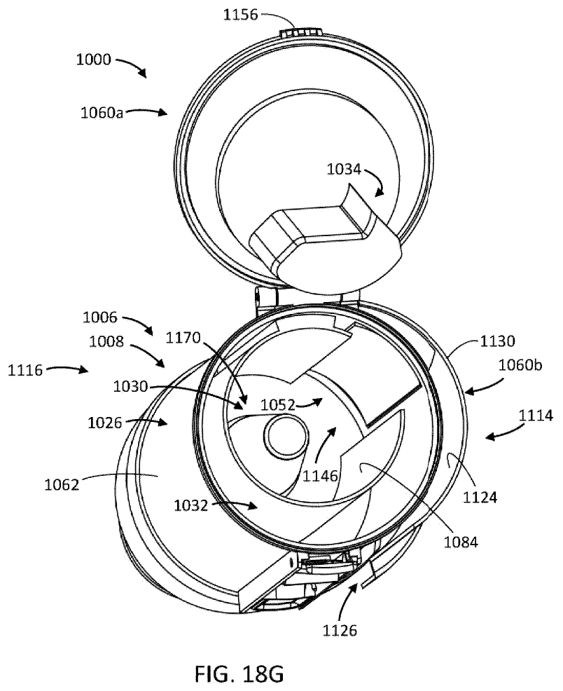

In the example illustrated in FIGS. 15A and 15B, each of the first openable portion 1060a and the second openable portion 1060b are independently operable. That is, the first openable portion 1060a may be opened and the second openable portion 1060b may be left in the closed position. Optionally, as discussed previously with respect to the embodiment of FIG. 4 or subsequently with respect to the embodiment of FIGS. 18A-G, the first openable portion 1060a and the second openable portion 1060b may be opened concurrently or, alternately, they may be opened sequentially (e.g., once one of the openable portions is opened, the other of the openable portions may be unlocked so it may be opened or one of the openable portions may be drivingly connected to the other of the openable portions such that opening one of the openable portions drives the other of the openable portions to the open position. More specifically, the cyclone assembly 1026 has a first openable portion 1060a that includes the front end wall 1076 of the dirt collection chamber 1032 and the air treatment chamber 1044. The cyclone assembly 1026 illustrated has a second openable portion 1060b that includes a portion (the lower end as exemplified) of the sidewall 1124 of the dirt collection chamber 1032 and the sidewall 1084 of the air treatment chamber 1044. As shown, the first openable portion 1060a is moveably mounted to the hand vacuum cleaner 1000 at a first location and the second openable portion 1060b is moveably mounted to the hand vacuum cleaner 1000 at a second location. Optionally, as shown, the first location may be spaced from the second location in a direction that is transverse to the cyclone axis of rotation 1050. Optionally, as shown, the first location may be axially spaced from the second location. Optionally, as exemplified in FIG. 14C, the first and second openable portions 1060a, 1060b may be located at the same portion (e.g., same end) of the air treatment member 1008.

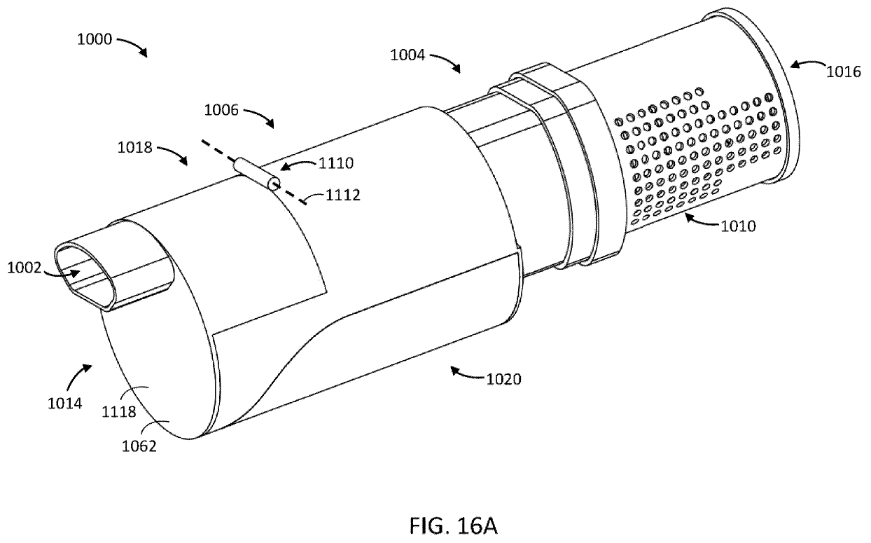

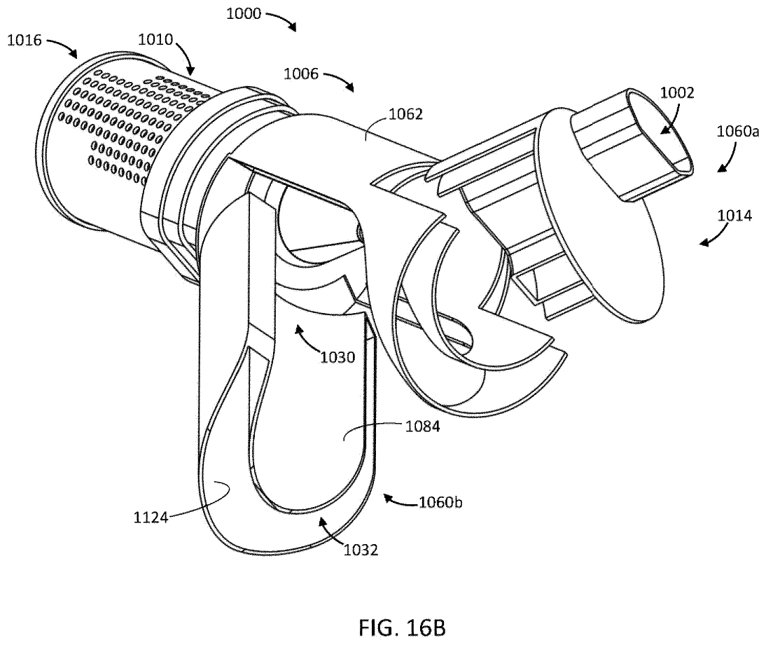

In the example illustrated in FIG. 15B, the first openable portion 1060a is moveably mounted to the main body 1006 at the front end 1014 thereof. Specifically, the first openable portion 1060a is moveably mounted to the main body 1006 at the front end 1014 thereof so that the first openable portion 1060a only includes the front end wall 1076 of the air treatment chamber 1044 and the dirt collection chamber 1032. Alternately, the first openable portion 1060a may be moveably mounted along at least one of the first and second laterally opposed sides 1114, 1116 of the main body 1006, or an upper end thereof as shown in FIG. 16B. Accordingly, the first openable portion 1060a may include a portion of the sidewall 1084 of the air treatment chamber 1044 and the rear end wall 1086 of the air treatment chamber 1044 and the dirt collection chamber 1032.

Another example is shown in FIGS. 14A-14D. As shown in FIG. 14C, when the first openable portion 1060a is in the open position, debris may be discharged from the dirt collection chamber 1032. When the second openable portion 1060b is in the open position, the dirt outlet 1052 of the air treatment member 1008 is opened and debris may be discharged from the air treatment chamber 1044.

It has been found that the rate at which debris collects in the dirt collection chamber 1032 may be greater than that of which debris compacts and collects within the air treatment chamber 1044 and/or the dirt outlet 1052. Accordingly, it may not be necessary to open the air treatment chamber 1044 and/or the dirt outlet 1052 every time the dirt collection chamber 1032 is opened to empty debris therefrom. It may be desirable to not open the air treatment chamber 1044 and/or the dirt outlet 1052 every time the dirt collection chamber 1032 is opened to reduce wear on the components used when opening the air treatment chamber 1044 and/or the dirt outlet 1052. Accordingly, instead of a single actuator that opens both openable portions 106a, 106b, two actuators may be provided, one for each openable portion 1060a, 1060b. Alternately, a single actuator may be provided which has two positions. When move to the first position, one openable portion 1060a is opened and when moved further to the second position, the other openable portion 1060a, 1060b is opened.

### The Openable Portion is Flexible

In accordance with this aspect of this disclosure, which may be used by itself or in combination with one or more other aspects of this disclosure the openable portion 1060 may be made of any material known in the art. In some examples, one or more of the openable portions 1060 may be made of the same material as the main body 1006 and/or the air treatment member 1008. In other examples, the openable portion 1060 may be, for example, a flexible membrane 1130.

Referring now to FIGS. 18A-18G, shown therein is an example of a hand vacuum cleaner 1000 in which the openable portion 1060b is or comprises a flexible membrane 1130 (e.g., an elastomeric material). As shown in FIGS. 18D and 18G, when the openable portion 1060b is in the open position, a portion of the air treatment chamber sidewall 1084 (the portion optionally including the dirt outlet 1052) and a portion of the dirt collection chamber sidewall 1124 are translated outwardly from their operating positions forming an opening 1126 in the exterior surface 1062 of the surface cleaning apparatus. Accordingly, in the example illustrated, when the openable portion 1060b is in the open position, debris from within the air treatment chamber 1044 and/or the dirt collection chamber 1032 may be discharged from the surface cleaning apparatus via the opening 1146 (FIG. 18G) left in the air treatment chamber sidewall 1084 and dirt collection chamber sidewall 1124 from moving the openable portion 1060b. In the example illustrated, moving the openable portion 1060b from the closed position to the open position also loosens debris that may have compacted within the air treatment chamber 1044, the dirt collection chamber 1032, and/or the dirt outlet 1052 connecting the air treatment chamber 1044 to the dirt collection chamber 1032.

Alternately, when the openable portion 1060b is in the open position, a portion of the air treatment chamber sidewall 1084 (the portion optionally including the dirt outlet 1052) is translated outwardly from its operating position enlarging the dirt outlet.

If part or all of the openable portion is flexible, then the openable portion may deform as an actuator acts thereon. The actuator may be moveable, e.g., axially as discussed subsequently or angularly around a portion of the outer perimeter of the hand vacuum cleaner.

Referring to FIGS. 18B and 18E, in the example illustrated, the openable portion 1060b includes a cammed surface 1132 and a user activated button 1134 that is drivingly connected to the actuator 1120 (e.g., a wedge-See FIG. 18E). As shown, the actuator 1120 may abut the cammed surface 1132 whereby movement of the actuator 1120 axially with the button 1134 may cause the cam surface 1132 to travel angularly along the actuator 1120 (i.e., upwardly in FIG. 8E) thereby driving the second openable portion 1060b from the closed position (FIG. 18B) to the open position (FIG. 18E) when the button 1134 is translated axially forwardly by a user of the hand vacuum cleaner 1000. Optionally, the button 1134 (and therefore actuator 1120) may be biased to the closed position. In the example illustrated, a spring (not shown) is used to bias the user activated button 1134 to the closed position of the openable portion 1060b. It will be appreciated that, if the openable portion 1060b is flexible, then the openable portion 1060b may provide some or all of the biasing force. Alternatively, there may be a handle on an exterior surface 1118 of the openable portion 1060 for a user to grip and pull the openable portion 1060 from the closed position to the open position.

As shown, the button 1134 may be driving connected by, e.g., linking member 1150 to the locking member 1152 of the first openable portion 1060a. As exemplified, the locking member 1152 may be in the from of a rocker switch and be pivotally mounted about a pivot 1154. When button 1134 is moved axially forwardly, the linking member 1150 may drive the rearward end 1152a of the locking member 1152 inwardly and the forward end 1152b of the locking member 1152 may be rotated outwardly, thereby disengaging lip 1156 and unlocking the first openable portion 1060A and enable the first openable portion 1060a to move from the closed position (FIG. 18A) to the open position (FIG. 18D), e.g., by a biasing spring provided as part of the pivot 1110 when the button 1134 is translated axially forwardly by a user of the hand vacuum cleaner 1000.

### The Energy Storage Member

In accordance with this aspect of this disclosure, which may be used by itself or in combination with one or more other aspects of this disclosure, power may be supplied to the surface cleaning apparatus by the energy storage member 1074 which may be any suitable device, including, for example one or more batteries, capacitors, which may be provided as part of a pack.

Optionally, the energy storage member may be rechargeable, optionally when installed in the hand vacuum cleaner, or may be replaceable, non-rechargeable batteries. Alternatively, or in addition to having power supplied by the energy storage member 1074, power may be supplied to the surface cleaning apparatus by an electrical cord connected thereto that can be connected to a standard wall electrical outlet.

### Type of Energy Storage Member

The energy storage member 1074 may include any suitable number of cells, and may include, for example, lithium ion battery cells, lithium polymer cells, and/or prismatic or pouch cells. Optionally, the energy storage member 1074 may include a plurality of prismatic or pouch cells that may be arranged in one or more longitudinally extending rows. A row of prismatic or pouch cells may include a plurality of layers of prismatic or pouch cells.

Any number of cells may be used to create a power source having a desired voltage and current, and any type of energy storage member 1074 may be used, including NiMH, alkaline, and the like. The energy storage member 1074 may be of any known design and may be electrically connected to the hand vacuum cleaner 1000 by any means known in the art.

### Location of Energy Storage Member

The energy storage member 1074 may be located within the surface cleaning apparatus at any position.

The energy storage member 1074 may be contained within an energy storage chamber 1140. Accordingly, the energy storage chamber 1140 may be positioned within the surface cleaning apparatus at any location.

More than one energy storage member 1074 may be contained within a single energy storage chamber 1140. It may be desirable to contain the energy storage member 1074 within an energy storage chamber 1140 to separate the energy storage member 1074 from any debris that may pass through the surface cleaning apparatus. The energy storage chamber 1140 may also protect the energy storage member 1074 from accidental damage, such as, for example, a puncture.

As shown in FIG. 1F, the energy storage member 1074 may be positioned radially outward from the air treatment chamber 1044. That is, a plane that is transverse to the central axis 1050 of the air treatment chamber 1044 may intersect the air treatment chamber 1044 and the energy storage member 1074.

The energy storage member 1074 may be positioned forward, rearward, and/or laterally beside the dirt collection chamber 1032. In the example illustrated in FIGS. 1D and 1E, the energy storage member 1074 is positioned forward a first portion 1032a of the dirt collection chamber 1032 and laterally beside a second portion 1032b of the dirt collection chamber 1032.

Accordingly, as exemplified in FIG. 1E, the energy storage member 1074 may be located beside and extend axially with the dirt collection chamber 1032. Further, as discussed subsequently, the energy storage member 1074 may be accessible when the dirt collection chamber 1032. It will be appreciated that two or more energy storage members 1074a, 1074b may be provided and they be located in separate compartments 1040a, 1040b (see FIG. 1E) or in a single compartment.

As a second example, as shown in FIG. 8C, the energy storage member 1074 may be positioned rearward of the air treatment member 1008. Optionally, as shown in FIG. 8C, the energy storage member 1074 may be positioned above the pre-motor filter 1066 and/or the motor and fan assembly 1022. That is, the motor and fan assembly 1022 may have an axis of rotation 1138 and a plane that is transverse to the axis of rotation 1138 may intersect the energy storage member 1074 and the motor and fan assembly 1022.

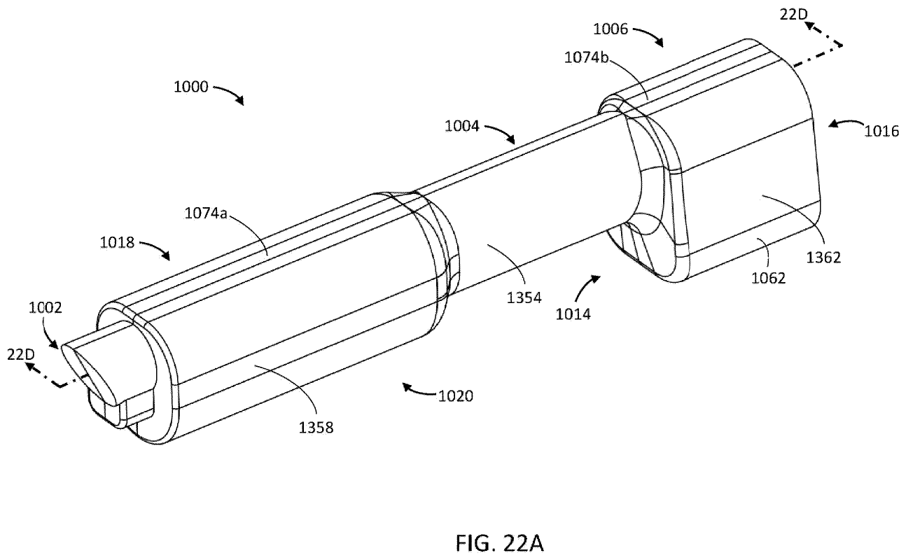

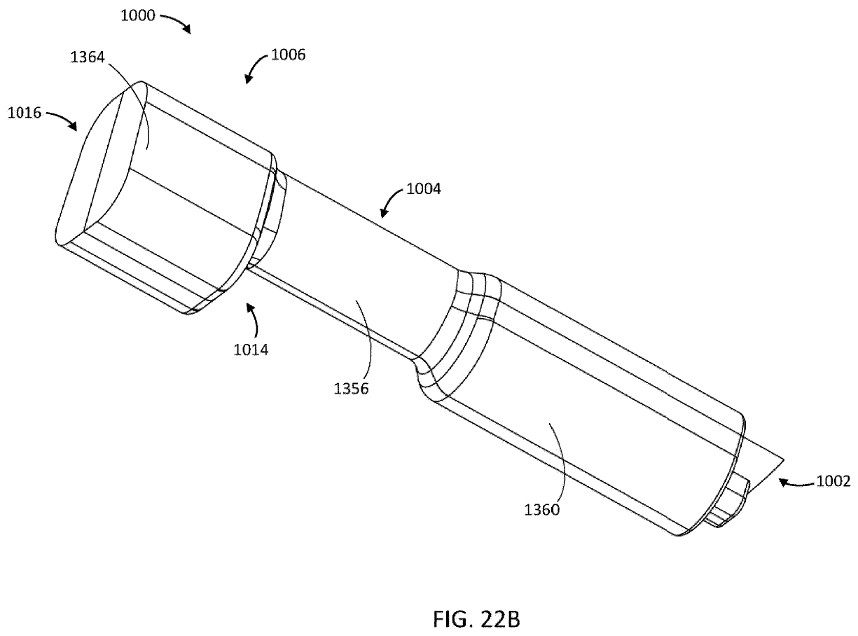

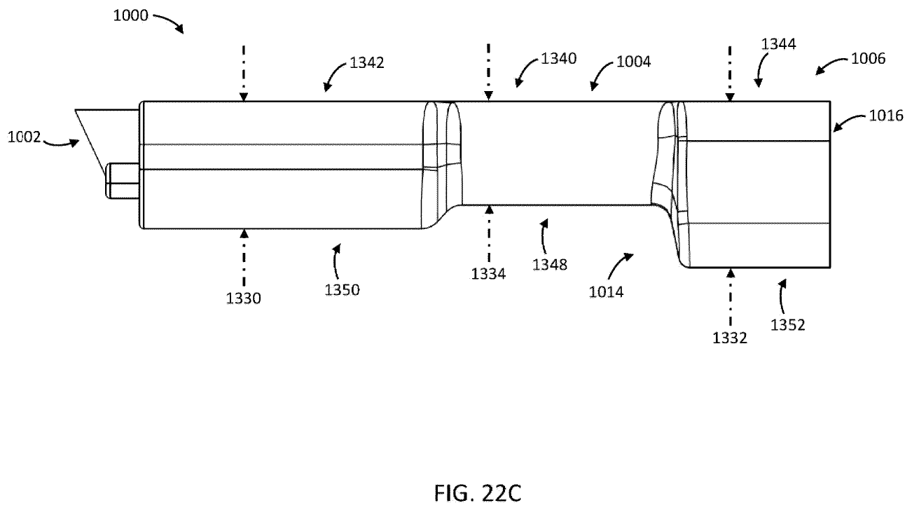

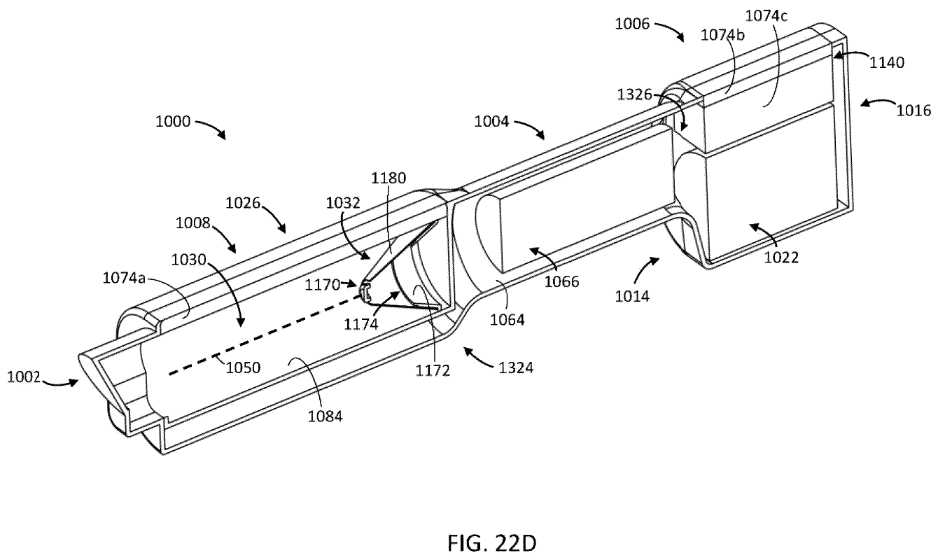

In the example illustrated in FIGS. 22A-22D, an energy storage member 1074 is located rearward of the handle 1004.

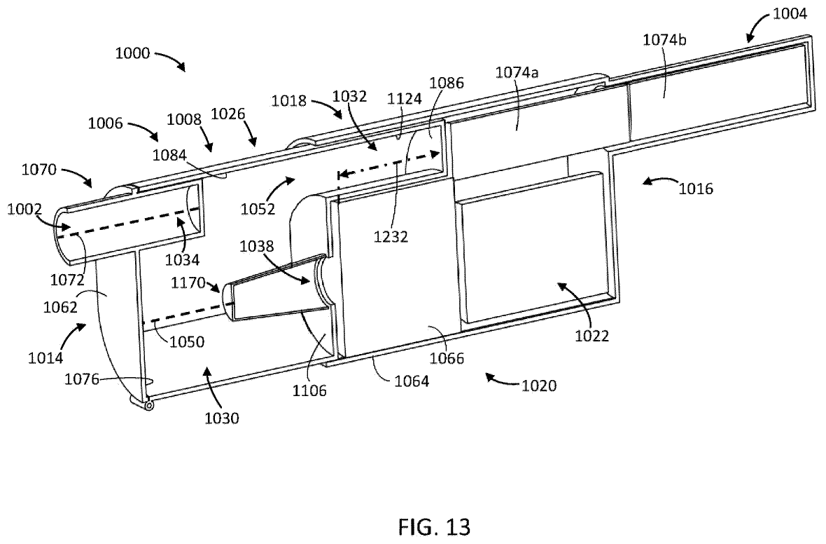

As a third example, the energy storage member 1074 may be positioned in the handle 1004, as is shown in FIG. 13.

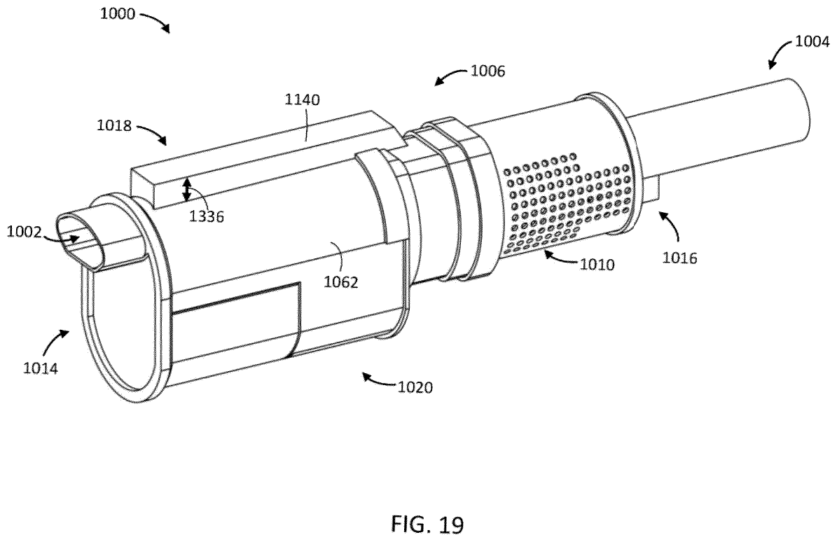

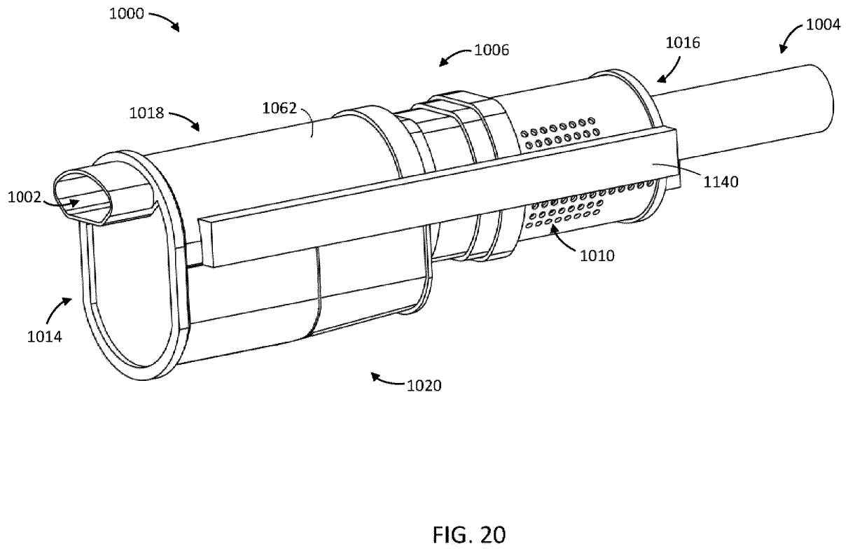

As a fourth example, the energy storage member 1074 may form part of the exterior surface 1062 of the surface cleaning apparatus, as is shown in FIGS. 19 and 20. When forming a part of the exterior surface 1062 of the surface cleaning apparatus, the energy storage member 1074 may be located on an upper end 1018, lower end 1020, and/or lateral side 1114, 1116 of the surface cleaning apparatus (this includes an upper, lower, and/or lateral side of the handle 1004). While the examples illustrated in FIGS. 19 and 20 show the energy storage chamber 1140 as protruding from the exterior surface 1062 of the hand vacuum cleaner 1000, in some embodiments (see e.g., FIG. 22A), there may be a smooth transition from a portion of the exterior surface 1062 not defined by the energy storage chamber 1140 and a portion of the exterior surface 1062 defined by the energy storage chamber 1140. As exemplified in FIG. 22A, a row of energy storage members 1074a may be provided along the top of the air treatment member and a row of energy storage members 1074b may be provided along the top of the main body 1006, which may house the suction motor and one or more filters and, optionally an additional energy storage member as exemplified in FIG. 22D. In such an embodiment, the energy storage members extending along to the top the air treatment member 1008 and the main housing 1006 may be pouch or prism cells, which are thin and may be arranged to add, e.g., 10-20 mm to the height of the hand vacuum cleaner. The energy storage members may not extend along the top of handle 1004 and therefore may assist in defining handle 1004 as the top of handle 1004 may be recessed inwardly due to the absence of energy storage members extending along the top thereof.

Alternately, for example, the energy storage member 1074 may extend from the front end 1014 of the surface cleaning apparatus to the rear end 1016 of the surface cleaning apparatus, including along the top of handle 1004 in FIG. 22A.

It is to be understood that the positions of the energy storage member 1074 described herein are not mutually exclusive. As exemplified in FIG. 22D, an energy storage member 1074c may be positioned radially outwardly from both the air treatment chamber 1044 and the motor and fan assembly 1022 as well as another energy storage member 1074a, 1074b extending along part of all of the entire length of the surface cleaning apparatus (including within/along the handle 1004).

Optionally, the energy storage chamber 1140 may include portions of other components of the surface cleaning apparatus. For example, as shown in FIG. 1E, a portion of the dirt collection chamber sidewall 1124 and a portion of the cyclone chamber sidewall 1084 each define a sidewall 1142 of the energy storage chamber 1140.

### Multiple Energy Storage Members

In accordance with this aspect of this disclosure, which may be used by itself or in combination with one or more other aspects of this disclosure, the energy storage member 1074 may be split between two locations within the surface cleaning apparatus.

Each of the first and second energy storage members 1074a, 1074b may be used to concurrently power the surface cleaning apparatus. Alternatively, the first and second energy storage members 1074a, 1074b may independently power the surface cleaning apparatus.

Each of the first and second energy storage members 1074a, 1074b may be contained within a separate energy storage chamber 1140. As exemplified in FIG. 1E, first and second energy storage members 1074a, 1074b are positioned in first and second energy storage chambers 1040a, 1040b.

It will be appreciated that the first and second energy storage chambers 1040a, 1040b may be located on the same portion on the hand vacuum cleaner and they may be spaced from each other in the lateral direction (e.g., they may extend concurrently). As exemplified in FIG. 1E, the first and second energy storage chambers 1040a, 1040b extend concurrently with the dirt collection chamber 1032 but on opposed lateral sides thereof. Alternately, the first and second energy storage members 1074a, 1074b may be located at different positions within the surface cleaning apparatus. For example, the first location may be spaced from the second location in a forward/rearward (axial) direction. Optionally, the first location is spaced from the second location in both a forward/rearward and lateral direction.

For example, referring to FIG. 22A, there may be a first energy storage member that extends forward of the handle 1004 on an exterior surface 1062 of the surface cleaning apparatus and rearward of the handle 1004 on an exterior surface 1062 of the surface cleaning apparatus. Accordingly, the handle 1004 may have an absence of the energy storage member.

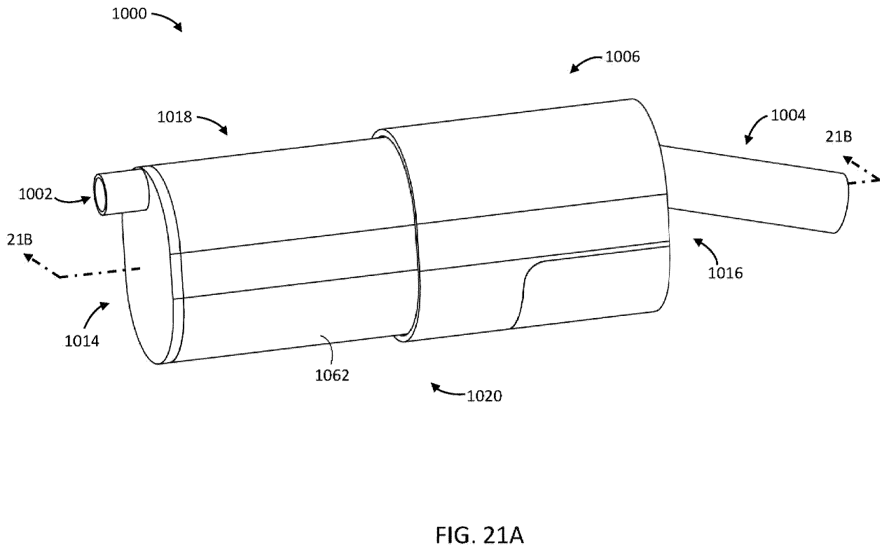

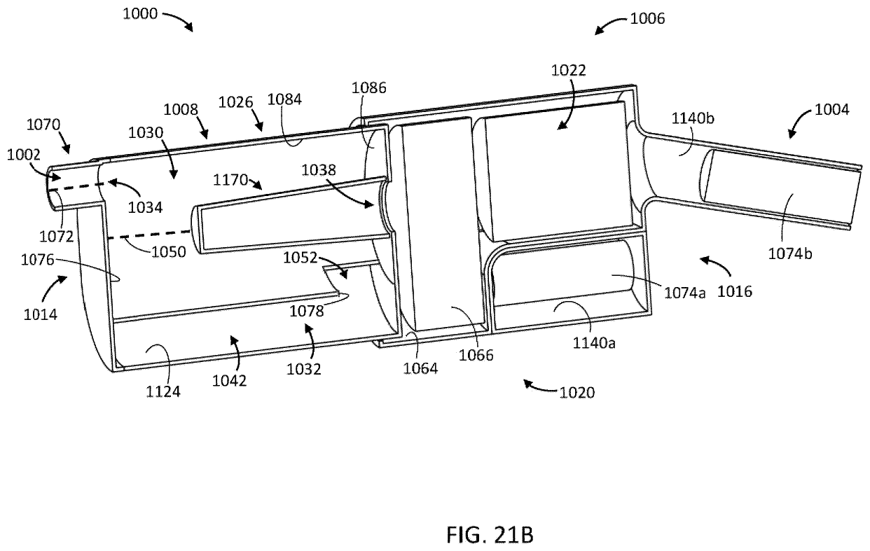

A second example of a surface cleaning apparatus having a split energy storage member 1074 is shown in FIG. 21B. In the example illustrated in FIG. 21B, the first energy storage member 1074a is located in the main body 1006 and the second energy storage member 1074b is located in the handle 1004. In the example illustrated, the first energy storage member 1074a is positioned axially from the dirt collection chamber 1032 whereby a projection of the energy storage member 1074a intersects the dirt collection chamber 1032.

### Access to the Energy Storage Member

In accordance with this aspect of this disclosure, which may be used by itself or in combination with one or more other aspects of this disclosure, the energy storage member(s) 1074 may be accessed by any means known in the art. For example, the energy storage member(s) 1074 may be accessed when charging or replacing the energy storage member(s) 1074. The energy storage member(s) 1074 may be chargeable within the surface cleaning apparatus, or the energy storage member(s) 1074 may be removable from surface cleaning apparatus for charging.

The surface cleaning apparatus may include an energy storage chamber door 1144 that is openable to permit access to the energy storage member 1074. Optionally, the energy storage chamber door 1144 may include a portion of the exterior surface 1062 of the surface cleaning apparatus. As shown in FIG. 1F, in the example illustrated, the hand vacuum cleaner 1000 includes a first energy storage chamber door 1144a for opening the first energy storage chamber 1140a and a second energy storage chamber door 1144b for opening the second energy storage chamber 1140b. Alternately, the first and second energy storage chambers 1040a, 1040b may be opened when the dirt collection chamber door is opened (e.g., if front end 1014 in FIG. 1A is a front openable door as shown in FIG. 12C or when the openable portion 1060 in the embodiment of FIG. 11 moves from the closed position to the open position).

As shown in FIG. 12C, opening the openable portion 1060 may alternatively provide access to a power coupling 1148 for supplying power (e.g., charging) to the energy storage member 1074. Any suitable power coupling 1148 may be used, for example, a female coupling configured to receive a male coupling of an electrical cord that is connectable to a source of AC or DC power, such as a household power socket.

### The Cyclone Unit

In accordance with this aspect of this disclosure, which may be used by itself or in combination with one or more other aspects of this disclosure, the air treatment member 1008 of the surface cleaning apparatus may be a cyclone assembly 1026.

As exemplified in FIGS. 1A-1H, a cyclone assembly 1026 may include a cyclone chamber 1030 (shown as a uniflow cyclone chamber 1030) and a dirt collection chamber 1032 that is positioned exterior to the cyclone chamber 1030. The dirt collection chamber 1032 may be in communication with the dirt outlet 1052 to receive debris separated from an air flow by the cyclone chamber 1030. In the illustrated example, the cyclone air inlet 1034 and dirt outlet 1052 are positioned toward opposing ends 1036, 1040 of the cyclone chamber 1030, and the cyclone chamber air outlet 1038 is provided toward the same end as the dirt outlet 1052 (the rear end 1040 as illustrated). In this configuration, dirty air can enter at the front end 1036 of the cyclone chamber 1030, while cleaner air and the separated dirt particles both exit the cyclone chamber 1030 at the opposing rear end 1040.

In this embodiment, the cyclone chamber 1030 has a front end wall 1076 and an opposing rear end wall 1086 that is spaced apart from the front end wall 1076 along the cyclone axis 1050 about which air circulates within the cyclone chamber 1030 during operation of the surface cleaning apparatus. The cyclone chamber sidewall 1084 extends between the front and rear end walls 1076, 1086. In the illustrated example, when the hand vacuum cleaner 1000 is oriented with the upper end 1018 above the lower end 1020, the cyclone axis 1050 is generally horizontal, and is closer to horizontal than vertical, e.g., ±20°, ±15°, ±10°, or ±5° from the horizontal. As exemplified, the cyclone axis 1050 may be substantially parallel to, e.g., within ±20°, ±15°, ±10°, or ±5°, and vertically offset below the inlet conduit axis 1072 of the inlet conduit 1070, and the cyclone chamber 1030 and dirt collection chamber 1032 are both below the inlet conduit axis 1072.

In the embodiment shown in FIG. 1D, the height 1056 and width (i.e., diameter in the example illustrated) of the cyclone chamber 1030 is generally constant along its length 1158. That is the height 1056 and width of the cyclone chamber 1030 in a direction transverse to the cyclone axis of rotation 1050 at the front end 1036 is generally equal to the height 1056 and width of the cyclone chamber 1030 in the direction transverse to the cyclone axis of rotation 1050 at the rear end 1040.

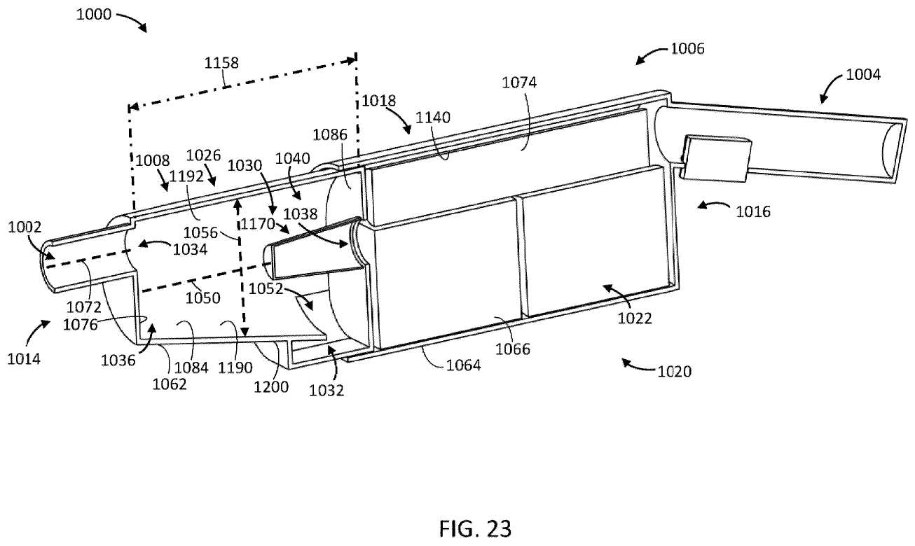

Optionally, as shown in FIGS. 23-25, the height 1056 and/or width of the cyclone chamber 1030 may increase along its length 1158 (i.e., the cyclone chamber 1030 may have a cyclone chamber sidewall 1084 that is stepped). That is, the height 1056 and/or width of the cyclone chamber 1030 in a direction transverse to the cyclone axis of rotation 1050 at the front end 1036 may be less than the height 1056 and/or width of the cyclone chamber 1030 in the direction transverse to the cyclone axis of rotation 1050 at the rear end 1040. Cyclone chambers having cyclone chamber sidewalls 1084 that are stepped are further discussed below.

Referring back to FIGS. 1A-1H, in this embodiment, the cyclone air inlet 1034 is a tangential air inlet 1160 that, as exemplified, terminates at an outlet end 1162 or port that is formed in the cyclone sidewall 1084, optionally an upper portion of the cyclone sidewall 1084, adjacent the front end wall 1076 (see, e.g., FIG. 1F). Optionally, the cyclone air inlet 1034 may be provided at an alternate location, such as in the front end wall 1076 (see, e.g., FIG. 8C).

The cyclone air inlet 1034 is fluidly connected with the dirty air inlet 1002 via the inlet conduit 1070. The cyclone air inlet 1034 may have any suitable arrangement and/or configuration, and in the example illustrated in FIG. 1D, is configured as a tangential air inlet. Connecting the cyclone air inlet 1034 to the dirty air inlet 1002 as shown in FIG. 1D may reduce or eliminate the need for additional bends or air flow direction changes between the dirty air inlet 1002 and the cyclone chamber 1030. Reducing the conduit length and number of bends may help reduce the backpressure and air flow losses within the air flow path.

Positioning the cyclone air inlet 1034 toward the front end 1036 of the cyclone chamber 1030 may help facilitate a desired air flow configuration within the cyclone chamber 1030. For example, in this configuration the cyclone chamber 1030 itself functions as part of the air flow path that conveys air rearwardly from the front end 1014 of the surface cleaning apparatus, without the need for a separate fluid conduit.

In the illustrated example, the cyclone air inlet 1034 is directly adjacent the front end wall 1076. Alternatively, cyclone air inlet 1034 may be axially spaced from the front end wall 1076, and may be located at another location along the length of the cyclone chamber 1030.

As shown in FIG. 1D, the cyclone chamber air outlet 1038 may be provided in the rear end wall 1086 of the cyclone chamber 1030. The cyclone chamber air outlet 1038 may include an axially extending vortex finder 1170 that may extend from the rear end wall 1086 and may be aligned with the cyclone chamber air outlet 1038.

The vortex finder 1170 may have any shape and configuration known in the art. In the example illustrated in FIG. 1D, the vortex finder 1170 is tapered towards the cyclone air inlet 1034 of the cyclone chamber 1030 and has a circular cross-section.

As shown in FIG. 1D, the vortex finder 1170 may include a conduit portion 1172. The conduit portion 1172 may be of any shape and configuration known in the art and may extend inwardly into the cyclone chamber 1030. For example, the conduit portion 1172 illustrated in FIG. 1D is frusto-conical, whereas in other examples the conduit portion 1172 may be cylindrical. In some examples, the conduit portion 1172 may be tapered at an angle of up to 25°, optionally from 2° to 15°, from 3° to 9°, or from 4° to 7°. As exemplified, all of the conduit portion 1172 may be solid (i.e., air impermeable or non-porous).

As shown, the conduit portion 1172 may have an inlet end 1174 and an outlet end 1176. The outlet end 1176 of the conduit portion 1172 may be joined (e.g., glued, welded, etc.) to the rear end wall 1086 of the outlet end of the cyclone chamber 1030. Alternatively, the conduit portion 1172 may be an integral component of the rear end wall 1086 of the outlet end of the cyclone chamber 1030 (i.e., in some examples, the rear end wall 1086 of the outlet end and the conduit portion 1172 may be formed from the same work piece).

In the example illustrated in FIG. 1D, the vortex finder 1170 also includes a porous portion 1180 (i.e., screen portion) at a front end thereof. In some examples, as discussed in more detail below, the vortex finder 1170 may consist of or consist essentially of a porous portion 1180 (i.e., it may not include a conduit portion 1172). The porous portion 1180 may have any shape and configuration known in the art. For example, the porous portion 1180 may be tapered as shown in FIG. 1D. As a second example, the porous portion 1180 may be cylindrical (i.e., linear).

The porous portion 1180 may have a length 1182 in the axial direction which is equal to a length 1184 in the axial direction of the cyclone air inlet 1034 (see, e.g., FIG. 5D). Alternatively, the length 1182 of the porous portion 1180 in the axial direction may be from 1 to 10 times, from 1.25 to 8 times, from 1.5 to 6 times, from 1.5 to 4 times, from 2 to 6 times, or from 2 to 4 times the length 1184 of the cyclone air inlet 1034 in the axial direction.

When tapered, the porous portion 1180 may be tapered at an angle of up to 25°, optionally from 2° to 15°, from 3° to 9°, or from 4° to 7°. As shown, the porous portion 1180 may extend inwardly into the cyclone chamber 1030 from the inlet end 1174 of the conduit portion 1172.

Positioning the cyclone chamber air outlet 1038 toward the rear end 1040 (and optionally in the rear end wall 1086) may help facilitate the desired air flow through the cyclone chamber 1030, such that air, while swirling, travels generally axially though the cyclone chamber 1030 from the front end wall 1076 toward the rear end wall 1086.

Positioning the cyclone chamber air outlet 1038 in the rear end wall 1086 of the cyclone chamber 1030 may also help facilitate the air flow connection between the cyclone chamber 1030 and other downstream components in the hand vacuum cleaner 1000, such as the pre-motor filter housing 1064 and suction motor housing 1024. In the illustrated embodiment the cyclone chamber air outlet 1038 is provided in the rear end wall 1086 and is connected to the pre-motor filter housing 1064 by a conduit. This may help simplify the air flow path and construction of the hand vacuum cleaner 1000. Alternatively, the air flow path may include one or more additional conduits connected downstream from the cyclone chamber air outlet 1038.

In this arrangement, air travelling through the hand vacuum cleaner 1000 will travel generally rearwardly along the inlet conduit 1070 (i.e., parallel to the inlet conduit axis 1072 and then enter a tangential air inlet 1160 which essentially changes the direction of the air to travel generally downwardly through the cyclone air inlet 1034 (i.e., generally orthogonal to the cyclone axis 1050). The air can then circulate within the cyclone chamber 1030, and travel generally rearwardly toward the cyclone chamber air outlet 1038, and ultimately exit the cyclone chamber 1030 via the cyclone chamber air outlet 1038 after travelling through the vortex finder 1170 in a rearward direction (i.e., generally parallel to the cyclone axis 1050). In this configuration, the air flow changes direction only once (and by only approximately 90° which may be accomplished by a tangential air inlet 1160), between entering the dirty air inlet 1002 and exiting the cyclone chamber air outlet 1038.

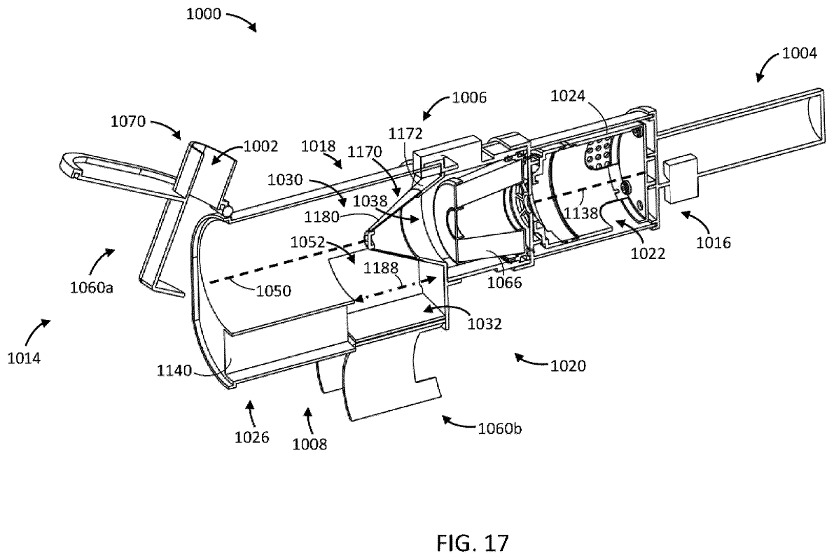

The cyclone dirt outlet 1052 may be of any suitable configuration, and in the illustrated embodiment is an opening that is provided in the cyclone chamber sidewall 1084, toward the rear end wall 1086. The dirt outlet 1052 may extend around at least a portion of the perimeter of the cyclone sidewall 1084, and may have any suitable length 1188 in the axial direction (see e.g., FIG. 17). As exemplified, the dirt outlet 1052 may be provided only in a lower portion of the cyclone sidewall 1084.

While shown directly adjacent the rear end wall 1086, such that the dirt outlet 1052 is partially bounded by the cyclone sidewall 1084 and the rear end wall 1086, the dirt outlet 1052 may be located at another location along the length of the cyclone sidewall 1084 and need not be directly adjacent the rear end wall 1086. Alternatively, the dirt outlet 1052 may be provided toward the mid-point of the cyclone chamber sidewall 1084 or may be provided toward the front end wall 1076. While illustrated with a single dirt outlet 1052, the cyclone chamber 1030 may include two or more dirt outlets 1052 that are in communication with the same dirt collection chamber 1032, or optionally with different dirt collection chambers 1032.

The Cyclone Chamber Having an Angled and/or Stepped Cyclone Chamber Sidewall

In accordance with this aspect of this disclosure, which may be used by itself or in combination with one or more other aspects of this disclosure, cyclone chamber 1030 may have a cyclone chamber sidewall 1084 that is angled and/or stepped.

As exemplified herein, a cyclone chamber sidewall may be a sidewall 1084 that defines a first height 1056 and/or width (e.g., diameter) of the cyclone chamber 1030 at the front end 1036 of the cyclone chamber 1030 and defines a second height 1056 and/or width (e.g., diameter) of the cyclone chamber 1030 at the rear end 1040 of the cyclone chamber 1030, wherein the second height 1056 and/or width is greater than the first height 1056 and/or width.

The cyclone chamber sidewall 1084 may have any shape to provide a cyclone chamber 1030 in which a height 1056 and/or width of the cyclone chamber 1030 at the front end 1036 may be less than a height 1056 and/or width of the cyclone chamber 1030 at the rear end 1040.

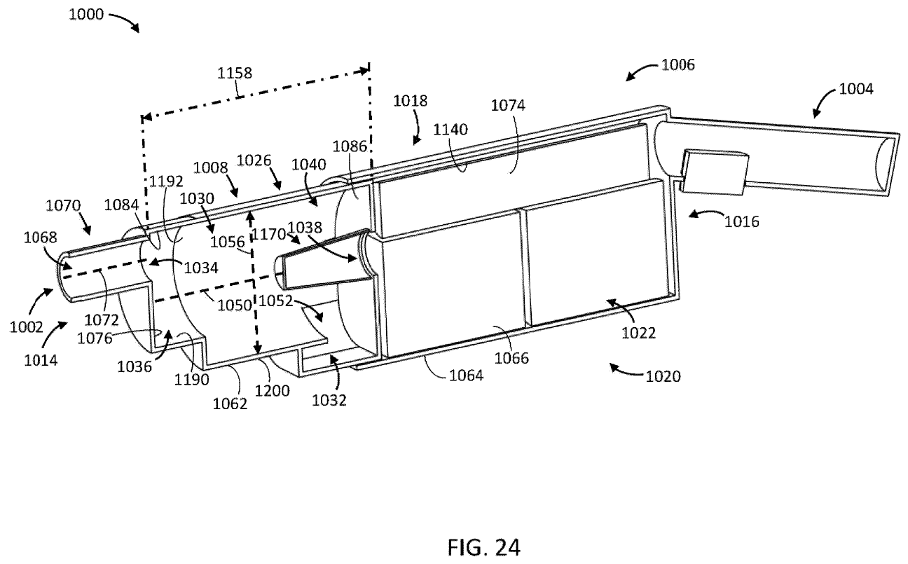

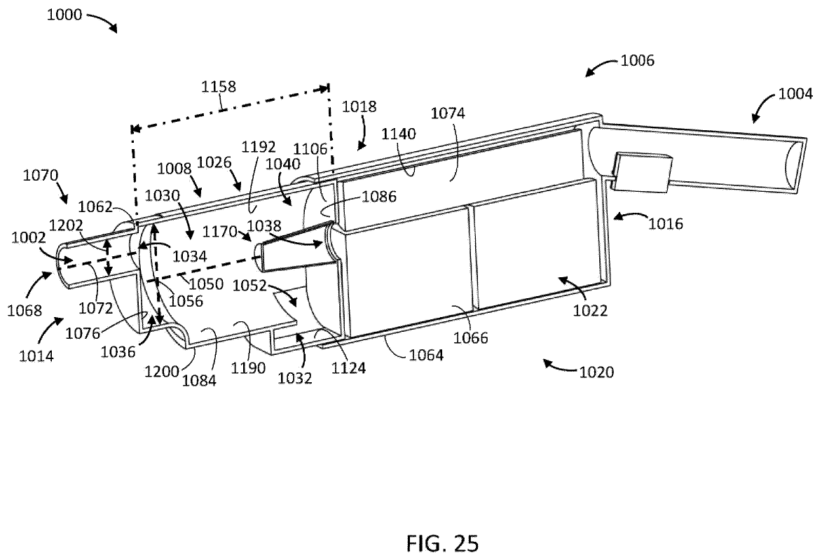

As exemplified in FIG. 23, when the hand vacuum cleaner 1000 is positioned with its upper end 1018 above its lower end 1020, at least some of a lower portion 1190 of the cyclone chamber sidewall 1084 may extend downwardly and rearwardly to provide a cyclone chamber 1030 with a smaller height 1056 and/or width at the front end 1036 thereof with respect to the height 1056 and/or width at the rear end 1040 thereof. Alternately, or in addition, the sidewall may be stepped as exemplified in FIGS. 24 and 25.

In other examples, alternatively or additionally to the lower portion 1190 of the cyclone chamber sidewall 1084 extending downwardly and rearwardly, an upper portion 1192 of the sidewall 1084 may extend upwardly and rearwardly and/or the lateral portions may extend outwardly and rearwardly.

The non-axially extending portion of the cyclone sidewall 1084 may extend along any path known in the art (i.e., linearly, arcuately, exponentially, stepwise, etc.). In some examples, the cyclone chamber sidewall 1084 may extend at an acute angle from the front end wall 1076 of the cyclone chamber 1030. In the example shown in FIG. 23, the lower portion 1190 of the cyclone chamber sidewall 1084 extends linearly. In the example shown in FIG. 24, the lower portion 1190 of the cyclone chamber sidewall 1084 extends stepwise, with a 90° step. In the example shown in FIG. 25, the lower portion 1190 of the cyclone chamber sidewall 1084 extends stepwise, with an exponentially curved step.

In the example shown in FIG. 23, the lower portion 1190 of the cyclone chamber sidewall 1084 extends at an angle downwardly and rearwardly along the entire length of the cyclone chamber sidewall 1084. In other examples, the lower portion 1190 of the cyclone chamber sidewall 1084 may extend at an angle downwardly and rearwardly along only a portion of the length of the cyclone chamber sidewall 1084.

Optionally, the cyclone chamber sidewall 1084 may form a portion of a lower surface 1200 of the surface cleaning apparatus. This configuration may minimize the height of the front end 1014 of the surface cleaning apparatus allowing for the surface cleaning apparatus to reach into tight spaces. In the example illustrated in FIG. 23-FIG. 25, the cyclone chamber sidewall 1084 includes a portion of the lower surface 1200 of the hand vacuum cleaner 1000.

In some examples, as shown in FIG. 23, the cyclone chamber sidewall 1084 may include a portion of the lower surface 1200 of the surface cleaning apparatus and the external dirt collection chamber 1042 may be positioned below the cyclone chamber sidewall 1084. Alternatively, as shown in FIG. 25, the cyclone chamber sidewall 1084 may include a portion of the lower surface 1200 of the surface cleaning apparatus and the external dirt collection chamber 1042 may be positioned only at a rearward portion of the cyclone chamber 1030.

The height 1056 of the front end 1036 of the cyclone chamber 1030 may be sized relative to the diameter 1202 of the dirty air inlet 1002. In examples where the dirty air inlet 1002 is not circular, the height 1056 of the front end 1036 of the cyclone chamber 1030 may be sized relative to a height 1204 of the dirt air inlet 1002, where the height 1204 of the dirty air inlet 1002 is measured along the same axis as the height 1056 of the cyclone chamber 1030. In some examples, the height 1056 of the front end 1036 of the cyclone chamber 1030 is 1-1.5 times a diameter 1202 of the dirty air inlet 1002, 1-1.25 times a diameter 1202 of the dirty air inlet 1002, or 1-1.1 times a diameter 1202 of the dirty air inlet 1002.

The Dirt Collection Chamber that is Contiguous with the Air Treatment Chamber

In accordance with this aspect of this disclosure, which may be used by itself or in combination with one or more other aspects of this disclosure, the dirt collection chamber 1032 may be contiguous with the air treatment chamber 1044. That is, the dirt collection chamber 1032 may be positioned axially from the front end wall 1076 and the rear end (e.g., rear end wall 1106) of the air treatment chamber 1044 (e.g., the cyclone chamber).

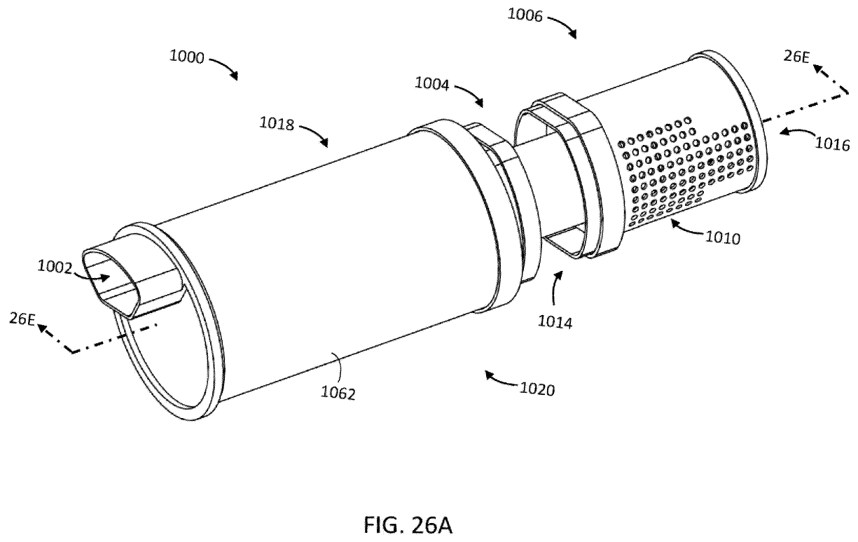

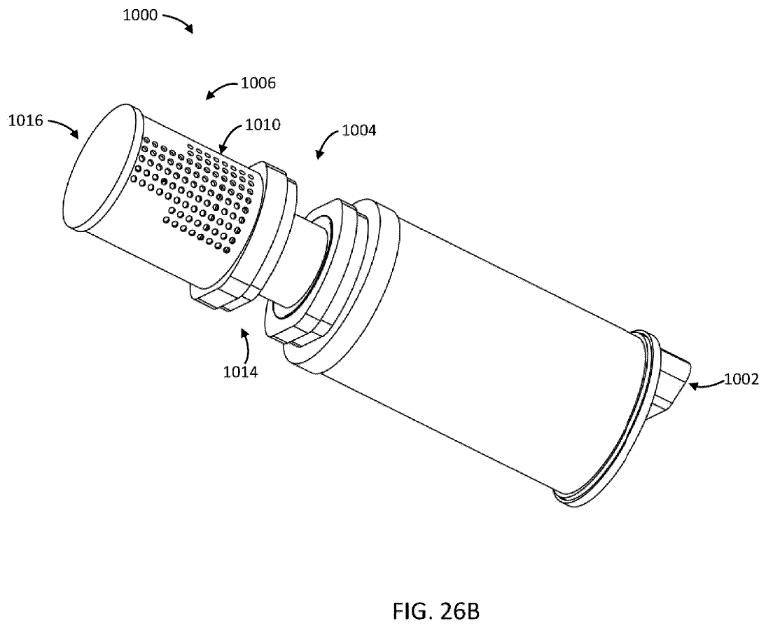

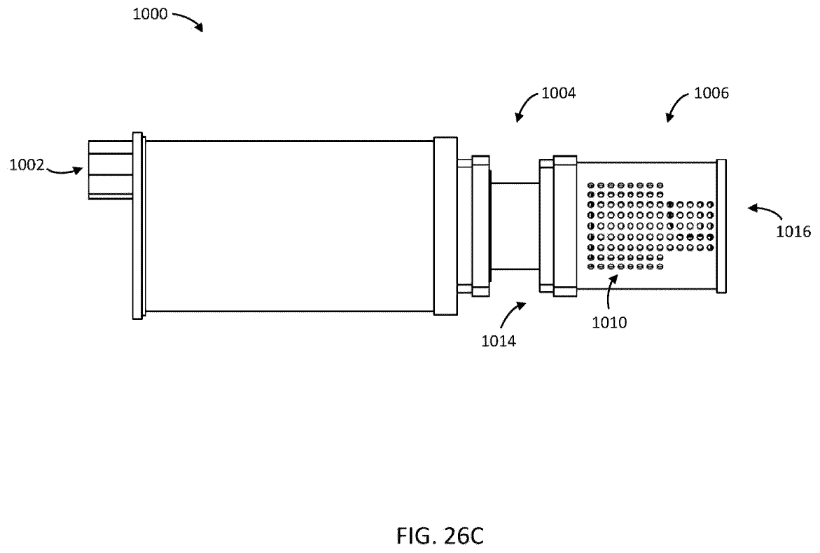

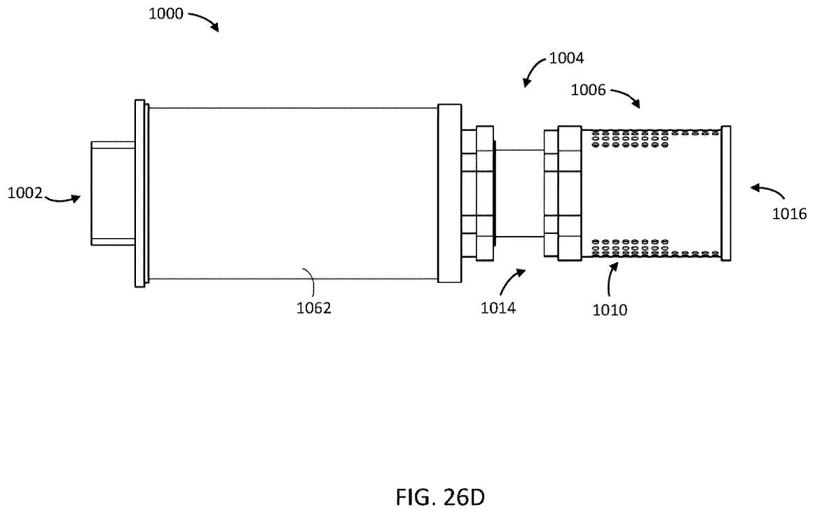

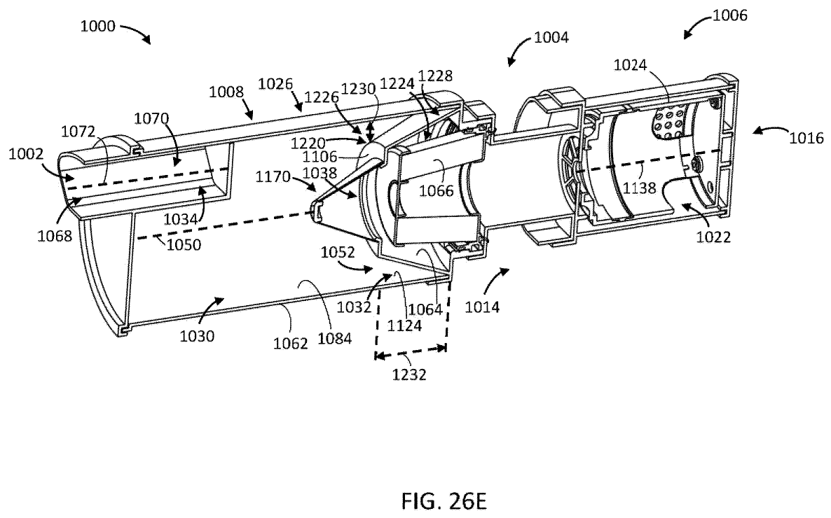

In the example illustrated in FIG. 26E, there is a dirt collection chamber 1032 that is contiguous with the air treatment chamber 1044 which is positioned axially (rearwardly) from the rear end wall 1106 of the air treatment chamber 1044 and is positioned closer to the rear end wall 1106 than the front end wall 1076. Accordingly, such a dirt collection chamber may be positioned rearward of the cyclone chamber (rearward of rear wall 1106) and forward of the rear end of the air treatment member 1008 (e.g., forward of rear wall 1086).

It is to be understood that an air treatment member 1008 having a dirt collection chamber or region 1032 that is contiguous with the air treatment chamber 1044 may also include an external, radially outwardly positioned, dirt collection chamber 1032.

A surface cleaning apparatus with a dirt collection chamber 1032 that is contiguous with the air treatment chamber 1044 may provide a longer, but slimmer main body 1006 compared to a surface cleaning apparatus having a dirt collection chamber 1032 positioned radially outwardly from the air treatment chamber 1044. A main body 1006 that is slim may be able to reach into tight spaces that may not be accessible by a wider bodied surface cleaning apparatus.

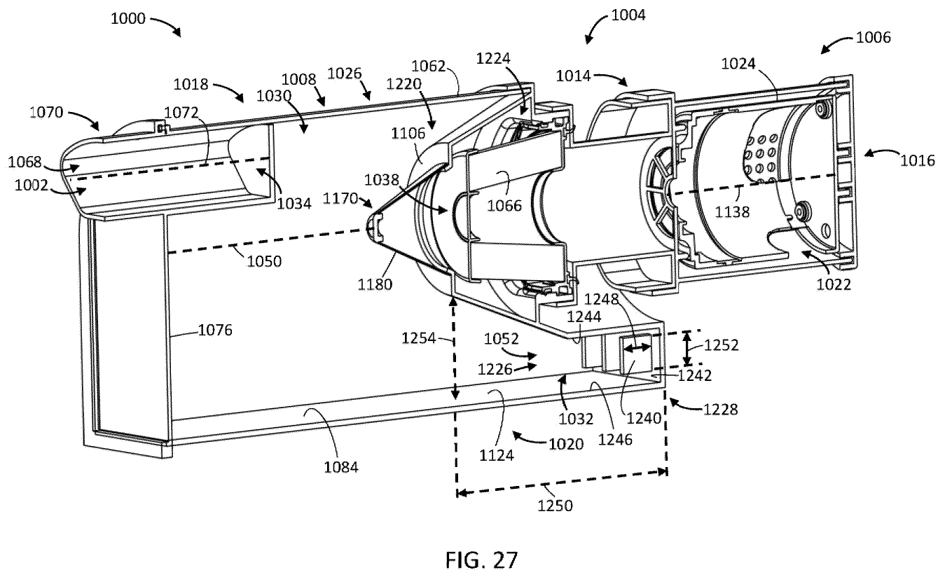

A dirt collection chamber 1032 that is contiguous with the air treatment chamber 1044 may extend about the entire perimeter or only a portion of the perimeter of the air treatment chamber 1044 (i.e., around the cyclone chamber air outlet 1038 in the example shown). For example, the dirt collection chamber 1032 may extend between 15°-360°, 30°-180°, or 45°-120° degrees around the perimeter of the air treatment chamber 1044. Optionally, there may be one or more dirt collection chambers 1032 that are each contiguous with the air treatment chamber 1044 and that are each positioned around the perimeter of the air treatment chamber 1044. Together, the plurality of dirt collection chambers 1032 may extend between 15°-360°, 30°-180°, or 45°-120° degrees around the perimeter of the air treatment chamber 1044. That is, for example, there may be a first dirt collection chamber 1032 that extends angularly part way around the cyclone chamber air outlet 1038 and at least a second dirt collection chamber 1032 that extends angularly part way around the cyclone chamber air outlet 1038 and each of the first and second dirt collection chambers 1032 may be contiguous with the air treatment chamber 1044. Accordingly, a dirt collection chamber 1032 that is contiguous with the air treatment chamber 1044 may surround part or all of the air flow path extending downstream from the air treatment chamber. Optionally, as exemplified in FIG. 27, if the pre-motor filter 1066 is nested part or all of the way forwardly, a dirt collection chamber 1032 that is contiguous with the air treatment chamber 1044 may surround part or all of the pre-motor filter 1066.

As exemplified in FIG. 26E, the cyclone chamber air outlet 1038 extends axially into the air treatment chamber 1044 from the rear end wall 1106. In the example illustrated, the rear end wall 1106 (i.e., the end wall opposite to the cyclone air inlet 1034) of the cyclone chamber 1030 has a radial outer end 1220 that is radially inwards of the sidewall 1084 of cyclone chamber 1030. Accordingly, in the example illustrated, the dirt outlet 1052 connecting the cyclone chamber 1030 to the dirt collection chamber 1032 is defined by the radial space or gap between the radially outer end 1220 of the rear end wall 1106 and the sidewall 1084 of the cyclone chamber 1030.

Optionally, as shown, the rear end wall 1106 may extend radially outwardly from the cyclone chamber air outlet 1038 (i.e., a shelf may extend between the cyclone chamber air outlet 1038 and the dirt outlet 1052). The rear end wall 1086 may extend between, e.g., 1 mm-25 mm, between, 3 mm-20 mm, or between 4 mm-12 mm in the radial direction outwardly from the cyclone chamber air outlet 1038.

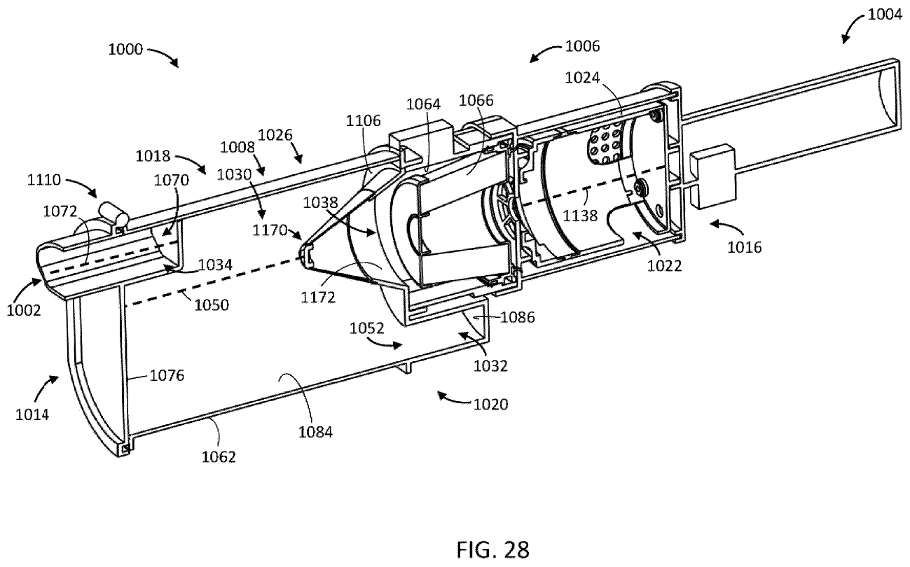

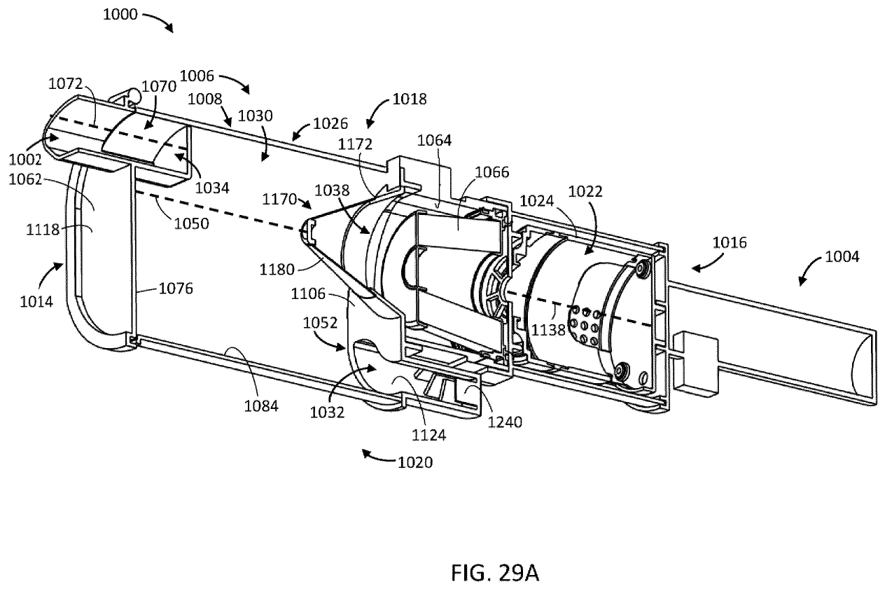

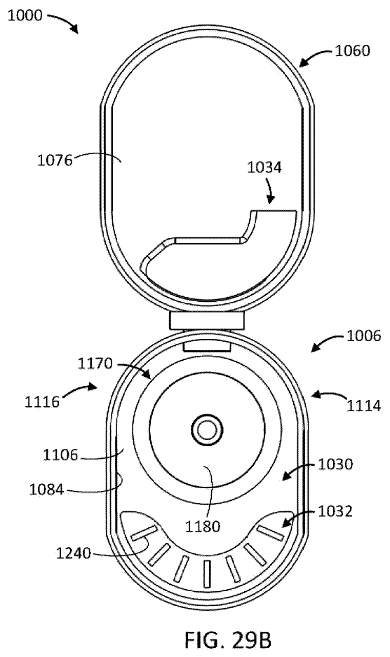

In other examples, as exemplified in FIG. 28, a rear end wall 1106 may not be provided and the radial inner wall of the contiguous dirt collection chamber 1032 may extend rearwardly from the vortex finder. Accordingly, there may be a smooth transition between the cyclone chamber air outlet 1038 and the dirt collection chamber 1032 (as shown in FIG. 22D).

In some examples, the dirt collection chamber 1032 that is contiguous with the air treatment chamber 1044 may extend about the cyclone chamber air outlet 1038 and may therefore define a radially inward cavity 1224 positioned downstream of the cyclone chamber air outlet 1038. As shown in FIG. 26E, the pre-motor filter 1066 may be positioned within the cavity 1224 defined by the dirt collection chamber 1032. That is, in some examples, some or all of the pre-motor filter 1066 may be located radially inwardly of the dirt collection chamber 1032 and the radial inner wall of the contiguous dirt collection chamber may form a header of the pre-motor filter 1066. Accordingly, a plane that is transverse to the air treatment chamber axis 1050 extends through the first dirt collection region and the pre-motor filter. In other examples, other components, such as, for example, the motor and fan assembly 1022 and/or the energy storage member 1074 may be located radially inwardly of the dirt collection chamber 1032. Optionally a second stage air treatment member 1008 may be located radially inwardly of the dirt collection chamber 1032.

The dirt collection chamber 1032 that is contiguous with the air treatment chamber 1044 may be of any shape known in the art. More specifically, the cross-sectional profile of the dirt collection chamber 1032 may be of any shape known in the art. In the example illustrated in FIG. 26E, the dirt collection chamber 1032 has an open first end 1226 located at the dirt outlet 1052 and an axially spaced apart second end 1228 and the dirt collection chamber 1032 is tapered axially from the first end 1226 to the second end 1228. As a second example, as shown in FIG. 13, the cross-section of the dirt collection chamber 1032 is constant along its length.

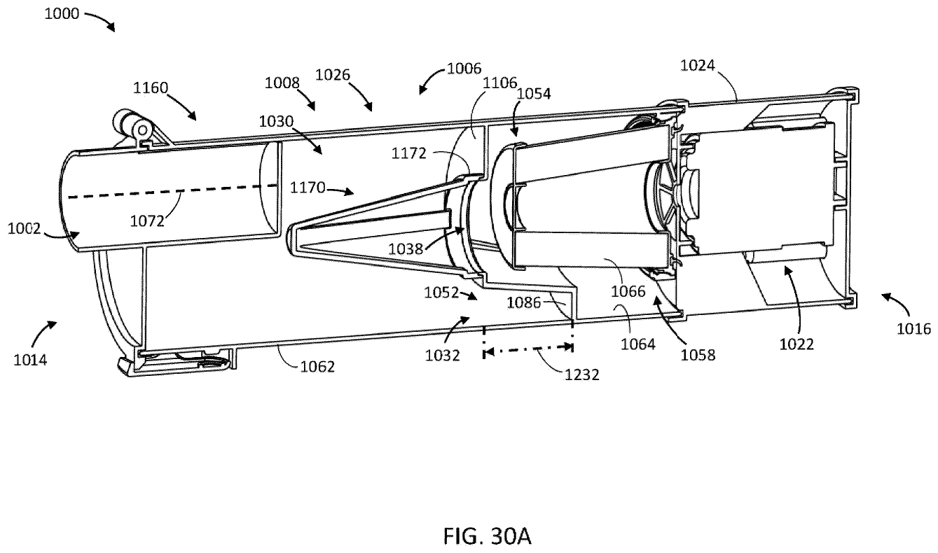

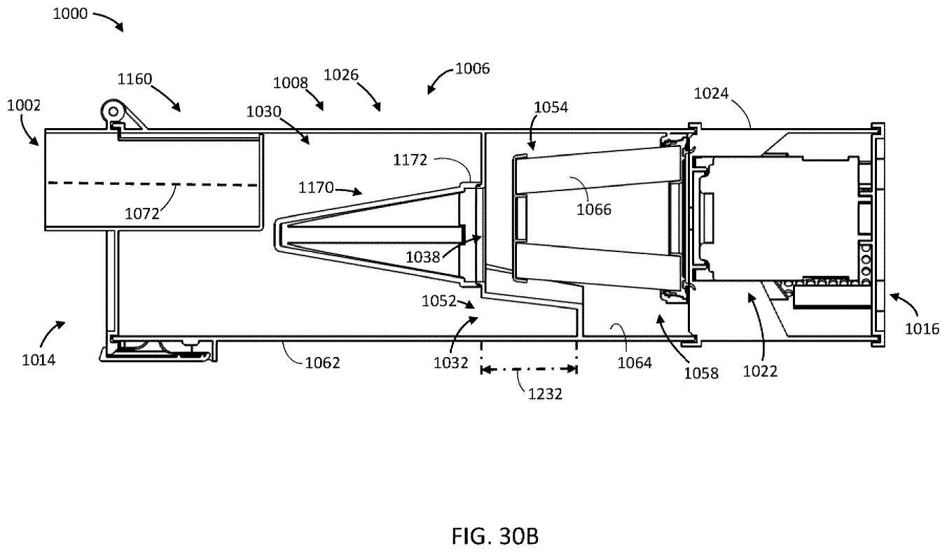

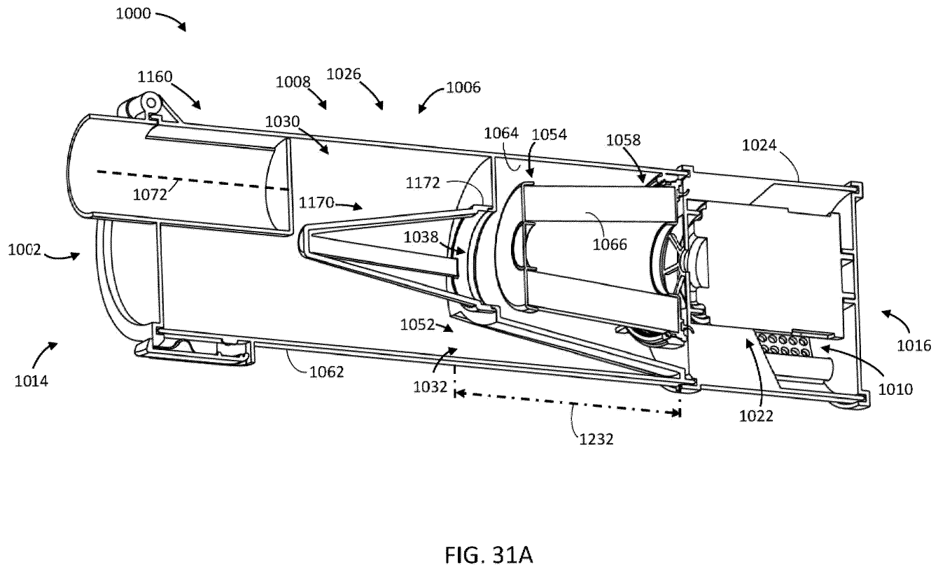

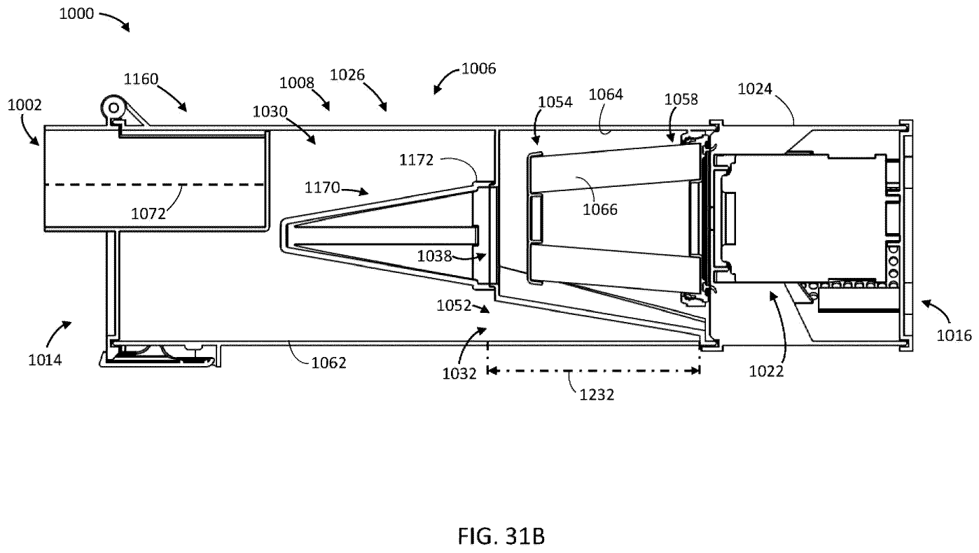

The dirt collection chamber 1032 may have any depth 1232. For example, in the examples illustrated in FIG. 13 and FIG. 31B, the depth 1232 of the dirt collection chamber 1032 extends to the rear end 1058 of the pre-motor filter 1066. In the example illustrated in FIG. 30B, the dirt collection chamber 1032 terminates prior to the rear end 1058 of the pre-motor filter 1066.

The dirt collection chamber 1032 may have a radial width 1230 at the dirt outlet 1052 of the air treatment chamber 1044 between 3 mm-50 mm, between 5 mm-30 mm, or between 6 mm-15 mm. The dirt collection chamber 1032 may have a depth 1232 in the axial direction between 2 mm-100 mm, between 5 mm-75 mm, or between 10 mm-44 mm.

Optionally, as discussed in more detail subsequently, the dirt collection chamber 1032 may include a baffle 1240 herein.

### The Baffle

In accordance with this aspect of this disclosure, which may be used by itself or in combination with one or more other aspects of this disclosure, the dirt collection chamber 1032 may include one or more baffles 1240.

There may be a baffle 1240 positioned in the dirt collection chamber 1032, in particular a dirt collection chamber 1032 that is contiguous with the air treatment chamber 1044, to promote the retention of debris within the dirt collection chamber 1032. The baffles may assist in reducing the movement of air in the dirt collection chamber 1032.

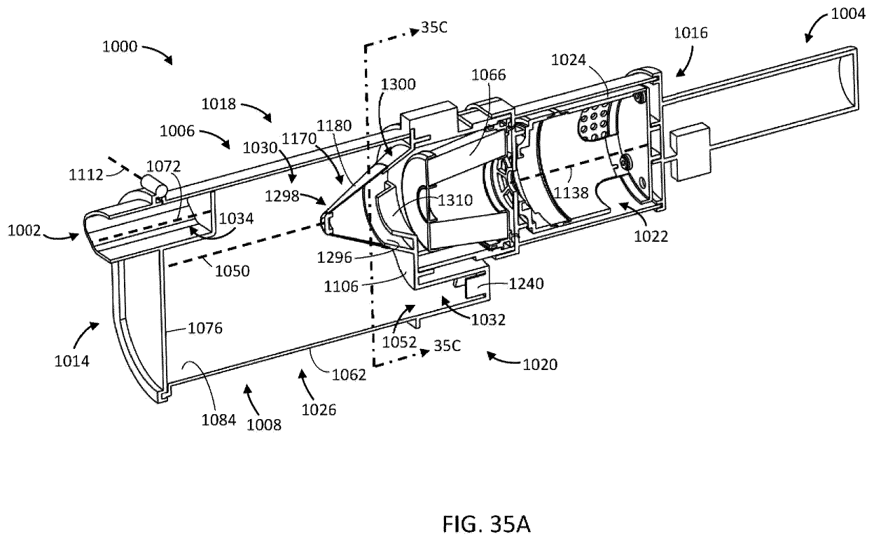

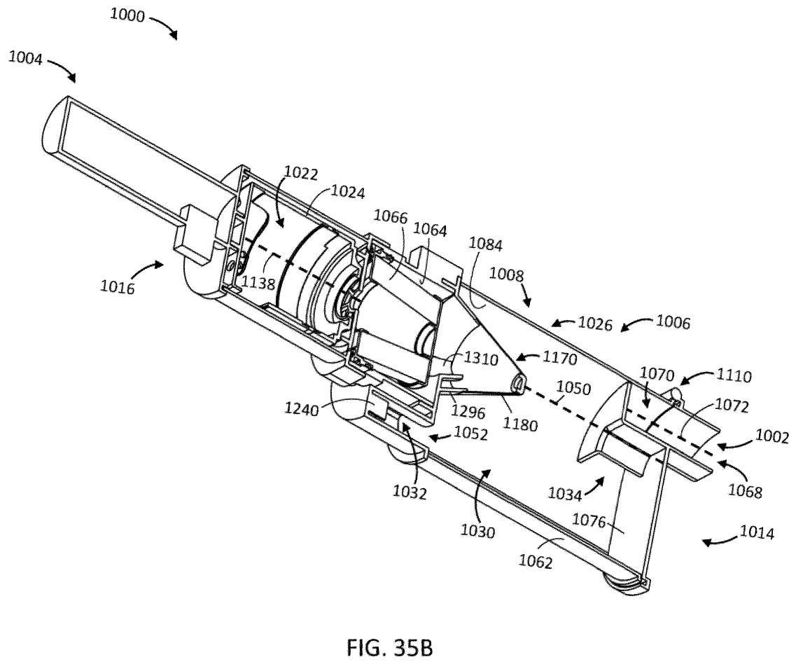

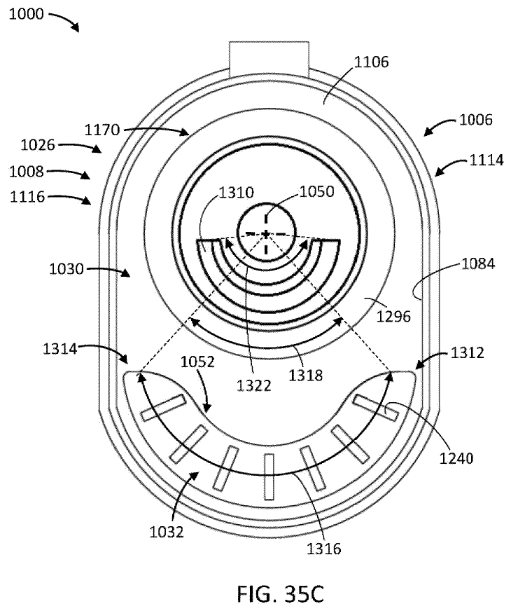

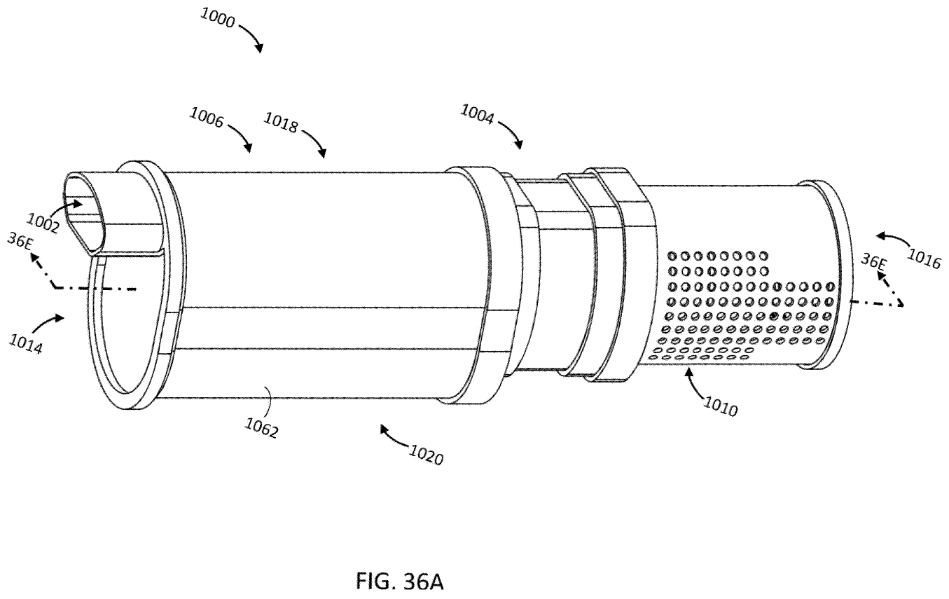

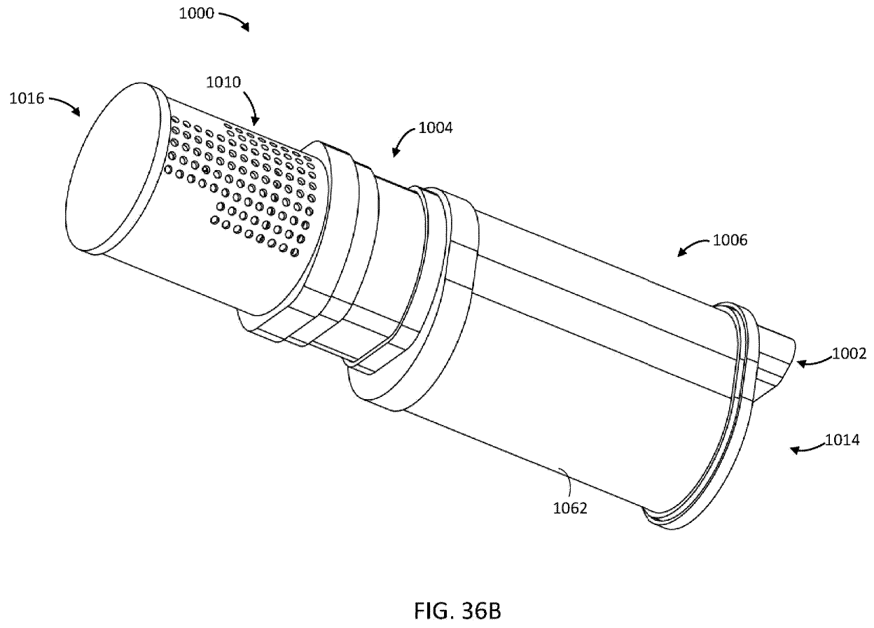

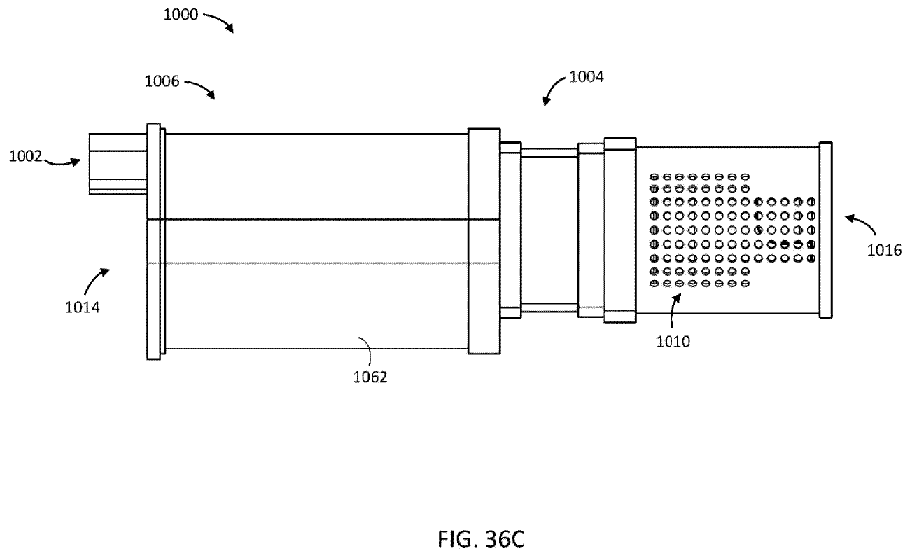

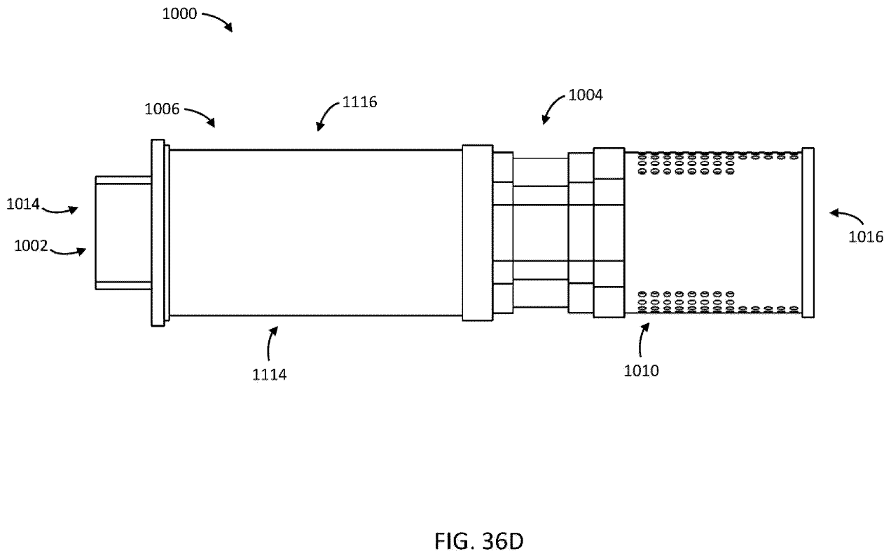

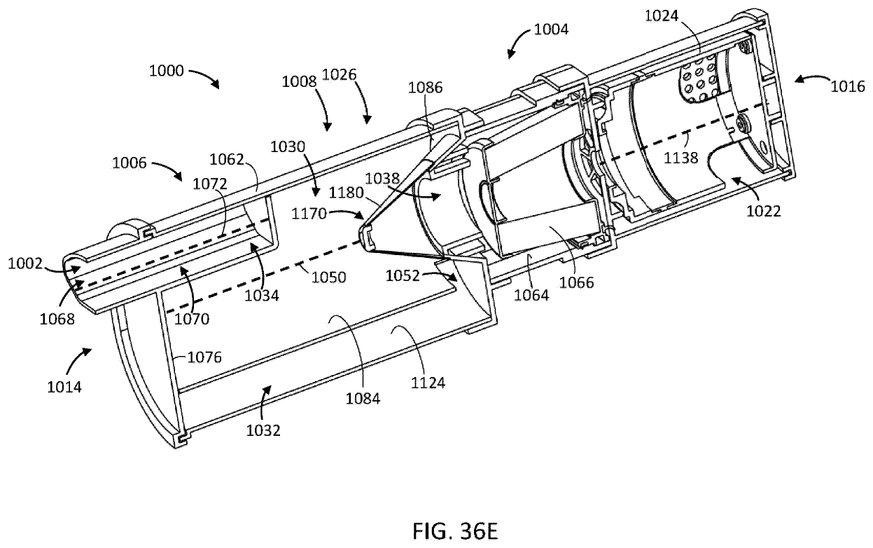

Optionally, the baffle 1240 may be positioned within the dirt collection chamber 1032 at an opposite end (e.g., a rear end as exemplified in FIGS. 27 and 35A) to the dirt outlet 1052 to the dirt collection chamber 1032. In the example illustrated in FIG. 27, the dirt collection chamber 1032 has an open first end 1226 located at the cyclone chamber air outlet 1038 and an axially spaced apart second end 1228 that includes a second end wall 1242 (which may also be the rear end wall 1086 of the air treatment member 1008). As shown the baffle 1240 may be provided on the second end wall 1242 and may extend forwardly part or all of the axial length of the contiguous dirt collection chamber 1032. In such a case, the baffles 1240 may be spaced from the radial inner wall 1244 of the dirt collection chamber 1032 and/or from the radial outer wall 1246 of the dirt collection chamber 1032.

Alternatively, or in addition, one or more baffles 1240 may be provided (a) on the radial inner wall 1244 and may extend radially outwardly; and/or (b) on the radial outer wall 1246 and may extend radially inwardly. If a baffle is provided on a radial inner or outer wall, then the baffle 1240 may be spaced apart from the second end 1228 of the dirt collection chamber 1032 and/or the open end 1226.

The baffle 1240 may be of any shape known in the art. Further, there may be any number of baffles 1240 positioned with a dirt collection chamber 1032. In the example illustrated in FIG. 27, the baffles 1240 each extend axially towards the open front end 1226 of the dirt collection chamber 1032 and the baffles 1240 are generally transverse to an angular direction. In the example shown, the baffles 1240 have a generally rectangular cross-sectional profile in a direction transverse to the air treatment chamber axis 1050. In other examples, the baffles 1240 may have a circular, triangular, square, etc. cross-sectional profile in the direction transverse to the air treatment chamber axis 1050.

In the example shown, the baffles 1240 have a constant profile along their height 1248. In other examples, the baffles 1240 may be tapered towards the dirt outlet 1052 to the dirt collection chamber 1032. The taper of the baffle 1240 may be between 1°−45°, between 3°−20°, or between 5°-12°.

The baffles 1240 may have a height 1248 between 5%-150%, between 10%-125%, or between 25%-100% of the axial depth 1250 of the dirt collection chamber 1032.

The baffles 1240 may have a width 1252 that is between 5%-100%, between 10%-60%, or between 25%-50% of the radial width 1254 of the dirt collection chamber 1032.

### The Cyclone Chamber Having a Slot Shaped Dirt Outlet

In accordance with this aspect of this disclosure, which may be used by itself or in combination with one or more other aspects of this disclosure, the cyclone chamber 1030 may have a dirt outlet 1052 that is slot shaped (i.e., a slot shaped dirt outlet 1260).

A slot shaped dirt outlet 1260 may connect the cyclone chamber 1030 to the external dirt collection chamber 1042 so that debris separated from the air flow within the cyclone chamber 1030 can pass to the dirt collection chamber 1032 for storage therein. As described below, a slot shaped dirt outlet 1260 is defined in part by a sidewall 1262 that is common to each of the cyclone chamber 1030 and the dirt collection chamber 1032.

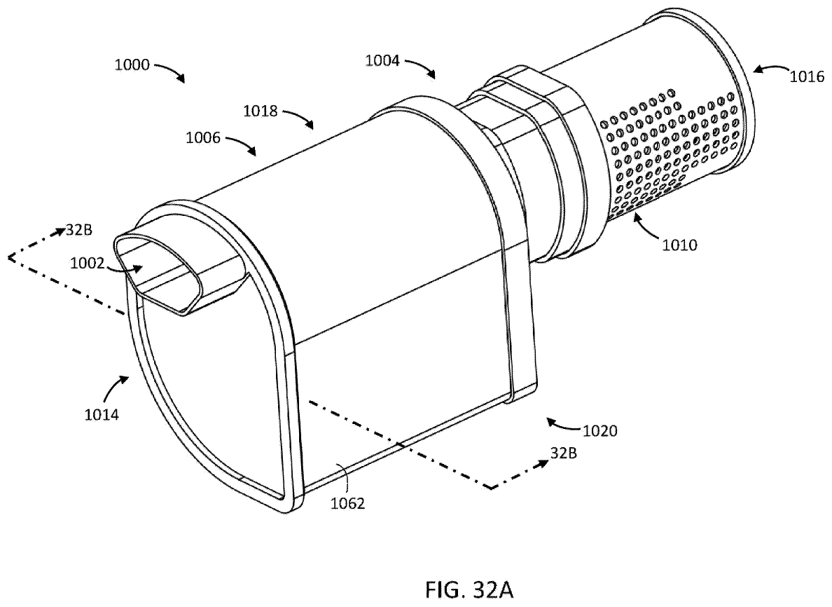

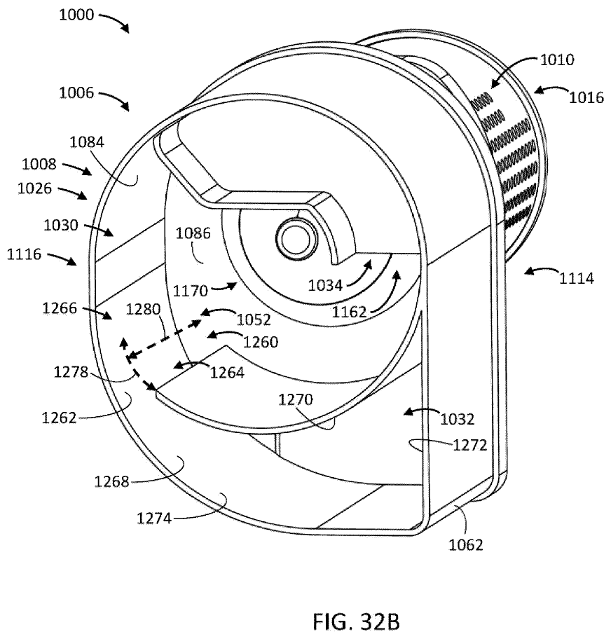

An example of a slot shaped dirt outlet 1260 is illustrated in FIG. 32B. As shown in the example illustrated, slot shaped dirt outlet 1260 is positioned in the sidewall 1084 of the cyclone chamber 1030. Accordingly, the slot shaped dirt outlet 1260 has an upstream side 1264 in a direction of rotation of air in the cyclone chamber 1030 and a downstream side 1266 in the direction of rotation of air in the cyclone chamber 1030.

External to the cyclone chamber 1030 is the dirt collection chamber 1032. As shown, the dirt collection chamber 1032 may be defined in part by at least first and second opposed walls 1268, 1270. In the example illustrated, the dirt collection chamber 1032 extends only part way around the cyclone chamber and therefore is exemplified with a third wall opposite 1272 to the slot shaped dirt outlet 1260 that extends between the first and second opposed walls 1268, 1270. It will be appreciated that the dirt collection chamber may extend around all of the cyclone chamber.

As shown, the first opposed wall 1268 is an extension of the sidewall 1084 of the cyclone chamber 1030. Specifically, an internal surface 1274 of the first opposed wall 1268 is an extension of an internal surface 1276 of the sidewall 1084 of the cyclone chamber 1030. Put another way, the first opposed wall 1268 extends contiguously from the downstream side 1266 of the slot shaped dirt outlet 1260. Accordingly, the first opposed wall 1268 and the sidewall 1084 of the cyclone chamber 1030 may include a continuous uninterrupted surface.

The slot shaped dirt outlet 1260 may be of any angular length 1278 (i.e., length in the direction of air flow) and axial length 1280. Optionally, the slot shaped dirt outlet 1260 extends at least 50%, 75%, or 90% of an axial length of the cyclone chamber 1030.

As air spirals within the cyclone chamber 1030, the air flow traverses the slot shaped dirt outlet 1260. The cyclone chamber may be circular other than the dirt outlet 1260 and an angular projection of the cyclone chamber sidewall 1084 in the direction of the angular length of the dirt outlet 1260 may, together with the cyclone sidewall 1084, define a circle in a plane transverse to the cyclone axis.

Still referring to FIG. 32B, as the air flow traverses the slot shaped dirt outlet 1260, the air flow continues to swirl about the cyclone chamber 1030. However, entrained debris is heavier and may not traverse the dirt outlet and may therefore travel through the dirt outlet 1260 into the dirt collection chamber. In addition, after traversing the dirt outlet 1260, some of the debris may hit the sidewall 1262, and debris entrained within the air flow may be separated therefrom and may pass through the slot shaped dirt outlet 1260 and be collected in the dirt collection chamber 1032.

Optionally, the first opposed wall 1268 may join the sidewall 1262 tangentially (e.g., the first opposed wall 1268 may be a curved wall) (as shown in FIG. 32B)) so that (a) the air flow is encouraged to continue to spiral within the cyclone chamber 1030; and (b) the debris separated from the air flow may slide along the sidewall 1262 as it transitions to the first opposed wall 1268 of the dirt collection chamber 1032 without any obstacles to impede its motion.

There may be a screen (not shown) that extends across the slot shaped dirt outlet 1260. The screen may stop larger debris from collecting in the dirt collection chamber 1032 connected to the slot shaped dirt outlet 1260.

It is to be understood that a surface cleaning apparatus may have a slot shaped dirt outlet 1260 connected to a first dirt collection chamber 1032 and any other dirt outlet discussed herein.

### The Porous Member Having Axially Extending Dimples

In accordance with this aspect of this disclosure, which may be used by itself or in combination with one or more other aspects of this disclosure, the air treatment chamber air outlet 1048 may include an axially extending porous member 1180 having at least one axially extending dimple 1286.

The axially extending porous member 1180 may act as a screen which allows air to pass therethrough and may stop debris such as hair from entering the pre-motor filter 1066 and/or the motor and fan assembly 1022.

The axially extending porous member 1180 may include at least one axially extending dimple 1286, and the axially extending dimple 1286 may provide rigidity to the axially extending porous member 1180 so that it does not collapse during regular use of the surface cleaning apparatus. Known screens may have a plurality of axially extending support ribs to keep the screen from collapsing during use. These support ribs reduce the total surface area of the screen through with air may pass therethrough. A reduction in the surface area of the screen through with air may pass may increase the back pressure of the surface cleaning apparatus.

The axially extending porous member 1180 with at least one axially extending dimple 1286 may have an absence of axially extending support ribs to maximize surface area through with air may pass through the axially extending porous member 1180. Therefore, the axially extending porous member 1180 may extend uninterrupted 360° around a central longitudinal axis 1288 of the axially extending porous member 1180.

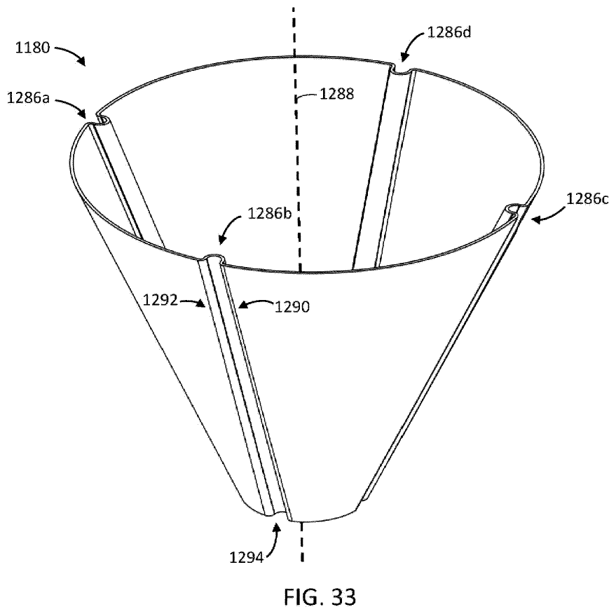

Referring now to FIG. 33, an example of an axially extending porous member 1180 having four axially extending dimples 1286a, 1286b, 1286c, 1286d is illustrated. The axially extending porous member 1180 may be of any shape known in the art. For example, the axially extending porous member 1180 may be conically shaped, cylindrically shaped, dome shaped, etc. In the example shown, the axially extending porous member 1180 is frusto-conical in shape.

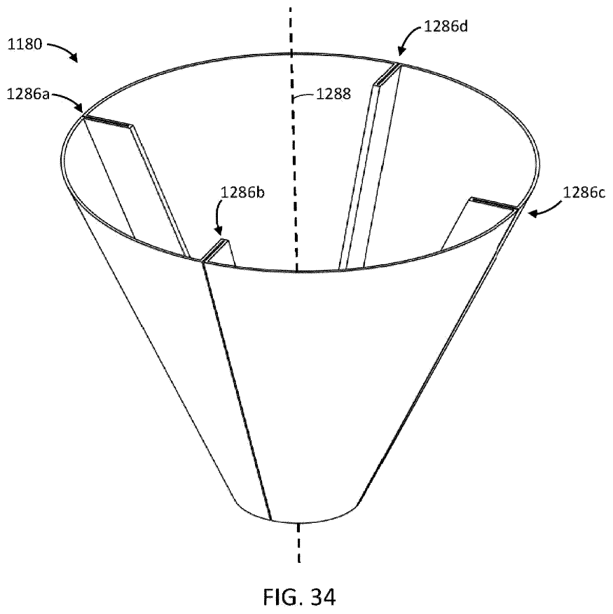

As shown in FIG. 33, the axially extending dimples 1286 may each have a first axially extending side 1290 and a second axially extending side 1292, and the first and second axially extending sides 1290, 1292 may be tapered radially inwardly towards each other. That is, the axially extending dimples 1286 may have a generally U-shaped profile or V-shaped profile in a plane transverse to the central longitudinal axis 1288 of the axially extending porous member 1180. The first axially extending side 1290 may be spaced between 0.25 mm-2 mm from the second radially extending side 1292 at a radial outer side 1294 of the axially extending dimple 1286. Alternatively, as shown in FIG. 34, the axially extending dimple(s) 1286 may have first and second axially extending sides 1290, 1292 that abut.

Optionally, the air treatment chamber 1044 may be a cyclone chamber 1030 and the axially extending porous member may include a vortex finder conduit portion 1172.

### The Vortex Finder Having Increased Air Permeable Surface Area

In accordance with this aspect of this disclosure, which may be used by itself or in combination with one or more other aspects of this disclosure, the surface area of the porous portion 1180 (i.e., screen portion) of the vortex finder 1170 may be increased without increasing the surface area of the vortex finder 1170 itself by perforating at least a portion of the conduit portion 1172 of the vortex finder 1170.

The surface area of the porous portion 1180 relative to an outlet area of the cyclone air inlet 1034 may have an effect on the performance characteristics of the surface cleaning apparatus. For example, if the surface area of the porous portion 1180 is less than the outlet area of the cyclone air inlet 1034, the cyclone chamber 1030 may produce an undesirable amount of back pressure, when in use. As a result, it may be desirable for the surface area of the porous portion 1180 to be equal to or greater than the outlet area (the outlet port) of the cyclone air inlet 1034. Optionally, the ratio of the surface area of the porous portion 1180 to the outlet area of the cyclone air inlet 1034 may be between 1:1 and 20:1, or between 2:1 and 15:1, or between 3:1 and 8:1, or between 3.5:1 and 5:1.

It is to be understood that if the cyclone air inlet 1034 includes multiple ports (i.e., opening into the cyclone chamber 1030), the outlet area of the cyclone air inlet 1034 is the combined outlet area of each port. Accordingly, it may be desirable for the surface area of the porous portion 1180 to be equal to or greater than the outlet area of the multiple outlet ports, combined.

It may be desirable to increase the surface area of the porous portion 1180 without increasing the surface area of the vortex finder 1170 itself, as a larger vortex finder 1170 may require a larger cyclone chamber 1030; which may be undesirable. In addition, it may be undesirable to decrease the outlet area of the cyclone air inlet 1034 so that the surface area of the porous portion 1180 is less than or equal to the outlet area of the cyclone air inlet 1034 as reducing the outlet area of the cyclone air inlet 1034 will reduce the rate of air flow into the cyclone chamber 1030 without increasing the power input to the suction motor.

Accordingly, it may be desirable to increase the surface area of the porous portion 1180 without increasing the surface area of the vortex finder 1170 as this may allow for the size of the cyclone chamber 1030 to be reduced without giving up performance.

To increase the surface area of the porous portion 1180 without increasing the surface area of the vortex finder 1170, the surface area of at least a portion of the conduit portion 1172 that is generally solid in vortex finders 1170 known in the art may be replaced with a porous section 1296.

The porous section 1296 at the first or rear end 1298 of the vortex finder 1170 (e.g., conduit portion 1172) may be less, more, or equally porous than the porous portion 1180 at the second or front end 1300. In some embodiments, the porous portion 1180 at the second end 1300 may be a screen (e.g., a metal mesh screen) which is more porous than the porous section 1296 at the first end 1298, which may be perforations in a molded plastic tapered wall of the cyclone chamber air outlet 1038.

In some examples, porous section 1296 at the first end 1298 of the vortex finder 1170 and the porous portion 1180 at the second end 1300 of the vortex finder 1170 may be formed of a single monolithic workpiece.

The porosity of the porous section 1296 at the first end 1298 of the vortex finder 1170 may vary about the circumference of the first end 1298 of the vortex finder 1170. According, a first section of the conduit portion 1172 may be porous and a second section of the conduit portion 1172 that is angularly spaced around the conduit portion 1172 from the first portion of the conduit portion 1172 may be air impermeable. Optionally the conduit portion 1172 may comprise two or more porous sections that are angularly spaced around the conduit portion 1172 from each other.

For example, a first section of the conduit portion 1172 that is radially opposed to and faces towards the dirt outlet 1052 (a first portion of the conduit portion 1172) may be porous. Alternately, or in addition, second section of the conduit portion 1172 that is on a radially opposed side of the conduit portion 1172 from the dirt outlet 152 may also be porous. The sections of the conduit portion 1172 between the first and second sections of the conduit portion 1172 that are porous may be air impermeable. In some examples, the opposed second section may be more porous than the porous section 1296 facing the dirt outlet 1052.

Optionally the porous section 1296 of the vortex finder 1170 that faces the dirt outlet 1052 of the cyclone chamber 1030 is less porous than other portions so that air pass is less likely to pass therethrough then the remaining portion of the vortex finder 1170. Debris separated from the air flow may be more likely to pass through the dirt outlet 1052 of cyclone chamber 1030 when the porous section 1296 of the vortex finder 1170 that faces the dirt outlet 1052 is less likely to have air pass therethrough then the remaining portion of the vortex finder 1170.

Alternately, or in addition, in some embodiments, there may be an air impermeable member 1310 positioned interior the cyclone chamber air outlet 1038 which faces the porous section 1296 of the vortex finder 1170 that faces the dirt outlet 1052. Accordingly, in some examples, a plane that is transverse to the cyclone axis of rotation 1050 may intersect the dirt outlet 1052, the porous section 1296, and the air impermeable member 1310.

The air impermeable member 1310 may be of any shape known in the art. In the example shown in FIG. 35A, the air impermeable member 1310 is arcuate. The air impermeable member 1310 may be spaced apart from the porous section 1296 in the radial direction. Alternatively, at least a portion the air impermeable member 1310 may abut the porous section 1296. In the example shown in FIG. 35C, the air impermeable member 1310 is spaced apart from the porous section 1296 in the radial direction. As also shown in FIG. 35C, the air impermeable member 1310 may be radially positioned between the cyclone axis of rotation 1050 and the porous section 1296.

Referring now to FIG. 35C, in the example illustrated, the dirt outlet 1052 extends from a first end 1312 angularly around the cyclone sidewall to a second end 1314. Accordingly, as shown, the dirt outlet 1052 has an arc length 1316 defining a section of the cyclone chamber 1030 and a dirt outlet sector angle 1318. In some examples, the dirt outlet sector angle 1318 can be from 30° to 90°, or from 45° to 75°.

Optionally, the porous section 1296 may have a porous section sector angle that is equal to or greater than the dirt outlet sector angle 1318 (in the example illustrated the porous section sector angle is) 360°. For example, the porous section 1296 may have a porous section sector angle that is 10°, 20°, 30°, 40°, 50° or 60° greater than the dirt outlet sector angle 1318. Accordingly for example, the porous section 1296 may extend angularly around the conduit portion 172 5°, 10°, 15°, 20°, 25° or 30° in one direction from one angular end of the dirt outlet and 5°, 10°, 15°, 20°, 25° or 30° in the other direction from the other angular end of the dirt outlet.

Likewise, the air impermeable member 1310 may have an air impermeable sector angle 1322 that is equal to or greater than the dirt outlet sector angle 1318 and/or the porous section sector angle. Accordingly, the air impermeable member 1310 may have a sector angle that is 10°, 20°, 30°, 40°, 50° or 60° greater than the sector angle of the porous section 1296. Accordingly for example, the air impermeable member 1310 may extend angularly around the conduit portion 172 5°, 10°, 15°, 20°, 25° or 30° in one direction from one angular end of the porous section 1296 and 5°, 10°, 15°, 20°, 25° or 30° in the other direction from the other angular end of the porous section 1296.

Similarly, a section of the conduit portion 1172 that is on a radially opposed side of the conduit portion 1172 from the dirt outlet 1052 (i.e., the upper portion in FIG. 35C, may be porous and may have the same or similar sector angle to sector angle 1318.

The cyclone chamber 1030 may have more than one dirt outlet 1052. If the cyclone chamber 1030 includes more than one dirt outlet 1052, a porous section 1296 with an aligned impermeable member 1310 positioned interior the cyclone air chamber air outlet 1038 may face each of the dirt outlets 1052.

### The Handle

In accordance with this aspect of this disclosure, which may be used by itself or in combination with one or more other aspects of this disclosure, the surface cleaning apparatus may include a handle 1004.

A handle 1004 is designed to be gripped by a user so that the user may comfortably hold the surface cleaning apparatus in an operating position. The handle 1004 may also be gripped by a user when emptying debris from the dirt collection chamber 1032. In theory, while any portion of a surface cleaning apparatus may be gripped, a handle 1004 is generally a distinctive region of the surface cleaning apparatus. The handle 1004 may have any shape known in the art and may be positioned at any location on the surface cleaning apparatus. Optionally, the handle 1004 may be a pistol grip.

As shown in FIG. 1A, the handle 1004 may extend axially (or generally axially as exemplified in FIG. 8A) from the rear end 1016 of the main body 1006 of the surface cleaning apparatus. As shown, in FIG. 1D, the handle 1004 may extend generally parallel with the cyclone axis of rotation 1050. Alternatively, the handle 1004 may extend at an angle to the cyclone axis of rotation 1050 as illustrated in FIG. 8A.

Referring now to FIG. 22A, the handle 1004 may be positioned between the distal ends 1320, 1322 of the surface cleaning apparatus. When the handle 1004 is position between distal ends 1320, 1322 of the surface cleaning apparatus, there may be components of the surface cleaning apparatus on either side of the handle 1004. It may be desirable to balance the weight of the components on the one side of the handle 1004 to the components on the other side of the handle 1004 for ergonomic purposes.

As shown in FIG. 22D, the handle 1004 may be longitudinally positioned between the air treatment bin assembly (i.e., air treatment member 1008), which includes the air treatment chamber 1044, and the main body 1006, which includes the motor and fan assembly 1022. More specifically, in the example illustrated, the air treatment bin assembly 1008 has a rear end 1324 having the air treatment chamber air outlet 1048, the main body 1006 has a front end 1014 having an air inlet 1326 and the handle 1004 extends between the rear end 1324 of the air treatment bin assembly 1008 and the front end 1014 of the main body 1006.

Accordingly, the handle 1004 may include a portion of the air flow path therein to fluidically connect the air treatment chamber air outlet 1048 of the air treatment bin assembly 1008 to the air inlet 1326 to the main body 1006. Optionally, the portion of the air flow path within the handle 1004 may include the pre-motor filter 1066.

Still referring to the example illustrated in FIGS. 22A-22D, each of the air treatment bin assembly 1008 and the main body 1006 has a height 1330, 1332 in a direction transverse to the central longitudinal axis 1052 of the hand vacuum cleaner 1000. As shown, the handle 1004 also has a height 1334 in the transverse direction that is less than the height 1330, 1332 of the air treatment bin assembly 1008 and the main body 1006.

As discussed previously, there may be an energy storage member 1074 optionally housed in an energy storage chamber 1140 that extends along at least a portion of the exterior surface 1062 of the surface cleaning apparatus illustrated in FIGS. 22A-22D. In such an example, the height 1330 of the air treatment bin assembly 1008, the height 1334 of the handle 1004, and/or the height 1332 of the main body 1006 may include a height 1336 of the energy storage member 1074 (and optionally the energy storage chamber 1140).

As shown, the height 1334 of the handle 1004 may be less than the height 1330, 1332 of the air treatment bin assembly 1008 and/or the main body 1006 (with or without an energy storage member 1074 optionally housed in an energy storage chamber 1140). The handle 1004 may be positioned at any vertical location with respect to the air treatment bin assembly 1008 and the main body 1006. That is, in some examples, (a) an upper longitudinally extending side 1340 of the handle 1004 may be flush with at least one of an upper longitudinally extending side 1342 of the air treatment bin assembly 1008 and an upper longitudinally extending side 1344 of the main body 1006 (as is shown in FIG. 22A); (b) an lower longitudinally extending side 1348 of the handle 1004 may be flush with at least one of a lower longitudinally extending side 1350 of the air treatment bin assembly 1008 and a lower longitudinally extending side 1352 of the main body 1006; or (c) the upper longitudinally extending side 1340 and the lower longitudinally extending side 1348 of the handle 1004 may be recessed inwardly compared to the corresponding sides 1342, 1344, 1350, 1352 of the air treatment bin assembly 1008 and the main body 1006 (as is shown in FIG. 26C).

Similarly, first and second laterally opposed longitudinally extending sides 1354, 1356 of the handle 1004 may be flush or positioned radially inwardly compared to corresponding sides 1358, 1360, 1362, 1364 of the air treatment bin assembly 1008 and the main body 1006. In the example illustrated in FIG. 22A, the first and second laterally opposed longitudinally extending sides 1354, 1356 of the handle 1004 are positioned radially inwardly compared to corresponding sides 1358, 1360, 1362, 1364 of the air treatment bin assembly 1008 and the main body 1006.

Optionally, energy storage members 1074a, 1074b may be provided along a surface (e.g., an upper surface in the orientation of FIGS. 22A-22D) of the air treatment member 1008 and the main body 1006, but not the handle 1004, such that the upper longitudinally extending side 1340 is recessed inwardly. Optionally, the lower longitudinally extending side 1348 of the handle 1004 may be recessed inwardly.

### At Least One Laterally Openable Dirt Collection Chamber Door

In accordance with this aspect of this disclosure, which may be used by itself or in combination with one or more other aspects of this disclosure, the hand vacuum cleaner may have at least one laterally openable dirt collection chamber door.

The air treatment member 1008, which may be an air treatment chamber such as a non-cyclonic momentum separator or a cyclone and/or a dirt collection chamber of the air treatment chamber, may have at least a first openable portion 1060₁ that opens a sidewall of the air treatment member 1008. For example, if the air treatment member 1008 is a cyclone, then the cyclone has first and second ends, a sidewall extending between the first and second ends and a cyclone axis of rotation that intersects the first and second ends. In such a case, in accordance with this aspect, the first openable portion 1060₁ opens a portion of the sidewall, which may be in a radial outward direction. The first openable portion 1060₁ may move outwardly such as by translating outwardly or by rotating outwardly. Accordingly, when open, the first openable portion 1060₁ may open an air treatment chamber and, if provided, a dirt collection chamber external to the air treatment chamber.

The first openable portion 1060₁ may be operable to open at least the dirt collection chamber 1042. Accordingly, the first openable portion 1060₁ may be referred to as a dirt collection chamber door 1400. The dirt collection chamber door 1400 may be rotatably mounted by a hinge 1110 about a dirt collection chamber opening axis 1402. The dirt collection chamber opening axis 1402 may be parallel to the air treatment chamber axis 1050. In this way, when the dirt collection chamber door 1400 is moved between the closed position and the open position, the dirt collection chamber door 1400 may move in a lateral or outward direction. When the air treatment chamber axis 1050 extends horizontally and the dirty air inlet 1002 is at the upper end 1018 of the hand vacuum cleaner 1000, the lateral direction may be understood as the direction defined by a horizontal axis that is transverse to the air treatment chamber axis 1050. It will be appreciated that the horizontal axis may be approximately transverse.

It will be appreciated that more than one door may move laterally to open a portion of the air treatment member 1008. For example, optionally, the first openable portion 1060₁ may include a first dirt collection chamber door 1400a and a second dirt collection chamber door 1400b which, when open, provide a single opening of the air treatment member 108. The first dirt collection chamber door 1400a may be rotatably mounted about a first dirt collection chamber opening axis 1402a. The first dirt collection chamber door 1400a may move in a first lateral direction from the closed position to the open position. The second dirt collection chamber door 1400b may be rotatably mounted about a second dirt collection chamber opening axis 1402b that is parallel to the first dirt collection chamber opening axis 1402a. The second dirt collection chamber door 1400b may move in a second lateral direction from the closed position to the open position.

The second lateral direction may be opposite the first lateral direction. In this way, when the first and second dirt collection chamber doors 1400 are moved from their respective closed positions to their respective open positions, the first and second dirt collection chamber doors 1400 may move laterally away from each other. Conversely, when the first and second dirt collection chamber doors 1400 are moved from their respective open positions to their respective closed positions, the first and second dirt collection chamber doors 1400 may move laterally toward each other. Each door may have a first end that is rotatably mounted and an opposed moveable end. In the closed position, the opposed moveable ends may meet (e.g., abut) to provide a continuous outer wall of the air treatment member 1008. One or both of the opposed moveable ends may be provided with a deformable material (e.g., gasket) or the like such that, when the doors are closed, a seal is provided.

It will be appreciated that, if the air treatment chamber has an external dirt collection chamber, then as discussed subsequently, each of the air treatment chamber and the dirt collection chamber may have one or more doors that open laterally.

The dirt collection chamber door 1400 may, in the closed position, form a lower portion of the sidewall 1124 of the dirt collection chamber 1042. Similarly, the first dirt collection chamber door 1400a may form a first portion of the lower portion of the sidewall 1124 of the dirt collection chamber 1042 and the second dirt collection chamber door 1400b may form a second portion of the lower portion of the sidewall 1124 of the dirt collection chamber 1042. In such embodiments, the first and second dirt collection chamber opening axes 1402 may be laterally spaced apart on opposed, e.g., lower, sides of the dirt collection chamber 1042. The first and second portions of the lower portion of the sidewall 1124 may form equal proportions (e.g., 50/50) of the lower portion of the sidewall 1124 or unequal proportions (e.g., 60/40, 70/30, or any other suitable proportions) of the lower portion of the sidewall 1124. It will be appreciated that the door(s) may be provided on the sides or upper side of the sidewall 1124.

The dirt collection chamber 1042 may have a width in the lateral direction and a length in the forward/rearward direction (i.e., the direction of the air treatment chamber axis 1050). In some embodiments, the width of the dirt collection chamber 1042 may be less than the length of the dirt collection chamber 1042. Accordingly, in such embodiments, a laterally openable dirt collection chamber door 1400 that spans the width of the dirt collection chamber 1042 may have a shorter turn radius about the dirt collection chamber opening axis 1402 than would a forwardly/rearwardly openable dirt collection chamber door 1400 that spans the length of the dirt collection chamber 1042. This may advantageously reduce the depth of a refuse container or docking station required to accommodate the dirt collection chamber door 1400 moving to the open position for emptying. Similarly, first and second laterally openable dirt collection chamber doors 1400 that each span a portion (e.g., half) of the width of the dirt collection chamber 1042 may have an even shorter turn radius about the dirt collection chamber opening axis 1402. This may advantageously further reduce the depth of a refuse container or docking station required to accommodate the first and second dirt collection chamber doors 1400 moving to the open position for emptying.

When the air treatment chamber axis 1050 extends horizontally and the dirty air inlet 1002 is at the upper end 1018 of the hand vacuum cleaner 1000, the dirt collection chamber opening axis 1402 may extend in a horizontal plane, referred to as a dirt collection chamber emptying plane 1404. Where the air treatment member 1008 has first and second laterally openable dirt collection chamber doors 1400, the laterally spaced apart first and second dirt collection chamber opening axes 1402 may be provided at the same elevation. In this way, when the air treatment chamber axis 1050 extends horizontally and the dirty air inlet 1002 is at the upper end 1018 of the hand vacuum cleaner 1000, the first and second dirt collection chamber opening axes 1402 may both extend in the dirt collection chamber emptying plane 1404.

When the dirt collection chamber door(s) 1400 are in the open position, a dirt collection chamber emptying port 1406 may be provided in the dirt collection chamber emptying plane 1404. The dirt collection chamber emptying port 1406 may have a perimeter having first and second laterally opposed sides that extend in the forward/rearward direction. The first and second laterally opposed sides may be respectively adjacent to, and parallel with, the first and second dirt collection chamber opening axes 1402. Accordingly, when the dirt collection chamber door(s) 1400 are in the open position, dirt and debris collected within the dirt collection chamber 1042 may fall (and, optionally, be drawn) through the dirt collection chamber emptying port 1406 into a refuse container or docking station below.

For example, in the example illustrated in FIGS. 37A to 37F, the air treatment member 1008 has a first openable portion 1060₁ including first and second dirt collection chamber doors 1400. The first dirt collection chamber door 1400a forms a first portion of the lower portion of the sidewall 1124 of the dirt collection chamber 1042 and the second dirt collection chamber door 1400b forms a second portion of the lower portion of the sidewall 1124 of the dirt collection chamber 1042. In the illustrated example, the first and second dirt collection chamber doors 1400 are also first and second air treatment chamber doors 1408 (i.e., common, continuous doors). Accordingly, the first dirt collection chamber door 1400a also forms a first portion of a lower portion of the sidewall 1084 of the air treatment chamber 1044 and the second dirt collection chamber door 1400b also forms a second portion of the lower portion of the sidewall 1084 of the air treatment chamber 1044.

As shown, the first and second dirt collection chamber opening axes 1402 (which are also first and second air treatment chamber opening axes 1410) are parallel and laterally spaced apart on opposed sides of the dirt collection chamber 1042 and of the air treatment chamber 1044. The first and second dirt collection chamber doors 1400 are rotatable about the first and second dirt collection chamber opening axes 1402 in opposed lateral directions from the closed position (see e.g., FIGS. 37A and 37B) to the open position (see e.g., FIGS. 37C to 37E). As shown, the first and second dirt collection chamber opening axes 1402 are provided at the same elevation such that, when the air treatment chamber axis 1050 extends horizontally and the dirty air inlet 1002 is at the upper end 1018 of the hand vacuum cleaner 1000, the first and second dirt collection chamber opening axes 1402 extend in a common dirt collection chamber emptying plane 1404 (which is also an air treatment chamber emptying plane 1412). Accordingly, when the first and second dirt collection chamber door 1400 are in the open position, a dirt collection chamber emptying port 1406 (and an air treatment chamber emptying port 1414) are provided in the dirt collection chamber emptying plane 1404.

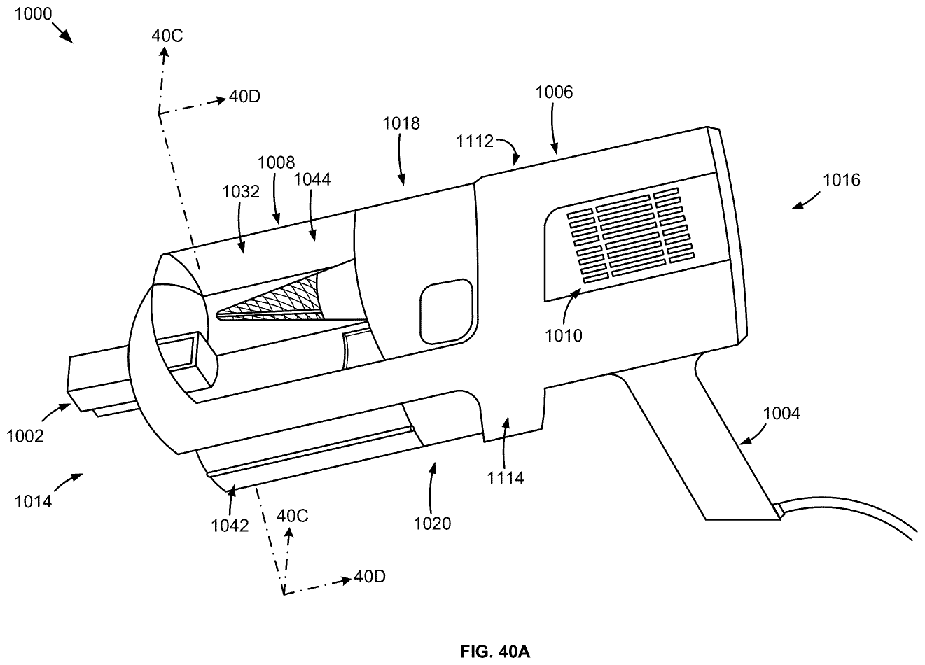

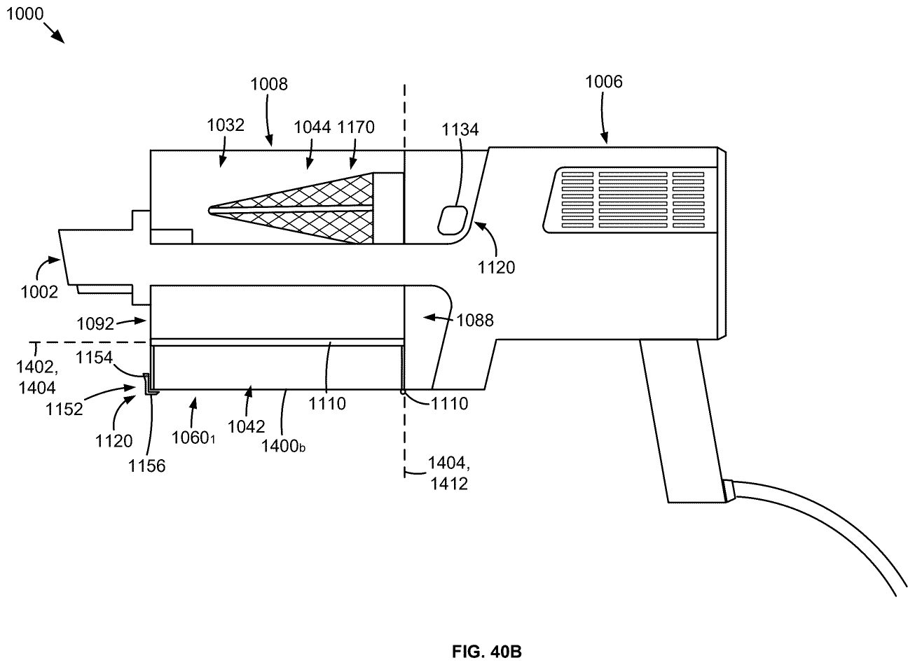

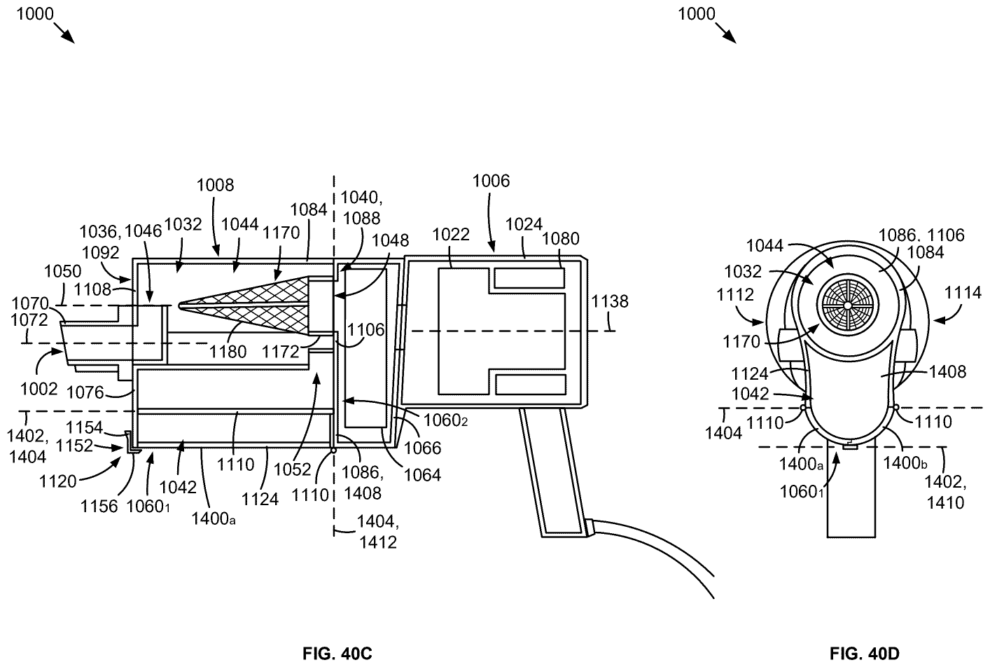

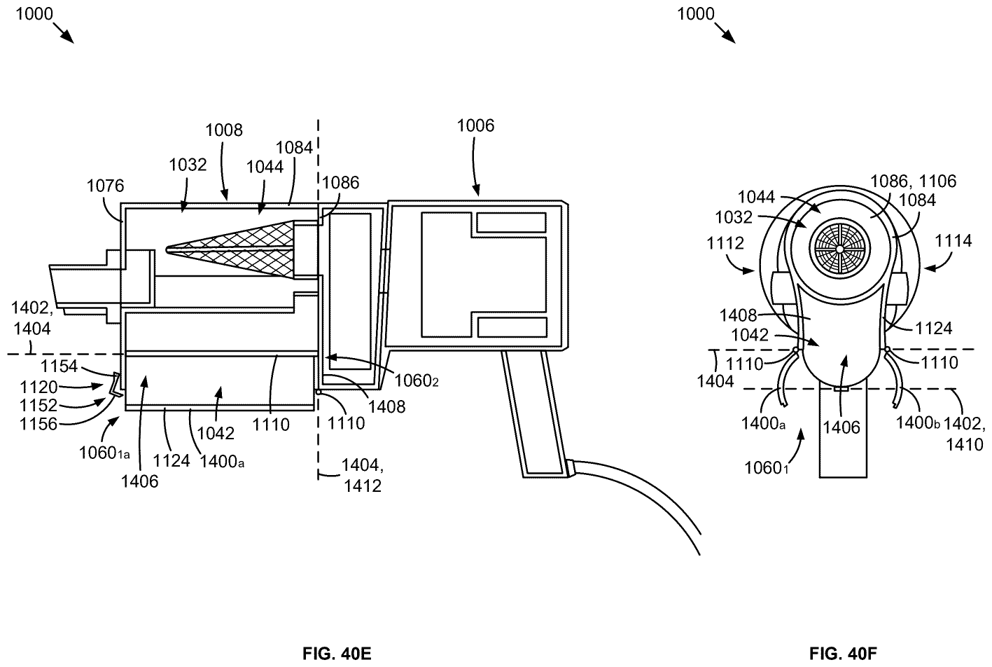

In the examples illustrated in FIGS. 40A to 40G and FIGS. 42A to 42G, the air treatment member 1008 has a first openable portion 1060₁ including first and second dirt collection chamber doors 1400. The first dirt collection chamber door 1400a forms a first portion of the lower portion of the sidewall 1124 of the dirt collection chamber 1042 and the second dirt collection chamber door 1400b forms a second portion of the lower portion of the sidewall 1124 of the dirt collection chamber 1042. As shown, the first and second dirt collection chamber opening axes 1402 are parallel and laterally spaced apart on opposed sides of the dirt collection chamber 1042. The first and second dirt collection chamber doors 1400 are rotatable about the first and second dirt collection chamber opening axes 1402 in opposed lateral directions from the closed position (see e.g., FIGS. 40A to 40D; FIGS. 42A to 42C) to the open position (see e.g., FIGS. 40E to 40F; FIGS. 42D to 42G). As shown, the first and second dirt collection chamber opening axes 1402 are provided at the same elevation such that, when the air treatment chamber axis 1050 extends horizontally and the dirty air inlet 1002 is at the upper end 1018 of the hand vacuum cleaner 1000, the first and second dirt collection chamber opening axes 1402 extend in a common dirt collection chamber emptying plane 1404. Accordingly, when the first and second dirt collection chamber door 1400 are in the open position, a dirt collection chamber emptying port 1406 is provided in the dirt collection chamber emptying plane 1404.

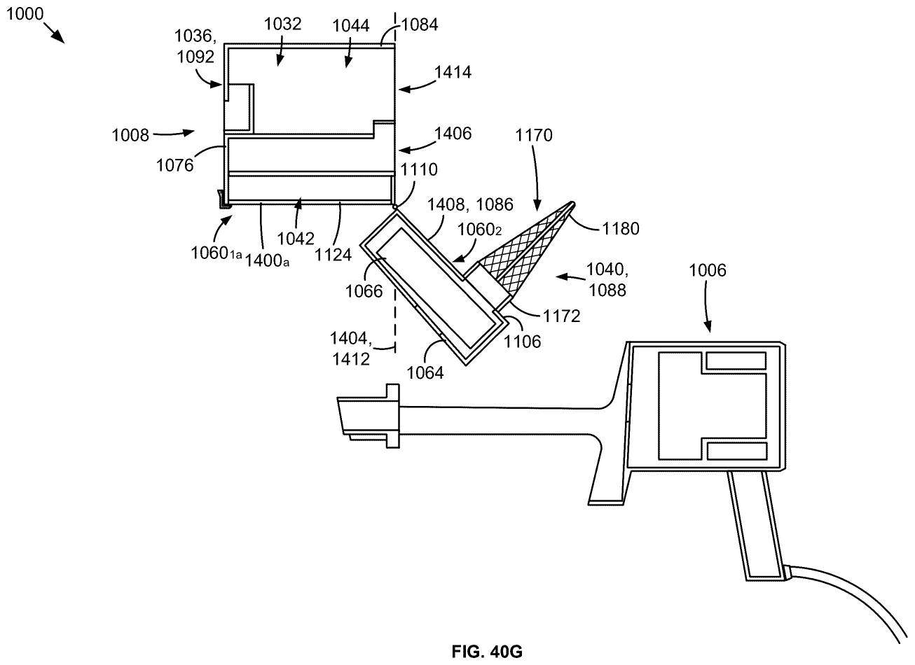

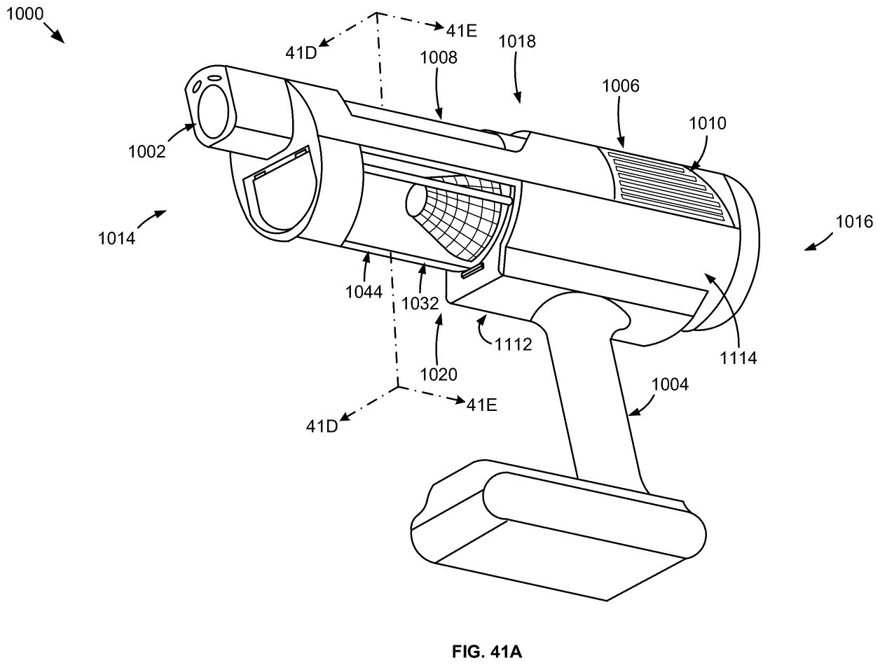

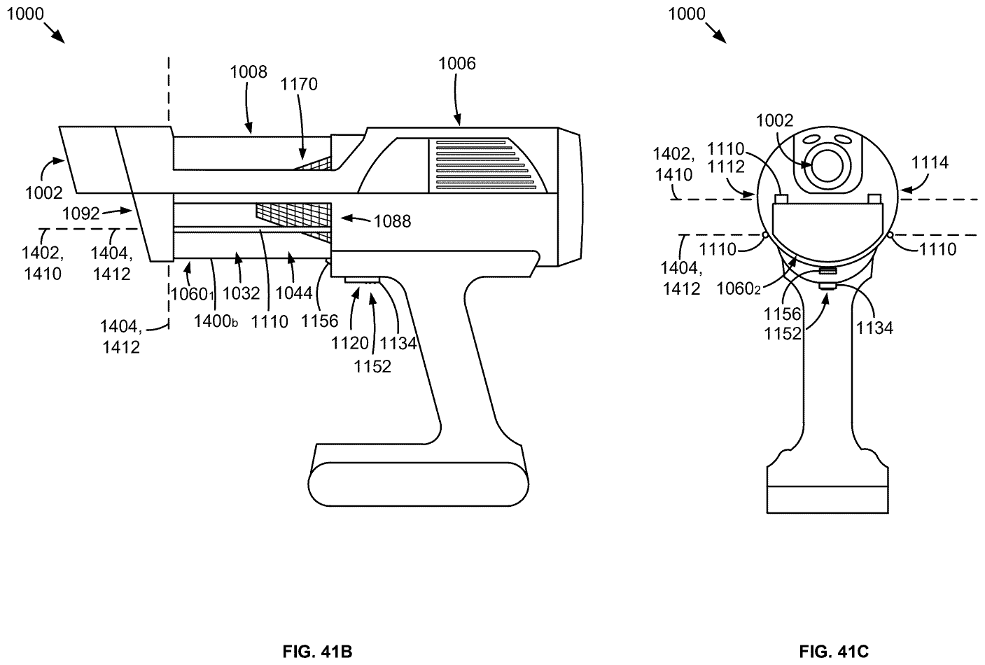

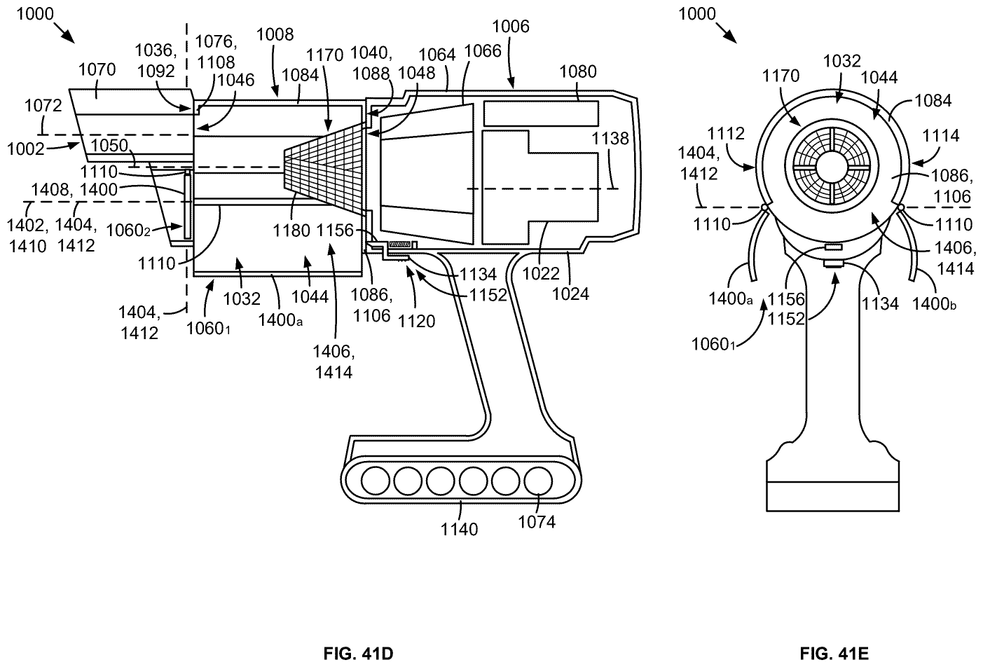

In the example illustrated in FIGS. 41A to 41F, the air treatment member 1008 has a first openable portion 1060₁ including first and second dirt collection chamber doors 1400. In the illustrated example, the dirt collection chamber 1032 and the air treatment chamber 1044 are a single contiguous volume whereby the dirt collection chamber 1032 is a region within the air treatment chamber. Accordingly, the first dirt collection chamber door 1400a (which may alternatively be referred to as a first air treatment chamber door 1408a) forms a first portion of the lower portion of the sidewall 1124 of the dirt collection chamber 1032 and of the sidewall 1084 of the air treatment chamber 1044. Similarly, the second dirt collection chamber door 1400b (which may alternatively be referred to as a second air treatment chamber door 1408b) forms a second portion of the lower portion of the sidewall 1124 of the dirt collection chamber 1032 and of the sidewall 1084 of the air treatment chamber 1044.

As shown, the first and second dirt collection chamber opening axes 1402 (which may alternatively be referred to as first and second air treatment chamber opening axis 1410) are parallel and laterally spaced apart on opposed sides of the dirt collection chamber 1032 and the air treatment chamber 1044. The first and second dirt collection chamber doors 1400 are rotatable about the first and second dirt collection chamber opening axes 1402 in opposed lateral directions from the closed position (see e.g., FIGS. 41A to 41C) to the open position (see e.g., FIGS. 41D to 41E). As shown, the first and second dirt collection chamber opening axes 1402 are provided at the same elevation such that, when the air treatment chamber axis 1050 extends horizontally and the dirty air inlet 1002 is at the upper end 1018 of the hand vacuum cleaner 1000, the first and second dirt collection chamber opening axes 1402 extend in a common dirt collection chamber emptying plane 1404 (which may alternatively be referred to as an air treatment chamber emptying plane 1412). Accordingly, when the first and second dirt collection chamber door 1400 are in the open position, a dirt collection chamber emptying port 1406 (which may alternatively be referred to as an air treatment chamber emptying port 1414) is provided in the dirt collection chamber emptying plane 1404.

While the air treatment chamber 1044 in the examples illustrated in FIGS. 40 through 42 is show as a horizontal cyclone with the air treatment chamber axis 1050 extending in the forward/rearward direction, it will be appreciated that laterally openable dirt collection chamber doors 1400 may be used in combination with a cyclone or other air treatment chamber or dirt collection chamber of any other orientation. For example, in the example illustrated in FIGS. 43A to 43G, the air treatment chamber 1044 is a transverse cyclone with the air treatment chamber axis 1050 extending in the lateral direction.

As shown in FIGS. 43A to 43G, the air treatment member 1008 has a first openable portion 1060₁ including first and second dirt collection chamber doors 1400. The first dirt collection chamber door 1400a forms a first portion of the lower portion of the sidewall 1124 of the dirt collection chamber 1042 and the second dirt collection chamber door 1400b forms a second portion of the lower portion of the sidewall 1124 of the dirt collection chamber 1042. As shown, the first and second dirt collection chamber opening axes 1402 are parallel and extend in the forward/rearward direction transverse to the air treatment chamber axis 1050. The first and second dirt collection chamber opening axes 1402 are laterally spaced apart on opposed sides of the dirt collection chamber 1042. The first and second dirt collection chamber doors 1400 are rotatable about the first and second dirt collection chamber opening axes 1402 in opposed lateral directions from the closed position (see e.g., FIGS. 43A to 43C) to the open position (see e.g., FIGS. 43D to 43G). As shown, the first and second dirt collection chamber opening axes 1402 are provided at the same elevation such that, when the air treatment chamber axis 1050 extends horizontally and the dirty air inlet 1002 is at the upper end 1018 of the hand vacuum cleaner 1000, the first and second dirt collection chamber opening axes 1402 extend in a common dirt collection chamber emptying plane 1404. Accordingly, when the first and second dirt collection chamber door 1400 are in the open position, a dirt collection chamber emptying port 1406 is provided in the dirt collection chamber emptying plane 1404. Alternately, it will be appreciated that the first and second dirt collection chamber opening axes 1402 may extend in a common direction with the cyclone axis of rotation 1050.

Accordingly, one or more doors may concurrently open an air treatment chamber and an external dirt collection chamber (see, e.g., FIGS. 37A-37E), an external dirt collection chamber (see, e.g., FIGS. 40A-40F and FIGS. 43A-43E) or an air treatment chamber wherein the dirt collection region is within the air treatment chamber (see, e.g., FIGS. 41A-41E). Whether or not the first openable portion 1060₁ opens only an external dirt collection chamber of both an external dirt collection chamber and the air treatment chamber, the air treatment chamber may be opened by a separate openable member.

Accordingly, as exemplified in FIGS. 43A to 43G the air treatment member 1008 may have a second openable portion 1060₂. The second openable portion 1060₂ may be operable to open at least the air treatment chamber 1044. Accordingly, the second openable portion 1060₂ may be referred to as an air treatment chamber door 1408. The air treatment chamber door 1408 may be any door known in the art. The air treatment chamber door 1408 may be rotatably mounted by a hinge 1110 about an air treatment chamber opening axis 1410 which may extend in any direction. The air treatment chamber opening axis 1410 may extend in the same direction as dirt collection chamber opening axis 1402 or in a different direction than the dirt collection chamber opening axis 1402 (e.g., different than the forward/rearward direction). In this way, when the air treatment chamber door 1408 is moved between a closed position and an open position, the air treatment chamber door 1408 may move in a different direction than the lateral direction. For example, the air treatment chamber door 1408 may move between the open and closed position in the forward/rearward direction transverse to the lateral direction.

When the air treatment chamber axis 1050 extends horizontally and the dirty air inlet 1002 is at the upper end 1018 of the hand vacuum cleaner 1000, the air treatment chamber opening axis 1410 may extend in a plane, referred to as an air treatment chamber emptying plane 1412. The air treatment chamber emptying plane 1412 may be vertically oriented (i.e., transverse to the dirt collection chamber emptying plane 1404). The air treatment chamber emptying plane 1412 may be vertically oriented where the air treatment chamber door 1408 forms a portion of the front end wall 1108 at the front end 1036 of the air treatment chamber 1044 (see e.g., FIGS. 37A-37F) or a portion of the rear end wall 1106 at the rear end 1040 of the air treatment chamber 1044 (see e.g., FIGS. 40A-40G). Such an air treatment chamber door 1408 may be moved forwardly (i.e., if the air treatment chamber opening axis 1410 is located at the front end 1036) or rearwardly (i.e., if the air treatment chamber opening axis 1410 is located at the rear end 1040) and upwardly or downwardly from the closed position to the open position. Alternatively, the air treatment chamber emptying plane 1412 may be horizontally oriented (i.e., parallel to the dirt collection chamber emptying plane 1404). The air treatment chamber emptying plane 1412 may be horizontally oriented where the air treatment chamber door 1408 forms a lower portion of the sidewall 1084 of the air treatment chamber 1044. Such an air treatment chamber door 1408 may be moved downwardly and forwardly (i.e., if the air treatment chamber opening axis 1410 is located at the front end 1036) or rearwardly (i.e., if the air treatment chamber opening axis 1410 is located at the rear end 1040) from the closed position to the open position.

When the air treatment chamber door 1408 is in the open position, an air treatment chamber emptying port 1414 may be provided in the air treatment chamber emptying plane 1412. The air treatment chamber emptying port 1414 may have a perimeter having first and second laterally opposed sides. Where the air treatment chamber emptying plane 1412 is vertically oriented, the first and second laterally opposed sides may extend in the vertical direction transverse to the air treatment chamber opening axis 1410 (see e.g., FIGS. 37F and 40G). Where the air treatment chamber emptying plane 1412 is horizontally oriented, the first and second laterally opposed sides may extend in the forward/rearward direction transverse to the air treatment chamber opening axis 1410. It will be appreciated that the second openable portion 1060₂ may open both the air treatment chamber and an external dirt collection chamber.

In some embodiments, when the air treatment chamber axis 1050 extends horizontally and the dirty air inlet 1002 is at the upper end 1018 of the hand vacuum cleaner 1000, at least a portion of the dirt collection chamber 1042 may underlie the air treatment chamber 1044. Similarly, at least a portion of the first openable portion 1060₁, which may include at least one laterally openable dirt collection chamber door 1400 (e.g., 1 or 2 or more), may underlie the air treatment chamber 1044. In some such embodiments, the air treatment member 1008 may have a second openable portion 1060₂ that is an air treatment chamber door 1408 forming a lower portion of the sidewall 1084 of the air treatment chamber 1044. In such embodiments, at least a portion of the dirt collection chamber 1042 and at least a portion of the first openable portion 1060₁, which may include at least one laterally openable dirt collection chamber door 1400, may underlie the air treatment chamber door 1408. In such embodiments, when the air treatment chamber door 1408 is moved from the closed position to the open position, the air treatment chamber door 1408 may descend through the underlying portion of the dirt collection chamber 1042. When the at least one laterally openable dirt collection chamber door 1400 is in the open position, the air treatment chamber door 1408 may further descend through the underlying portion of the dirt collection chamber emptying port 1406. Accordingly, in such embodiments, the dirt collection chamber emptying port 1406 may have a larger cross-sectional area than a cross-sectional area of the air treatment chamber emptying port 1414 to facilitate movement of the air treatment chamber door 1408 through the dirt collection chamber emptying port 1406.

An advantage of this design is that, as the air treatment chamber door 1408 descends though the dirt collection chamber 1042, the air treatment chamber door 1408 may push dirt and debris from the dirt collection chamber 1042. This may improve emptying of the dirt collection chamber 1042. Optionally, the dirt collection chamber 1042 may be sized such that the air treatment chamber door 1408 passes in close proximity to or travel along part or all of one or more walls of the dirt collection chamber 1042 such that the edges of the air treatment chamber door 1408 may scrape caked on dirt and debris off of the one or more walls. This may further improve emptying of the dirt collection chamber 1042.

For example, in the example illustrated in FIGS. 37A to 37F, the air treatment member 1008 has a second openable portion 1060₂, which includes the front end wall 1076 of the air treatment member 1008 and an air treatment chamber door 1408. The air treatment chamber door 1408 is rearwardly spaced from the front end wall 1076. The air treatment chamber door 1408 forms the front end wall 1108 of the air treatment chamber 1044. A portion of the dirt collection chamber 1042 is positioned between the air treatment chamber door 1408 and the front end wall 1076. In the illustrated example, the front end wall 1076 of the air treatment member 1008 is rotatably mounted by a hinge 1110. The air treatment chamber door 1408 is connected to the front end wall 1076 such that the front end wall 1076 and the air treatment chamber door 1408 move concurrently. In this way, the second openable portion 1060₂ is operable to concurrently open the dirt collection chamber 1042 and the air treatment chamber 1044.

As shown, the air treatment chamber opening axis 1410, about which the front end wall 1076 and the air treatment chamber door 1408 together rotate, extends in the lateral direction transverse to the dirt collection chamber opening axis 1402. In this way, when the air treatment chamber door 1408 is moved between the closed position and the open position, the air treatment chamber door 1408 moves in the forward/rearward direction. For example, the air treatment chamber door 1408 moves forwardly and downwardly from the closed position (see e.g., FIGS. 37A to 37D) to the open position (see e.g., FIG. 37F).

Alternately, as discussed subsequently, the air treatment chamber door 1408 may be one or more laterally openable doors as discussed herein with respect to a laterally openable dirt collection chamber door 1400. In the example illustrated in FIGS. 40A to 40G, the air treatment member 1008 has a second openable portion 1060₂, which includes the rear end wall 1086 of the air treatment member 1008. The rear end wall 1086 is the rear end wall 1106 of the air treatment chamber 1044 and a rear end wall of the dirt collection chamber 1042, which underlies the air treatment chamber 1044. The rear end wall 1086 is thus an air treatment chamber door 1408, which is rotatably mounted by a hinge 1110. In this way, moving the air treatment chamber door 1408 to the open position concurrently opens the air treatment chamber 1044 and the dirt collection chamber 1042.

As shown, the air treatment chamber opening axis 1410, about which the air treatment chamber door 1408 rotates, extends in the lateral direction transverse to the dirt collection chamber opening axis 1402. In this way, when the air treatment chamber door 1408 is moved between the closed position and the open position, the air treatment chamber door 1408 moves in the forward/rearward direction. For example, the air treatment chamber door 1408 moves rearwardly and downwardly from the closed position (see e.g., FIGS. 40A to 40F) to the open position (see e.g., FIG. 40G). As shown, the air treatment member 1008 is removed from the main body 1006 before the air treatment chamber door 1408 may be moved to the open position (see e.g., FIG. 40G).

In the example illustrated in FIGS. 41A to 41F, the air treatment member 1008 has a second openable portion 1060₂, which includes the front end wall 1076 of the air treatment member 1008. The air treatment chamber 1044 and the dirt collection chamber 1032 form a single contiguous volume such that the front end wall 1076 is the front end wall 1108 of the air treatment chamber 1044 and a front end wall of the dirt collection chamber 1032. The front end wall 1076 is thus an air treatment chamber door 1408, which is rotatably mounted by a hinge 1110. In this way, moving the air treatment chamber door 1408 to the open position concurrently opens the air treatment chamber 1044 and the dirt collection chamber 1032.

As shown, the air treatment chamber opening axis 1410, about which the air treatment chamber door 1408 rotates, extends in the lateral direction transverse to the dirt collection chamber opening axis 1402. In this way, when the air treatment chamber door 1408 is moved between the closed position and the open position, the air treatment chamber door 1408 moves in the forward/rearward direction. For example, the air treatment chamber door 1408 moves forwardly and upwardly from the closed position (see e.g., FIGS. 41A to 41D) to the open position (see e.g., FIG. 41F).

In the examples illustrated in FIGS. 37A to 37F, 40A to 40G, and 41A to 41F, since the air treatment chamber door 1408 forms either the front end wall 1108 or rear end wall 1106 of the air treatment chamber 1044, when the air treatment chamber axis 1050 extends horizontally and the dirty air inlet 1002 is at the upper end 1018 of the hand vacuum cleaner 1000, the air treatment chamber opening axis 1410 extends in a vertically oriented air treatment chamber emptying plane 1412 (i.e., transverse to the dirt collection chamber emptying plane 1404). When the air treatment chamber door 1408 is in the open position, an air treatment chamber emptying port 1414 is provided in the air treatment chamber emptying plane 1412. The air treatment chamber emptying port 1414 has a perimeter having first and second laterally opposed sides. Depending on the shape of the air treatment chamber 1044, the first and second laterally opposed sides may extend in linearly in the vertical direction transverse to the air treatment chamber opening axis 1410 or, as shown, may be curved sides that lie in the vertically oriented air treatment chamber emptying plane 1412.

In the example illustrated in FIGS. 42A to 42G, the air treatment member 1008 has a second openable portion 1060₂, which includes an air treatment chamber door 1408 that forms a lower portion of the sidewall 1084 of the air treatment chamber 1044. The air treatment chamber door 1408 is rotatably mounted by a hinge 1110 about an air treatment chamber opening axis 1410 extending in the lateral direction.

When the air treatment chamber axis 1050 extends horizontally and the dirty air inlet 1002 is at the upper end 1018 of the hand vacuum cleaner 1000, the dirt collection chamber 1042 underlies the air treatment chamber 1044 and the air treatment chamber door 1408. Similarly, the first openable portion 1060₁, which includes first and second laterally openable dirt collection chamber doors 1400, underlies the air treatment chamber 1044 and the air treatment chamber door 1408. In this way, when the air treatment chamber door 1408 is moved from the closed position (see e.g., FIGS. 42A to 42E) to the open position (see e.g., FIGS. 42F to 42G), the air treatment chamber 1044 is opened and the air treatment chamber door 1408 descends through the dirt collection chamber 1042. When the laterally openable dirt collection chamber doors 1400 are in the open position, the air treatment chamber door 1408 further descends through the underlying portion of the dirt collection chamber emptying port 1406. Accordingly, as shown, the dirt collection chamber emptying port 1406 has a larger cross-sectional area than a cross-sectional area of the air treatment chamber emptying port 1414 to facilitate movement of the air treatment chamber door 1408 through the dirt collection chamber emptying port 1406.

Since the air treatment chamber door 1408 forms a lower portion of the sidewall 1084 of the air treatment chamber 1044, when the air treatment chamber axis 1050 extends horizontally and the dirty air inlet 1002 is at the upper end 1018 of the hand vacuum cleaner 1000, the air treatment chamber opening axis 1410 extends in a horizontally oriented air treatment chamber emptying plane 1412 (i.e., parallel to the dirt collection chamber emptying plane 1404). When the air treatment chamber door 1408 is in the open position, an air treatment chamber emptying port 1414 is provided in the air treatment chamber emptying plane 1412. The air treatment chamber emptying port 1414 has a perimeter having first and second laterally opposed sides, which extend in the horizontal direction transverse to the air treatment chamber opening axis 1410. It will be appreciated that, in this embodiment, the second openable portion 1060₂ could alternately have been one or two doors that rotate open in the same direction as the first openable portion 1060a, and the axis of rotation could have been parallel to the dirt collection chamber opening axis 1402.

In the example illustrated in FIGS. 43A to 43G, the air treatment member 1008 has a second openable portion 1060₂, which includes an air treatment chamber door 1408 that forms a lower portion of the sidewall 1084 of the air treatment chamber 1044. The air treatment chamber door 1408 is rotatably mounted by a hinge 1110 about an air treatment chamber opening axis 1410 extending in the lateral direction.

When the air treatment chamber axis 1050 extends horizontally and the dirty air inlet 1002 is at the upper end 1018 of the hand vacuum cleaner 1000, a portion of the dirt collection chamber 1042 underlies the air treatment chamber 1044 and the air treatment chamber door 1408. Similarly, a portion of the first openable portion 1060₁, which includes first and second laterally openable dirt collection chamber doors 1400, underlies the air treatment chamber 1044 and the air treatment chamber door 1408. In this way, when the air treatment chamber door 1408 is moved from the closed position (see e.g., FIGS. 43A to 43E) to the open position (see e.g., FIGS. 43F to 43G), the air treatment chamber 1044 is opened and the air treatment chamber door 1408 descends through the dirt collection chamber 1042. When the laterally openable dirt collection chamber doors 1400 are in the open position, the air treatment chamber door 1408 further descends through the dirt collection chamber emptying port 1406. Accordingly, as shown, the dirt collection chamber emptying port 1406 has a larger cross-sectional area than a cross-sectional area of the air treatment chamber emptying port 1414 to facilitate movement of the air treatment chamber door 1408 through the dirt collection chamber emptying port 1406.

In the illustrated example, the air treatment chamber door 1408 forms a front half of the lower portion of the sidewall 1084 of the air treatment chamber 1044. Therefore, when the air treatment chamber axis 1050 extends horizontally and the dirty air inlet 1002 is at the upper end 1018 of the hand vacuum cleaner 1000, the air treatment chamber opening axis 1410 does not extend in a horizontally or vertically oriented air treatment chamber emptying plane 1412. Instead, the air treatment chamber emptying plane 1412 is at an oblique angle to the horizontally oriented dirt collection chamber emptying plane 1404. Nonetheless, when the air treatment chamber door 1408 is in the open position, an air treatment chamber emptying port 1414 is provided in the air treatment chamber emptying plane 1412. It will thus be appreciated that any angle of air treatment chamber emptying plane 1412 may be achieved which may depend, for example, on the location of the air treatment chamber door 1408. It will be appreciated that, alternately, two doors may be provided to open the air treatment chamber in which case the door may rotate open in both directions to provide an opening of the air treatment chamber that is aligned with the opening of the dirt collection chamber.

In the illustrated examples described in this section, the air treatment chambers 1044 are cyclone chambers, and the air treatment chamber axes 1050 are cyclone axes of rotation. It will be appreciated, however, that any other type of air treatment chamber may be used with the openable portion(s) described herein.

It will also be appreciated that the doors may extend the entire length of the sidewall of only a portion thereof.

It will be appreciated that the laterally openable door(s) may open any percentage of the angular distance around the perimeter of the sidewall of the dirt collection chamber. Accordingly, the laterally openable door(s) may extend around 90°, 120°, 180° or more of the angular distance around the perimeter.

It will be appreciated that the dirt collection chamber door(s) 1400 and the air treatment chamber door(s) 1408 may open concurrently or sequentially.

### At Least One Laterally Openable Air Treatment Chamber Door

In accordance with this aspect of this disclosure, which may be used by itself or in combination with one or more other aspects of this disclosure, the hand vacuum cleaner may have at least one laterally openable air treatment chamber door.

The air treatment member 1008 may have a first openable portion 1060₁ and a second openable portion 1060₂. The second openable portion 1060₂ may be operable to open the air treatment chamber 1044. Accordingly, the second openable portion 1060₂ may be referred to as an air treatment chamber door 1408. The air treatment chamber door 1408 may be rotatably mounted by a hinge 1110 about an air treatment chamber opening axis 1410 in any manner discussed herein with respect to a dirt collection chamber door 1400. Accordingly, the air treatment chamber opening axis 1410 may be parallel to the air treatment chamber axis 1050. In this way, when the air treatment chamber door 1408 is moved between the closed position and the open position, the air treatment chamber door 1408 may move in a lateral direction. When the air treatment chamber axis 1050 extends horizontally and the dirty air inlet 1002 is at the upper end 1018 of the hand vacuum cleaner 1000, the lateral direction may be understood as the direction defined by a horizontal axis that is transverse to the air treatment chamber axis 1050.

Optionally, as discussed herein with respect to a dirt collection chamber door 1400, the second openable portion 1060₂ may include a first air treatment chamber door 1408a and a second air treatment chamber door 1408b. The first air treatment chamber door 1408a may be rotatably mounted about a first air treatment chamber opening axis 1410a. The first air treatment chamber door 1408a may move in a first lateral direction from the closed position to the open position. The second air treatment chamber door 1408b may be rotatably mounted about a second air treatment chamber opening axis 1410b that is parallel to the first air treatment chamber opening axis 1410a. The second air treatment chamber door 1408b may move in a second lateral direction from the closed position to the open position.

The second lateral direction may be opposite the first lateral direction. In this way, when the first and second air treatment chamber doors 1408 are moved from their respective closed positions to their respective open positions, the first and second air treatment chamber doors 1408 may move laterally away from each other. Conversely, when the first and second air treatment chamber doors 1408 are moved from their respective open positions to their respective closed positions, the first and second air treatment chamber doors 1408 may move laterally toward each other. Each door may have a first end that is rotatably mounted and an opposed moveable end. In the closed position, the opposed moveable ends may meet (e.g., abut) to provide a continuous outer wall of the air treatment chamber 1044. One or both of the opposed moveable ends may be provided with a deformable material (e.g., gasket) or the like such that, when the doors are closed, a seal is provided.

The air treatment chamber door 1408 may, in the closed position, form a lower portion of the sidewall 1084 of the air treatment chamber 1044. Similarly, the first air treatment chamber door 1408a may form a first portion of the lower portion of the sidewall 1084 of the air treatment chamber 1044 and the second air treatment chamber door 1408b may form a second portion of the lower portion of the sidewall 1084 of the air treatment chamber 1044. In such embodiments, the first and second air treatment chamber opening axes 1410 may be laterally spaced apart on opposed sides of the air treatment chamber 1044. The first and second portions of the lower portion of the sidewall 1084 may form equal proportions (e.g., 50/50) of the lower portion of the sidewall 1084 or unequal proportions (e.g., 60/40, 70/30, or any other suitable proportions) of the lower portion of the sidewall 1084.

When the air treatment chamber axis 1050 extends horizontally and the dirty air inlet 1002 is at the upper end 1018 of the hand vacuum cleaner 1000, the air treatment chamber opening axis 1410 may extend in a horizontal plane, referred to as an air treatment chamber emptying plane 1412. Where the air treatment member 1008 has first and second laterally openable air treatment chamber doors 1408, the laterally spaced apart first and second air treatment chamber opening axes 1410 may be provided at the same elevation. In this way, when the air treatment chamber axis 1050 extends horizontally and the dirty air inlet 1002 is at the upper end 1018 of the hand vacuum cleaner 1000, the first and second air treatment chamber opening axes 1410 may both extend in the air treatment chamber emptying plane 1412.

When the air treatment chamber door(s) 1408 are in the open position, an air treatment chamber emptying port 1414 may be provided in the air treatment chamber emptying plane 1412. The air treatment chamber emptying port 1414 may have a perimeter having first and second laterally opposed sides that extend in the forward/rearward direction. The first and second laterally opposed sides may be respectively adjacent to, and parallel with, the first and second air treatment chamber opening axes 1410. Accordingly, when the air treatment chamber door(s) 1408 are in the open position, dirt and debris collected within the air treatment chamber 1044 may fall due to gravity (and, optionally, be drawn) through the air treatment chamber emptying port 1414 into a refuse container or docking station below.

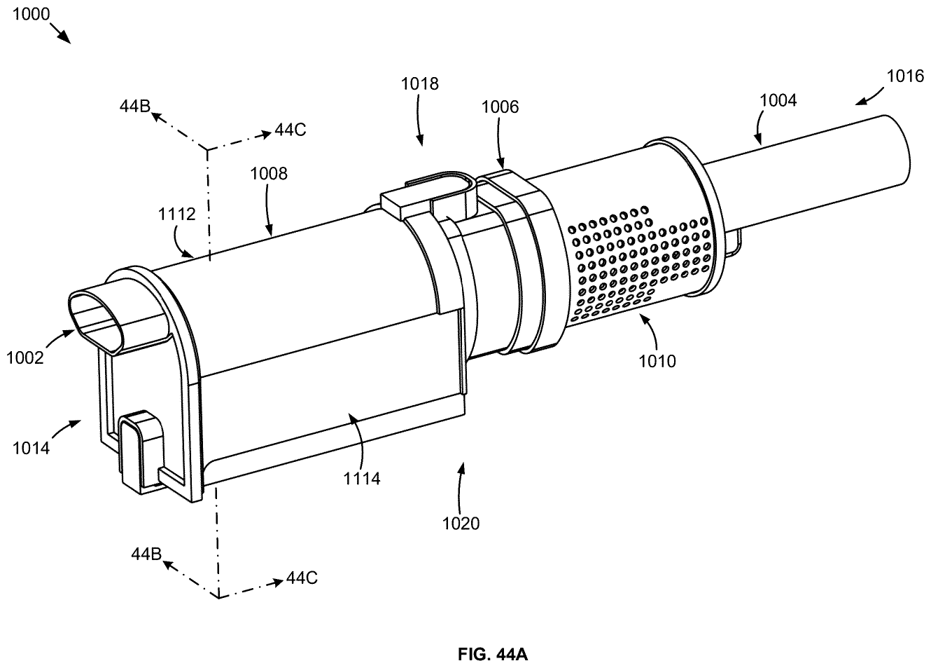

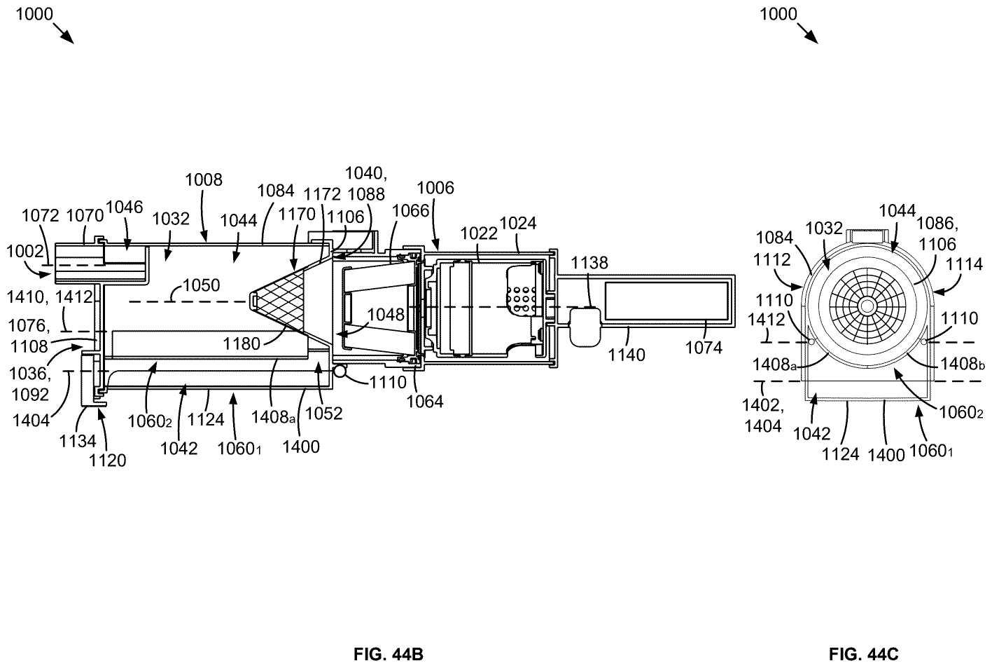

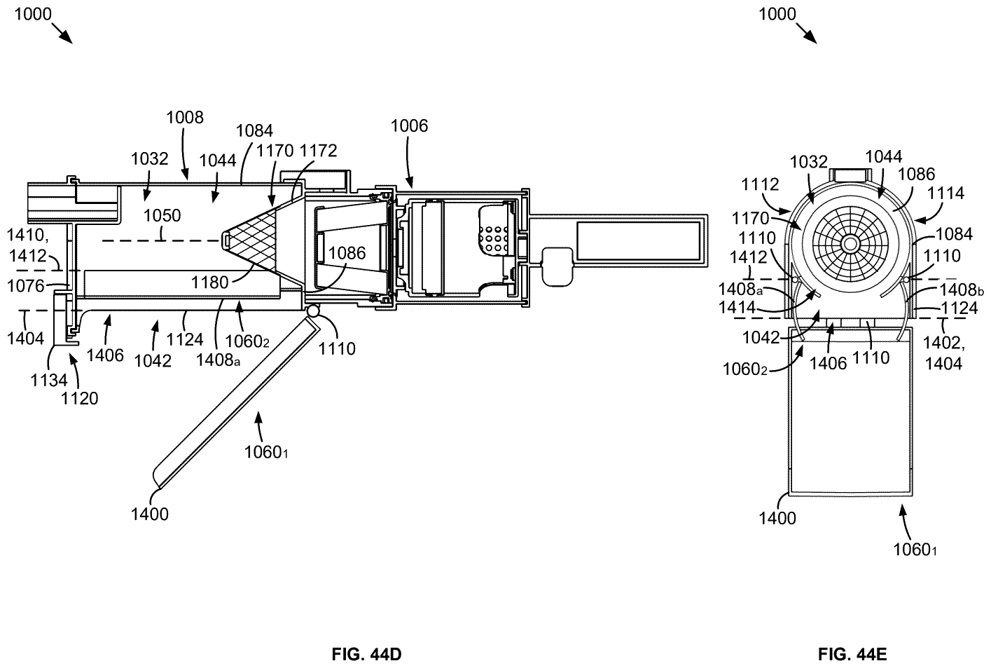

For example, in the example illustrated in FIGS. 44A to 44E, the air treatment member 1008 has a first openable portion 1060₁ and a second openable portion 1060₂. The second openable portion 1060₂ includes a first air treatment chamber door 1408a and a second air treatment chamber door 1408b that are operable to open the air treatment chamber 1044. The air treatment chamber doors 1408 are each rotatably mounted by a hinge 1110 about an air treatment chamber opening axis 1410. The air treatment chamber opening axes 1410 are parallel to the air treatment chamber axis 1050. The air treatment chamber opening axes 1410 are laterally spaced apart on opposed sides of the air treatment chamber 1044. In the closed position, the first air treatment chamber door 1408a forms a first portion (e.g., half) of a lower portion of the sidewall 1084 of the air treatment chamber 1044 and the second air treatment chamber door 1408b forms a second portion (e.g., half) of the lower portion of the sidewall 1084 of the air treatment chamber 1044. In this way, when the first and second air treatment chamber doors 1408 are moved from their respective closed positions (see e.g., FIGS. 44B to 44D) to their respective open positions (see e.g., FIG. 44E), the air treatment chamber doors 1408 move laterally away from each other. Conversely, when the first and second air treatment chamber doors 1408 are moved from their respective open positions to their respective closed positions, the air treatment chamber doors 1408 move laterally toward each other.

As shown, when the air treatment chamber axis 1050 extends horizontally and the dirty air inlet 1002 is at the upper end 1018 of the hand vacuum cleaner 1000, the air treatment chamber opening axes 1410 are provided at the same elevation such that they extend in a common horizontal air treatment chamber emptying plane 1412. When the air treatment chamber doors 1408 are in the open position, an air treatment chamber emptying port 1414 is provided in the air treatment chamber emptying plane 1412. The air treatment chamber emptying port 1414 has a perimeter having first and second laterally opposed sides that are respectively adjacent to, and parallel with, the first and second air treatment chamber opening axes 1410.

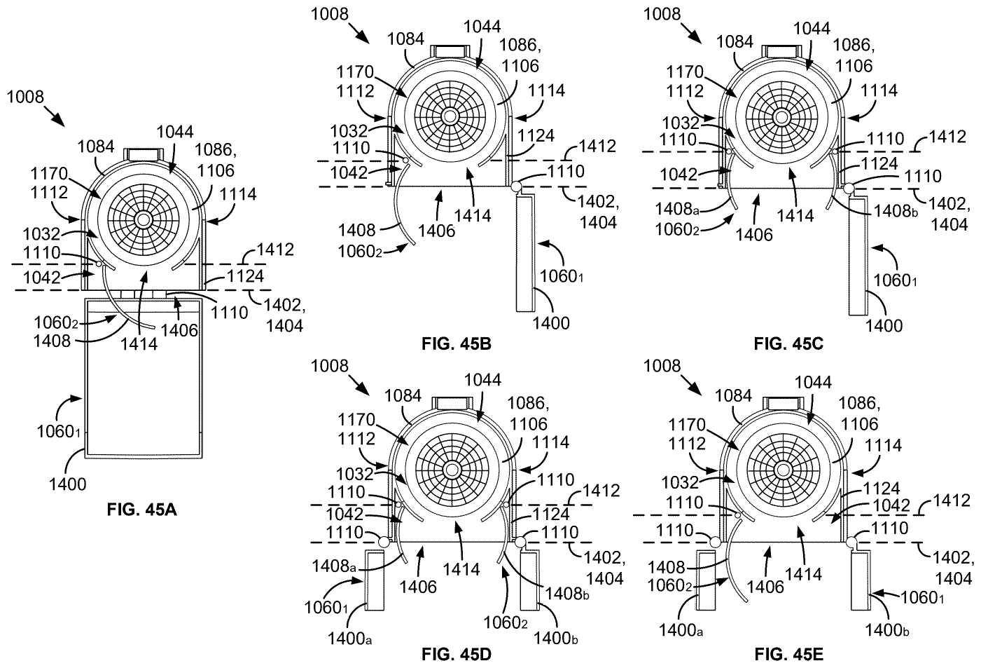

FIGS. 45A to 45E show alternate configurations of the air treatment member 1008. The air treatment chamber doors 1408 in the examples illustrated in FIGS. 45C and 45D are configured similar to as described with respect to FIGS. 44A to 44E.

In the examples illustrated FIGS. 45A, 45B, and 45E, a single laterally openable air treatment chamber door 1408 is provided. In the illustrated examples, the air treatment chamber door 1408 is rotatably mounted by a hinge 1110 about an air treatment chamber opening axis 1410. The air treatment chamber opening axis 1410 is parallel to the air treatment chamber axis 1050. In the closed position, the air treatment chamber door 1408 forms the lower portion of the sidewall 1084 of the air treatment chamber 1044. In this way, when the air treatment chamber door 1408 is moved from the closed positions to the open position shown, the air treatment chamber door 1408 moves in the lateral direction.

As shown, when the air treatment chamber axis 1050 extends horizontally and the dirty air inlet 1002 is at the upper end 1018 of the hand vacuum cleaner 1000, the air treatment chamber opening axis 1410 extends in a horizontal air treatment chamber emptying plane 1412. When the air treatment chamber doors 1408 are in the open position, an air treatment chamber emptying port 1414 is provided in the air treatment chamber emptying plane 1412. The air treatment chamber emptying port 1414 has a perimeter having first and second laterally opposed sides one of which is adjacent to, and parallel with, the air treatment chamber opening axis 1410.

The first openable portion 1060₁ may be any openable door and may be at least one laterally openable dirt collection chamber door 1400 operable to open the dirt collection chamber 1042. In such embodiments, each openable dirt collection chamber door 1400 may be rotatably mounted by a hinge 1110 about a dirt collection chamber opening axis 1402 that is parallel to the air treatment chamber opening axis 1410 of each air treatment chamber door 1408. Alternatively, the first openable portion 1060₁ may be a dirt collection chamber door 1400 that is rotatably mounted by a hinge 1110 about a dirt collection chamber opening axis 1402 that extends in a different direction than the air treatment chamber opening axis 1410 of each air treatment chamber door 1408 (i.e., different than the forward/rearward direction). In this way, when the dirt collection chamber door 1400 is moved between a closed position and an open position, the dirt collection chamber door 1400 may move in a different direction than the lateral direction. For example, the dirt collection chamber door 1400 may move between the open and closed position in the forward/rearward direction transverse to the lateral direction.

In either embodiment, when the air treatment chamber axis 1050 extends horizontally and the dirty air inlet 1002 is at the upper end 1018 of the hand vacuum cleaner 1000, each dirt collection chamber opening axis 1402 may extend in a plane, referred to as a dirt collection chamber emptying plane 1404. The dirt collection chamber emptying plane 1404 may be horizontally oriented (i.e., parallel to the air treatment chamber emptying plane 1412). For example, the dirt collection chamber emptying plane 1404 may be horizontally oriented where the dirt collection chamber door(s) 1400 form a lower portion of the sidewall 1124 of the dirt collection chamber 1042.

In such embodiments, if the first openable portion 1060₁ is a laterally openable dirt collection chamber door 1400, the dirt collection chamber door 1400 may be moved downwardly and laterally from the closed position to the open position. Similarly, if the first openable portion 1060₁ is a first and second laterally openable dirt collection chamber door 1400, the dirt collection chamber doors 1400 may be moved downwardly and in opposed lateral directions from the closed position to the open position. If the first openable portion 1060₁ is a forwardly/rearwardly openable dirt collection chamber door 1400, the dirt collection chamber door 1400 may be moved downwardly and forwardly (i.e., if the dirt collection chamber opening axis 1402 is located at the front end 1098 of the dirt collection chamber) or rearwardly (i.e., if the dirt collection chamber opening axis 1402 is located at the rear end of the dirt collection chamber) from the closed position to the open position.

Optionally, each dirt collection chamber door 1400 may include at least a portion of a rear end wall and/or front end wall of the dirt collection chamber 1042. The portion of a rear end wall and/or front end wall of the dirt collection chamber 1042 may thus be moveable with the dirt collection chamber door(s) 1400 between the closed position and the open position.

When the dirt collection chamber door(s) 1400 is/are in the open position, dirt collection chamber emptying port 1406 may be provided in the dirt collection chamber emptying plane 1404. The dirt collection chamber emptying port 1406 may have a perimeter having first and second laterally opposed sides. Where the dirt collection chamber emptying port 1406 is horizontally oriented, the first and second laterally opposed sides may extend in the forward/rearward direction. If the first openable portion 1060₁ is at least one laterally openable dirt collection chamber door 1400, at least one of laterally opposed sides of the dirt collection chamber emptying port 1406 may extend adjacent to, and parallel with, a dirt collection chamber opening axis 1402. If the first openable portion 1060₁ is a forwardly/rearwardly openable dirt collection chamber door 1400, the first and second laterally opposed sides may extend in a direction transverse to the dirt collection chamber opening axis 1402.

For example, in the example illustrated in FIGS. 44A to 44E, the first openable portion 1060₁ is a dirt collection chamber door 1400 that is rotatably mounted by a hinge 1110 about a dirt collection chamber opening axis 1402 that extends in a different direction than the air treatment chamber opening axis 1410 of each air treatment chamber door 1408. As shown, the dirt collection chamber opening axis 1402 extends in the lateral direction transverse to the air treatment chamber opening axes 1410. The dirt collection chamber door 1400 forms a lower portion of the sidewall 1124 of the dirt collection chamber 1042. In this way, when the dirt collection chamber door 1400 is moved between a closed position and an open position, the dirt collection chamber door 1400 moves in a different direction than the lateral direction. As shown, the dirt collection chamber door 1400 moves downwardly and rearwardly from the closed position (see e.g., FIGS. 44A to 44C) the open position (see e.g., FIGS. 44D to 44E). The dirt collection chamber door 1400 also includes a portion of the rear end wall of the dirt collection chamber, which moves with the dirt collection chamber door 1400 between the open and closed positions.

As shown, when the air treatment chamber axis 1050 extends horizontally and the dirty air inlet 1002 is at the upper end 1018 of the hand vacuum cleaner 1000, each dirt collection chamber opening axis 1402 extends in a horizontal dirt collection chamber emptying plane 1404. When the dirt collection chamber door 1400 is in the open position, a dirt collection chamber emptying port 1406 is provided in the dirt collection chamber emptying plane 1404. The dirt collection chamber emptying port 1406 has a perimeter having first and second laterally opposed sides. Where the dirt collection chamber emptying port 1406 is horizontally oriented, the first and second laterally opposed sides extend in the forward/rearward direction transverse to the dirt collection chamber opening axis 1402.

FIGS. 45A to 45E show alternate configurations of the air treatment member 1008. The dirt collection chamber door 1400 in the example illustrated in FIG. 45A is configured similar to as described with respect to FIGS. 44A to 44E.

In the examples illustrated FIGS. 45B and 45C, a single laterally openable dirt collection chamber door 1400 is provided. In the illustrated examples, the dirt collection chamber door 1400 is rotatably mounted by a hinge 1110 about a dirt collection chamber opening axis 1402 that is parallel to the air treatment chamber opening axis 1410 of each air treatment chamber door 1408. The dirt collection chamber door 1400 forms a lower portion of the sidewall 1124 of the dirt collection chamber 1042. In this way, when the dirt collection chamber door 1400 is moved between a closed position and an open position, the dirt collection chamber door 1400 moves in the lateral direction.

In the examples illustrated FIGS. 45D and 45E, first and second laterally openable dirt collection chamber doors 1400 are provided. In the illustrated examples, the dirt collection chamber doors 1400 are rotatably mounted by respective a hinge 1110 about a dirt collection chamber opening axis 1402 that is parallel to the air treatment chamber opening axis 1410 of each air treatment chamber door 1408. The dirt collection chamber opening axes 1402 are laterally spaced apart on opposed sides of the dirt collection chamber 1042. The dirt collection chamber doors 1400 each form a portion (e.g., half) of a lower portion of the sidewall 1124 of the dirt collection chamber 1042. In this way, when the dirt collection chamber doors 1400 are moved between a closed position and an open position, the dirt collection chamber doors 1400 move in opposed lateral directions.

In the examples illustrated in FIGS. 45B to 45E, each dirt collection chamber door 1400 moves downwardly and laterally from the closed position the open position shown. A single laterally openable dirt collection chamber door 1400 may move in the same lateral direction as a single air treatment chamber door 1408, an opposed lateral direction to a single air treatment chamber door 1408 (see e.g., FIG. 45B), or the same lateral direction as one air treatment chamber door 1408 (see e.g., FIG. 45C). Two laterally openable dirt collection chamber doors 1400 move downwardly and in opposed lateral directions from the closed position to the open position. Each laterally openable dirt collection chamber door 1400 may move in the same lateral direction as a respective air treatment chamber door 1408 (see e.g., FIG. 45D) or one of the dirt collection chamber doors 1400 may move in the same lateral direction as a single air treatment chamber door 1408 (see e.g., FIG. 45E). Optionally, as exemplified in each of the illustrated examples, the dirt collection chamber door 1400 also includes a portion of the rear end wall of the dirt collection chamber, which moves with the dirt collection chamber door 1400 between the open and closed positions.

As shown in the examples illustrated in FIGS. 45B to 45E, when the air treatment chamber axis 1050 extends horizontally and the dirty air inlet 1002 is at the upper end 1018 of the hand vacuum cleaner 1000, each dirt collection chamber opening axis 1402 extends in a horizontal dirt collection chamber emptying plane 1404. When each dirt collection chamber door 1400 is in the open position, a dirt collection chamber emptying port 1406 is provided in the dirt collection chamber emptying plane 1404. The dirt collection chamber emptying port 1406 has a perimeter having first and second laterally opposed sides. Where the dirt collection chamber emptying port 1406 is horizontally oriented, the first and second laterally opposed sides extend in the forward/rearward direction parallel to the dirt collection chamber opening axis 1402. Where a single laterally openable dirt collection chamber door 1400 is provided (see e.g., FIGS. 45B to 45C), one of the first and second laterally opposed sides of the dirt collection chamber emptying port 1406 may extend proximate to (or adjacent) and parallel to the dirt collection chamber opening axis 1402. Where first and second laterally openable dirt collection chamber doors 1400 are provided (see e.g., FIGS. 45D to 45E), both of the first and second laterally opposed sides of the dirt collection chamber emptying port 1406 may extend proximate to (or adjacent) and parallel to a respective dirt collection chamber opening axis 1402.

When the air treatment chamber axis 1050 extends horizontally and the dirty air inlet 1002 is at the upper end 1018 of the hand vacuum cleaner 1000, at least a portion of the dirt collection chamber 1042 may underlie the air treatment chamber 1044. Similarly, at least a portion of the first openable portion 1060₁, which may include at least one laterally openable dirt collection chamber door 1400 (e.g., 1 or 2 or more) or a forwardly/rearwardly openable dirt collection chamber door 1400, may underlie the air treatment chamber 1044. In such embodiments, at least a portion of the dirt collection chamber 1042 and at least a portion of the first openable portion 1060₁, which may include at least one laterally openable dirt collection chamber door 1400 or a forwardly/rearwardly openable dirt collection chamber door 1400, may underlie the air treatment chamber door(s) 1408.

In such embodiments, when the air treatment chamber door 1408 is moved from the closed position to the open position, the air treatment chamber door 1408 may descend through the underlying portion of the dirt collection chamber 1042. When each dirt collection chamber door 1400 is in the open position, the air treatment chamber door(s) 1408 may further descend through the underlying portion of the dirt collection chamber emptying port 1406. Accordingly, in such embodiments, the dirt collection chamber emptying port 1406 may have a larger cross-sectional area than a cross-sectional area of the air treatment chamber emptying port 1414 to facilitate movement of the air treatment chamber door 1408 through the dirt collection chamber emptying port 1406. An advantage of this design is that, as the air treatment chamber door 1408 descends though the dirt collection chamber 1042, the air treatment chamber door 1408 may push dirt and debris from the dirt collection chamber 1042 and may wipe part or all of an interior wall of the dirt collection chamber. This may improve emptying of the dirt collection chamber 1042.

For example, in the example illustrated in FIGS. 44A to 44E, when the air treatment chamber axis 1050 extends horizontally and the dirty air inlet 1002 is at the upper end 1018 of the hand vacuum cleaner 1000, the dirt collection chamber 1042 underlies the air treatment chamber 1044. Similarly, the first openable portion 1060₁, which includes a forwardly/rearwardly openable dirt collection chamber door 1400, also underlies the air treatment chamber 1044. As such, the dirt collection chamber 1042 and the dirt collection chamber door 1400 also underlie the air treatment chamber doors 1408.

As shown, when the air treatment chamber doors 1408 are moved from the closed position (see e.g., FIGS. 44B to 44D) to the open position (see e.g., FIG. 44E), the air treatment chamber doors 1408 descend through the underlying dirt collection chamber 1042. Further, when the dirt collection chamber door 1400 is in the open position (see e.g., FIGS. 44D to 44E), the air treatment chamber doors 1408 optionally also descend through the underlying dirt collection chamber emptying port 1406 and extend at least partially downwardly therefrom.

FIGS. 45A to 45E show alternate configurations of the air treatment member 1008. In the illustrated examples, when the air treatment chamber axis 1050 extends horizontally and the dirty air inlet 1002 is at the upper end 1018 of the hand vacuum cleaner 1000, the dirt collection chamber 1042 underlies the air treatment chamber 1044. Similarly, the first openable portion 1060₁, which includes a forwardly/rearwardly openable dirt collection chamber door 1400 (see e.g., FIG. 45A), a laterally openable dirt collection chamber door 1400 (see e.g., FIGS. 45B to 45C), or first and second laterally openable dirt collection chamber doors 1400 (see e.g., FIGS. 45D to 45E), also underlies the air treatment chamber 1044. As such, the dirt collection chamber 1042 and the dirt collection chamber door(s) 1400 also underlie the laterally openable air treatment chamber door 1408 (see e.g., FIGS. 45A, 45B, and 45E) or doors (see e.g., FIGS. 45C to 45D).

As shown in each of the examples illustrated in FIGS. 45A to 45E, when the air treatment chamber door(s) 1408 are moved from the closed position to the open position shown, each air treatment chamber door 1408 descends through the underlying dirt collection chamber 1042. Further, when the dirt collection chamber door(s) 1400 is/are in the open position shown, each air treatment chamber door 1408 optionally also descends through the underlying dirt collection chamber emptying port 1406 and extends at least partially downwardly therefrom.

As shown in each of the examples illustrated in FIGS. 44 to 45, the dirt collection chamber emptying port 1406 may have a larger cross-sectional area than a cross-sectional area of the air treatment chamber emptying port 1414 to facilitate movement of the air treatment chamber door 1408 through the dirt collection chamber emptying port 1406.

The air treatment chamber 1044 may have a width in the lateral direction and a length in the forward/rearward direction (i.e., the direction of the air treatment chamber axis 1050). In some embodiments, the width of the air treatment chamber 1044 may be less than the length of the air treatment chamber 1044. Accordingly, in such embodiments, a laterally openable air treatment chamber door 1408 that spans the width of the air treatment chamber 1044 may have a shorter turn radius about the air treatment chamber opening axis 1410 than would a forwardly/rearwardly openable air treatment chamber door 1408 that spans the length of the air treatment chamber 1044. This may advantageously reduce the distance that each air treatment chamber door 1408 extends from the dirt collection chamber emptying port 1406 when in the open position. Similarly, first and second laterally openable air treatment chamber doors 1408 that each span a portion (e.g., half) of the width of the air treatment chamber 1044 may have an even shorter turn radius about their air treatment chamber opening axes 1410. This may advantageously further reduce the distance (if any) that each air treatment chamber door 1408 extends from the dirt collection chamber emptying port 1406 when in the open position.

As described in the previous section, the dirt collection chamber 1042 may have a width in the lateral direction that may be less than a length of the dirt collection chamber 1042 in the forward/rearward direction. Accordingly, as described, using a laterally openable dirt collection chamber door 1400 that spans the width of the dirt collection chamber 1042, or first and second laterally openable dirt collection chamber doors 1400 that each span a portion (e.g., half) of the width of the dirt collection chamber 1042, may advantageously reduce the depth of a refuse container or docking station required to accommodate each dirt collection chamber door 1400 moving to the open position for emptying.

Depending on the length of a forwardly/rearwardly openable air treatment chamber door 1408 used with laterally openable dirt collection chamber door(s) 1400, the air treatment chamber door 1408 may extend below the dirt collection chamber door(s) 1400 when the doors 1400, 1408 are all in their respective open positions. However, in embodiments in which one or more laterally openable air treatment chamber doors 1408 are used, the air treatment chamber door(s) 1408 may not extend below the dirt collection chamber door(s) 1400 when the doors 1400, 1408 are all in their respective open positions. Accordingly, the use of one or more laterally openable air treatment chamber doors 1408 in combination with one or more laterally openable dirt collection chamber doors 1400 may advantageously yield a more compact hand vacuum cleaner 1000 when the doors 1400, 1408 are all in their respective open positions. This may advantageously reduce the depth of a refuse container or docking station required to accommodate each dirt collection chamber door 1400 and air treatment chamber door 1408 moving to the open position for emptying.

For example, in contrast to a forwardly/rearwardly openable air treatment chamber door 1408 that spans the length of the air treatment chamber 1044 (see e.g., FIGS. 42D and 42F), the laterally openable air treatment chamber door 1408 that spans the width of the air treatment chamber 1044 (see e.g., FIGS. 45A, 45B, and 45E) has a shorter turn radius about the air treatment chamber opening axis 1410. As shown, this may reduce the distance that each air treatment chamber door 1408 extends from the dirt collection chamber emptying port 1406 when in the open position. In further contrast, first and second laterally openable air treatment chamber doors 1408 that each span a portion (e.g., half) of the width of the air treatment chamber 1044 (see e.g., FIGS. 44E and 45C to 47D) have an even shorter turn radius about their air treatment chamber opening axes 1410. As shown, this may further reduce the distance (if any) that each air treatment chamber door 1408 extends from the dirt collection chamber emptying port 1406 when in the open position.

Similarly, in contrast to a forwardly/rearwardly openable air treatment chamber door 1408 that spans the length of the air treatment chamber 1044 (see e.g., FIGS. 44E and 45A), the laterally openable dirt collection chamber door 1400 that spans the width of the dirt collection chamber 1042 (see e.g., FIGS. 45B to 45C) has a shorter turn radius about the dirt collection chamber opening axis 1402. In further contrast, first and second laterally openable dirt collection chamber doors 1400 that each span a portion (e.g., half) of the width of the dirt collection chamber 1042 (see e.g., FIGS. 45D and 45E) have an even shorter turn radius about their dirt collection chamber opening axes 1402. Depending on the length of a forwardly/rearwardly openable air treatment chamber door 1408 used with laterally openable dirt collection chamber door(s) 1400, the air treatment chamber door 1408 may extend below the dirt collection chamber door(s) 1400 when the doors 1400, 1408 are all in their respective open positions (see e.g., FIGS. 42D and 42F). However, in embodiments in which one or more laterally openable air treatment chamber doors 1408 are used with laterally openable dirt collection chamber door(s) 1400, the air treatment chamber door(s) 1408 may not extend below the dirt collection chamber door(s) 1400 when the doors 1400, 1408 are all in their respective open positions (see e.g., FIGS. 45B to 45E). Accordingly, the use of one or more laterally openable air treatment chamber doors 1408 in combination with one or more laterally openable dirt collection chamber doors 1400 may yield a more compact hand vacuum cleaner 1000 (i.e., in the vertical direction) when the doors 1400, 1408 are all in their respective open positions.

In the illustrated examples described in this section, the air treatment chambers 1044 are cyclone chambers, and the air treatment chamber axes 1050 are cyclone axes of rotation. It will be appreciated, however, that any other type of air treatment chamber may be used with the openable portion(s) described herein.

It will also be appreciated that the doors may extend the entire length of the sidewall of only a portion thereof.

It will be appreciated that the laterally openable door(s) may open any percentage of the angular distance around the perimeter of the sidewall of the air treatment chamber. Accordingly, the laterally openable door(s) may extend around 90°, 120°, 180° or more of the angular distance around the perimeter.

### Laterally Openable Air Treatment Assembly Door Using at Least One Living Hinge

In accordance with this aspect of this disclosure, which may be used by itself or in combination with one or more other aspects of this disclosure, a surface cleaner such as the hand vacuum cleaner may have at least one laterally openable door, which may be an air treatment chamber door and/or an external dirt collection chamber door, where each air treatment chamber door includes at least one living hinge.

A living hinge of an air treatment chamber door and/or a dirt collection chamber door may be a thin, flexible section that connects two rigid sections (e.g., the sidewall of the air treatment chamber to an air treatment chamber door; two sections of an air treatment chamber door). The living hinge may allow the rigid sections to bend or pivot relative to each other without the need for mechanical hinges or separate moving parts. As opposed to a mechanical hinge, such as a piano hinge, a living hinge may be any thin flexible material known in the art which permits one part to rotate with respect to another. The living hinge may be an elastomeric member or a thin plastic substrate that connects a first portion of a wall to another to permit one part to rotate relative to the other to thereby provide an openable door. The living hinge may be separately manufactured and applied to the sidewall of a chamber and a door thereof. Alternately the sidewall of the air treatment chamber or dirt collection chamber and its respective door(s) may be molded as a single piece with each air treatment chamber door connected to the sidewall by a respective living hinge, which is a thinner walled portion of the molded sidewall. An advantage of a living hinge is that is provides a continuous hinge that connects the sidewall to a door thereby providing an air tight connection without the need for a sealing member such as a gasket. The air treatment chamber 1044 may have at least one air treatment chamber door 1408 that is operable to open the air treatment chamber 1044. The air treatment chamber door 1408 may be pivotably mounted by a living hinge 1416 about an air treatment chamber opening axis 1410. The air treatment chamber door 1408 may, in the closed position, form a lower portion of the sidewall 1084 of the air treatment chamber 1044. The living hinge 1416 may connect the air treatment chamber door 1408 to a remainder of the sidewall 1084 of the air treatment chamber 1044 (e.g., an upper portion). The living hinge 1416 may extend along the sidewall 1084 of the air treatment chamber 1044 parallel to the air treatment chamber axis 1050 (i.e., the direction extending between the front end 1036 and the rear end 1040 of the air treatment chamber 1044). The air treatment chamber opening axis 1410 may therefore also be parallel to the air treatment chamber axis 1050. In this way, when the air treatment chamber door 1408 is pivoted about the air treatment chamber opening axis 1410 between the closed position and the open position, the air treatment chamber door 1408 may move in a lateral direction (i.e., as defined previously herein).

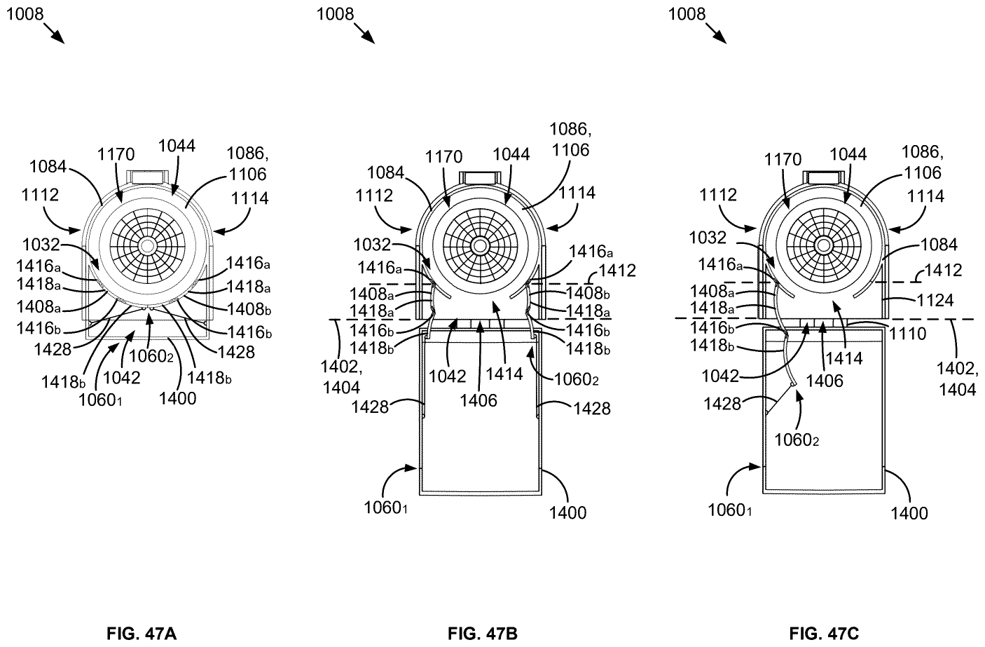

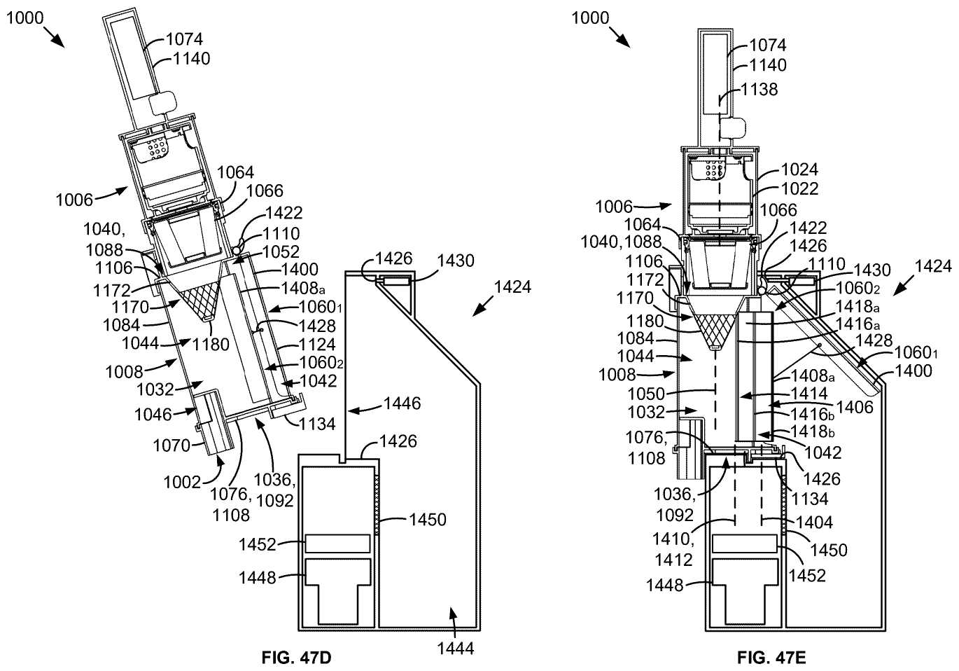

In some embodiments, the air treatment chamber door 1408 may be pivotably mounted to the remainder of the sidewall 1084 by a first living hinge 1416a about a first air treatment chamber opening axis 1410a as described above. In such embodiments, the air treatment chamber door 1408 may further have a second living hinge 1416b connecting a first rigid section 1418a of the air treatment chamber door 1408 to a second rigid section 1418b of the air treatment chamber door 1408 (see, e.g., FIGS. 47A to 47C). The second rigid section 1418b of the air treatment chamber door 1408 may be pivotably mounted to the first rigid section 1418a by the second living hinge 1416b about a second air treatment chamber opening axis 1410b. The second living hinge 1416b may extend along the air treatment chamber door 1408 parallel to the air treatment chamber axis 1050. The second air treatment chamber opening axis 1410b may therefore also be parallel to the air treatment chamber axis 1050. In this way, when the air treatment chamber door 1408 is pivoted about the first air treatment chamber opening axis 1410a between the closed position and the open position, the air treatment chamber door 1408 may move in the lateral direction. The second rigid section 1418b of the air treatment chamber door 1408 may move further in the lateral direction relative to the first rigid section 1418a by pivoting about the second air treatment chamber opening axis 1410b.

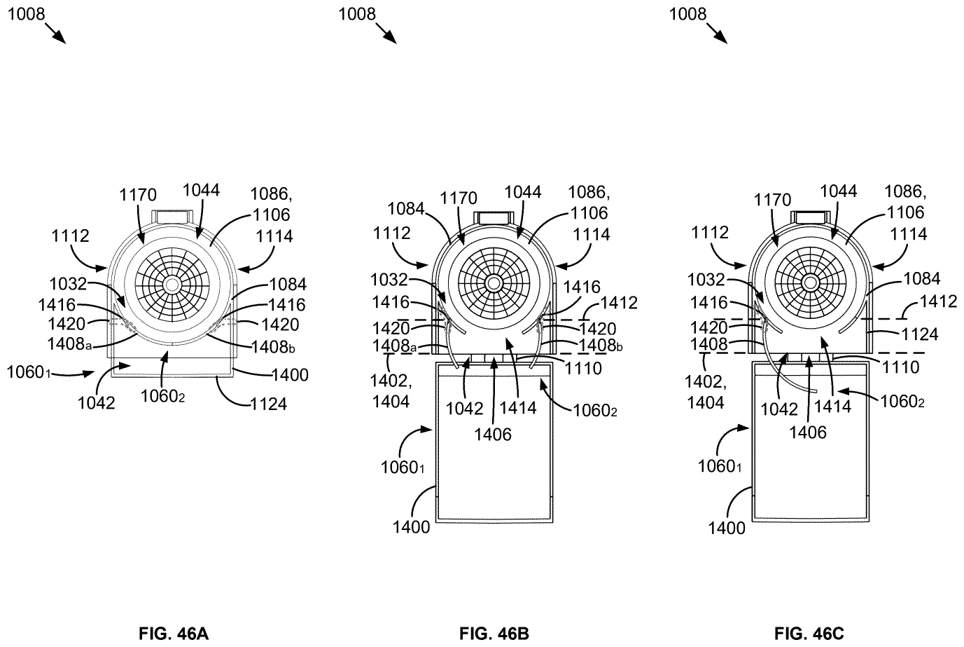

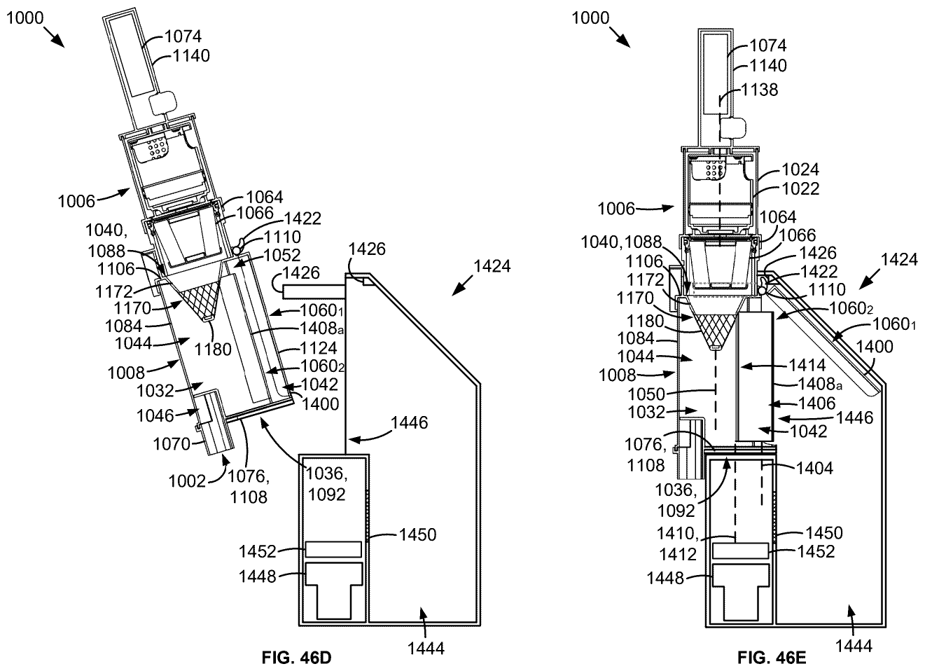

Optionally, the air treatment chamber 1044 may have a first air treatment chamber door 1408a and a second air treatment chamber door 1408b (see, e.g., FIGS. 46A to 46B). The first air treatment chamber door 1408a may form a first portion of the lower portion of the sidewall 1084 of the air treatment chamber 1044 and the second air treatment chamber door 1408b may form a second portion of the lower portion of the sidewall 1084 of the air treatment chamber 1044. The first and second air treatment chamber doors 1408 may each be pivotably mounted by a respective living hinge 1416 about a respective air treatment chamber opening axis 1410. The air treatment chamber opening axes 1410 may be parallel to the air treatment chamber axis 1050. The air treatment chamber opening axes 1410 may be positioned at opposed lateral sides of the air treatment chamber 1044. In this way, the first air treatment chamber door 1408a may move in a first lateral direction from the closed position to the open position and the second air treatment chamber door 1408b may move in a second lateral direction from the closed position to the open position.

The second lateral direction may be opposite the first lateral direction. In this way, when the first and second air treatment chamber doors 1408 are moved from their respective closed positions to their respective open positions, the first and second air treatment chamber doors 1408 may move laterally away from each other. Conversely, when the first and second air treatment chamber doors 1408 are moved from their respective open positions to their respective closed positions, the first and second air treatment chamber doors 1408 may move laterally toward each other.

In some embodiments, the first and second air treatment chamber doors 1408 may each have a first living hinge 1416a and a second living hinge 1416b (see, e.g., FIG. 47C). In such embodiments, the first and second air treatment chamber doors 1408 may each be configured as described previously in this section.

For example, in the examples illustrated in FIGS. 46A to 46C, each air treatment chamber door 1408 of the air treatment chamber 1044 has one living hinge 1416. In the example illustrated in FIG. 46C, the air treatment chamber door 1408 forms a lower portion of the sidewall 1084 of the air treatment chamber 1044 when in the closed position. In the example illustrated in FIGS. 46A to 46B, each air treatment chamber door 1408 forms a portion of the lower portion of the sidewall 1084 of the air treatment chamber 1044 when in the closed position.

In each example, the living hinge 1416 connects the air treatment chamber door 1408 to a remainder of the sidewall 1084 of the air treatment chamber 1044. Each air treatment chamber door 1408 is thus pivotably mounted by the living hinge 1416 about an air treatment chamber opening axis 1410 between a closed position (see e.g., FIG. 46A) and an open position (see e.g., FIGS. 46B to 46C). Each living hinge 1416 extends along the sidewall 1084 of the air treatment chamber 1044 parallel to the air treatment chamber axis 1050 such that the air treatment chamber opening axis 1410 is also parallel to the air treatment chamber axis 1050. In this way, when each air treatment chamber door 1408 is pivoted about the air treatment chamber opening axis 1410 between the closed position and the open position, the air treatment chamber door 1408 moves in the lateral direction.

In the examples illustrated in FIGS. 47A to 47C, each air treatment chamber door 1408 of the air treatment chamber 1044 has a first living hinge 1416a and a second living hinge 1416b. In the example illustrated in FIG. 47C, the air treatment chamber door 1408 forms a lower portion of the sidewall 1084 of the air treatment chamber 1044 when in the closed position. In the example illustrated in FIGS. 47A to 47B, each air treatment chamber door 1408 forms a portion of the lower portion of the sidewall 1084 of the air treatment chamber 1044 when in the closed position.

In each example, the first living hinge 1416a of each air treatment chamber door 1408 is configured as described with respect to the living hinge of FIGS. 46A to 46C. The second living hinge 1416b of each air treatment chamber door 1408 connects a first rigid section 1418a of the air treatment chamber door 1408 to a second rigid section 1418b of the air treatment chamber door 1408. The second rigid section 1418b is pivotably mounted to the first rigid section 1418a by the second living hinge 1416b about a second air treatment chamber opening axis 1410b. Each second living hinge 1416b extends along the air treatment chamber door 1408 parallel to the air treatment chamber axis 1050 such that the second air treatment chamber opening axis 1410b is also parallel to the air treatment chamber axis 1050. In this way, when each air treatment chamber door 1408 is moved from the closed position to the open position, the air treatment chamber door 1408 pivots in the lateral direction about the first air treatment chamber opening axis 1410a, and the second rigid section 1418b of the air treatment chamber door 1408 pivots further in the lateral direction relative to the first rigid section 1418a by pivoting about the second air treatment chamber opening axis 1410b.

The second living hinge 1416b may allow a single air treatment chamber door 1408 to open to a greater extent. That is, by dividing the air treatment chamber door 1408, which is curved due to forming a portion of the sidewall 1084, into the first rigid section 1418a and the second rigid section 1418b, the second living hinge 1416b may allow the second rigid section 1418b to pivot relative to the first rigid section 1418a such that the air treatment chamber door 1408 may hang straighter in the open position. Similarly, the second living hinge 1416b may allow first and second air treatment chamber doors 1408 to open to an even greater extent. That is, the first and second air treatment chamber doors 1408 divide the lower portion of the sidewall 1084, which may reduce the degree of curvature of each air treatment chamber door 1408 and thereby allow the air treatment chamber doors 1408 to hang straighter in the open position. By further subdividing the air treatment chamber doors 1408 into the first rigid section 1418a and the second rigid section 1418b, the second living hinge 1416b may allow the second rigid section 1418b to pivot relative to the first rigid section 1418a such that the air treatment chamber doors 1408 may hang even straighter in the open position. The second living hinge 1416b may therefore ensure that the air treatment chamber emptying port 1414 is relatively unobstructed by the air treatment chamber door(s) 1408 when in the open position. This may improve emptying of the air treatment chamber 1044.

For example, in the examples illustrated in FIGS. 46C and 47C, the air treatment chamber 1044 has a single air treatment chamber door 1408. In the example illustrated in FIG. 46C, the air treatment chamber door 1408 has a single living hinge 1416. In the example illustrated in FIG. 47C, the air treatment chamber door 1408 has a first living hinge 1416a and a second living hinge 1416b. As shown, the air treatment chamber door 1408 of FIG. 47C opens to a greater extent than that of FIG. 46C.

Similarly, in the examples illustrated in FIGS. 46B and 47B, the air treatment chamber 1044 has a first air treatment chamber door 1408a and a second air treatment chamber door 1408b. In the example illustrated in FIG. 46B, each air treatment chamber door 1408 has a single living hinge 1416. In the example illustrated in FIG. 47B, each air treatment chamber door 1408 has a first living hinge 1416a and a second living hinge 1416b. As shown, the air treatment chamber doors 1408 of FIG. 47B open to a greater extent than those of FIG. 46B.

Further, as shown in FIGS. 47B and 47C in which each air treatment chamber door 1408 has a first living hinge 1416a and a second living hinge 1416b, the first and second air treatment chamber doors 1408 of FIG. 47B open to a greater extent than the single air treatment chamber door 1408 of FIG. 46B.

Accordingly, as exemplified in FIGS. 46 to 47, the difference in degree of opening may be attributed the size of the air treatment chamber door(s) 1408 and/or to the second living hinge 1416b allowing the second rigid section 1418b to rotate relative to the first rigid section 1418a such that each air treatment chamber door 1408 hangs straighter in the open position. It will be appreciated that increasing the number of living hinges 1416 may further enhance the degree of opening. The extent to which the air treatment chamber door(s) 1408 is/are opened may thus be selected depending on, for example, the size of the air treatment chamber emptying port 1414 and/or the size of an underlying dirt collection chamber emptying port 1406.

In any embodiment, the living hinge 1416 of each air treatment chamber door 1408 may bias the air treatment chamber door 1408 to the closed position. Similarly, where an air treatment chamber door 1408 has a first living hinge 1416a and a second living hinge 1416b, the first living hinge 1416a may bias the air treatment chamber door 1408 to the closed position and the second living hinge 1416b may bias the second rigid section 1418b of the air treatment chamber door 1408 to the closed position. That is, the second living hinge 1416b may bias the second rigid section 1418b to the appropriate orientation relative to the first rigid section 1418a, and the first living hinge 1416a may bias the air treatment chamber door 1408 to the closed position.

To empty the air treatment chamber 1044, the biasing force of the living hinge(s) 1416 of each air treatment chamber door 1408 may be overcome to move the treatment chamber door(s) 1408 from the closed position to the open position. The biasing force of the living hinge 1416 (or first living hinge 1416a, if more than one) may be overcome by any suitable means such as, for example, upon application of force by manual (e.g., user) or automatic (e.g., motorized) means. The biasing force of the second living hinge 1416b (if present) may be overcome by any suitable means such as the draw member described subsequently in this section. Upon cessation of the application of force, the living hinge(s) 1416 of each air treatment chamber door 1408, by itself or with manual or automatic assistance, may return the air treatment chamber door 1408 to the closed position.

The air treatment chamber door(s) 1408 may be independently moveable from the closed position to the open position. That is, each air treatment chamber door 1408 may have an actuator operable to move the air treatment chamber door 1408 from the closed position to the open position. In such embodiments, the dirt collection chamber door 1400 may similarly be independently moveable by an actuator that is operable to move the dirt collection chamber door 1400 from the closed position to the open position. The air treatment chamber 1044 and the dirt collection chamber 1042 may thus be sequentially opened by independent actuation. Alternatively, the air treatment chamber 1044 and the dirt collection chamber 1042 may be concurrently opened by synchronized independent actuation. If will be appreciated that if a chamber (the air treatment chamber or the dirt collection chamber) have two doors, then an actuator may be drivingly connected to each door so that the doors open concurrently. It will also be appreciated that the door(s) of a chamber may be biased to the open position or the closed position in which case the actuator may move the door in only one direction.

For example, in the examples illustrated in FIGS. 46A to 46E, each air treatment chamber door 1408 has an actuator, shown as a lever arm 1420 (see e.g., phantom stippled lines in FIGS. 46A to 46C). Each lever arm 1420 is pivotable about the air treatment chamber opening axis 1410 of the living hinge 1416 of the corresponding air treatment chamber door 1408. Each lever arm 1420 is external to the air treatment chamber 1044 and drivingly connected to (e.g., it may be mounted in a fixed orientation to) the corresponding air treatment chamber door 1408. Accordingly, pivoting the lever arm 1420 about the air treatment chamber opening axis 1410 similarly pivots the corresponding air treatment chamber door 1408. In this way, each lever arm 1420 is operable (e.g., by application of manual or automatic force) to move the corresponding air treatment chamber door 1408 from the closed position to the open position.

Similarly, the dirt collection chamber door 1400 has an actuator, shown as a rocker arm 1422 (see e.g., FIGS. 46D to 46E). The rocker arm 1422 is pivotable about the dirt collection chamber opening axis 1402 of the hinge 1110 of the dirt collection chamber door 1400. The rocker arm 1422 is external to the dirt collection chamber 1042 and drivingly connected to (e.g., it may be mounted in a fixed orientation to) the dirt collection chamber door 1400. Accordingly, pivoting the rocker arm 1422 about the dirt collection chamber opening axis 1402 similarly pivots the dirt collection chamber door 1400. In this way, the rocker arm 1422 is operable (e.g., by application of manual or automatic force) to move the dirt collection chamber door 1400 from the closed position to the open position.

As shown in FIGS. 46D to 46E, when the hand vacuum cleaner 1000 is docked to a docking station 1424, the air treatment chamber 1044 and the dirt collection chamber 1042 may be both opened, e.g., concurrently or sequentially opened, by synchronized independent actuation of each actuator of the air treatment chamber door(s) 1408 and dirt collection chamber door 1400. As shown, the docking station 1424 has an abutment surface 1426 corresponding to each lever arm 1420 and the rocker arm 1422. The abutment surfaces 1426 may be collectively referred to as a docking station actuator. In the example shown, as the hand vacuum cleaner 1000 is docked to the docking station 1424, the hand vacuum cleaner 1000 may pass between a pair of laterally opposed arms. At least one of the laterally opposed arms may have an abutment surface 1426 at the distal end thereof. As the hand vacuum cleaner 1000 is positioned between the laterally opposed arms, the abutment surface 1426 of each arm may engage a corresponding one of the lever arms 1420 of the air treatment chamber door(s) 1408. In this way, as the hand vacuum cleaner 1000 is moved to a docked position (see e.g., FIG. 46E), each air treatment chamber door 1408 may be driven to the open position by the abutment surface 1426 of one of the arms rotating the lever arm 1420. Similarly, as the hand vacuum cleaner 1000 is moved to the docked position, the dirt collection chamber door 1400 may be driven to the open position by another abutment surface 1426 rotating the rocker arm 1422. Accordingly, docking the hand vacuum cleaner 1000 may automatically passively open the air treatment chamber 1044 and the dirt collection chamber 1042 by independent but concurrent actuation of each lever arm 1420 and the rocker arm 1422.

In alternate embodiments, the air treatment chamber door(s) 1408 and dirt collection chamber door(s) 1400 may be operatively linked such that moving one from the closed position to the open position concurrently moves all from the closed position to the open position. In some such embodiments, each lever arm 1420 and the rocker arm 1422 may be operatively linked by a mechanical linkage or gear train such as those described subsequently herein. In such embodiments, only one lever arm 1420 or rocker arm 1422 may be accessible or provided and operable to concurrently move each air treatment chamber door 1408 and dirt collection chamber door 1400. Additionally, or in alternate embodiments, the air treatment chamber door(s) 1408 may be operatively linked directly to the dirt collection chamber door 1400 itself. For example, the air treatment chamber door(s) 1408 may have a push member (e.g., rigid protrusion from the bottom of the door) located in the dirt collection chamber 1042. When the air treatment chamber door(s) 1408 is/are moved to the open position (e.g., by actuating lever arm(s) 1420), the push member may drive the dirt collection chamber door 1400 to the open position. Conversely, the dirt collection chamber door 1400 may have a draw member, which may be a flexible draw member (e.g., tether, cord, or other tensile member), connecting the dirt collection chamber door 1400 to each air treatment chamber door 1408. When the dirt collection chamber door 1400 is moved to the open position (e.g., by actuating rocker arm 1422), each draw member may pull a respective air treatment chamber door 1408 to the open position. A draw member may be advantageously employed where the air treatment chamber door(s) 1408 have first and second living hinges 1416, where the draw member may help straighten the first and second rigid sections 1418 across the second living hinge 1416b. In either such embodiments, only one lever arm 1420 or rocker arm 1422 may be accessible or provided and operable to concurrently move each air treatment chamber door 1408 and dirt collection chamber door 1400. The air treatment chamber 1044 and the dirt collection chamber 1042 may thus be concurrently openable.

For example, in the examples illustrated in FIGS. 47A to 47E, only the dirt collection chamber door 1400 has an actuator, shown as a rocker arm 1422 (see e.g., FIGS. 47D to 47E). As shown, the dirt collection chamber door 1400 has a flexible draw member, shown as a tether 1428, connecting the dirt collection chamber door 1400 to each air treatment chamber door 1408. In this way, when the dirt collection chamber door 1400 is moved from the closed position (see e.g., FIGS. 47A and 47D) to the open position (see e.g., FIGS. 47B, 47C, and 47E), each tether 1428 draws a corresponding air treatment chamber door 1408 with the dirt collection chamber door 1400 from the closed position to the open position. It will be appreciated that the draw member may be a mechanical linkage and it may be a rigid member such as a rigid rod that is pivotally mounted at one or both ends to the doors to which it is attached.

As shown in FIGS. 47D to 47E, when the hand vacuum cleaner 1000 is docked to a docking station 1424, the air treatment chamber 1044 and the dirt collection chamber 1042 may be concurrently opened by actuation of the actuator of the dirt collection chamber door 1400. The docking station actuator of the docking station 1424 may be an abutment surface 1426 corresponding to the rocker arm 1422 as described with respect to FIGS. 46D to 46E. Alternatively, as shown, the docking station actuator may be a linear actuator 1430 having an abutment surface 1426 at a distal end thereof. Once docked, the linear actuator 1430 may be activated (e.g., by a user or by a sensor detecting the hand vacuum cleaner has been docked). The abutment surface 1426 of the linear actuator 1430 may engage the rocker arm 1422 and drive the rocker arm 1422 to open the dirt collection chamber door 1400. At the same time, each tether 1428 may draw a corresponding air treatment chamber door 1408 with the dirt collection chamber door 1400 from the closed position to the open position. Accordingly, after docking the hand vacuum cleaner 1000, the linear actuator (or other suitable electro-mechanical means such as a stepper motor) may automatically concurrently open the air treatment chamber 1044 and the dirt collection chamber 1042 by actuation of the rocker arm 1422.

It will be appreciated that, in the illustrated example, the tether(s) 1428 may be omitted and the rocker arm 1422 may be operatively linked to the lever arm(s) 1420 by other means. It will further be appreciated that, in the illustrated example, the tether(s) 1428 may be omitted and the actuator to be engaged by the abutment surface 1426 of the linear actuator 1430 may be the lever arm(s) 1420 of the air treatment chamber door(s) 1408. In such a case, the lever arm(s) 1420 may be operatively linked to the rocker arm 1422 by other means or the air treatment chamber door(s) 1408 may have the push member to drive the dirt collection chamber door 1400.

Optionally, the rocker arm 1422 may be biased (e.g., by torsion spring or a living hinge) such that the dirt collection chamber door 1400 is biased to the closed position. In such embodiments, the dirt collection chamber door 1400 may be moved to the open position by any means described previously (e.g., a mechanical actuator such as a rocker arm or a push member push member or an electro-mechanical member). After the force holding the dirt collection chamber door 1400 in the open position is removed, the bias may return the dirt collection chamber door 1400 to the closed position. In embodiments in which the dirt collection chamber door 1400 has a draw member connected to each air treatment chamber door 1418, tension in the draw member(s) may be released as the dirt collection chamber door 1400 returns to the closed position such that each air treatment chamber door 1408 may similarly passively return to the closed position by the biasing force of a biasing member such as the living hinge(s) 1416 thereof. Similarly, in embodiments in which the air treatment chamber door(s) 1408 have a push member, as each air treatment chamber door 1408 returns to the closed position by the biasing force of a biasing member such as the living hinge(s) 1416 thereof, the push member may be removed from contact with the dirt collection chamber door 1400 such that the dirt collection chamber door 1400 may similarly passively return to the closed position by the bias thereof.

For example, in the example illustrated in FIGS. 47D to 47E, each air treatment chamber door 1408 has an independently actuated lever arm 1420 and the dirt collection chamber door 1400 has an independently actuated rocker arm 1422. That is, none of the doors are operatively linked. Each air treatment chamber door 1408 is biased to the closed position by at least one living hinge 1416. The dirt collection chamber door 1400 is similarly biased to the closed position by a torsion spring (not shown). Accordingly, upon removal of the force applied to the lever arm(s) 1420 and the rocker arm 1422 (e.g., when removing the hand vacuum cleaner 1000 from the docking station 1424 and thereby disengaging the abutment surfaces 1426 from the arms 1420, 1422), each air treatment chamber door 1408 may be automatically passively returned to the closed position by the living hinge(s) 1416 and the dirt collection chamber door 1400 may similarly be automatically passively returned to the closed position by the torsion spring. Alternately or in addition, the docking station actuator may also drive one or more door(s) closed as the vacuum cleaner is removed from the docking station.

Alternatively, the dirt collection chamber door 1400 may be unbiased and held in the closed position by a latch. A user may thus release the dirt collection chamber door 1400 by actuating the latch. In this way, when the air treatment chamber axis 1050 extends horizontally and the dirty air inlet 1002 is at an upper end 1018 of the hand vacuum cleaner 1000, the dirt collection chamber door 1400 may fall under the influence of gravity to the open position once released. In embodiments in which the dirt collection chamber door 1400 includes a draw member connected to each air treatment chamber door 1408, the weight of the dirt collection chamber door 1400 may be sufficient to draw each air treatment chamber door 1408 with it to the open position. When the air treatment chamber axis 1050 extends vertically, the dirt collection chamber door 1400 may be driven to the open position once released by actuation of the rocker arm 1422. In embodiments in which an air treatment chamber door 1408 includes a push member, the dirt collection chamber door 1400 may also be driven to the open position by moving the air treatment chamber door 1408 to the open position. In any embodiments in which the dirt collection chamber door 1400 is unbiased, the dirt collection chamber door 1400 may be manually returned to the closed position after emptying (e.g., via the rocker arm or pushing the door itself) and caught by the latch in the closed position.

For example, in the example illustrated in FIGS. 47D to 47E, the dirt collection chamber door 1400 is unbiased and held in the closed position by a latch actuator, shown as a button 1134. A user may thus release the dirt collection chamber door 1400 by depressing the button 1134. When the air treatment chamber axis 1050 extends horizontally and the dirty air inlet 1002 is at an upper end 1018 of the hand vacuum cleaner 1000, the dirt collection chamber door 1400 may fall under the influence of gravity to the open position once released. As shown, the dirt collection chamber door 1400 includes a draw member connected to each air treatment chamber door 1408. The dirt collection chamber door 1400 may thus draw each air treatment chamber door 1408 with it to the open position as it falls. However, when docked to the docking station 1424, the air treatment chamber axis 1050 extends vertically. In such an orientation, the dirt collection chamber door 1400 may need to be driven to the open position once released by actuation of the rocker arm 1422. As shown, the docking station 1424 may include an additional abutment surface 1426 configured to engage the button 1134 as the hand vacuum cleaner 1000 is docked, thereby releasing the dirt collection chamber door 1400. As described previously, once docked, the linear actuator 1430 may be activated (e.g., by a user or by a sensor detecting the hand vacuum cleaner has been docked). The linear actuator 1430 may engage the rocker arm 1422 such that the abutment surface 1426 drives the rocker arm 1422 to open the dirt collection chamber door 1400. At the same time, each tether 1424 may draw a corresponding air treatment chamber door 1408 with the dirt collection chamber door 1400 from the closed position to the open position. After completing an emptying sequence in which collected dirt and debris is drawn from the hand vacuum cleaner 1000 into the docking station 1424, the linear actuator 1430 may retract. The dirt collection chamber door 1400 may then be returned to the closed position (e.g., under force of gravity or manual force applied to the rocker arm or the door itself or the linear actuator may drive the door(s) closed as it retracts) and caught by the latch in the closed position.

As shown in the examples illustrated in FIGS. 46A to 46E and 47A to 47E, optionally when the air treatment chamber axis 1050 extends horizontally and the dirty air inlet 1002 is at the upper end 1018 of the hand vacuum cleaner 1000, the dirt collection chamber 1042 underlies the air treatment chamber 1044 and the air treatment chamber door(s) 1408. Similarly, the first openable portion 1060₁, which may include any dirt collection chamber door(s) 1400 as described herein, underlies the air treatment chamber 1044 and the air treatment chamber door(s) 1408. In this way, when the air treatment chamber door(s) 1408 is/are moved from the closed position (see e.g., FIGS. 46A and 46D; 47A and 47D) to the open position (see e.g., FIGS. 46B, 46C, and 46E; 47B, 47C, and 47E), the air treatment chamber 1044 is opened and each air treatment chamber door 1408 descends through the dirt collection chamber 1042. When the dirt collection chamber door(s) 1400 is/are in the open position, each air treatment chamber door 1408 further descends through the underlying portion of the dirt collection chamber emptying port 1406.

In the illustrated examples described in this section, the air treatment chambers 1044 are cyclone chambers, and the air treatment chamber axes 1050 are cyclone axes of rotation. It will be appreciated, however, that any other type of air treatment chamber may be used with the openable portion(s) described herein.

It will be appreciated that a living hinge may be used with a dirt collection chamber door.

### Laterally Openable Air Treatment Chamber Door Including Part of the Dirt Outlet

In accordance with this aspect of this disclosure, which may be used by itself or in combination with one or more other aspects of this disclosure, a vacuum cleaner having an air treatment chamber and an external dirt collection chamber may have at least one laterally openable air treatment chamber door, where at least one or each air treatment chamber door includes part of the dirt outlet. In accordance with this aspect, the dirt outlet may widen, e.g., in the direction of the air treatment chamber axis, as the door opens.

The air treatment chamber 1044 may have a front end 1036, an axially spaced apart rear end 1040, and an air treatment chamber axis 1050 that intersects the front and rear ends 1036, 1044. The air treatment chamber 1044 may be cyclone such as a horizontal cyclone such that the air treatment chamber axis 1050 (also referred to as a cyclone axis of rotation) extends in the forward/rearward direction. It will be appreciated, however, that any other type of air treatment chamber (e.g., non-cyclonic) may be used and have an air treatment chamber axis 1050 that extends in the forward/rearward direction. The air treatment chamber 1044 may have any laterally openable air treatment chamber door(s) 1408 described previously herein. It will be appreciated that the air treatment chamber axis 1050 may extend in any direction.

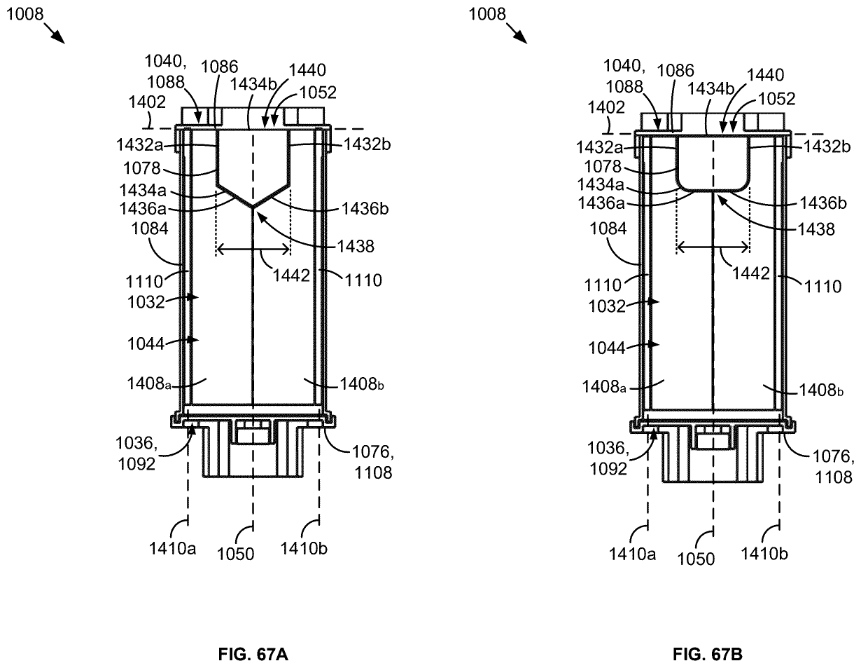

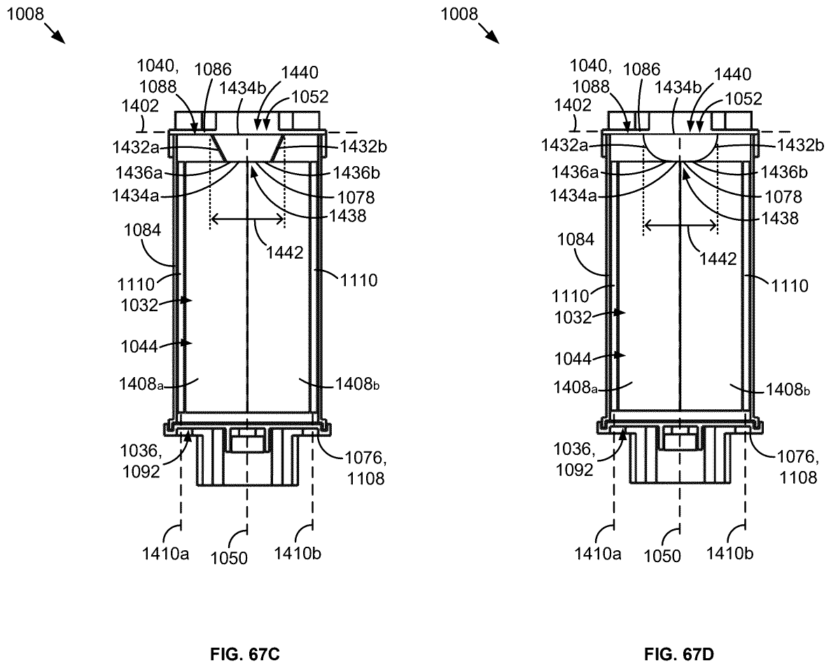

For example, in the examples illustrated in FIGS. 67A to 67D, the air treatment chamber 1044 has a front end 1036, an axially spaced apart rear end 1040, and an air treatment chamber axis 1050 that intersects the front and rear ends 1036, 1044. The air treatment chamber axis 1050 extends in the forward/rearward direction. As shown, the air treatment chamber 1044 has a first air treatment chamber door 1408a rotatably mounted about a first air treatment chamber opening axis 1410a and a second air treatment chamber door 1408b rotatably mounted about a second air treatment chamber opening axis 1410b. The first and second air treatment chamber opening axes 1410 are laterally spaced apart and extend in the forward/rearward direction parallel to the air treatment chamber axis 1050. In this way, the first air treatment chamber door 1408a moves in a first lateral direction from the closed position to the open position, and the second air treatment chamber door 1408b moves in a second lateral direction opposite the first lateral direction from the closed position to the open position. As described previously herein, the air treatment chamber opening axes 1410 extend in an air treatment chamber emptying plane 1412 and, when the air treatment chamber door 1408 are in the open position, an air treatment chamber emptying port 1414 is provided in the air treatment chamber emptying plane 1412.

When the air treatment chamber axis 1050 extends horizontally and the dirty air inlet 1002 is at the upper end 1018 of the hand vacuum cleaner 1000, the dirt collection chamber 1042 may underlie the air treatment chamber 1044 and the air treatment chamber doors 1408. The dirt collection chamber 1042 may have any dirt collection chamber door(s) 1400 described previously herein (e.g., one or more laterally openable or forwardly/rearwardly openable). The dirt collection chamber door(s) 1400 may also underlie the air treatment chamber 1044 and the air treatment chamber doors 1408.

For example, in the examples illustrated in FIGS. 67A to 67D, the dirt collection chamber 1042 has a dirt collection chamber door 1400 rotatably mounted by a hinge 1110 about a dirt collection chamber opening axis 1402 that extends in a different direction than the air treatment chamber opening axis 1410 of each air treatment chamber door 1408 (shown as transverse to the forward/rearward direction and as exemplified in FIG. 42F). In this way, when the dirt collection chamber door 1400 is moved from the closed position to the open position, the dirt collection chamber door 1400 moves in a different direction than the lateral direction (i.e., the forward/rearward direction). As described previously herein, the dirt collection chamber opening axis 1402 extends in a dirt collection chamber emptying plane 1404 and, when the dirt collection chamber door 1400 is in the open position, a dirt collection chamber emptying port 1406 is provided in the dirt collection chamber emptying plane 1404. The dirt collection chamber 1042 underlies the air treatment chamber 1044 and the air treatment chamber doors 1408 such that, when the air treatment chamber doors 1408 are moved from the closed position to the open position, each air treatment chamber door 1408 descends through the dirt collection chamber 1042 and, when the dirt collection chamber door 1400 is in the open position, through the underlying portion of the dirt collection chamber emptying port 1406.

The air treatment chamber 1044 may have one or more dirt outlet(s) 1052 provided in the sidewall 1084 thereof. The dirt outlet(s) 1052 may place the air treatment chamber 1044 in communication with the dirt collection chamber 1042. Accordingly, where the dirt collection chamber 1042 underlies the air treatment chamber 1044, the dirt outlet 1052 may be provided through the lower portion of the sidewall 1084 of the air treatment chamber 1044. In such embodiments, dirt separated from the air flow within the air treatment chamber 1044 may thus fall through the dirt outlet 1052 into the underlying dirt collection chamber 1042 (e.g., under the influence of gravity and/or thrown by momentum separation). For example, in the examples illustrated in FIGS. 67A to 67D, the dirt outlet 1052 is provided through the lower portion of the sidewall 1084 of the air treatment chamber 1044. In this way, the dirt outlet 1052 faces the underlying dirt collection chamber 1042.

The dirt outlet 1052 may have a perimeter 1078. The perimeter 1078 may include a first axially extending side 1432a and a second axially extending side 1432b. The first and second axially extending sides 1432 may be laterally spaced apart and extend generally in the forward/rearward direction. The perimeter 1078 may further include a first laterally extending side 1434a and a second laterally extending side 1434. The first laterally extending side 1434a may be spaced axially inwardly (i.e., in the forward/rearward direction) into the air treatment chamber 1044 from the second laterally extending side 1434b. The first and second laterally extending sides 1434 may extend generally in the lateral direction from the first axially extending side 1432a to the second axially extending side 1432b.

The perimeter 1078 of the dirt outlet 1052 may be defined by one or more portions of the air treatment chamber 1044. That is, the perimeter 1078 of the dirt outlet 1052 may be defined by one or more of the sidewall 1084, the front end wall 1108, and/or the rear end wall 1106. The portions of the air treatment chamber 1044 that define the perimeter 1078 of the dirt outlet 1052 may depend, for example, on the location of the dirt outlet 1052 between the front end 1036 and the rear end 1040 of the air treatment chamber 1044. For example, the dirt outlet 1052 may be provided at the front end 1036 of the air treatment chamber 1044 such that the dirt outlet 1052 is partially defined by the front end wall 1108 of the air treatment chamber 1044. In such embodiments, the front end wall 1108 may define the second laterally extending side 1434b of the perimeter 1078 of the dirt outlet 1052. The dirt outlet 1052 may alternatively be provided at the rear end 1040 of the air treatment chamber 1044 such that the dirt outlet 1052 is partially defined by the rear end wall 1106 of the air treatment chamber 1044. In such embodiments, the rear end wall 1106 may define the second laterally extending side 1434b of the perimeter 1078 of the dirt outlet 1052.

The portions of the air treatment chamber 1044 that define the perimeter 1078 of the dirt outlet 1052 may further depend, for example, on the location of the air treatment chamber door(s) 1408. An air treatment chamber door 1408 may define at least a portion of a perimeter 1078 of the dirt outlet 1052. Where a first and second air treatment chamber door 1408 are provided, the first air treatment chamber door 1408a may define a first portion of the perimeter 1078 of the dirt outlet 1052 and the second air treatment chamber door 1408b may define a second portion of the perimeter 1078 of the dirt outlet 1052.

In embodiments in which the air treatment chamber doors 1408 form the lower portion of the sidewall 1084 of the air treatment chamber 1044, the dirt outlet 1052 may be provided through the air treatment chamber doors 1408. In such embodiments, the first portion of the perimeter 1078 of the dirt outlet 1052 defined by the first air treatment chamber door 1408a may include the first axially extending side 1432a and a first portion 1436a of the first laterally extending side 1434a. Similarly, the second portion of the perimeter 1078 of the dirt outlet 1052 defined by the second air treatment chamber door 1408b may include the second axially extending side 1432b and a second portion 1436b of the first laterally extending side 1434a. The second laterally extending side 1434b of the perimeter 1078 of the dirt outlet 1052 may be defined by the front end wall 1108 (i.e., where the dirt outlet 1052 is at the front end 1036), the rear end wall 1106 (i.e., where the dirt outlet 1052 is at the rear end 1040), or a first portion may be defined by the first air treatment chamber door 1408a and a second portion may be defined by the second air treatment chamber door 1408b (i.e., where the dirt outlet 1052 is spaced apart from the front and rear ends 1036, 1040).

In embodiments in which the air treatment chamber doors 1408 only form part of the lower portion of the sidewall 1084 of the air treatment chamber 1044, the dirt outlet 1052 may be provided through a stationary portion of the sidewall 1084 adjacent the air treatment chamber doors 1408. In such embodiments, the first portion of the perimeter 1078 of the dirt outlet 1052 defined by the first air treatment chamber door 1408a may include a first portion 1436a of the first laterally extending side 1434a. Similarly, the second portion of the perimeter 1078 of the dirt outlet 1052 defined by the second air treatment chamber door 1408b may include a second portion 1436b of the first laterally extending side 1434a. The stationary portion of the sidewall 1084 may thus define the first and second axially extending sides 1432, and the second laterally extending side 1434b of the perimeter 1078 may be defined by the front end wall 1108 (i.e., where the dirt outlet 1052 is at the front end 1036) or the rear end wall 1106 (i.e., where the dirt outlet 1052 is at the rear end 1040).

Accordingly, when a door is opened, the portion of the perimeter 1078 formed by that door moves thereby increasing the size of the dirt outlet 1052. Accordingly, in the embodiment of FIG. 67A, both doors may be opened and the portions of the perimeter 1078 defined by each door move away from each other as the doors are opened thereby increasing the size of the dirt outlet 1052. Therefore, any large debris that may be lodged in the dirt outlet 1052 when the doors are closed may be dislodged and emptied. It will be appreciated that if only one door moves, then the dirt outlet 1052 may still be opened when the door is opened. Accordingly, in any embodiment herein, a door may define only part of the perimeter of the dirt outlet 1052.

For example, in the examples illustrated in FIGS. 67A and 67B, the air treatment chamber doors 1408 form the lower portion of the sidewall 1084 of the air treatment chamber 1044. The dirt outlet 1052 is provided at the rear end 1040 of the air treatment chamber 1044 through the air treatment chamber doors 1408. Accordingly, as shown, the second laterally extending side 1434b of the perimeter 1078 of the dirt outlet 1052 is defined by the rear end wall 1106 of the air treatment chamber 1044. A first portion 1436a of the first laterally extending side 1434a of the perimeter 1078 of the dirt outlet 1052 is defined by the first air treatment chamber door 1408a and a second portion 1436b of the first laterally extending side 1434a of the perimeter 1078 of the dirt outlet 1052 is defined by the second air treatment chamber door 1408b. The first axially extending side 1432a of the perimeter 1078 of the dirt outlet 1052 is defined by the first air treatment chamber door 1408a and the second axially extending side 1432b of the perimeter 1078 of the dirt outlet 1052 is defined by the second air treatment chamber door 1408b.

In the examples illustrated in FIGS. 67C and 67D, the air treatment chamber doors 1408 form a moveable portion of the lower portion of the sidewall 1084 of the air treatment chamber 1044 and the lower portion further includes a stationary portion at the rear end 1040. The dirt outlet 1052 is provided at the rear end 1040 of the air treatment chamber 1044 through the stationary portion of the lower portion of the sidewall 1084. Accordingly, as shown, the second laterally extending side 1434b of the perimeter 1078 of the dirt outlet 1052 is defined by the rear end wall 1106 of the air treatment chamber 1044. The first and second axially extending sides 1432 of the perimeter 1078 of the dirt outlet 1052 are defined by the stationary portion of the lower portion of the sidewall 1084. In the closed position, a rearward edge of the air treatment chamber doors 1408 are adjacent (e.g., abut) the stationary portion such that the air treatment chamber doors 1408 enclose an axially inward end 1438 of the dirt outlet 1052. In this way, a first portion 1436a of the first laterally extending side 1434a of the perimeter 1078 of the dirt outlet 1052 is defined by the first air treatment chamber door 1408a and a second portion 1436b of the first laterally extending side 1434a of the perimeter 1078 of the dirt outlet 1052 is defined by the second air treatment chamber door 1408b.

The dirt outlet 1052 may be any suitable shape. Optionally, the dirt outlet 1052 may be shaped such that the axially inward end 1438 of the dirt outlet 1052 at the first laterally extending side 1434a is narrower than an axially outward end 1440 at the second laterally extending side 1434b. That is, the dirt outlet 1052 may have a width 1442 in the lateral direction, and the width 1442 at the axially inward end 1438 may be narrower than the width 1442 at the axially outward end 1440. In this way, sides 1432, 1434 of the perimeter 1078 that define the shape of the dirt outlet 1052 may form at least two included angles within the shape. Depending on the shape of the dirt outlet 1052, the included angles may include one or more 90° angles, one or more acute angles (e.g., from 30° to 80°, or 45° to) 75°, one or more obtuse angles (e.g., from 120° to 170°, or 135° to) 155°, or a combination thereof. It will be appreciated that a dirt outlet that narrows in the axially inward direction may be used in any air treatment chamber regardless of whether a door forms part of the perimeter of the dirt outlet.

The width 1442 may decrease continuously, linearly or non-linearly, from the axially outward end 1440 to the axially inward end 1438. In embodiments in which the width 1442 decreases linearly, the first and second axially extending sides 1432 of the perimeter 1078 of the dirt outlet 1052 may extend linearly at an angle to the air treatment chamber axis 1050 from the second laterally extending side 1434b to the first laterally extending side 1434a. In embodiments in which the width 1442 decreases non-linearly, the first and second axially extending sides 1432 of the perimeter 1078 of the dirt outlet 1052 may curve laterally inwardly toward each other from the second laterally extending side 1434b to the first laterally extending side 1434a. In this way, the curved first and second axially extending sides 1432 may transition into the first laterally extending side 1434a. The first laterally extending side 1434a may itself be curved continuously with the first and second axially extending sides 1432 such that the dirt outlet 1052 is generally semi-circular, or the first laterally extending side 1434a may extend generally linearly laterally such that the dirt outlet 1052 is generally trapezoidal with rounded ends.

Alternatively, the width 1442 may decrease continuously, linearly or non-linearly, from a location between the first and second laterally extending sides 1434 to the axially inward end 1438. In such embodiments, the first and second axially extending sides 1432 of the perimeter 1078 of the dirt outlet 1052 may extend generally in the forward/rearward direction parallel to the air treatment chamber axis 1050. In embodiments in which the width 1442 decreases linearly, the first and second portions 1436 of the first laterally extending side 1434 of the perimeter 1078 of the dirt outlet 1052 may extend generally in the lateral direction at an angle to each other such that the dirt outlet 1052 is general pentagonal. In embodiments in which the width 1442 decreases non-linearly, the first and second portions 1436 of the first laterally extending side 1434 of the perimeter 1078 of the dirt outlet 1052 may extend generally in the lateral direction and curve laterally inwardly toward each other from the first and second axially extending sides 1432. In this way, the curved first and second portions 1436 of the first laterally extending side 1434a may transition from the first and second axially extending sides 1432 to each other such that the dirt outlet 1052 is generally rectangular with a rounded axially inward end 1438, or the curved first and second portions 1436 of the first laterally extending side 1434a may transition into a generally laterally extending edge such that the dirt outlet 1052 is generally rectangular with two rounded corners at the axially inward end 1438.

For example, in the example illustrated in FIG. 67A, the dirt outlet 1052 is generally pentagonal. Accordingly, the first and second axially extending sides 1432 of the perimeter 1078 of the dirt outlet 1052 extend in the forward/rearward direction generally parallel to the air treatment chamber axis 1050 from the second laterally extending side 1434b to a location between the first and second laterally extending sides 1434. The first and second portions 1436 of the first laterally extending side 1434 of the perimeter 1078 of the dirt outlet 1052 extend generally in the lateral direction at an angle to each other from the first and second axially extending sides 1432. The width 1442 of the dirt outlet 1052 thus decreases continuously linearly from the location between the first and second laterally extending sides 1434 to axially inward end 1438 of the dirt outlet 1052.

In the example illustrated in FIG. 67B, the dirt outlet 1052 is generally rectangular with rounded corners. Accordingly, the first and second axially extending sides 1432 of the perimeter 1078 of the dirt outlet 1052 extend generally in the forward/rearward direction parallel to the air treatment chamber axis 1050 from the second laterally extending side 1434b to a location between the first and second laterally extending sides 1434. The first and second portions 1436 of the first laterally extending side 1434 of the perimeter 1078 of the dirt outlet 1052 extend generally in the lateral direction and curve laterally inwardly toward each other from the first and second axially extending sides 1432 and transition into a generally linear laterally extending edge at the axially inward end 1438. The width 1442 of the dirt outlet 1052 thus decreases continuously non-linearly from the location between the first and second laterally extending sides 1434 to the axially inward end 1438 of the dirt outlet 1052.

In the example illustrated in FIG. 67C, the dirt outlet 1052 is generally trapezoidal. Accordingly, the first and second axially extending sides 1432 of the perimeter 1078 of the dirt outlet 1052 extend generally in the forward/rearward direction at an angle to the air treatment chamber axis 1050 from the second laterally extending side 1434b to the first laterally extending side 1434a at the axially inward end 1438. The width 1442 of the dirt outlet 1052 thus decreases continuously linearly from the second laterally extending side 1434b to the axially inward end 1438 of the dirt outlet 1052.

In the example illustrated in FIG. 67D, the dirt outlet 1052 is generally trapezoidal with rounded ends. Accordingly, the first and second axially extending sides 1432 of the perimeter 1078 of the dirt outlet 1052 extend generally in the forward/rearward direction and curve laterally inwardly toward each other from the second laterally extending side 1434b to the first laterally extending side 1434a at the axially inward end 1438. The width 1442 of the dirt outlet 1052 thus decreases continuously non-linearly from the second laterally extending side 1434b to the axially inward end 1438 of the dirt outlet 1052.

### Magnetically Actuated Air Treatment Assembly Door(s)

In accordance with this aspect of this disclosure, which may be used by itself or in combination with one or more other aspects of this disclosure, a surface cleaner such as the hand vacuum cleaner may have at least one air treatment chamber door and/or dirt collection chamber door that is moveable by a magnetic actuator.

In accordance with this aspect, an air treatment chamber 1044 and/or a dirt collection chamber that is external to an air treatment chamber of any surface cleaner may have any openable portion 1060 as known in the art or as described previously herein. Accordingly, for example, the openable portion 1060 may be at least one air treatment chamber door 1408, such as at least one laterally openable air treatment chamber door 1408. For example, the air treatment chamber 1044 may have one laterally openable air treatment chamber door 1408 or, alternatively, a first laterally openable air treatment chamber door 1408a and a second laterally openable air treatment chamber door 1408b as described previously herein. Each air treatment chamber door 1408 may be moveable between an open position and a closed position.

An air treatment chamber door 1408 may be moved by a magnetic actuator 1454 between the open and closed positions. For example, upon actuation of the magnetic actuator 1454, the air treatment chamber door 1408 may be moved from the closed position to the open position, from the open position to the closed position, or from the open position to the closed position and back to the open position (e.g., after a preset duration, upon completion of an operation, upon user initiation).

The magnetic actuator 1454 may be positioned in or on an exterior surface of the vacuum cleaner. In such embodiments, the magnetic actuator 1454 may be positioned exterior to the air treatment chamber 1044. For example, the magnetic actuator 1454 may be positioned in the hand vacuum cleaner 1000 at a location that is forward of the front end wall 1108 of the air treatment chamber 1044, rearward of the rear end wall 1106 of the air treatment chamber 1044, or radially outward of the sidewall 1084 of the air treatment chamber 1044.

In any such embodiments, the magnetic actuator 1454 may be located such that the magnetic actuator 1454 is in sufficient proximity with the air treatment chamber door 1408 to be operatively linked thereto. Accordingly, one or both of the magnetic actuator 1454 and the door(s) magnetically driven thereby may comprise a magnet. If only one comprises a magnet, then the other comprises a magnetically attractive material, such as iron, nickel, steel and the like. Accordingly moving the magnetic actuator 1454 may move a door(s) that is magnetically coupled to the magnetic actuator 1454. It will be appreciated that the magnet may be a permanent magnet or electromagnet. Alternately, the magnetic actuator 1454 may be an actuator (e.g., a mechanical drive linkage or an electromechanical drive) that moves to move a magnet.

Accordingly, the magnetic actuator 1454 may have an actuator magnet 1456 which, from the exterior of the air treatment chamber 1044, may magnetically couple to an air treatment chamber door magnet 1458 of the air treatment chamber door 1408 whereby the actuator may be operatively (magnetically) linked to the air treatment chamber door 1408. The actuator magnet 1456 and the air treatment chamber door magnet 1458 may be of sufficient strength so as to be magnetically coupled through, e.g., the rear end wall 1086 of the air treatment member 1008, the front end wall 1076 of the air treatment member 1008, or the sidewall 1124 of the dirt collection chamber 1042, depending on the relative location of the magnetic actuator 1454 to the air treatment chamber door 1408 in the hand vacuum cleaner 1000.

It will be appreciated that one or more magnets may be used in each location. Accordingly, a magnetic actuator may comprise one or more magnets 1456 that is magnetically coupled to a door and/or a door may comprise one or more magnets 1456 that is magnetically coupled to a magnetic actuator.

As discussed subsequently, a magnet 1456 may be positioned such that it is mounted in a position in which it is always magnetically coupled, e.g., to a door or it may be moved into position to be magnetically coupled, e.g., as a magnetic actuator is moved to open and/or close a door.

A magnet 1456 may be moved (whether as part of a magnetic actuator and/or as part of a door) such that the part it is magnetically coupled to (whether a magnet or a magnetically attractive material) remain a constant distance apart as the door moves. The magnet 1456 may contact the magnet or a magnetically attractive material that it is magnetically coupled to or maintain a relatively constant gap therebetween.

Optionally, a magnet or a magnetically attractive material are provided in a volume that is separate from a dirty air flow. Therefore, a magnet or a magnetically attractive material may be on an outer surface of the surface cleaner or it may be in an isolated spaced within the surface cleaner.

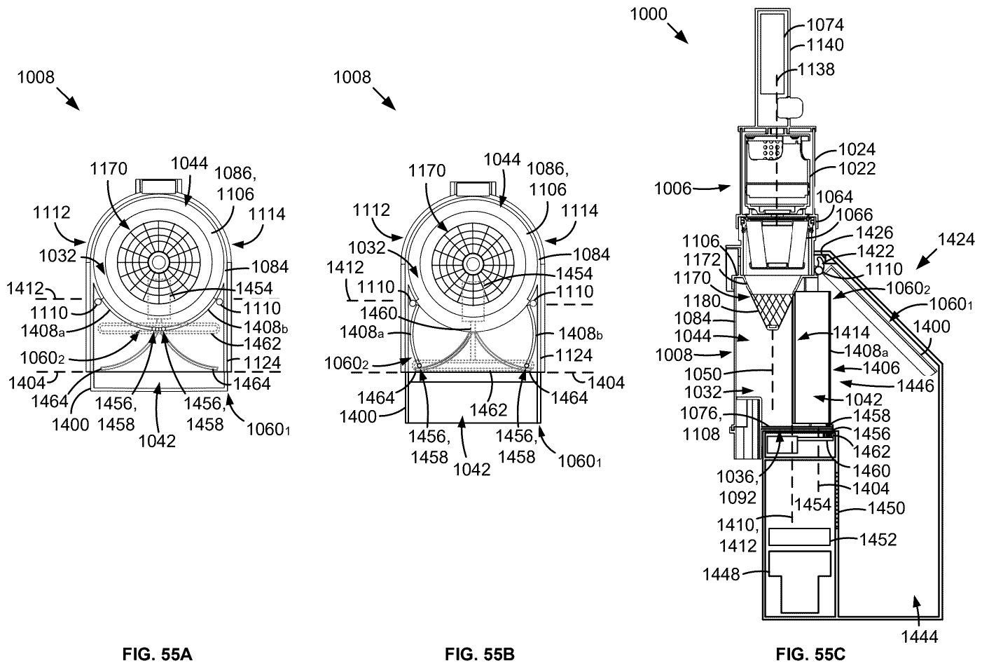

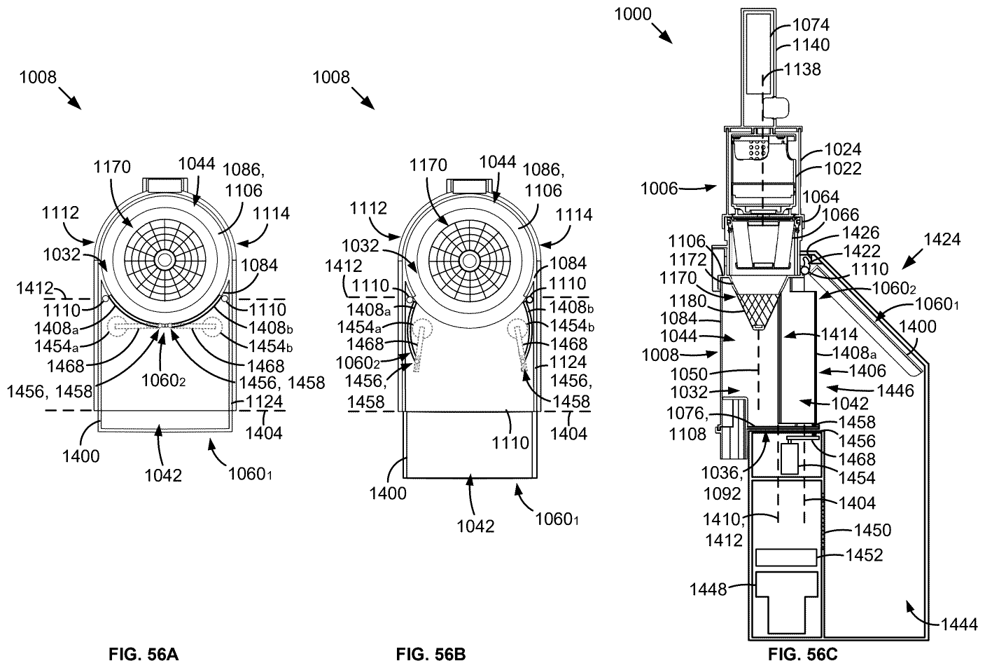

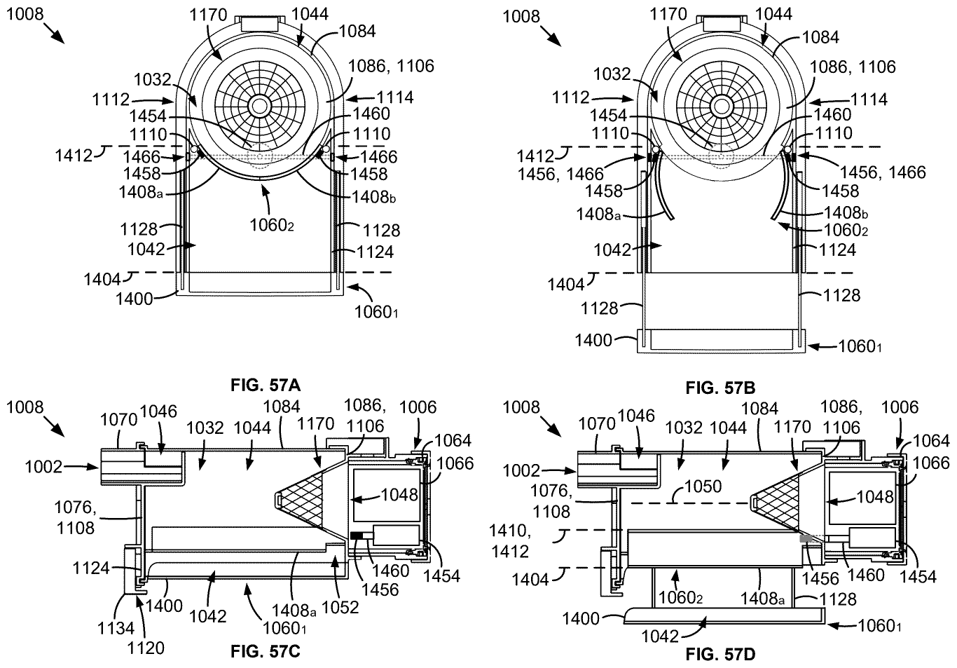

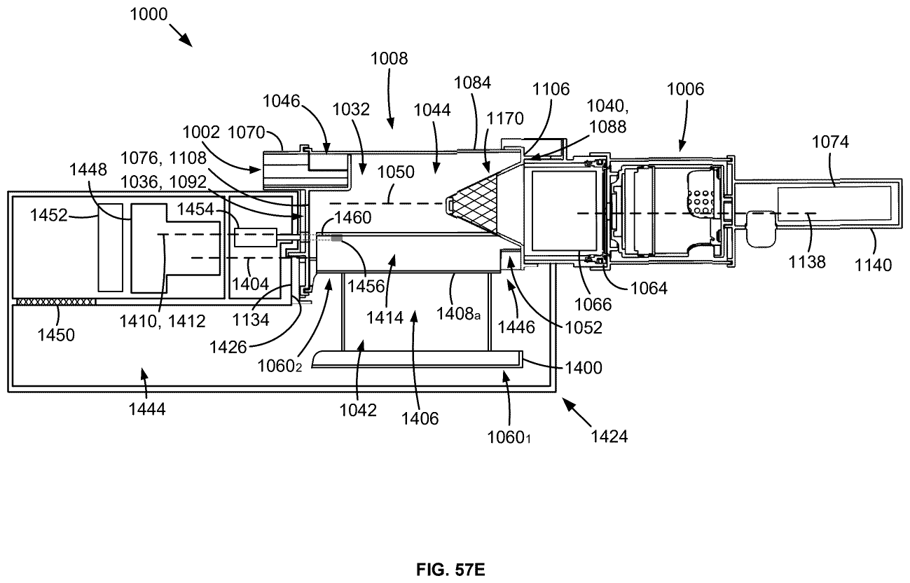

For example, in the examples illustrated in FIGS. 55A-55B, 56A-56B, and 57A-57B, the magnetic actuator 1454 (and associated elements) is shown in phantom. In the position shown, the magnetic actuator 1454 is rearward of the rear end wall 1106 of the air treatment chamber 1044. Accordingly, the air treatment chamber door magnet 1458 of each air treatment chamber door 1408 is located at the rear end 1040 of the air treatment chamber 1044 proximate the rear end wall 1106. In this way, the actuator magnets 1456 may be in, or brought into, sufficient proximity with the air treatment chamber door magnets 1458 to magnetically couple thereto. In the examples illustrated in FIGS. 55A-55B and 56A-56B, the actuator magnets 1456 are also rearward of the rear end wall 1106 of the air treatment chamber 1044. The actuator magnets 1456 thus magnetically couple with the air treatment chamber door magnets 1458 through the rear end wall 1106 of the air treatment chamber 1044. In the example illustrated in FIGS. 57A-57D, the actuator magnets 1456 move into the sidewall 1124 of the dirt collection chamber 1042 radially outward of the air treatment chamber 1044. The actuator magnets 1456 thus magnetically couple with the air treatment chamber door magnets 1458 through the sidewall 1124 of the dirt collection chamber 1042.

Where the air treatment chamber 1044 has first and second air treatment chamber doors 1408, the air treatment chamber doors 1408 may share a common magnetic actuator 1454. In such embodiments, the common magnetic actuator 1454 may be drivingly connected to both air treatment chamber doors 1408, such as by a linkage. Accordingly, the magnetic actuator 1454 may have an actuator magnet 1456 corresponding to each of the first and second air treatment chamber doors 1408. The actuator magnets 1456 may magnetically couple to an air treatment chamber door magnet 1458 of the first air treatment chamber door 1408a and to an air treatment chamber door magnet 1458 of the second air treatment chamber door 1408b, whereby the magnetic actuator 1454 may be operatively linked to the air treatment chamber doors 1408.

For example, in the example illustrated in FIGS. 55A-55B, the air treatment chamber doors 1408 share a common magnetic actuator 1454, shown as a linear actuator. As shown, the magnetic actuator 1454 is drivingly connected to both air treatment chamber doors 1408 by a linkage. The linkage includes a drive rod 1460 connected to a slotted guide rail 1462 in which the actuator magnets 1456 are slidably positioned. Each actuator magnet 1456 is magnetically coupled to an air treatment chamber door magnet 1458 of a respective air treatment chamber door 1408, whereby the magnetic actuator 1454 is operatively linked to both of the air treatment chamber doors 1408. In this configuration, as the magnetic actuator 1454 extends/retracts the drive rod 1460, the actuator magnets 1456 may each be guided along a respective track 1464 in a rearwardly facing side of the rear end wall 1086 of the air treatment member 1008 while sliding within the slotted guide rail 1462. As the actuator magnets 1456 move along the tracks 1464, the magnetically coupled air treatment chamber door magnets 1458 may follow the path of the actuator magnets 1456. In this way, the common magnetic actuator 1454 may move the air treatment chamber doors 1408 between the open and closed positions.

In the example illustrated in FIGS. 57A-57D, the air treatment chamber doors 1408 share a common magnetic actuator 1454, shown as a linear actuator. As shown, the magnetic actuator 1454 has a two-prong drive rod 1460 with an actuator magnet 1456 at a distal end of each prong. As the magnetic actuator 1454 extends/retracts the drive rod 1460, the actuator magnets 1456 may each be inserted/removed from magnet slots 1466 in the sidewall 1124 of the dirt collection chamber 1042 radially outward of the air treatment chamber doors 1408. When inserted into the magnet slots 1466, each actuator magnet 1456 may be magnetically coupled to an air treatment chamber door magnet 1458 of a respective air treatment chamber door 1408. That is, when inserted into the magnet slots 1466, the actuator magnets 1456 may draw the air treatment chamber door magnets 1458 toward the actuator magnets 1456 to magnetically couple thereto. In this way, the common magnetic actuator 1454 may move the air treatment chamber doors 1408 between the open and closed positions.

Alternatively, a magnetic actuator 1454 may be provided for each air treatment chamber door 1408. In such embodiments, an actuator magnet 1456 of a first magnetic actuator 1454a may magnetically couple to an air treatment chamber door magnet 1458 of the first air treatment chamber door 1408a, and an actuator magnet 1456 of a second magnetic actuator 1454b may magnetically couple to an air treatment chamber door magnet 1458 of the second air treatment chamber door 1408b. In this way, the first magnetic actuator 1454a may be operatively linked to the first air treatment chamber door 1408a and the second magnetic actuator 1454b may be operatively linked to the second air treatment chamber door 1408b. Both magnetic actuators may be operated (e.g., manually operated) concurrently.

For example, in the example illustrated in FIGS. 56A-56B, the air treatment chamber doors 1408 each have a magnetic actuator 1454, shown as a rotary actuator. As shown, each magnetic actuator 1454 is drivingly connected to a respective air treatment chamber door 1408 by an output arm 1468 with an actuator magnet 1456 at a distal end of the output arm 1468. The actuator magnets 1456 are magnetically coupled to an air treatment chamber door magnet 1458 of the respective air treatment chamber door 1408, whereby each magnetic actuator 1454 is operatively linked to the respective air treatment chamber door 1408. In this configuration, as the magnetic actuators 1454 rotate the output arm 1468, the actuator magnets 1456 may rotate along an arced path. As the actuator magnets 1456 rotate, the magnetically coupled air treatment chamber door magnets 1458 may follow the path of the actuator magnets 1456. In this way, each magnetic actuator 1454 may move the respective air treatment chamber door 1408 between the open and closed positions.

The actuator magnet 1456 may be magnetically coupled to the air treatment chamber door magnet 1458 while the air treatment chamber door 1408 is moved by the magnetic actuator 1454 between the open and closed positions. For example, the actuator magnet 1456 may be magnetically coupled to the air treatment chamber door magnet 1458 while the air treatment chamber door 1408 is moved by the magnetic actuator 1454 from the closed position to the open position, from the open position to the closed position, or from the open position to the closed position and back to the open position. In embodiments in which the actuator magnet 1456 is only magnetically coupled to the air treatment chamber door magnet 1458 or magnetically attractive material when the air treatment chamber door 1408 is moved to one of the open position and the closed position, the actuator magnet 1456 and the air treatment chamber door magnet 1458 may be magnetically decoupled prior to the air treatment chamber door 1408 moving to the other of the open position and the closed position. In such embodiments, the air treatment chamber door 1408 or a member that is drivingly connected to the door may be, e.g., biased to one position.

For example, the air treatment chamber door 1408 or a member that is drivingly connected to the door (e.g., a dirt collection chamber door) may be biased to the closed position (e.g., by a torsion spring or other suitable biasing means) such that, when the actuator magnet 1456 and the air treatment chamber door magnet 1458 are magnetically decoupled at the open position, the bias may automatically move the air treatment chamber door 1408 to the closed position. The actuator magnet 1456 and the air treatment chamber door magnet 1458 may thus be magnetically coupled at the closed position prior to the magnetic actuator 1454 moving the air treatment chamber door 1408, against the biasing force of the bias, to the open position. The magnetic actuator 1454 and actuator magnet 1456 may hold the air treatment chamber door 1408 at the open position (e.g., for a preset duration, until completion of an operation, or any other suitable prompt). The actuator magnet 1456 and the air treatment chamber door magnet 1458 may be subsequently magnetically decoupled (e.g., moved away from) to permit the bias to return the air treatment chamber door 1408 to the closed position.

Conversely, the air treatment chamber door 1408 may be biased to the open position such that, when the actuator magnet 1456 and the air treatment chamber door magnet 1458 are magnetically decoupled at the closed position, the bias may automatically move the air treatment chamber door 1408 to the open position. The actuator magnet 1456 and the air treatment chamber door magnet 1458 may thus be magnetically coupled at the closed position. The magnetic actuator 1454 and actuator magnet 1456 may hold the air treatment chamber door 1408 at the closed position (e.g., until initiation of an emptying operation). The actuator magnet 1456 and the air treatment chamber door magnet 1458 may, upon some external initiation (e.g., docking to a docking station or user activated button which moves a magnet or magnetically attractive material), be magnetically decoupled (e.g., moved away from) to permit the bias to move the air treatment chamber door 1408 to the open position. The actuator magnet 1456 and the air treatment chamber door magnet 1458 may be subsequently magnetically coupled and the magnetic actuator 1454 may return the air treatment chamber door 1408, against the biasing force of the bias, to the closed position.

For example, in the examples illustrated in FIGS. 55A-55B and 56A-56B, the actuator magnets 1456 are magnetically coupled to the air treatment chamber door magnets 1458 while the air treatment chamber door 1408 is moved by the magnetic actuator 1454 from the closed position to the open position and back to the closed position. Optionally, the air treatment chamber doors 1408 may be biased to the closed position such that, if an actuator magnet 1456 becomes decoupled from an air treatment chamber door magnet 1458 for any reason, the air treatment chamber door 1408 may return to the closed position. Upon returning the actuator magnet 1456 to a position corresponding to the closed position of the air treatment chamber door 1408, the actuator magnet 1456 may again magnetically couple to the air treatment chamber door magnet 1458.

In the example illustrated in FIGS. 57A-57D, the actuator magnets 1456 are magnetically coupled to the air treatment chamber door magnets 1458 in the open position only. That is, when inserted into the magnet slots 1466, each actuator magnet 1456 may magnetically attract an air treatment chamber door magnet 1458 of a respective air treatment chamber door 1408 to draw the air treatment chamber doors 1408 from the closed position to the open position. The air treatment chamber doors 1408 may be biased to the closed position such that the magnetic attraction must overcome the biasing force of the biases to move the air treatment chamber doors 1408 to the open position. When the actuator magnets 1456 are retracted from the magnet slots 1466 and removed from proximity with the air treatment chamber door magnets 1458, the magnets 1456, 1458 may be magnetically decoupled allowing the biases to return the air treatment chamber doors 1408 to the closed position.

Optionally, the air treatment chamber doors 1408 may be biased to the open position. In such alternate embodiments, when inserted into the magnet slots 1466, each actuator magnet 1456 may magnetically repel an air treatment chamber door magnet 1458 of a respective air treatment chamber door 1408 to push the air treatment chamber doors 1408 from the open position to the closed position against the biasing force of the biases. When the actuator magnets 1456 are retracted from the magnet slots 1466 and removed from proximity with the air treatment chamber door magnets 1458, the repelling force may be removed allowing the biases to return the air treatment chamber doors 1408 to the open position.

A surface cleaner, such as a hand vacuum cleaner 1000 configured in accordance with the examples illustrated in FIGS. 55A-55B, 56A-56B, and 57A-57D may be used in combination with a docking station 1424. In such embodiments, the magnetic actuator 1454 may automatically actuate upon docking the surface cleaner to the docking station 1424. For example, the docking station 1424 may have an engagement member which, as or once the surface cleaner is docked, engages a button, switch, or the like that activates each magnetic actuator 1454 of the hand vacuum cleaner 1000. The engagement member may also be electrical contacts corresponding to contacts of the surface cleaner such that, once the surface cleaner is docked, the contacts communicatively couple the docking station 1424 and the surface cleaner to send a signal to each magnetic actuator 1454 to activate.

For example, in the examples shown in FIGS. 55C and 56C, the dirt collection chamber door 1400 has a rocker arm 1422 (as described in a previous section) operable to move the dirt collection chamber door 1400 from the closed position to the open position. The rocker arm 1422 may be a magnetic actuator 1454 having a magnet 1456 and the dirt collection chamber door 1400 may have a magnet or magnetically attractive material. The dirt collection chamber door 1400 may be biased to the closed position. As shown, the docking station 1424 has an engagement member, shown as abutment surface 1426. The abutment surface 1426 is positioned such that, as the hand vacuum cleaner 1000 is docked to the docking station 1424, the abutment surface 1426 engages the rocker arm 1422 whereby the dirt collection chamber door 1400 may be driven to the open position. Optionally, the rocker arm 1422 may be operatively connected to a magnetic actuator 1454. For example, if the magnetic actuator(s) 1454 are positioned in the hand vacuum cleaner 1000 (e.g., a linear actuator), the rocker arm 1422 may also be a switch that controls the magnetic actuator(s) 1454. In such embodiments, when the rocker arm 1422 is rotated or moved, it may actuate an electro-mechanical member to move the dirt collection chamber door 1400 to the open position. Alternately, if the air treatment chamber door 1408 is magnetically actuated, then when the rocker arm 1422 is rotated, e.g., to move the dirt collection chamber door 1400 to the open position (e.g., by a magnetic or mechanical drive linkage), the switch may send a signal to the magnetic actuator(s) 1454 to similarly move each air treatment chamber door 1408 to the open position. The reverse may be true when the rocker arm 1422 is rotated to move the dirt collection chamber door 1400 to the closed position, such as when the hand vacuum cleaner 1000 is removed from the docking station 1424. Accordingly, in such embodiments, docking the hand vacuum cleaner 1000 may automatically passively move the dirt collection chamber door 1400 to the open position and cause the air treatment chamber doors 1408 to be moved to the open position by the magnetic actuators 1454. Removing the hand vacuum cleaner 1000 may automatically passively move the dirt collection chamber door 1400 to the closed position and cause the air treatment chamber doors 1408 to be moved to the closed position by the magnetic actuators 1454.

It will be appreciated that docking the hand vacuum cleaner 1000 may move one or both of the dirt collection chamber door(s) 1400 and the air treatment chamber door(s) 1408 to the open position using magnetic coupling and removing (undocking) the hand vacuum cleaner 1000 may move one or both of the dirt collection chamber door(s) 1400 and the air treatment chamber door(s) 1408 to the closed position using magnetic coupling. Alternately, if one of the dirt collection chamber door(s) 1400 and the air treatment chamber door(s) 1408 is moved using magnetic coupling, then the other of the dirt collection chamber door(s) 1400 and the air treatment chamber door(s) 1408 may be driven by the one that is magnetically coupled or by an independent actuator that is actuated upon docking and/or undocking.

In the example illustrated in FIG. 57E, the dirt collection chamber door 1400 is unbiased and held in the closed position by a latch actuator, shown as a button 1134. When the button 1134 is depressed, the dirt collection chamber door 1400 may be released and may fall under the influence of gravity to the open position. As shown, the docking station 1424 has an engagement member, shown as abutment surface 1426. The abutment surface 1426 is positioned such that, as the hand vacuum cleaner 1000 is docked to the docking station 1424, the abutment surface 1426 engages the button 1134, thereby releasing the dirt collection chamber door 1400. Optionally, if the magnetic actuator(s) 1454 are positioned in the hand vacuum cleaner 1000, the button 1134 may also be a switch that controls the magnetic actuator(s) 1454. In such embodiments, when the button 1134 is depressed to release the dirt collection chamber door 1400, the switch may send a signal to the magnetic actuator(s) 1454 to similarly move each air treatment chamber door 1408 to the open position. The reverse may be true when the button 1134 is released, such as when the hand vacuum cleaner 1000 is removed from the docking station 1424. Accordingly, in such embodiments, docking the hand vacuum cleaner 1000 may automatically passively move the dirt collection chamber door 1400 to the open position and cause the air treatment chamber doors 1408 to be moved to the open position by the magnetic actuators 1454. Removing the hand vacuum cleaner 1000 may cause the air treatment chamber doors 1408 to be moved to the closed position by the magnetic actuators 1454.

In alternate embodiments, or in addition to the magnetic actuator(s) 1454 positioned in the hand vacuum cleaner 1000, the docking station 1424 may include one or more magnetic actuators 1454. In such embodiments, the magnetic actuator(s) 1454 may be located in the docking station 1424 such that, when the hand vacuum cleaner 1000 is docked to the docking station 1424, each magnetic actuator 1454 is brought into sufficient proximity with the air treatment chamber door magnet 1458 of a respective air treatment chamber door 1408 to magnetically couple thereto and thereby be operatively linked to the air treatment chamber door 1408. The magnetic actuator(s) 1454 of the docking station 1424 may be configured to move the air treatment chamber doors 1408 in any manner and using any configuration as described in accordance with the examples illustrated in FIGS. 55A-55B, 56A-56B, and 57A-57D.

For example, in the examples illustrated in FIGS. 55C, 56C, and 57E, the magnetic actuator(s) 1454 positioned in the hand vacuum cleaner 1000 have been omitted. Instead, the docking station 1424 includes the magnetic actuator(s) 1454. The magnetic actuator(s) 1454 are provided, e.g., near the station inlet port 1446 at a surface that abuts front end wall 1076 of the air treatment member 1008. The air treatment chamber door magnet 1458 of each air treatment chamber door 1408 is thus located at the front end 1036 of the air treatment chamber 1044 proximate the front end wall 1108. In this way, the actuator magnets 1456 may be in, or brought into, sufficient proximity with the air treatment chamber door magnets 1458 to magnetically couple thereto when the hand vacuum cleaner 1000 is docked to the docking station 1424.

As shown, the magnetic actuator(s) 1454 are configured as described with respect to the corresponding Figures. That is, the magnetic actuator 1454 of the docking station 1424 of FIG. 55C is configured as described with respect to that of the hand vacuum cleaner 1000 of FIGS. 55A-55B. The magnetic actuators 1454 of the docking station 1424 of FIG. 56C are configured as described with respect to those of the hand vacuum cleaner 1000 of FIGS. 56A-56B. The magnetic actuator 1454 of the docking station 1424 of FIG. 57E is configured as described with respect to that of the hand vacuum cleaner 1000 of FIGS. 57A-57D. Each prong of the two-prong drive rod 1460 with the actuator magnets 1456 may each be inserted into/removed from the magnet slots 1466 in the sidewall 1124 of the dirt collection chamber 1042 through opening in the front end wall 1076 of the air treatment member 1008.

The magnetic actuator(s) 1454 of the docking station 1424 may automatically actuate upon docking the hand vacuum cleaner 1000 to the docking station 1424. For example, the hand vacuum cleaner 1000 may have an engagement member which, as or once the hand vacuum cleaner 1000 is docked, engages a button, switch, or the like that activates each magnetic actuator 1454 of the docking station 1424. The engagement member may also be contacts corresponding to contacts of the docking station 1424 such that, once the hand vacuum cleaner 1000 is docked, the contacts communicatively couple the docking station 1424 and the hand vacuum cleaner 1000 to send a signal to each magnetic actuator 1454 to activate. Optionally, the actuator magnets 1456 may themselves be a sensor which, upon magnetically coupling to an air treatment chamber door magnet 1458, sends a signal to the corresponding magnetic actuator 1454 to activate.

Operation of the magnetic actuator(s) 1454 of the docking stations 1424 in FIGS. 55C, 56C, and 57E to move the air treatment chamber doors 1408 between the open and closed positions may be similar as described with respect to the magnetic actuator(s) 1454 of corresponding the hand vacuum cleaner 1000 and is therefore omitted for brevity.

Whether the magnetic actuator(s) 1454 are those of the hand vacuum cleaner 1000 or of the docking station 1424, each magnetic actuator 1454 may be actuated to move the air treatment chamber door(s) 1408 to the open position before an emptying operation in a docking mode in which dirt from the dirt collection chamber 1042 and air treatment chamber 1044 is transferred to into the receptacle 1444 of the docking station 1424. As described previously, each magnetic actuator 1454 may be actuated as or once the hand vacuum cleaner 1000 is docked. After the emptying operation, each magnetic actuator 1454 may be actuated to move the air treatment chamber door(s) 1408 to the closed position. As described previously, each magnetic actuator 1454 may be actuated before or as the hand vacuum cleaner 1000 is removed from the docking station 1424.

### Gear Actuated Air Treatment Assembly Door(s)

In accordance with this aspect of this disclosure, which may be used by itself or in combination with one or more other aspects of this disclosure, a surface cleaner such as the hand vacuum cleaner may have at least one air treatment chamber door and/or dirt collection chamber door that is moveable by a gear transmission.

In accordance with this aspect, a surface cleaner may have one or more dirt collection chamber doors for a dirt collection chamber that is external to an air treatment chamber. The dirt collection chamber door(s) may be openable in any manner known in the art. The dirt collection chamber door(s) are located internal of an air treatment assembly and may overlie the dirt collection chamber door(s). One or more of the dirt collection chamber doors may be drivingly connected to one or more air treatment chamber doors whereby movement (e.g., opening and/or closing) of the dirt collection chamber door(s) drives movement of the air treatment chamber door(s).

It will be appreciated that one or both of the dirt collection chamber door(s) and air treatment chamber door(s) may be biased to the open or the closed position. Therefore, this biasing force may drive the or assist in moving the dirt collection chamber door(s) and air treatment chamber door(s) to the open or the closed position.

An air treatment chamber 1044 in accordance with this aspect may have any openable portion 1060 as described previously herein. Accordingly, the openable portion 1060 may be at least one air treatment chamber door 1408, such as at least one laterally openable air treatment chamber door 1408 or at least one dirt collection chamber door, such as at least one laterally openable door. For example, the air treatment chamber 1044 may have one laterally openable air treatment chamber door 1408 or, alternatively, a first laterally openable air treatment chamber door 1408a and a second laterally openable air treatment chamber door 1408b as described previously herein. Each air treatment chamber door 1408 may be moveable between an open position and a closed position.

An air treatment chamber door(s) 1408 may be moved by a transmission 1470 between the open and closed positions. The transmission 1470 may include at least one gear 1472 and may be actuated by an actuator. The at least one gear 1472 may be drivingly connected to the air treatment chamber door 1408 such that, upon actuation by the actuator, the transmission 1470 may move the air treatment chamber door 1408 between the open position and the closed position. For example, upon actuation of the transmission 1470, the air treatment chamber door 1408 may be moved from the closed position to the open position, from the open position to the closed position, or from the open position to the closed position and back to the open position (e.g., after a preset duration, upon completion of an operation, upon user initiation). It will be appreciated that the transmission 1470 may be drivingly connected to one or more air treatment chamber doors and/or one or more dirt collection chamber doors.

Where the air treatment chamber 1044 has first and second air treatment chamber doors 1408, the transmission 1470 may include at least two gears actuated by the actuator. That is, the transmission 1470 may include at least a first gear 1472a that is drivingly connected to the first air treatment chamber door 1408a and at least a second gear 1472b that is drivingly connected to the second air treatment chamber door 1408b. In this way, upon actuation by the actuator, the transmission 1470 may move the first and second air treatment chamber doors 1408, optionally concurrently, between the open position and the closed position. Where the air treatment chamber doors 1408 are laterally openable, the transmission 1470 may move the first and second air treatment chamber doors 1408 in opposite directions.

In some embodiments, the transmission 1470 may comprise a rack and pinion. In such embodiments, the first and second gears 1472 may be the pinions driven by the rack(s) 1474. The transmission may include a single rack 1474 drivingly connected to both the first and second gears 1472 or, alternatively, a first rack 1474a and a second rack 1474b respectively drivingly connected to the first and second gears 1472. The rack and pinion transmission 1470 may be actuated by any suitable actuator. The actuator may cause the rack(s) 1474 to translate whereby the rack(s) 1474 may drive the first and second gears 1472 to rotate.

For example, in the example illustrated in FIGS. 37-38, the transmission 1470 includes a single rack 1474 drivingly connected to both the first and second gears 1472. The rack and pinion transmission 1470 may be actuated by a button 1134, which is connected to the rack 1474. As shown, the rack 1474 is biased by a bias 1475, shown as a spring, to hold the button 1134 in an undepressed state (see e.g., FIGS. 37F and 38A). The button 1134 may be pushed, against the biasing force of the bias 1475, to a depressed state (see e.g., FIGS. 37D and 38B). As shown, the rack 1474 may be translatable with the button 1134 between the undepressed state and the depressed state. As the rack 1474 translates, the rack 1474 may drive the pinions 1472 (i.e., the first and second gears) to rotate. The first and second gears 1472 may then drive the first and second air treatment chamber doors 1408 to rotate from the closed position (see e.g., FIGS. 37F and 38A) to the open position (see e.g., FIGS. 37D and 38B) via a gear train. It will be appreciated that any rack and pinion transmission and actuator may be used and it may be biased to move in one direction.

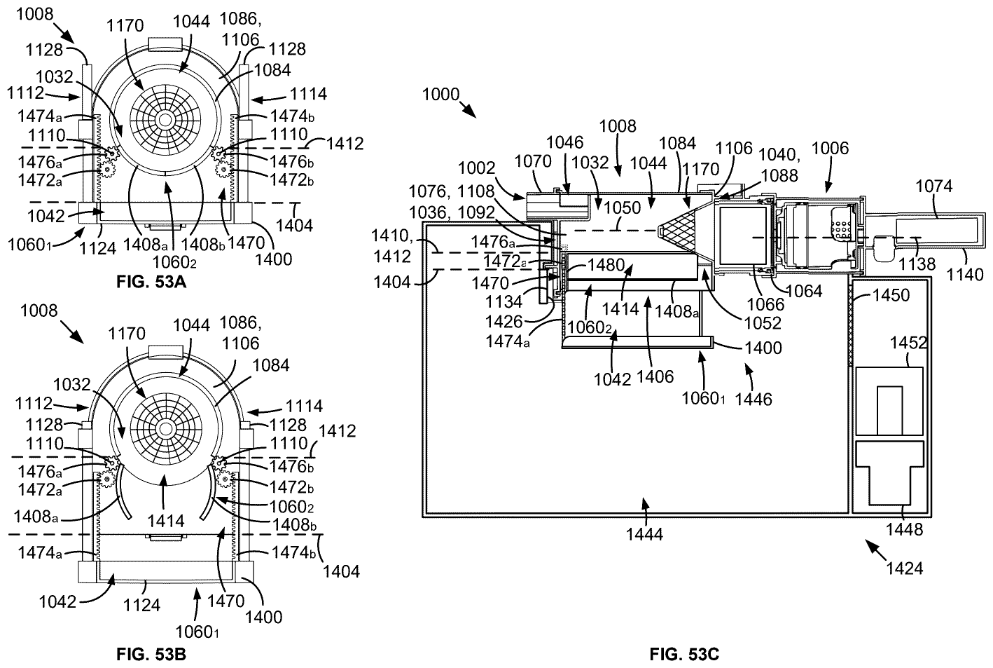

In the example illustrated in FIGS. 53A-53B, the transmission 1470 includes a first rack 1474a drivingly connected to the first gear 1472a and a second rack 1474b drivingly connected to the second gear 1474b. The rack and pinion transmission 1470 may be actuated by actuating the dirt collection chamber door 1400. As shown, the dirt collection chamber door 1400 is translatable along rails 1128. The first and second racks 1474 may be translatable with the dirt collection chamber door 1400 between a closed position (see e.g., FIG. 53A) and an open position (see e.g., FIG. 53B). As the racks 1474 translate, the racks 1474 may drive the pinions 1472 (i.e., the first and second gears) to rotate. The first and second gears 1472 may then drive the first and second air treatment chamber doors 1408 to rotate from the closed position (see e.g., FIG. 53A) to the open position (see e.g., FIG. 53B) via a gear train.

As shown in the examples illustrated in FIGS. 38A-38B and 53A-53B, each gear train may include a hinge gear 1476 drivingly connected to the hinge 1110 of the corresponding air treatment chamber door 1408. In this way, as the first and second racks 1474 translate, the racks 1474 may drive rotation of the first and second gears 1472, which in turn may drive rotation of the first and second hinge gears 1476. The first and second hinge gears 1476 may then drive rotation of the hinges 1110 and thereby drive rotation of the corresponding first and second air treatment chamber doors 1408.

In some embodiments, the transmission 1470 may include a worm gear 1478. In such embodiments, the first and second gears 1472 may be driven by the worm gear 1478. The transmission 1470 may include a single worm 1478 gear drivingly connected to both the first and second gears 1472 or, alternatively, a first worm gear 1478a and a second worm gear 1478b respectively drivingly connected to the first and second gears 1472. The worm gear transmission 1470 may be actuated by any suitable actuator. The actuator may cause the worm gear 1478 to rotate whereby the worm gear 1478 may drive the first and second gears 1472 to rotate.

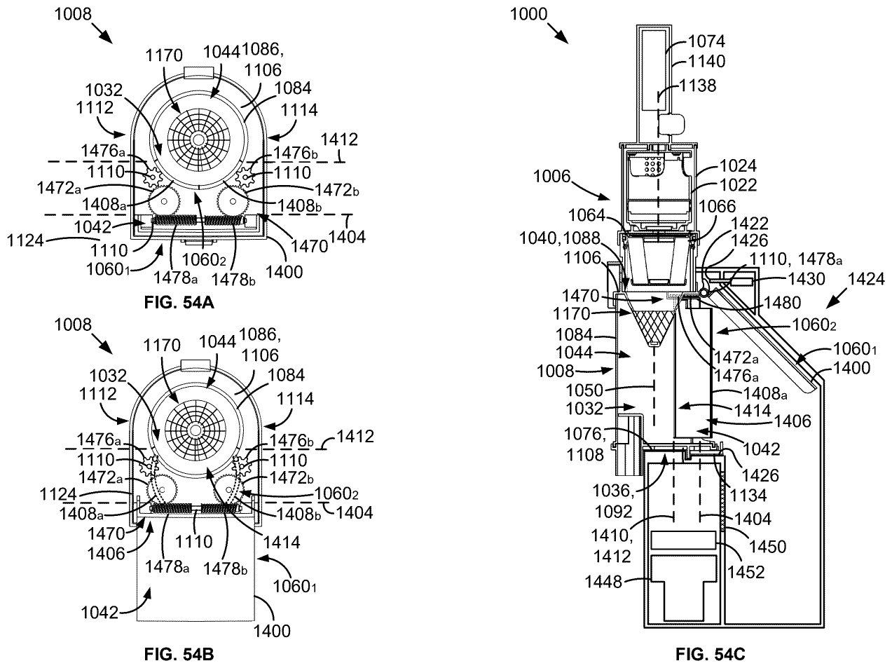

For example, in the example illustrated in FIGS. 54A-54B, the transmission 1470 includes a first worm gear 1478a drivingly connected to the first gear 1472a and a second worm gear 1478b drivingly connected to the second gear 1478b. The worm gear transmission 1470 may be actuated by actuating the dirt collection chamber door 1400. As shown, the dirt collection chamber door 1400 is rotatable about hinge 1110. The hinge 1110 includes the worm gears 1478 such that they may be rotatable with the hinge 1110 as the dirt collection chamber door 1400 is rotated between a closed position (see e.g., FIG. 54A) and an open position (see e.g., FIG. 54B). As the worm gears 1478 rotate, the worm gears 1478 may drive the first and second gears 1472 to rotate. The first and second gears 1472 may then drive the first and second air treatment chamber doors 1408 to rotate from the closed position (see e.g., FIG. 54A) to the open position (see e.g., FIG. 54B) via a gear train. As shown, each gear train may include a hinge gear 1476 drivingly connected to the hinge 1110 of the corresponding air treatment chamber door 1408. In this way, as the first and second worm gears 1478 rotate, the worm gears 1478 may drive rotation of the first and second gears 1472, which in turn may drive rotation of the first and second hinge gears 1476. The first and second hinge gears 1476 may then drive rotation of the hinges 1110 and thereby drive rotation of the corresponding first and second air treatment chamber doors 1408.

In any embodiment, the transmission 1470 may be automatically actuated by docking the hand vacuum cleaner 1000 to a docking station 1424. In such embodiments, the docking station 1424 may have an engagement member which, as or once the hand vacuum cleaner 1000 is docked, engages a button, switch, or the like, thereby actuating the transmission 1470.

For example, in the example illustrated in FIGS. 39A-39B, the hand vacuum cleaner 1000 has the transmission 1470 of FIGS. 38A-38B. As described previously, the transmission 1470 is biased by a bias 1475 to hold the air treatment chamber doors 1408 in the closed position and to hold the actuator, shown as a button 1134, in the undepressed state. As shown, the docking station 1424 has an engagement member, shown as abutment surface 1426. The abutment surface 1426 is positioned such that, as the hand vacuum cleaner 1000 is docked to the docking station 1424, the abutment surface 1426 engages the button 1134, thereby translating the rack 1474 with the button 1134 to the depressed state and driving the air treatment chamber doors 1408 to the open position. Removing the hand vacuum cleaner 1000 from the docking station 1424 may disengage the abutment surface 1426 from the button 1134, allowing the bias 1475 to translate the rack 1474 and button 1134 back to the undepressed state and thereby return the air treatment chamber doors 1408 to the closed position.

In the example illustrated in FIG. 53C, the hand vacuum cleaner 1000 has the transmission 1470 of FIGS. 53A-53B. As described previously, the transmission 1470 is actuated by translating the dirt collection chamber door 1400, which concurrently translates the racks 1474 and thereby drives the air treatment chamber doors 1408. As shown, the dirt collection chamber door 1400 is unbiased and held in the closed position by a latch actuator, shown as a button 1134, which is thus also the actuator of the transmission 1470. When the button 1134 is depressed, the dirt collection chamber door 1400 may be released and may fall under the influence of gravity to the open position. As shown, the docking station 1424 has an engagement member, shown as abutment surface 1426. The abutment surface 1426 is positioned such that, as the hand vacuum cleaner 1000 is docked to the docking station 1424, the abutment surface 1426 engages the button 1134, thereby releasing the dirt collection chamber door 1400. Accordingly, docking the hand vacuum cleaner 1000 to the docking station 1424 may allow the dirt collection chamber door 1400 to move to the open position and thereby drive the air treatment chamber doors 1408 to the open position via the transmission 1470. After removing the hand vacuum cleaner 1000 from the docking station 1424, the user may push the dirt collection chamber door 1400 to the closed position at which it may be caught by the latch actuator. Pushing the dirt collection chamber door 1400 to the closed position may thereby return the air treatment chamber doors 1408 to the closed position via the transmission 1470.

In the example illustrated in FIG. 54C, the hand vacuum cleaner 1000 has the transmission 1470 of FIGS. 54A-54B. As described previously, the transmission 1470 is actuated by rotating the dirt collection chamber door 1400, which concurrently rotates the worm gears 1478 and thereby drives the air treatment chamber doors 1408. As shown, the dirt collection chamber door 1400 has an actuator, shown as a rocker arm 1422, which is thus also the actuator of the transmission 1470. As shown, the docking station 1424 has an engagement member, shown as abutment surface 1426 of the linear actuator 1430 of the docking station 1424. Once docked, the linear actuator 1430 may be activated by any means described previously herein (e.g., by a user or by a sensor detecting the hand vacuum cleaner has been docked). The abutment surface 1426 of the linear actuator 1430 may engage the rocker arm 1422 and drive the rocker arm 1422 to open the dirt collection chamber door 1400. Accordingly, once the hand vacuum cleaner 1000 is docked to the docking station 1424, the linear actuator 1430 may drive the dirt collection chamber door 1400 to the open position and thereby rotate the worm gears 1478 with the hinge 1110 and drive the air treatment chamber doors 1408 to the open position. The dirt collection chamber door 1400 may be biased to the closed position such that disengaging the abutment surface 1426 of the linear actuator 1430 may permit the dirt collection chamber door 1400 to return to the closed position at which it may be caught by the latch actuator. In rotating back to the closed position, the dirt collection chamber door 1400 may thereby also return the air treatment chamber doors 1408 to the closed position via the transmission 1470.

The transmission 1470 may be positioned in a transmission housing 1480 in the hand vacuum cleaner 1000. The transmission housing 1480 may house at least part of the transmission 1470. The transmission housing 1480 may house the at least part of the transmission 1470 at any suitable location exterior to the air treatment chamber 1044. For example, the transmission 1470 may be positioned in the transmission housing 1480 at the front end 1036 of the air treatment chamber 1044 or at the rear end 1040 of the air treatment chamber 1044. The transmission 1470 may be at least partially forward or at least partially rearward of the air treatment chamber 1044. The transmission 1470 may further be at least partially radially outward of the sidewall 1084 of the air treatment chamber 1044, such as at least partially in the dirt collection chamber 1042. In such embodiments, at a wall of the transmission housing 1480 may define a wall of the dirt collection chamber 1042.

For example, in the example illustrated in FIGS. 37-39, the transmission 1470 is located in the transmission housing 1480 rearward of the rear end 1088 of the air treatment member 1008. In the example illustrated in FIGS. 53A-53C, the transmission 1470 is located in the transmission housing 1480 at the front end 1036 of the air treatment chamber 1044. As shown, the transmission 1470 is radially outward of the sidewall 1084 of the air treatment chamber 1044 and forward of the dirt collection chamber 1042. A rear end wall of the transmission housing 1480 thus forms a front end wall of the dirt collection chamber 1042. Similarly, in the example illustrated in FIGS. 54A-54C, the transmission 1470 is located in the transmission housing 1480 at the rear end 1040 of the air treatment chamber 1044. As shown, the transmission 1470 is radially outward of the sidewall 1084 of the air treatment chamber 1044 and rearward of the dirt collection chamber 1042. A front end wall of the transmission housing 1480 thus forms a rear end wall of the dirt collection chamber 1042. Accordingly, the operating components (e.g., gears) of the transmission may be provided in a volume that is isolated from dirt flowing through or collected in the surface cleaner.

It will be appreciated that the transmissions 1470 described in this section may alternatively be actuated by any mechanical or electro-mechanical actuator, for example, one or more rotary actuators, linear actuators, solenoid or stepper motor. In such embodiments, the rotary actuator(s) may drive rotation of the gears (e.g., 1472, 1476, 1478) of the transmission 1470. Additionally, similar to as described in the previous section, such rotary actuators may be those of the hand vacuum cleaner 1000 and/or of the docking station 1424.

### Air Treatment Chamber Door(s) Actuated by Dirt Collection Chamber Door

In accordance with this aspect of this disclosure, which may be used by itself or in combination with one or more other aspects of this disclosure, a surface cleaner such as the hand vacuum cleaner may have a dirt collection chamber door drivingly connected to at least one air treatment chamber door.

The air treatment member 1008 may have a first openable portion 1060₁ and a second openable portion 1060₂. The first openable portion 1060₁ may be a dirt collection chamber door 1400. The second openable portion 1060₂ may be at least one air treatment chamber door 1408.

The air treatment chamber door(s) 1408 may be configured any way described previously herein. For example, each air treatment chamber door 1408 may be rotatably mounted by a hinge 1110 about an air treatment chamber opening axis 1410 that is parallel to the air treatment chamber axis 1050. In this way, when the air treatment chamber door 1408 is moved between the closed position and the open position, the air treatment chamber door 1408 may move in the lateral direction. Where the second openable portion 1060₂ includes a first air treatment chamber door 1408a and a second air treatment chamber door 1408b, the first air treatment chamber door 1408a may move in a first lateral direction from the closed position to the open position and the second air treatment chamber door 1408b may move in a second lateral direction from the closed position to the open position.

The second lateral direction may be opposite the first lateral direction. In this way, when the first and second air treatment chamber doors 1408 are moved from their respective closed positions to their respective open positions, the first and second air treatment chamber doors 1408 may move laterally away from each other. Conversely, when the first and second air treatment chamber doors 1408 are moved from their respective open positions to their respective closed positions, the first and second air treatment chamber doors 1408 may move laterally toward each other.

When the air treatment chamber axis 1050 extends horizontally and the dirty air inlet 1002 is at the upper end 1018 of the hand vacuum cleaner 1000, each air treatment chamber opening axis 1410 may extend in the horizontal air treatment chamber emptying plane 1412. Where the air treatment member 1008 has first and second laterally openable air treatment chamber doors 1408, the air treatment chamber opening axes 1410 may be laterally spaced apart across the air treatment chamber 1044 and may both extend in the air treatment chamber emptying plane 1412.

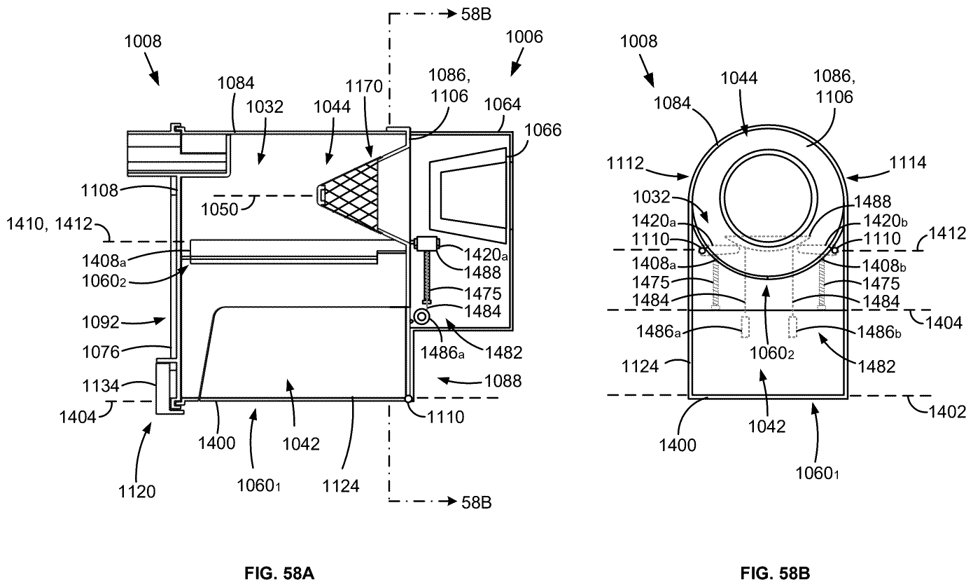

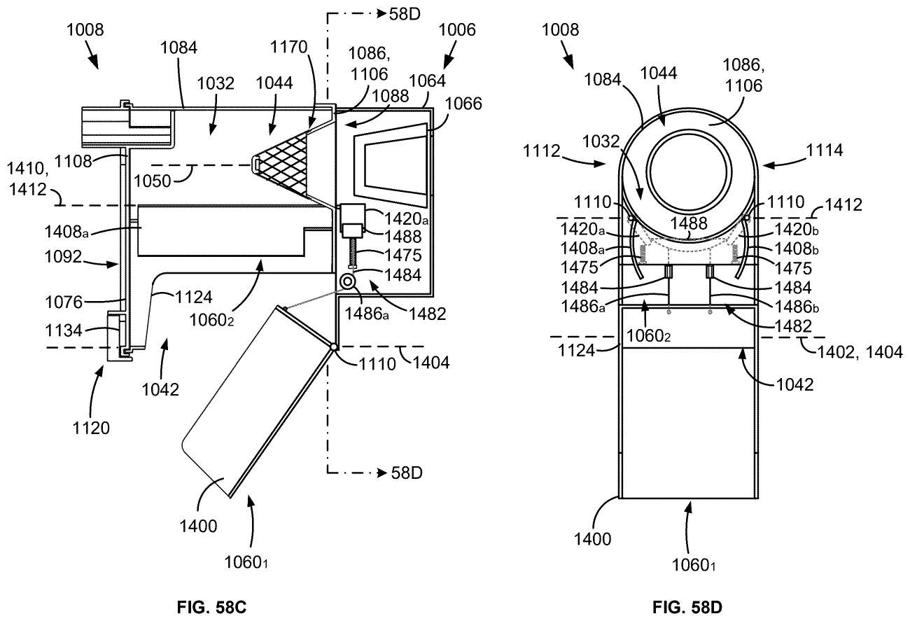

For example, in the examples illustrated in FIGS. 58A-58D, 59A-59D, 60A-60B, and 61A-61D, the first and second air treatment chamber doors 1408 are both rotatably mounted by a hinge 1110 about a respective air treatment chamber opening axis 1410. The first and second air treatment chamber opening axes 1410 are parallel to the air treatment chamber axis 1050 and laterally spaced apart across the air treatment chamber 1044. In this way, when the air treatment chamber doors 1408 are moved from the closed position (see e.g., FIGS. 58A-58B, 59A-59B, 60A, and 61A-61B) to the open position (see e.g., FIGS. 58C-58D, 59C-59D, 60B, and 61C-61D), the first air treatment chamber door 1408a moves in a first lateral direction and the second air treatment chamber door 1408b moves in a second lateral direction that is opposite the first lateral direction.

The dirt collection chamber door 1400 may be configured any way described previously herein. For example, the dirt collection chamber door 1400 may be rotatably mounted by a hinge 1110 about a dirt collection chamber opening axis 1402 that is transverse to the air treatment chamber opening axis 1410 of each air treatment chamber door 1408 (i.e., extends in the lateral direction). In this way, the dirt collection chamber door 1400 may move between the open and closed position in the forward/rearward direction transverse to the lateral direction. Alternatively, the dirt collection chamber door 1400 may be translatably mounted by rails 1128. In this way, the dirt collection chamber door 1400 may move between the open and closed position in the upward/downward direction transverse to the lateral direction.

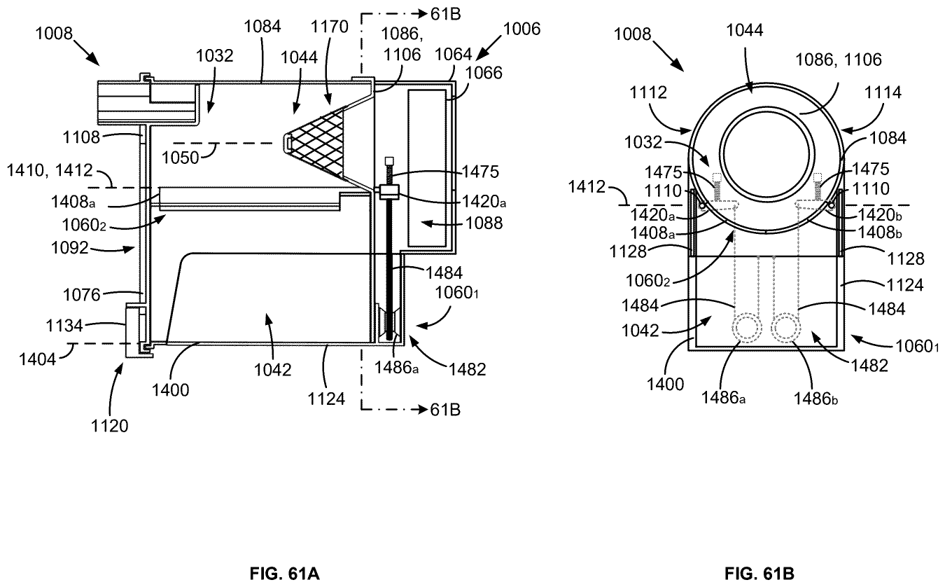

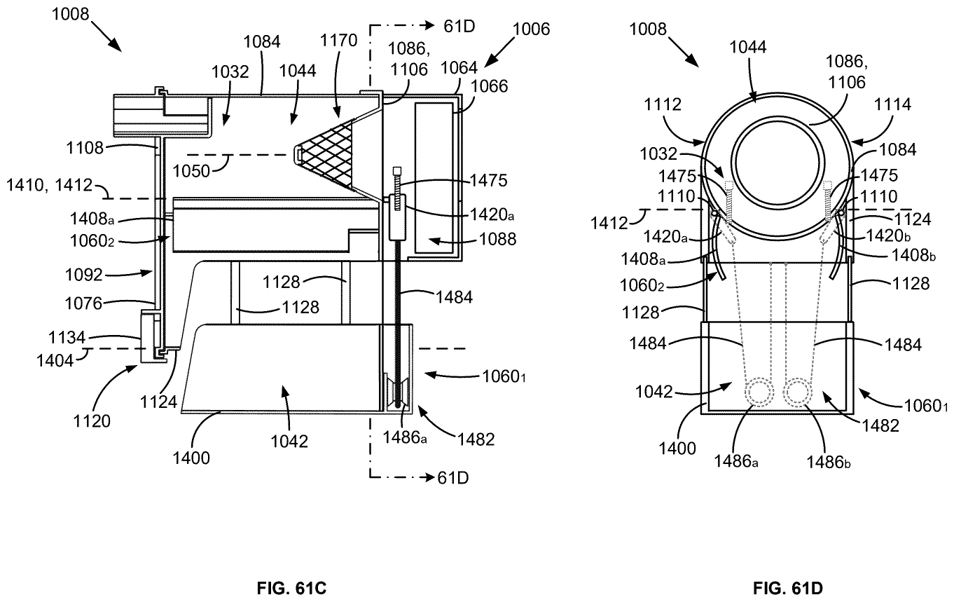

For example, in the examples illustrated in FIGS. 58A-58D, 59A-59D, and 60A-60B, the dirt collection chamber door 1400 is rotatably mounted by a hinge 1110 about a dirt collection chamber opening axis 1402. The dirt collection chamber opening axis 1402 extends in the lateral direction transverse to the air treatment chamber opening axes 1410. In this way, when the dirt collection chamber door 1400 is moved from the closed position (see e.g., FIGS. 58A-58B, 59A-59B, and 60A) to the open position (see e.g., FIGS. 58C-58D, 59C-59D, and 60B), the dirt collection chamber door 1400 moves in the forward/rearward direction transverse to the lateral direction. In the example illustrated in FIG. 61A-61D, the dirt collection chamber door 1400 is translatably mounted by rails 1128. The rails 1128 extend in the upward/downward direction transverse to the air treatment chamber opening axes 1410. In this way, when the dirt collection chamber door 1400 is moved from the closed position (see e.g., FIGS. 61A-61B) to the open position (see e.g., FIGS. 61C-61D), the dirt collection chamber door 1400 moves in the upward/downward direction transverse to the lateral direction.

Optionally, as exemplified in FIGS. 58A-58D, 59A-59D, 60A-60B, and 61A-61D, the dirt collection chamber door 1400 may include at least a portion of a rear end wall of the dirt collection chamber 1042. As shown, the portion of a rear end wall of the dirt collection chamber 1042 may thus be moveable with the dirt collection chamber door 1400 between the closed position and the open position.

One or more dirt collection chamber door 1400 may be drivingly connected to one or more air treatment chamber door. The dirt collection chamber door 1400 may be drivingly connected to each air treatment chamber door 1408 by any suitable means. For example, the dirt collection chamber door 1400 may be drivingly connected to each air treatment chamber door 1408 by a mechanical linkage. The mechanical linkage may include, for example, levers, linkage assemblies, gear transmission, tethers, magnets, or any other mechanical linkage such as those described herein. The mechanical linkage may be any other suitable mechanical linkage such as, for example, a pulley system. In any such embodiments, the mechanical linkage may be configured such that opening one dirt collection chamber door 1400 may open one air treatment chamber door 1408 or, if there are two air treatment chamber doors, may open the first air treatment chamber door 1408a and the second air treatment chamber door 1408b. Alternately, if there are two air treatment chamber doors, a first dirt collection chamber door may open the first air treatment chamber door 1408a and a second dirt collection chamber door may open the second air treatment chamber door 1408b.

For example, in the examples illustrated in FIGS. 58A-58D, 59A-59D, 60A-60B, and 61A-61D, the dirt collection chamber door 1400 is drivingly connected to each air treatment chamber door 1408 by a mechanical linkage, shown as a pulley system 1482.

The pulley system 1482 may include at least one cable 1484, where each cable 1484 is guided by at least one pulley 1486. Each cable 1484 may be connected, directly or indirectly, to a lever arm 1420. The pulley system 1482 may thus include at least one lever arm 1420. Each lever arm 1420 may be pivotable about the air treatment chamber opening axis 1410 of the hinge 1110 of a corresponding air treatment chamber door 1408. Each lever arm 1420 may be drivingly connected to the corresponding air treatment chamber door 1408. Accordingly, rotating the lever arm 1420 about the air treatment chamber opening axis 1410 may similarly rotate the corresponding air treatment chamber door 1408. In this way, the pulley system 1482 may be operable, upon application of tensioning force to each cable 1484, to draw the corresponding lever arm 1420 and thereby rotate the lever arm 1420 and corresponding air treatment chamber door 1408 from the closed position to the open position. The pulley system 1482 may further include at least one bias 1475 (e.g., a tension spring, a compression spring, a torsion spring). The bias(es) 1475 may, directly or indirectly, bias each lever arm 1420 to hold each air treatment chamber door 1408 in the closed position. Accordingly, removing the tensioning force applied to each cable 1484 may enable to bias(es) 1475 to rotate each lever arm 1420 and thereby rotate the corresponding air treatment chamber door 1408 from the open position back to the closed position.

The dirt collection chamber door 1400 may be drivingly connected to each air treatment chamber door 1408 by the pulley system 1482 such that moving the dirt collection chamber door 1400 from the closed position to the open position may apply the tensioning force to each cable 1484 that moves each air treatment chamber door 1408 from the closed position to the open position. Conversely, moving the dirt collection chamber door 1400 from the open position to the closed position may remove the tensioning force applied to each cable 1484, thereby allowing the biasing force of each bias 1475 to return each air treatment chamber door 1408 to the closed position. As shown in the following example implementations in FIGS. 58A-58D, 59A-59D, 60A-60B, and 61A-61D, the pulley system 1482 may have any configuration suitable for drivingly connecting the dirt collection chamber door 1400 to the air treatment chamber door(s) 1408.

As shown in the example illustrated in FIGS. 58A-58D, the pulley system 1482 may include a first pulley 1486a and a second pulley 1486b and cables 1484 guided over each pulley 1486. The pulleys 1486 may be rotatably mounted to a stationary portion of the hand vacuum cleaner 1000 (e.g., a stationary portion of the air treatment member 1008 or, as shown, of the main body 1006). The cables 1484 may be anchored at one end to the dirt collection chamber door 1400 and at the opposite end to a pulley plate 1488. The pulley plate 1488 may be supported on a first lever arm 1420a and a second lever arm 1420b. Each lever arm 1420 may be drivingly connected to a corresponding one of the air treatment chamber doors 1408. The lever arms 1420 may be biased by a bias 1475, shown as a compression spring, to hold the air treatment chamber doors 1408 in the closed position. When the dirt collection chamber door 1400 moves from the closed position (see e.g., FIGS. 58A-58B) to the open position (see e.g., FIGS. 58C-58D), the dirt collection chamber door 1400 may apply a tensioning force to the cables 1484, which may draw the cables 1484 over the pulleys 1486. The cables 1484 may then draw the pulley plate 1488 downwardly into the lever arms 1420, which may cause the lever arms 1420 to rotate downwardly against the biasing force of the biases 1475. The downward rotation of the lever arms 1420 may drive the air treatment chamber doors 1408 to rotate from the closed position (see e.g., FIGS. 58A-58B) to the open position (see e.g., FIGS. 58C-58D). As the dirt collection chamber door 1400 is returned to the closed position, the tensioning force may be removed from the cables 1484 such that the biases 1475 may push the lever arms 1420 and the pulley plate 1488 upwardly. The upward rotation of the lever arms 1420 may drive the air treatment chamber doors 1408 to rotate from the open position back to the closed position.

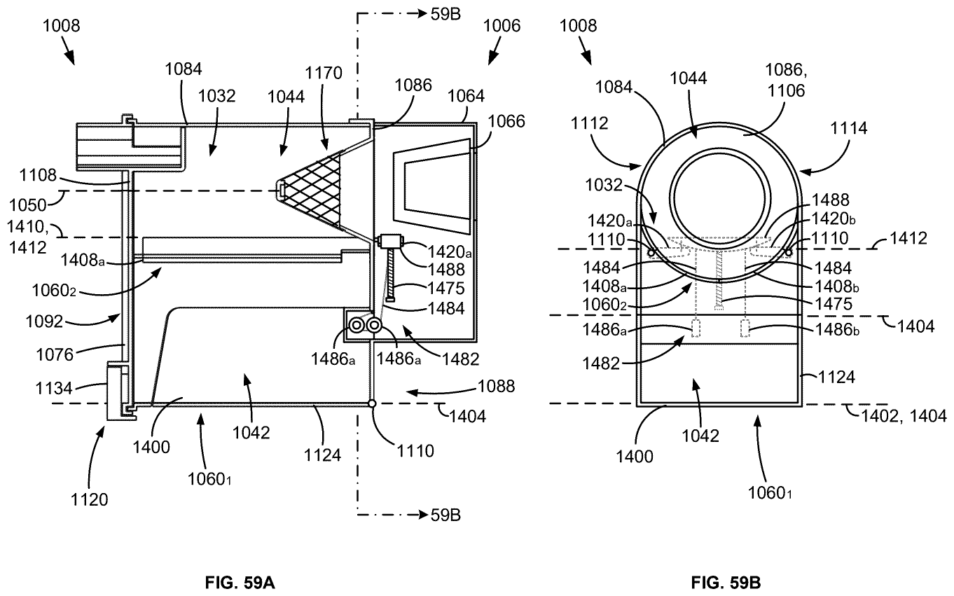

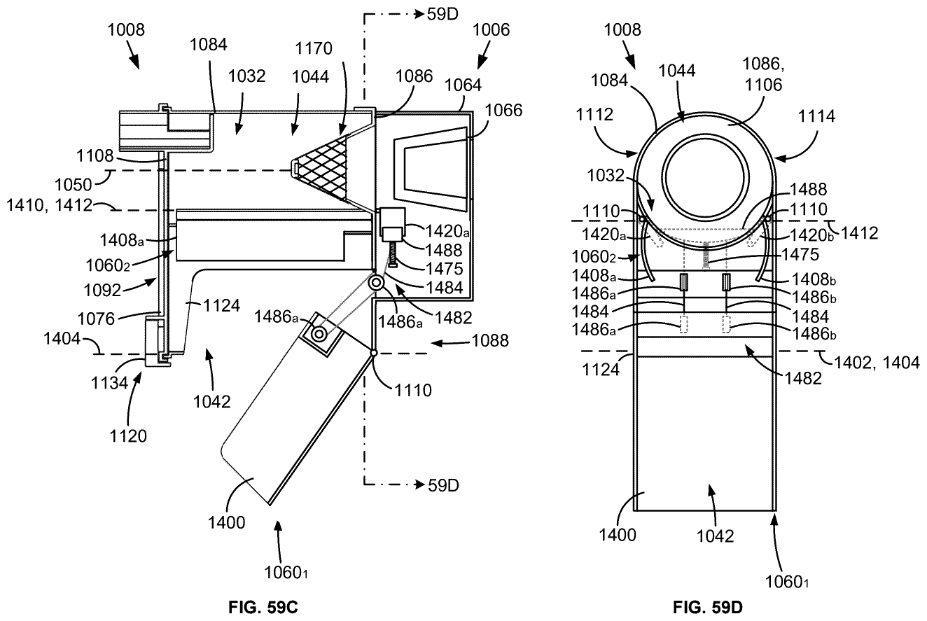

As shown in the example illustrated in FIGS. 59A-59D, the pulley system 1482 may include a pair of first pulleys 1486a and a pair of second pulleys 1486b and cables 1484 guided over each pair of pulleys 1486. One pulley of each pair of pulleys 1486 may be rotatably mounted to the dirt collection chamber door 1400 and the other pulley of each pair of pulleys 1486 may be rotatably mounted to a stationary portion of the hand vacuum cleaner 1000 (e.g., a stationary portion of the air treatment member 1008 or, as shown, of the main body 1006). The cables 1484 may be anchored at one end to the stationary portion and at the opposite end to a pulley plate 1488. The pulley plate 1488 may be supported on a first lever arm 1420a and a second lever arm 1420b. Each lever arm 1420 may be drivingly connected to a corresponding one of the air treatment chamber doors 1408. The pulley plate 1488 may be upwardly biased by a bias 1475, shown as a compression spring, and connected to the lever arms 1420 to thereby hold the air treatment chamber doors 1408 in the closed position. When the dirt collection chamber door 1400 moves from the closed position (see e.g., FIGS. 59A-59B) to the open position (see e.g., FIGS. 59C-59D), the dirt collection chamber door 1400 may apply a tensioning force to the cables 1484, which may draw the cables 1484 over each pair of pulleys 1486. The cables 1484 may then draw the pulley plate 1488 downwardly into the lever arms 1420 against the biasing force of the bias 1475, which may cause the lever arms 1420 to rotate downwardly. The downward rotation of the lever arms 1420 may drive the air treatment chamber doors 1408 to rotate from the closed position (see e.g., FIGS. 59A-59B) to the open position (see e.g., FIGS. 59C-59D). As the dirt collection chamber door 1400 is returned to the closed position, the tensioning force may be removed from the cables 1484 such that the bias 1475 may push the pulley plate 1488 upwardly, thus drawing the lever arms 1420 upwardly with the pulley plate 1488. The upward rotation of the lever arms 1420 may drive the air treatment chamber doors 1408 to rotate from the open position back to the closed position.

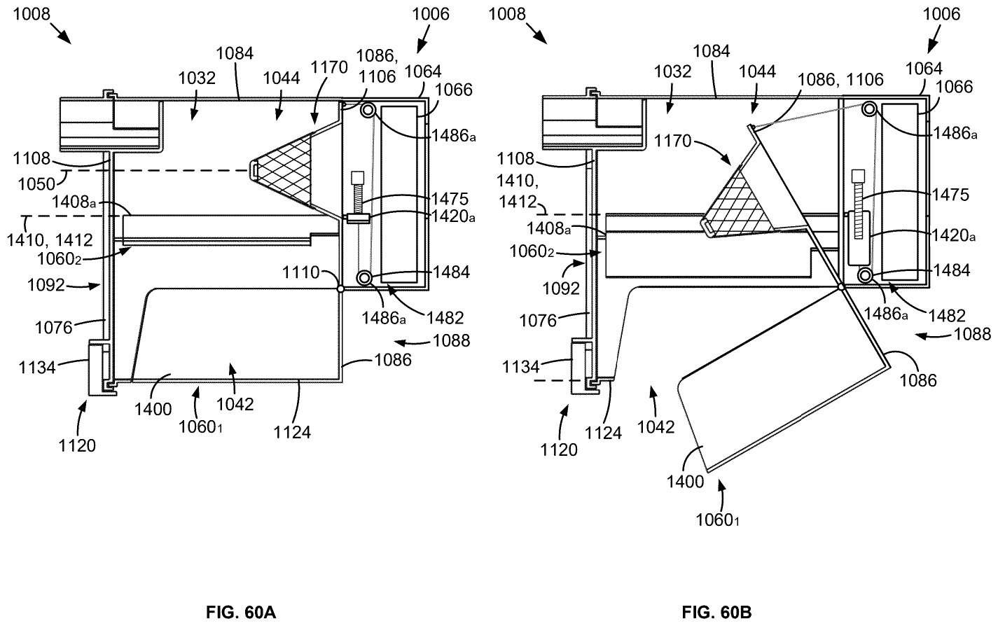

As shown in the example illustrated in FIGS. 60A-60B, at least a portion of the rear end wall 1086 of the air treatment member 1008 may be moveable with the dirt collection chamber door 1400. The portion of the rear end wall 1086 may include at least a portion of the rear end wall 1106 of the air treatment chamber 1044. In such embodiments, as shown, the pulley system 1482 may include a pair of first pulleys 1486a and a pair of second pulleys (not shown) and cables 1484 guided over each pair of pulleys 1486. The pulleys of each pair of pulleys 1486 may be rotatably mounted to a stationary portion of the hand vacuum cleaner 1000 (e.g., a stationary portion of the air treatment member 1008 or, as shown, of the main body 1006). The cables 1484 may be anchored at one end to the moveable portion of the rear end wall 1106 of the air treatment chamber 1044 and at the opposite end to a lever arm 1420. Each lever arm 1420 may be drivingly connected to a corresponding one of the air treatment chamber doors 1408. Each lever arm 1420 may be upwardly biased by a bias 1475, shown as a tension spring, to thereby hold the air treatment chamber doors 1408 in the closed position. When the dirt collection chamber door 1400 moves from the closed position (see e.g., FIG. 60A) to the open position (see e.g., FIG. 60B), the dirt collection chamber door 1400 (via the moveable portion of the rear end wall 1106) may apply a tensioning force to the cables 1484, which may draw the cables 1484 over each pair of pulleys 1486. The cables 1484 may then draw the lever arms 1420 downwardly against the biasing force of the bias 1475. The downward rotation of the lever arms 1420 may drive the air treatment chamber doors 1408 to rotate from the closed position (see e.g., FIG. 60A) to the open position (see e.g., FIG. 60B). As the dirt collection chamber door 1400 is returned to the closed position, the tensioning force may be removed from the cables 1484 such that the bias 1475 may pull the lever arms 1420 upwardly. The upward rotation of the lever arms 1420 may drive the air treatment chamber doors 1408 to rotate from the open position back to the closed position.

As shown in the example illustrated in FIGS. 61A-61D, the pulley system 1482 may include a first pulley 1486a and a second pulley 1486b and cables 1484 guided over each pulley 1486. The pulleys 1486 may be rotatably mounted to the dirt collection chamber door 1400. The cables 1484 may be anchored at one end to a stationary portion of the hand vacuum cleaner 1000 (e.g., a stationary portion of the air treatment member 1008 or, as shown, of the main body 1006) and at the opposite end to a lever arm 1420. Each lever arm 1420 may be drivingly connected to a corresponding one of the air treatment chamber doors 1408. Each lever arm 1420 may be upwardly biased by a bias 1475, shown as a tension spring, to thereby hold the air treatment chamber doors 1408 in the closed position. When the dirt collection chamber door 1400 moves from the closed position (see e.g., FIGS. 61A-61B) to the open position (see e.g., FIGS. 61C-61D), the dirt collection chamber door 1400 may apply a tensioning force to the cables 1484, which may draw the cables 1484 over each pair of pulleys 1486. The cables 1484 may then draw the lever arms 1420 downwardly against the biasing force of the bias 1475. The downward rotation of the lever arms 1420 may drive the air treatment chamber doors 1408 to rotate from the closed position (see e.g., FIGS. 61A-61B) to the open position (see e.g., FIGS. 61C-61D). As the dirt collection chamber door 1400 is returned to the closed position, the tensioning force may be removed from the cables 1484 such that the bias 1475 may pull the lever arms 1420 upwardly. The upward rotation of the lever arms 1420 may drive the air treatment chamber doors 1408 to rotate from the open position back to the closed position.

As shown in each of the examples illustrated in FIGS. 58A-58D, 59A-59D, 60A-60B, and 61A-61D, the air treatment chamber doors 1408 may be biased to the closed position. Alternately, or in addition, the dirt collection chamber door 1400 may also be biased to the closed position. In such embodiments, the dirt collection chamber door 1400 may have an actuator such as, for example, a rocker arm 1422 as described previously herein. In such embodiments, actuation of the dirt collection chamber door 1400 may, via the mechanical linkage (e.g., pulley system 1482), concurrently actuate each air treatment chamber door 1408.

The mechanical linkage may be provided at any suitable location for drivingly connecting the dirt collection chamber door 1400 to the air treatment chamber door(s) 1408. At least a portion of the mechanical linkage may be located exterior to the dirt collection chamber 1042. Optionally, all of the mechanical linkage may be located exterior to the dirt collection chamber 1042. In either such embodiments, at least a portion of the mechanical linkage may be located at the rear end 1040 of the air treatment chamber 1044. It will be appreciated that, optionally, the operating components (e.g., gears, pulleys' etc.) may be provided in a volume that is isolated from dirt flowing through or collected in the surface cleaner.

For example, in the examples illustrated in FIGS. 58A-58D, 60A-60B, and 61A-61D, the pulley system 1482 is housed in the pre-motor filter housing 1064 within the head space upstream of the pre-motor filter 1066. In the example illustrated in FIGS. 59A-59D, one pulley in each pair of pulleys 1486 is housed in an enclosed portion of the dirt collection chamber 1042. In each of the illustrated examples, at least the lever arms 1420 are positioned at the rear end 1040 of the air treatment chamber 1044 such that the lever arms 1420 can be drivingly connected to the air treatment chamber doors 1408. Accordingly, the pulley plate 1488 (if provided, see e.g., FIGS. 58B and 59B), and at least a portion of the biases 1475 (see e.g., FIGS. 58B, 59B, 60A, and 61B) may therefore also be positioned at the rear end 1040 of the air treatment chamber 1044.

In the illustrated examples described in this section, the air treatment chambers 1044 are cyclone chambers, and the air treatment chamber axes 1050 are cyclone axes of rotation. It will be appreciated, however, that any other type of air treatment chamber may be used with the openable portion(s) described herein.

### Laterally Openable Air Treatment Chamber Door and Dirt Collection Chamber Door

In accordance with this aspect of this disclosure, which may be used by itself or in combination with one or more other aspects of this disclosure, a surface cleaner such as the hand vacuum cleaner may have a laterally openable air treatment chamber door and a laterally openable dirt collection chamber door.

When the air treatment chamber axis 1050 extends horizontally and the dirty air inlet 1002 is at the upper end 1018 of the hand vacuum cleaner 1000, the dirt collection chamber 1042 may be positioned at least partially at a lateral side of the air treatment chamber 1044. When the air treatment chamber axis 1050 extends horizontally and the dirty air inlet 1002 is at the upper end 1018 of the hand vacuum cleaner 1000, the lateral direction may be understood as the direction defined by a horizontal axis that is transverse to the air treatment chamber axis 1050. It will be appreciated that this aspect may be used with any surface cleaner wherein the doors open in a direction that is radially outwardly of the air treatment chamber axis 1050 such as a cyclone axis of rotation.

The air treatment chamber 1044 may have a dirt outlet 1052, which may place the air treatment chamber 1044 in communication with the dirt collection chamber 1042. Where the dirt collection chamber 1042 is positioned at a lateral side of the air treatment chamber 1044, the dirt outlet 1052 may be provided through a lateral side of the sidewall 1084 of the air treatment chamber 1044. In such embodiments, dirt separated from the air flow within the air treatment chamber 1044 may thus be thrown laterally through the dirt outlet 1052 into the laterally adjacent dirt collection chamber 1042 (e.g., by momentum or cyclonic separation). The dirt outlet 1052 may be of any suitable configuration such as, for example, a slot/port provided in the sidewall 1084.

For example, in the examples illustrated in FIGS. 50A-50B, 51A-51B, and 52A-52B, the dirt collection chamber 1042 is positioned radially outwardly of the air treatment chamber 1044 so as to be at a lateral side of the air treatment chamber 1044. The air treatment chamber 1044 has a dirt outlet 1052, shown as a slot/port provided in a lateral side the sidewall 1084, which places the air treatment chamber 1044 in communication with the dirt collection chamber 1042.

The air treatment member 1008 may have at least one openable portion 1060. The openable portion 1060 may be operable to open at least one of the dirt collection chamber 1042 and the air treatment chamber 1044.

Optionally, the air treatment member 1008 may have a single openable portion 1060 operable to open both the dirt collection chamber 1042 and the air treatment chamber 1044. In such embodiments, the openable portion 1060 may thus be both a dirt collection chamber door 1400 and an air treatment chamber door 1408.

The openable portion 1060 may be rotatably mounted by a hinge 1110 about a common axis representative of both the dirt collection chamber opening axis 1402 and the air treatment chamber opening axis 1410. The common axis 1402, 1410 may be parallel to the air treatment chamber axis 1050. In this way, when the openable portion 1060 is moved between a closed position and an open position, the dirt collection chamber door 1400 and the air treatment chamber door 1408 may move together in the lateral direction. Accordingly, when the air treatment chamber axis 1050 extends horizontally and the dirty air inlet 1002 is at the upper end 1018 of the hand vacuum cleaner 1000, the common axis 1402, 1410 may extend in a common horizontal plane representative of both the dirt collection chamber emptying plane 1404 and the air treatment chamber emptying plane 1412.

Where the openable portion 1060 is connected to the hinge 1110 by the air treatment chamber door 1408, the dirt collection chamber door 1400 may extend from the air treatment chamber door 1408. Similarly, where the openable portion 1060 is connected to the hinge 1110 by the dirt collection chamber door 1400, the air treatment chamber door 1408 may extend from the dirt collection chamber door 1400. In either such embodiments, the dirt collection chamber door 1400 and the air treatment chamber door 1408 may be integrally molded as a single part.

The dirt collection chamber door 1400 may, in the closed position, form a lower portion of the sidewall 1124 of the dirt collection chamber 1042. Similarly, the air treatment chamber door 1408 may, in the closed position, form a lower portion of the sidewall 1084 of the air treatment chamber 1044. The openable portion 1060 may thus form a lower portion of the air treatment member 1008.

For example, in the example illustrated in FIGS. 50A-50B, the air treatment member 1008 has a single openable portion 1060, including both a dirt collection chamber door 1400 and an air treatment chamber door 1408. Accordingly, the openable portion 1060 is operable to open the dirt collection chamber 1042 and the air treatment chamber 1044. The openable portion 1060 is rotatably mounted by a hinge 1110 about a common axis 1402, 1410 that is parallel to the air treatment chamber axis 1050. As shown, the openable portion 1060 is connected to the hinge 1110 by the air treatment chamber door 1408. The dirt collection chamber door 1400 extends from the air treatment chamber door 1408 and is integrally molded as a single part with the air treatment chamber door 1408. In this way, when the openable portion 1060 is moved between a closed position (see e.g., FIG. 50A) and an open position (see e.g., FIG. 50B), the air treatment chamber door 1408 and the dirt collection chamber door 1400 move together in the lateral direction. In the closed position, the dirt collection chamber door 1400 forms a lower portion of the sidewall 1124 of the dirt collection chamber 1042, the air treatment chamber door 1408 forms a lower portion of the sidewall 1084 of the air treatment chamber 1044, and the openable portion 1060 thus forms a lower portion of the air treatment member 1008.

Optionally, the air treatment member 1008 may have a first openable portion 1060₁ and a second openable portion 1060₂.

The first openable portion 1060₁ may be a dirt collection chamber door 1400 operable to open the dirt collection chamber 1042. The dirt collection chamber door 1400 may be rotatably mounted by a hinge 1110 about a dirt collection chamber opening axis 1402. The dirt collection chamber opening axis 1402 may be parallel to the air treatment chamber axis 1050. In this way, when the dirt collection chamber door 1400 is moved between a closed position and an open position, the dirt collection chamber door 1400 may move in a lateral direction.

The second openable portion 1060₂ may be an air treatment chamber door 1408 operable to open the air treatment chamber 1044. The air treatment chamber door 1408 may be rotatably mounted by a hinge 1110 about an air treatment chamber opening axis 1410. The air treatment chamber opening axis 1410 may be parallel to the air treatment chamber axis 1050. In this way, when the air treatment chamber door 1408 is moved between a closed position and an open position, the air treatment chamber door 1408 may move in the lateral direction.

The air treatment chamber door 1408 may move in a first lateral direction from the closed position to the open position. The dirt collection chamber door 1400 may move in a second lateral direction from the closed position to the open position. The second lateral direction may be opposite the first lateral direction. In this way, when the air treatment chamber door 1408 and the dirt collection chamber door 1400 are moved from their respective closed positions to their respective open positions, they may move laterally away from each other. Conversely, when the air treatment chamber door 1408 and the dirt collection chamber door 1400 are moved from their respective open positions to their respective closed positions, they may move laterally toward each other.

In such embodiments, the dirt collection chamber opening axis 1402 and the air treatment chamber opening axis 1410 may be laterally spaced apart on opposed sides of the air treatment member 1008. When the air treatment chamber axis 1050 extends horizontally and the dirty air inlet 1002 is at the upper end 1018 of the hand vacuum cleaner 1000, the dirt collection chamber opening axis 1402 may extend in a horizontal plane, referred to as a dirt collection chamber emptying plane 1404, and the air treatment chamber opening axis 1410 may extend in another horizontal plane, referred to as an air treatment chamber emptying plane 1412. Optionally, the dirt collection chamber emptying plane 1404 and the air treatment chamber emptying plane 1412 may be coincident such that the laterally spaced apart dirt collection chamber opening axis 1402 and air treatment chamber opening axis 1410 may be provided at the same elevation. In this way, when the air treatment chamber axis 1050 extends horizontally and the dirty air inlet 1002 is at the upper end 1018 of the hand vacuum cleaner 1000, the dirt collection chamber opening axis 1402 and the air treatment chamber opening axis 1410 may extend in a common emptying plane.

The dirt collection chamber door 1400 may, in the closed position, form a lower portion of the sidewall 1124 of the dirt collection chamber 1042. The dirt collection chamber door 1400 may also form a portion of a lower portion of the air treatment member 1008. Similarly, the air treatment chamber door 1408 may, in the closed position, form a lower portion of the sidewall 1084 of the air treatment chamber 1044. The air treatment chamber door 1408 may form another portion of the lower portion of the air treatment member 1008.

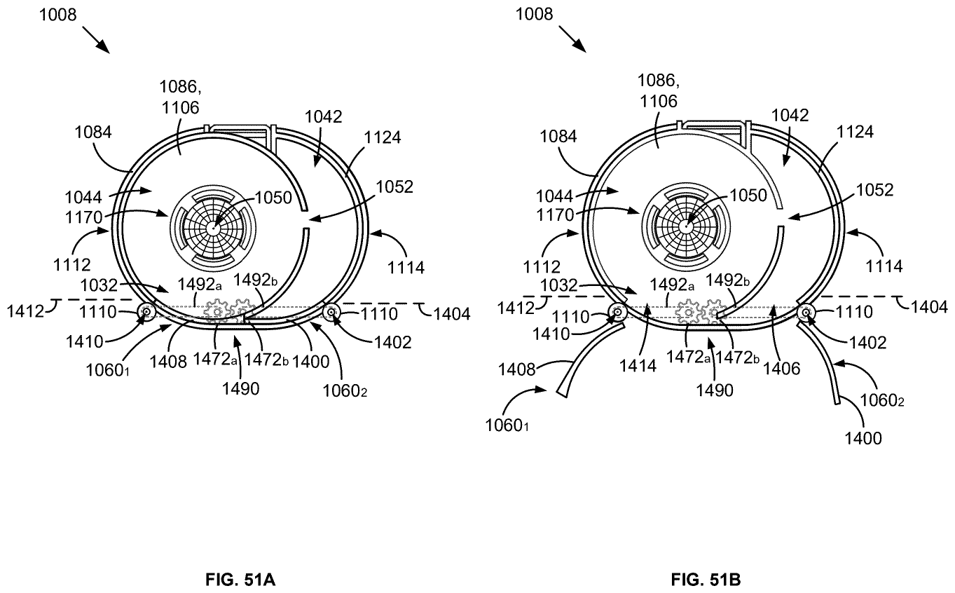

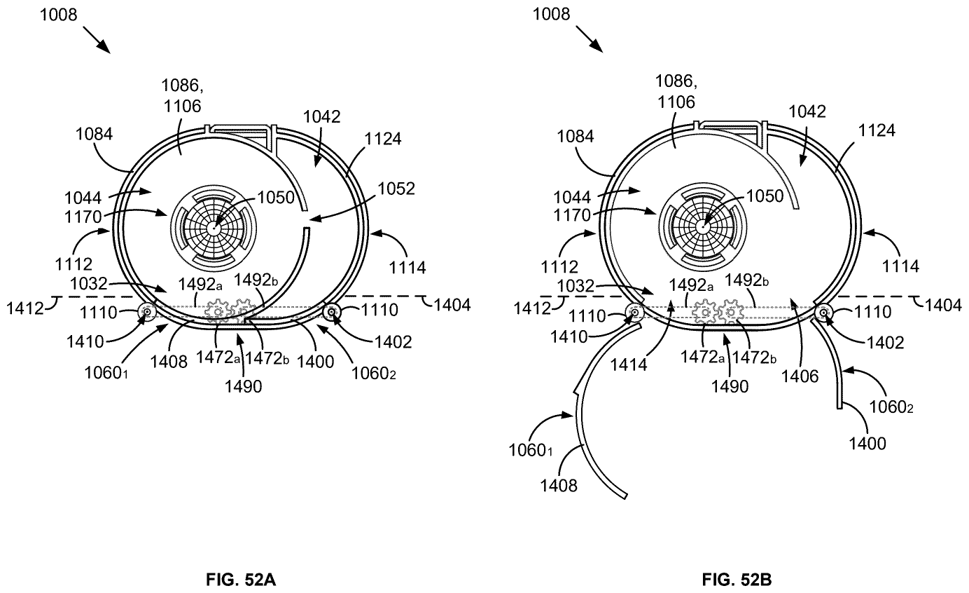

For example, in the examples illustrated in FIGS. 51A-51B and 52A-52B, the air treatment member 1008 has a first openable portion 1060₁ and a second openable portion 1060₂. The first openable portion 1060₁ is a dirt collection chamber door 1400 rotatably mounted by a hinge 1110 about a dirt collection chamber opening axis 1402. The second openable portion 1060₂ is an air treatment chamber door 1408 rotatably mounted by a hinge 1110 about an air treatment chamber opening axis 1410. The dirt collection chamber opening axis 1402 and air treatment chamber opening axis 1410 are parallel to the air treatment chamber axis 1050. The dirt collection chamber opening axis 1402 and the air treatment chamber opening axis 1410 are also laterally spaced apart on opposed sides of the air treatment member 1008. In this way, as shown, the air treatment chamber door 1408 and the dirt collection chamber door 1400 move laterally away from each other when moved from the closed position (see e.g., FIGS. 51A and 52A) to the open position (see e.g., FIGS. 51B and 52B). Conversely, when the air treatment chamber door 1408 and the dirt collection chamber door 1400 move laterally toward each other when moved from the open position to the closed position. In the closed position, the dirt collection chamber door 1400 forms a lower portion of the sidewall 1124 of the dirt collection chamber 1042 and the air treatment chamber door 1408 forms a lower portion of the sidewall 1084 of the air treatment chamber 1044. Each openable portion 1060 thus forms a portion of a lower portion of the air treatment member 1008 when in the closed position.

In any embodiment, the air treatment chamber door 1408 may optionally include a portion of the sidewall 1084 of the air treatment chamber 1044 between the air treatment chamber 1044 and the dirt collection chamber 1042. The portion of the sidewall 1084 may define at least a lower portion of the perimeter 1078 of the dirt outlet 1052. In operation of the hand vacuum cleaner 1000 to clean a surface, the dirt outlet 1052 may clog with compacted debris. The compacted debris may partially bridge the dirt outlet 1052. Accordingly, movement of the air treatment chamber door 1408 from the closed position to the open position may cause the portion of the sidewall 1084 defining at least the lower portion of the perimeter 1078 of the dirt outlet 1052 to move with respect to the rest of the perimeter 1078 of the dirt outlet 1052. This may open the dirt outlet 1052, which may advantageously urge the compacted debris to be dislodged from the dirt outlet 1052. The portion of the sidewall 1084 defining at least the lower portion of the perimeter 1078 of the dirt outlet 1052 may also pass through the dirt collection chamber 1042 when moving from the closed position to the open position, which may advantageously assist in pushing dirt from the dirt collection chamber 1042.

For example, in the example illustrated in FIGS. 52A-52B, the air treatment chamber door 1408 includes the portion of the sidewall 1084 defining a lower portion of the perimeter 1078 of the dirt outlet 1052. As shown, when the air treatment chamber door 1408 is moved from the closed position (see e.g., FIG. 52A) to the open position (see e.g., FIG. 52B), the portion of the sidewall 1084 defining the lower portion of the perimeter 1078 of the dirt outlet 1052 moves with the air treatment chamber door 1408. Opening the air treatment chamber door 1408 thus opens the dirt outlet 1052 and urges compacted debris to be dislodged from the dirt outlet 1052 and fall through the dirt collection chamber emptying port 1406 and/or air treatment chamber emptying port 1414.

In any embodiment, one of the air treatment chamber door 1408 and the dirt collection chamber door 1400 may be drivingly connected to the other of the air treatment chamber door 1408 and the dirt collection chamber door 1400. The one of the air treatment chamber door 1408 and the dirt collection chamber door 1400 may be drivingly connected to the other of the air treatment chamber door 1408 and the dirt collection chamber door 1400 by any means described herein such as, for example, levers, linkage assemblies, gear transmission, tethers, magnets, pulley system, and/or any other mechanical linkage.

For example, in the example illustrated in FIGS. 50A-50B, the dirt collection chamber door 1400 and the air treatment chamber door 1408 are integrally molded as a single part with the dirt collection chamber door 1400 extending from the air treatment chamber door 1408. Accordingly, in moving the air treatment chamber door 1408 between the open and closed positions, the air treatment chamber door 1408 may be understood as driving the dirt collection chamber door 1400 between the open and closed positions.

In the examples illustrated in FIGS. 51A-51B and 52A-52B, the dirt collection chamber door 1400 and the air treatment chamber door 1408 are drivingly connected by a belt-driven transmission 1490 (shown in phantom). As shown, a first belt 1492a is wrapped at one end around a drive shaft (not shown) of the hinge 1110 of the air treatment chamber door 1408 and at another end around a drive shaft (not shown) of a first gear 1472a. A second belt 1492b is wrapped at one end around a drive shaft (not shown) of the hinge 1110 of the dirt collection chamber door 1400 and at another end around a drive shaft (not shown) of a second gear 1472b. The first and second gears 1472 intermesh such that rotation of one gear 1472 drives rotation of the other gear 1472. In this configuration, either of the dirt collection chamber door 1400 and the air treatment chamber door 1408 may be a driver of the belt-driven transmission 1490.

In embodiments in which the air treatment chamber door 1408 is the driver of the belt-driven transmission 1490, when the air treatment chamber door 1408 is rotated between the closed position and the open position, rotation of the air treatment chamber door 1408 and the drive shaft thereof may impart motion to the first belt 1492a. As the first belt 1492a moves, it may pull on the circumference of the drive shaft of the first gear 1472a, causing the first gear 1472a to rotate in unison with the air treatment chamber door 1408. The first gear 1472a may then drive the second gear 1472b to rotate in the opposite direction. Rotation of the second gear 1472b may impart motion to the second belt 1492b. As the second belt 1492b moves, it may pull on the circumference of the drive shaft of the dirt collection chamber door 1400, causing the dirt collection chamber door 1400 to rotate in unison with the air treatment chamber door 1408 in the opposite direction. It will be appreciated that, in embodiments in which the dirt collection chamber door 1400 is the driver of the belt-driven transmission 1490, the reverse operation may occur when the dirt collection chamber door 1400 is rotated between the closed position and the open position.

In alternate embodiments, the gears 1472 may optionally be omitted and the belt-driven transmission 1490 may instead be a cross-belt driven transmission. In such embodiments, a single belt 1492 may be used. The belt 1492 may be wrapped at one end around a drive shaft of the hinge 1110 of the air treatment chamber door 1408 and at another end around a drive shaft of the hinge 1110 of the dirt collection chamber door 1400. The belt 1492 may cross over itself between the drive shafts. In this way, rotation of the driver of the one of the air treatment chamber door 1408 and the dirt collection chamber door 1400 in one direction may drive rotation of the other of the air treatment chamber door 1408 and the dirt collection chamber door 1400 in unison and in the opposite direction.

In the illustrated examples described in this section, the air treatment chambers 1044 are cyclone chambers, and the air treatment chamber axes 1050 are cyclone axes of rotation. It will be appreciated, however, that any other type of air treatment chamber may be used with the openable portion(s) described herein.

### Axially Openable Portion of Air Treatment Assembly

In accordance with this aspect of this disclosure, which may be used by itself or in combination with one or more other aspects of this disclosure, the hand vacuum cleaner may have an air treatment member having an axially translatable, e.g. forwardly or rearwardly translatable openable portion.

The air treatment chamber axis 1050 may extend in the forward/rearward direction. When the air treatment chamber axis 1050 extends horizontally and the dirty air inlet 1002 is at the upper end 1018 of the hand vacuum cleaner 1000, the dirt collection chamber 1042 may be positioned at least partially below the air treatment chamber 1044. Additionally, or alternatively, when the air treatment chamber axis 1050 extends horizontally and the dirty air inlet 1002 is at the upper end 1018 of the hand vacuum cleaner 1000, the dirt collection chamber 1042 may be positioned at least partially forward of the air treatment chamber 1044.

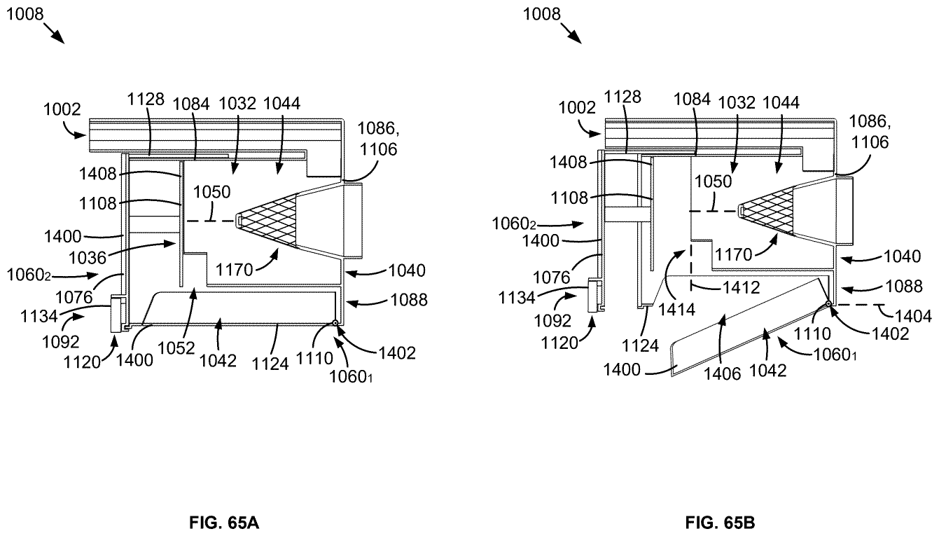

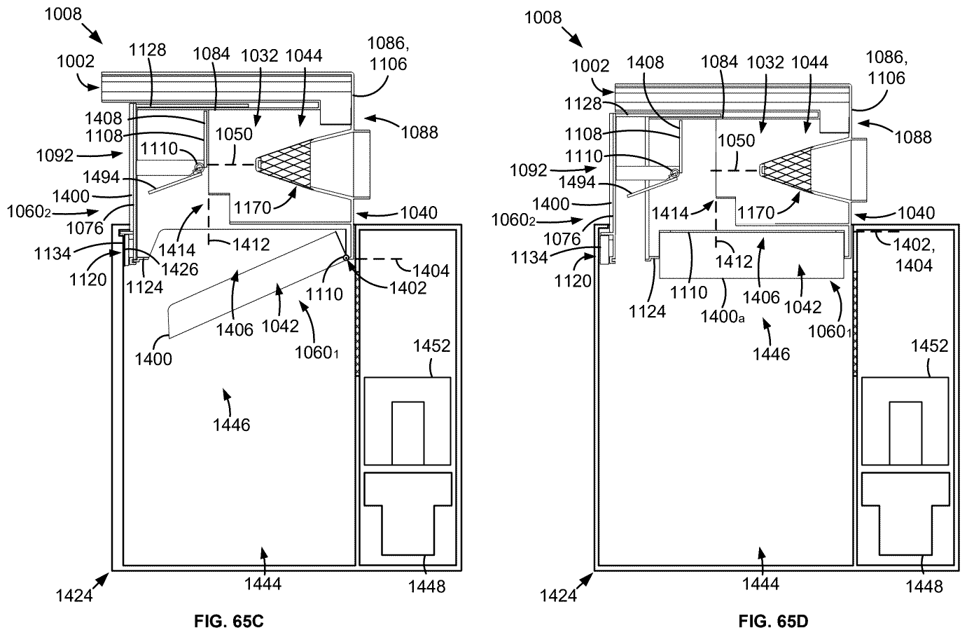

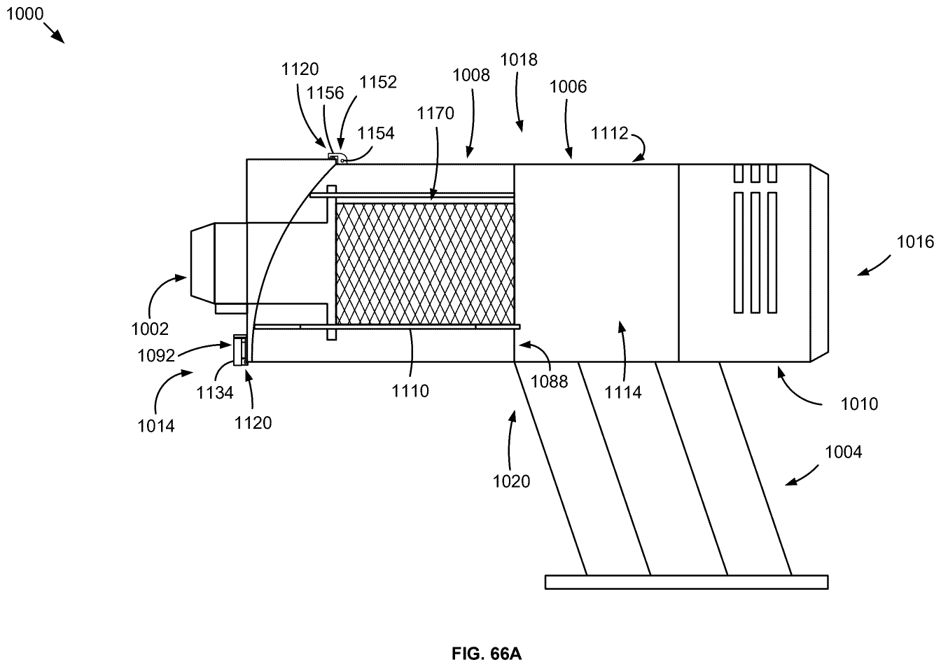

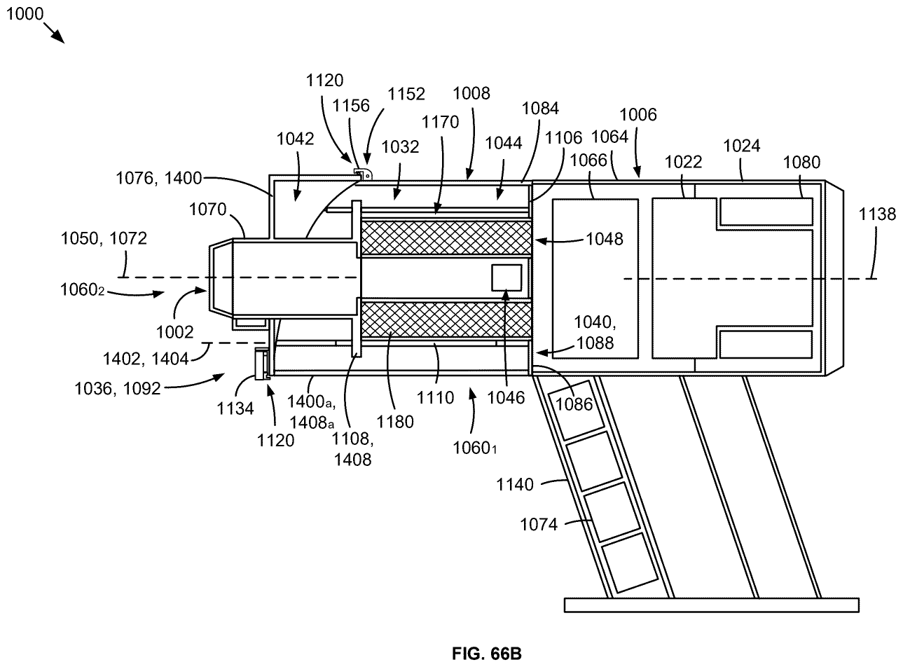

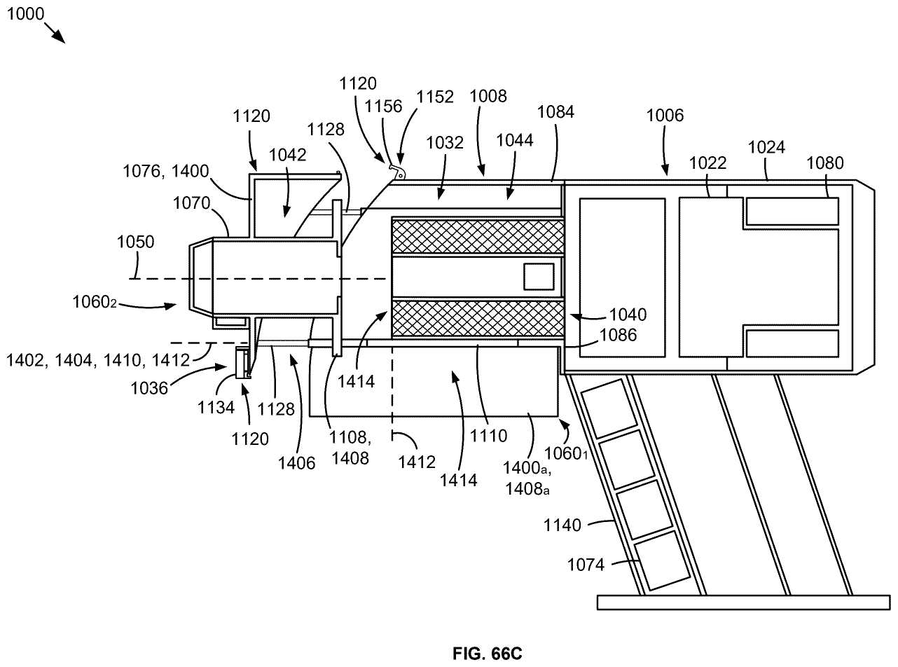

For example, in the examples illustrated in FIGS. 65A-65D, when the air treatment chamber axis 1050 extends horizontally and the dirty air inlet 1002 is at the upper end 1018 of the hand vacuum cleaner 1000, the dirt collection chamber 1042 is positioned partially below the air treatment chamber 1044 and partially forward of the air treatment chamber 1044. In the example illustrated in FIGS. 66A-66C, when the air treatment chamber axis 1050 extends horizontally and the dirty air inlet 1002 is at the upper end 1018 of the hand vacuum cleaner 1000, the dirt collection chamber 1042 is positioned forward of the air treatment chamber 1044.

The air treatment member 1008 may have a first openable portion 1060₁ and a second openable portion 1060₂. The first openable portion 1060₁ may be operable to open at least one of the dirt collection chamber 1042 and the air treatment chamber 1044. The second openable portion 1060₂ may be operable to open at least one of the dirt collection chamber 1042 and the air treatment chamber 1044. The air treatment chamber 1044 may therefore have at least one air treatment chamber door 1408 and the dirt collection chamber 1042 may similarly have at least one dirt collection chamber door 1400.

The first openable portion 1060₁ may form a lower portion of the air treatment member 1008. The first openable portion 1060₁ may be rotatably mounted by one or more hinges 1110 that are parallel to the air treatment chamber axis 1050. The first openable portion 1060₁ may thus be laterally openable. Alternatively, the first openable portion 1060₁ may be rotatably mounted by a hinge 1110 that is transverse to the air treatment chamber axis 1050 in the lateral direction. The first openable portion 1060₁ may thus alternatively be forwardly/rearwardly openable.

In some embodiments, the lower portion of the air treatment member 1008 may be a lower portion of the sidewall 1124 of the dirt collection chamber 1042 (e.g., where the dirt collection chamber 1042 is at least partially below of the air treatment chamber 1044). In some such embodiments, the first openable portion 1060₁ may thus be at least one laterally openable dirt collection chamber door 1400. Each laterally openable dirt collection chamber door 1400 may be rotatably mounted by a hinge 1110 about a dirt collection chamber opening axis 1402 that is parallel to the air treatment chamber axis 1050. In other such embodiments, the first openable portion 1060₁ may be a forwardly/rearwardly openable dirt collection chamber door 1400. The forwardly/rearwardly openable dirt collection chamber door 1400 may be rotatably mounted by a hinge 1110 about a dirt collection chamber opening axis 1402 that extends in the lateral direction transverse to the air treatment chamber axis 1050.

In alternate embodiments, the lower portion of the air treatment member 1008 may be a lower portion of the sidewall 1124 of the dirt collection chamber 1042 and a lower portion of the sidewall 1084 of the air treatment chamber 1044 (e.g., where the dirt collection chamber 1042 is forward of the air treatment chamber 1044). In some such embodiments, the first openable portion 1060₁ may thus be at least one laterally openable door forming both a dirt collection chamber door 1400 and an air treatment chamber door 1408. Each laterally openable door may be rotatably mounted by a hinge 1110 about an axis that is parallel to the air treatment chamber axis 1050. In other such embodiments, the first openable portion 1060₁ may be a forwardly/rearwardly openable door forming both a dirt collection chamber door 1400 and an air treatment chamber door 1408. The forwardly/rearwardly openable door may be rotatably mounted by a hinge 1110 about an axis that extends in the lateral direction transverse to the air treatment chamber axis 1050. In either embodiment, the axis may be a coaxial dirt collection chamber opening axis 1402 and air treatment chamber opening axis 1410.

For example, in the examples illustrated in FIGS. 65A-65C, the lower portion of the air treatment member 1008 is a lower portion of the sidewall 1124 of the dirt collection chamber 1042. As shown, the first openable portion 1060₁ is a rearwardly openable dirt collection chamber door 1400 that is rotatably mounted by a hinge 1110 at the rear end 1088 of the air treatment member 1008. The rearwardly openable dirt collection chamber door 1400 is rotatable about a dirt collection chamber opening axis 1402 that extends in the lateral direction transverse to the air treatment chamber axis 1050.

In the example illustrated in FIG. 65D, the lower portion of the air treatment member 1008 is a lower portion of the sidewall 1124 of the dirt collection chamber 1042. As shown, the first openable portion 1060₁ is a first and second laterally openable dirt collection chamber door 1400 rotatably mounted by hinges 1110 at laterally opposed sides of the air treatment member 1008. The laterally openable dirt collection chamber doors 1400 are rotatable about respective dirt collection chamber opening axes 1402 that are parallel to the air treatment chamber axis 1050.

In the example illustrated in FIGS. 66A-66C, the lower portion of the air treatment member 1008 is a lower portion of the sidewall 1124 of the dirt collection chamber 1042 and a lower portion of the sidewall 1084 of the air treatment chamber 1044. As shown, the first openable portion 1060₁ is a first and second laterally openable door. Each laterally openable door therefore forms both a dirt collection chamber door 1400 and an air treatment chamber door 1408 that is rotatably mounted by a hinge 1110 at lateral side of the air treatment member 1008. The laterally openable doors are rotatable about a respective axis that is parallel to the air treatment chamber axis 1050, where the axes are a coaxial dirt collection chamber opening axis 1402 and air treatment chamber opening axis 1410.

The second openable portion 1060₂ may include the front end wall 1076 of the air treatment member 1008. The second openable portion 1060₂ may be translatably mounted by rails 1128 that are parallel to the air treatment chamber axis 1050. The second openable portion 1060₂ may thus be forwardly openable.

In some embodiments, the front end wall 1076 of the air treatment member 1008 may be the front end wall 1108 of the air treatment chamber 1044. In such embodiments, the second openable portion 1060₂ may thus be a forwardly openable air treatment chamber door 1408. The forwardly openable air treatment chamber door 1408 may be translatably mounted by rails 1128 along an air treatment chamber opening axis 1410 that is parallel to the air treatment chamber axis 1050. In some such embodiments, the front end wall 1076 of the air treatment member 1008 may also be the front end wall of the dirt collection chamber 1042 (e.g., where the dirt collection chamber 1042 is below the air treatment chamber 1044). In such embodiments, the second openable portion 1060₂ may thus be a forwardly openable door forming both an air treatment chamber door 1408 and a dirt collection chamber door 1400. The forwardly openable door may be translatably mounted by rails 1128 along an air treatment chamber opening axis 1410 and a dirt collection chamber opening axis 1410, which are coaxial and parallel to the air treatment chamber axis 1050.

In alternate embodiments, the front end wall 1076 of the air treatment member 1008 may be the front end wall of the dirt collection chamber 1042 (e.g., where at least part of the dirt collection chamber 1042 is forward the air treatment chamber 1044). In such embodiments, the second openable portion 1060₂ may thus be a forwardly openable door forming a dirt collection chamber door 1400 and the air treatment chamber door 1408 may be axially forward and drivenly connected to the dirt collection chamber door (see e.g., FIGS. 37A-37F)0 Accordingly, the front end wall 1108 of the air treatment chamber 1044 may be rearwardly spaced from the front end wall 1076 of the air treatment member 1008 (e.g., where the dirt collection chamber 1042 is at least partially forward of the air treatment chamber 1044). In such embodiments, the second openable portion 1060₂ may thus be a forwardly openable dirt collection chamber door 1400. The forwardly openable dirt collection chamber door 1400 may be translatably mounted by rails 1128 along a dirt collection chamber opening axis 1410 that is parallel to the air treatment chamber axis 1050. In some such embodiments, the front end wall 1108 of the air treatment chamber 1044 (which may also be referred to as an arrestor plate in such embodiments) may be connected to the front end wall 1076 of the air treatment member 1008 and moveable therewith. In such embodiments, the second openable portion 1060₂ may thus include a forwardly openable dirt collection chamber door 1400 and a forwardly openable air treatment chamber door 1408. The forwardly openable air treatment chamber door 1408 and dirt collection chamber door 1400 may be translatably mounted by rails 1128 along an air treatment chamber opening axis 1410 and a dirt collection chamber opening axis 1410, which are coaxial and parallel to the air treatment chamber axis 1050.

For example, in the examples illustrated in FIGS. 65A-65D and 66A-66C, the front end wall 1108 of the air treatment chamber 1044 is rearwardly spaced from the front end wall 1076 of the air treatment member 1008. The front end wall 1108 of the air treatment chamber 1044 is connected to the front end wall 1076 of the air treatment member 1008 and moveable therewith (e.g., connected by a connector in FIGS. 65A-65D; connected by the inlet conduit 1070 in FIGS. 66A-66C). As shown, the second openable portion 1060₂ therefore includes a forwardly openable dirt collection chamber door 1400 and a forwardly openable air treatment chamber door 1408. The forwardly openable air treatment chamber door 1408 and dirt collection chamber door 1400 are translatably mounted by rails 1128. The forwardly openable air treatment chamber door 1408 and dirt collection chamber door 1400 are concurrently translatable along an axis that is parallel to the air treatment chamber axis 1050, where the axis is a coaxial dirt collection chamber opening axis 1402 and air treatment chamber opening axis 1410.

When the first openable portion 1060₁ is in the open position, a dirt collection chamber emptying port 1406 may be provided in a dirt collection chamber emptying plane 1404. When the air treatment chamber axis 1050 extends horizontally and the dirty air inlet 1002 is at the upper end 1018 of the hand vacuum cleaner 1000, the dirt collection chamber emptying plane 1404 may be generally horizontal. The dirt collection chamber opening axis 1402 may extend in the dirt collection chamber emptying plane 1404. Where the first openable portion 1060₁ also forms at least one air treatment chamber door 1400, an air treatment chamber emptying port 1414 may similarly be provided in an air treatment chamber emptying plane 1412 when the first openable portion 1060₁ is in the open position. When the air treatment chamber axis 1050 extends horizontally and the dirty air inlet 1002 is at the upper end 1018 of the hand vacuum cleaner 1000, the air treatment chamber emptying plane 1412 may also be generally horizontal. The air treatment chamber opening axis 1412 may extend in the air treatment chamber emptying plane 1414. Accordingly, when the first openable portion 1060₁ is in the open position, dirt and debris collected within the dirt collection chamber 1042 (and, in some embodiments, the air treatment chamber 1044) may fall downwardly through the dirt collection chamber emptying port 1406 (and, in some embodiments, the air treatment chamber emptying port 1414) into a refuse container or docking station below.

For example, in the examples illustrated in FIGS. 65B-65D, when the first openable portion 1060₁ is in the open position, a dirt collection chamber emptying port 1406 is provided in a dirt collection chamber emptying plane 1404. When the air treatment chamber axis 1050 extends horizontally and the dirty air inlet 1002 is at the upper end 1018 of the hand vacuum cleaner 1000, the dirt collection chamber emptying plane 1404 is generally horizontal. The dirt collection chamber opening axis 1402 extends in the dirt collection chamber emptying plane 1404. Accordingly, when the first openable portion 1060₁ is in the open position, dirt and debris collected within the dirt collection chamber 1042 may fall downwardly through the dirt collection chamber emptying port 1406.

In the example illustrated in FIG. 66C, when the first openable portion 1060₁ is in the open position, a dirt collection chamber emptying port 1406 is provided in a dirt collection chamber emptying plane 1404 and an air treatment chamber emptying port 1414 is provided in an air treatment chamber emptying plane 1412. When the air treatment chamber axis 1050 extends horizontally and the dirty air inlet 1002 is at the upper end 1018 of the hand vacuum cleaner 1000, the dirt collection chamber emptying plane 1404 and the air treatment chamber emptying plane 1412 are generally horizontal. As shown, the dirt collection chamber emptying plane 1404 and the air treatment chamber emptying plane 1412 may be coplanar. The dirt collection chamber opening axis 1402 extends in the dirt collection chamber emptying plane 1404. The air treatment chamber opening axis 1412 extends in the air treatment chamber emptying plane 1414. Accordingly, when the first openable portion 1060₁ is in the open position, dirt and debris collected within the hand vacuum cleaner 1000 may fall downwardly through the dirt collection chamber emptying port 1406 and the air treatment chamber emptying port 1414.

When the second openable portion 1060₂ is in the open position, an air treatment chamber emptying port 1414 may be provided in an air treatment chamber emptying plane 1412. When the air treatment chamber axis 1050 extends horizontally and the dirty air inlet 1002 is at the upper end 1018 of the hand vacuum cleaner 1000, the air treatment chamber emptying plane 1412 may be generally vertical and generally transverse to the air treatment chamber axis 1050. The air treatment chamber opening axes 1412 may be transverse to the air treatment chamber emptying plane 1414. Where the second openable portion 1060₂ includes a dirt collection chamber door 1400, a dirt collection chamber emptying port 1406 may be provided in a dirt collection chamber emptying plane 1404 when the second openable portion 1060₂ is in the open position. When the air treatment chamber axis 1050 extends horizontally and the dirty air inlet 1002 is at the upper end 1018 of the hand vacuum cleaner 1000, the dirt collection chamber emptying plane 1404 may be generally horizontal. The dirt collection chamber opening axes 1402 may extend parallel to the dirt collection chamber emptying plane 1404. Accordingly, when the second openable portion 1060₂ is in the open position, dirt and debris collected within the air treatment chamber 1044 (and, in some embodiments, the dirt collection chamber 1042) may fall forwardly through the air treatment chamber emptying port 1414 (and, in some embodiments, downwardly through the dirt collection chamber emptying port 1406) into a refuse container or docking station below.

For example, in the examples illustrated in FIGS. 65A-65D and 66A-66C, when the second openable portion 1060₂ is in the open position, an air treatment chamber emptying port 1414 is provided in an air treatment chamber emptying plane 1412 and a dirt collection chamber emptying port 1406 is provided in a dirt collection chamber emptying plane 1404. When the air treatment chamber axis 1050 extends horizontally and the dirty air inlet 1002 is at the upper end 1018 of the hand vacuum cleaner 1000, the air treatment chamber emptying plane 1412 is generally vertical and generally transverse to the air treatment chamber axis 1050 and the dirt collection chamber emptying plane 1404 is generally horizontal. The air treatment chamber opening axes 1412 are transverse to the air treatment chamber emptying plane 1414. The dirt collection chamber opening axes 1402 are parallel to the dirt collection chamber emptying plane 1404. Accordingly, when the second openable portion 1060₂ is in the open position, dirt and debris collected within hand vacuum cleaner 1000 may fall forwardly through the air treatment chamber emptying port 1414 and downwardly through the dirt collection chamber emptying port 1406 into a refuse container or docking station below.

The first openable portion 1060₁ may be held in the closed position by a latch or any other suitable actuatable holding means. A user may release the first openable portion 1060₁ by actuating the holding means. Once released, the first openable portion 1060₁ may move to the open position (e.g., under the influence of gravity or a biasing means). The first openable portion 1060₁ may be openable independently of the second openable portion 1060₂. That is, the first openable portion 1060₁ may be openable while the second openable portion 1060₂ remains in the closed position.

Similarly, the second openable portion 1060₂ may be held in the closed position by a latch or any other suitable actuatable holding means. A user may thus release the second openable portion 1060₂ by actuating the holding means. Once released, the second openable portion 1060₂ may move to the open position (e.g., under the influence of gravity or a biasing means). The second openable portion 1060₂ may be openable independently of the first openable portion 1060₁. That is, the second openable portion 1060₂ may be openable while the first openable portion 1060₁ remains in the closed position.

Optionally, in some embodiments, opening one of the first openable portion 1060₁ and the second openable portion 1060₂ may concurrently open the other of the first openable portion 1060₁ and the second openable portion 1060₂. In such embodiments, actuating the holding means of one of the first openable portion 1060₁ and the second openable portion 1060₂ may concurrently actuate the holding means of the other of the first openable portion 1060₁ and the second openable portion 1060₂. One of the first openable portion 1060₁ and the second openable portion 1060₂ may be drivingly connected to the other by any means disclosed herein.

For example, in the examples illustrated in FIGS. 65A-65D and 66A-66C, a latch actuator 1120 of the first openable portion 1060₁ is provided on the front end wall 1076 of the air treatment member 1008. When the second openable portion 1060₂ is released by actuating the holding means (not shown in FIGS. 65A-65D; shown as locking member 1152 in FIGS. 66A-66C), the latch actuator 1120 of the first openable portion 1060₁ translates with the front end wall 1076. In this way, the latch actuator 1120 may be retracted from holding the first openable portion 1060₁ in the closed position. Actuating the holding means of the second openable portion 1060₂ may thus concurrently actuate the holding means of the first openable portion 1060₁. The first openable portion 1060₁, on the other hand, may be openable independently of the second openable portion 1060₂. That is, when the second openable portion 1060₂ is in the closed position, the latch actuator 1120 of the first openable portion 1060₁ may be actuated by depressing button 1134. The first openable portion 1060₁ may then move to the open position while the second openable portion 1060₂ remains in the closed position.

When a hand vacuum cleaner 1000 with an air treatment member 1008 having first and second openable portions 1060 as described in this section is docked to a docking station 1424, at least one of the first openable portion 1060₁ and the second openable portion 1060₂ may open. That is, docking the hand vacuum cleaner 1000 to the docking station 1424 may actuate at least one of the holding means of the first openable portion 1060₁ and the second openable portion 1060₂.

For example, the example illustrated in FIG. 65C shows an air treatment member 1008 docked to a docking station 1424. In the example shown, the docking station 1424 has an abutment surface 1426 configured to engage the button 1134 of the latch actuator 1120 of the first openable portion 1060₁ as the hand vacuum cleaner 1000 is docked, thereby releasing the first openable portion 1060₁. Similarly, the example illustrated in FIG. 65D shows another air treatment member 1008 docked to a docking station 1424. In the example shown, the docking station 1424 has an abutment surface (not shown) configured to engage the holding means of the second openable portion 1060₂ (not shown) as the hand vacuum cleaner 1000 is docked, thereby releasing the second openable portion 1060₂ and, resultantly, the first openable portion 1060₁. By actuating the holding means of the second openable portion 1060₂, docking the hand vacuum cleaner 1000 thus concurrently opens both the first and second openable portions.

Optionally, where the front end wall 1108 of the air treatment chamber 1044 is in the form of an arrestor plate (i.e., connected to the front end wall 1076 of the air treatment member 1008), a portion of the front end wall 1108 (referred to herein as an arrestor valve 1494) may be moveably mounted to a remainder of the front end wall 1108. The arrestor valve 1494 may be rotatably mounted to the remainder of the front end wall 1108 by a hinge 1110. The arrestor valve 1494 may be rotatable between a closed position, in which the front end wall 1108 encloses the front end 1036 of the air treatment chamber 1044, and an open position, in which the front end 1036 of the air treatment chamber 1044 is at least partially opened.

The front end wall 1108 of the air treatment chamber 1044 may be moveable with the front end wall 1076 of the air treatment member 1008 as described previously. In some embodiments, moving the second openable portion 1060₂ between the closed position and the open position may drive the arrestor valve 1494 to move between the closed position and the open position. The arrestor valve 1494 may be driven by any suitable means (e.g., gears). In alternate embodiments, the arrestor valve 1494 may be moveable independently of the second openable portion 1060₂.

For example, in the examples illustrated in FIGS. 65C and 65D, the arrestor valve 1494 is translatable with the second openable portion 1060₂. The arrestor valve 1494 is also moveable independently from the second openable portion 1060₂. The arrestor valve 1494 may be biased to the closed position by a bias (e.g., a torsion spring). Subsequent to docking the hand vacuum cleaner 1000 to the docking station 1424, an emptying operation in a docking mode may commence. During the emptying operation, the station suction motor 1448 may generate suction to draw dirt collected in the hand vacuum cleaner 1000 through the opening of the openable portions 1060, through the station inlet port 1446, and into the station receptacle 1444. As shown, the suction force may be sufficient to overcome the biasing force of the bias to thereby move the arrestor valve 1494 to the open position. Upon completion of the emptying operation, the station suction motor 1448 may deactivate, and the bias may return the arrestor valve 1494 to the closed position.

Optionally, as shown in the examples illustrated in FIGS. 65C and 65D, the dirt outlet 1052 of the air treatment chamber 1044 may be positioned adjacent the arrestor valve 1494. In this way, moving the arrestor valve 1494 to the open position may open the dirt outlet 1052. This may urge any compacted debris to be dislodged from the dirt outlet 1052. This may also create a larger opening at the front end 1036 of the air treatment chamber 1044 when the arrestor valve 1494 is in the open position.

In the illustrated examples described in this section, the air treatment chambers 1044 are cyclone chambers, and the air treatment chamber axes 1050 are cyclone axes of rotation. It will be appreciated, however, that any other type of air treatment chamber may be used with the openable portion(s) described herein.

### Air Treatment Assembly Door Lock

In accordance with this aspect of this disclosure, which may be used by itself or in combination with one or more other aspects of this disclosure, a surface cleaner such as the hand vacuum cleaner may have an air treatment member having at least one door such as a dirt collection chamber door and or an air treatment chamber door that can be locked in the closed position. In accordance with this aspect, each air treatment chamber door, such as a laterally openable door, can be locked in the closed position by one or more axially translatable members such as an axially extending member(s).

In accordance with this aspect, an air treatment assembly may have any openable door known in the art. The door may be secured in a closed position by a lock comprising a locking element that is translated such that part of the locking element is received in an opening of a stationary member. Once inserted, the locking element inhibits the door from moving to an open position. The locking element is translated in a direction that is different to the direction the door moves from the closed position to the open position. Accordingly, if the door rotates open, then the locking element may translate in a direction that is parallel to the axis of rotation of the door. If the door translates open, then the locking element may translate in a direction that is transverse to the direction that the door moves from the closed position to the open position.

It will be appreciated that, if as exemplified herein, two doors are provided which move to open an air treatment chamber or a dirt collection chamber, then a lock may be provided for each door. Alternately, if a first door overlaps a second door, then the first door that overlaps the second door may have an associated lock and, in the closed position, the lock secures the first door in the closed position and the first door secures the second door in the closed position.

It will be appreciated that is an external dirt collection chamber is provided, then the air treatment chamber and/or the dirt collection chamber may have one or more doors that are held in a closed position by a translatable lock.

The locking element may be a pin or other locking element that has a portion which extends in the translatable direction such that the portion may be translated into an opening so as to inhibit a door moving in a direction that is in different to the translation direction.

The air treatment chamber 1044 may have at least one air treatment chamber door 1408 that is operable to open the air treatment chamber 1044. The air treatment chamber door 1408 may be pivotably mounted by a hinge 1110 about an air treatment chamber opening axis 1410. The air treatment chamber opening axis 1410 may be parallel to the air treatment chamber axis 1050. In this way, when the air treatment chamber door 1408 is pivoted about the air treatment chamber opening axis 1410 between the closed position and the open position, the air treatment chamber door 1408 may move in a lateral direction (as defined previously herein).

Optionally, the air treatment chamber 1044 may have a first air treatment chamber door 1408a and a second air treatment chamber door 1408b that are each pivotably mounted by a respective hinge 1110 about a respective air treatment chamber opening axis 1410. The air treatment chamber opening axes 1410 may be parallel to the air treatment chamber axis 1050. The air treatment chamber opening axes 1410 may be positioned at opposed lateral sides of the air treatment chamber 1044. In this way, the first air treatment chamber door 1408a may move in a first lateral direction from the closed position to the open position and the second air treatment chamber door 1408b may move in a second lateral direction from the closed position to the open position (as described previously herein).

The air treatment chamber 1044 may have a lock that secures one or more doors, such as the air treatment chamber door(s) 1408 in the closed position. The lock may include at least one member that is translatable axially between a locked and unlocked position. Accordingly, for example, an axially extending member, such as an axially extending pin 1496, for each air treatment chamber door 1408. Each axially extending pin 1496 may be parallel to the air treatment chamber axis 1050. Each axially extending pin 1496 may be slidably positioned in an axially extending pin channel 1498. When the air treatment chamber door 1408 is in the closed position, an opening 1502 (i.e., an outlet port) of an axially extending pin channel 1498 may be aligned with an opening 1504 (i.e., an inlet port) of a corresponding axially extending hole 1500. In this way, each axially extending pin 1496 may be removably receivable in the corresponding axially extending hole 1500 from the axially extending pin channel 1498 when the air treatment chamber door 1408 is in the closed position. Each axially extending pin 1496 may thus be moveable between a locked position and an unlocked position. In the locked position, the axially extending pin 1496 may extend from the opening 1502 of the axially extending pin channel 1498 and through the opening 1504 of the axially extending hole 1500. In the unlocked position, the axially extending pin 1496 may be exterior to the opening 1504 of the axially extending hole 1500 (i.e., fully within the axially extending pin channel 1498). When each axially extending pin 1496 is in the unlocked position, the air treatment chamber doors 1408 may be moveable from the closed position to the open position by any means described herein.

An axially extending pin channel 1498 may be provided in each air treatment chamber door 1408. Accordingly, at least one axially extending pin 1496 of the lock may be slidably positioned within each air treatment chamber door 1408. The opening 1502 of each axially extending pin channel 1498 may thus be provided at a front end, a rear end, or the front and rear ends, of each air treatment chamber door 1408.

An axially extending hole 1500 may be provided in the front end wall 1108 of the air treatment chamber 1044, the rear end wall 1106 of the air treatment chamber 1044, or both end walls 1106, 1108 of the air treatment chamber 1044. The opening 1504 of each axially extending hole 1500 may thus similarly be provided in the front end wall 1108 and/or rear end wall 1106 of the air treatment chamber 1044.

The opening 1502 of each axially extending pin channel 1498 may extend in a plane that is transverse to the air treatment chamber axis 1050. The opening 1504 of each axially extending hole 1500 may also extend in a plane that is transverse to the air treatment chamber axis 1050. The openings 1502, 1504 of the axially extending pin channel 1498 and the axially extending hole 1500 may thus extend in adjacent parallel planes at the front end 1036 and/or rear end 1040 of the air treatment chamber 1044.

In embodiments in which the opening 1504 of each axially extending hole 1500 is provided in the front end wall 1108 of the air treatment chamber 1044, the opening 1502 of each axially extending pin channel 1498 may be provided at the front end of each air treatment chamber door 1408. In this way, when the air treatment chamber door 1408 is in the closed position and the opening 1502 of each axially extending pin channel 1498 is aligned with the opening 1504 of a corresponding axially extending hole 1500, each axially extending pin 1496 may be moveable rearwardly from the locked position to the unlocked position.

In embodiments in which the opening 1504 of each axially extending hole 1500 is provided in the rear end wall 1106 of the air treatment chamber 1044, the opening 1502 of each axially extending pin channel 1498 may be provided at the rear end of each air treatment chamber door 1408. In this way, when the air treatment chamber door 1408 is in the closed position and the opening 1502 of each axially extending pin channel 1498 is aligned with the opening 1504 of a corresponding axially extending hole 1500, each axially extending pin 1496 may be moveable forwardly from the locked position to the unlocked position.

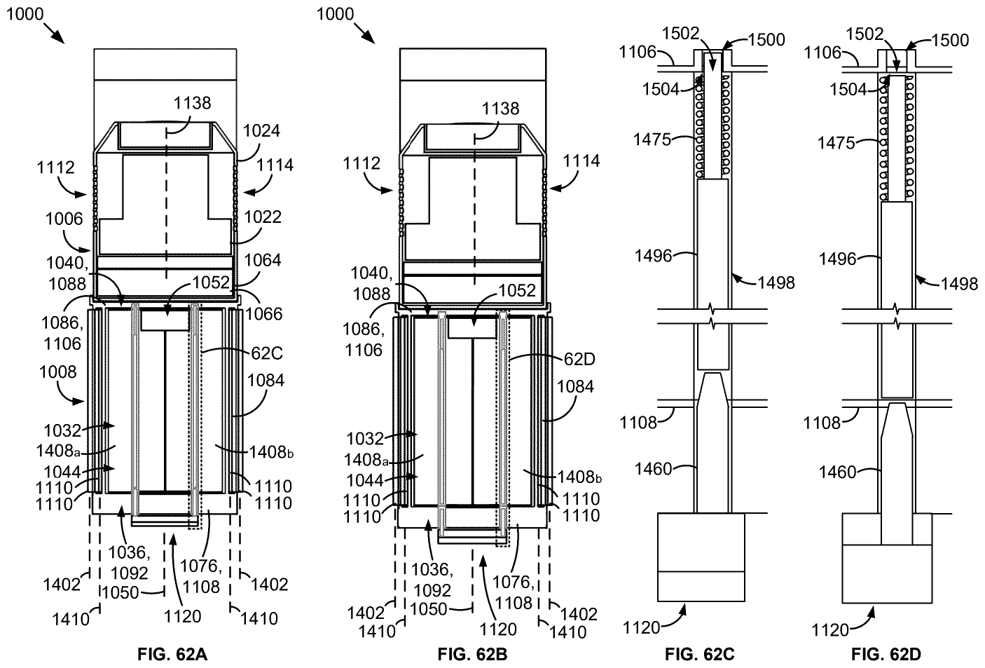

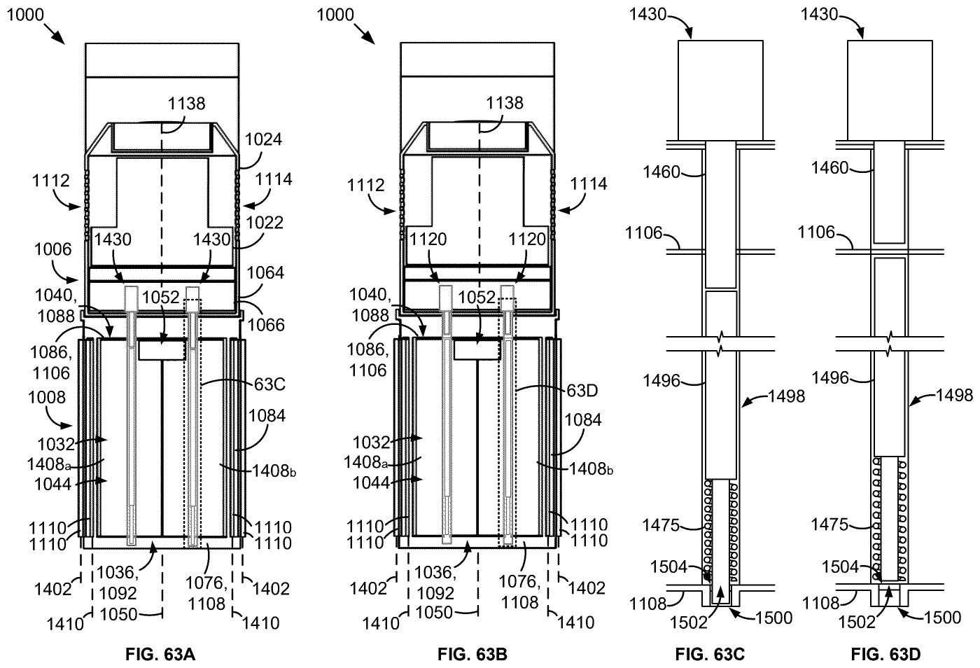

For example, in the examples illustrated in FIGS. 62A-62D and 63A-63D, the air treatment chamber 1044 has first and second laterally openable air treatment chamber doors 1408 and a lock that secures the air treatment chamber doors 1408 in the closed position. As shown, the lock includes an axially extending pin 1496 for each air treatment chamber door 1408. The axially extending pins 1496 are each slidably positioned in an axially extending pin channel 1498 within a respective one of the air treatment chamber doors 1408. As shown, when the air treatment chamber doors 1408 are in the closed position, an opening 1502 of each axially extending pin channel 1498 is aligned with an opening 1504 of a corresponding axially extending hole 1500. When the air treatment chamber doors 1408 are in the closed position, each axially extending pin 1496 is moveable between a locked position (see e.g., FIGS. 62A and 62C, 63A and 63C), in which the axially extending pin 1496 extends from the opening 1502 of the axially extending pin channel 1498 and through the opening 1504 of the axially extending hole 1500, and an unlocked position (see e.g., FIGS. 62B and 62D, 63B and 63D), in which the axially extending pin 1496 is exterior to the opening 1504 of the axially extending hole 1500.

In the example illustrated in FIGS. 62A-62D, the opening 1504 of each axially extending hole 1500 is provided in the rear end wall 1106 of the air treatment chamber 1044. The opening 1502 of each axially extending pin channel 1498 is correspondingly provided at the rear end of each air treatment chamber door 1408. In this way, when the air treatment chamber door 1408 is in the closed position and the opening 1502 of each axially extending pin channel 1498 is aligned with the opening 1504 of a corresponding axially extending hole 1500, each axially extending pin 1496 is moveable forwardly from the locked position (see e.g., FIGS. 62A and 62C) to the unlocked position (see e.g., FIGS. 62B and 62D). The openings 1502, 1504 of the axially extending pin channel 1498 and the axially extending hole 1500 extend in adjacent parallel planes (out of page transverse to the air treatment chamber axis 1050) at the rear end 1040 of the air treatment chamber 1044.

In the example illustrated in FIGS. 63A-63D, the opening 1504 of each axially extending hole 1500 is provided in the front end wall 1108 of the air treatment chamber 1044. The opening 1502 of each axially extending pin channel 1498 is correspondingly provided at the front end of each air treatment chamber door 1408. In this way, when the air treatment chamber door 1408 is in the closed position and the opening 1502 of each axially extending pin channel 1498 is aligned with the opening 1504 of a corresponding axially extending hole 1500, each axially extending pin 1496 is moveable rearwardly from the locked position (see e.g., FIGS. 63A and 63C) to the unlocked position (see e.g., FIGS. 63B and 63D). The openings 1502, 1504 of the axially extending pin channel 1498 and the axially extending hole 1500 extend in adjacent parallel planes (out of page transverse to the air treatment chamber axis 1050) at the front end 1036 of the air treatment chamber 1044.

Optionally, the lock may include two axially extending members, such as a first axially extending pin 1496a and a second axially extending pin 1496b, for each air treatment chamber door 1408. In such embodiments, the opening 1504 of a first axially extending hole 1500a may be provided in the rear end wall 1106 of the air treatment chamber 1044 and the opening 1502 of a first axially extending pin channel 1498a may be provided at the rear end of each air treatment chamber door 1408. Additionally, the opening 1504 of a second axially extending hole 1500b may be provided in the front end wall 1108 of the air treatment chamber 1044 and the opening 1502 of a second axially extending pin channel 1498b may be provided at the front end of each air treatment chamber door 1408. The first axially extending pin 1496a may be provided in the first axially extending pin channel 1498a and the second axially extending pin 1496b may be provided in the second axially extending pin channel 1498b.

The openings 1502, 1504 of the first axially extending pin channel 1498a and the first axially extending hole 1500a may thus extend in adjacent parallel planes at the rear end 1040 of the air treatment chamber 1044 and the openings 1502, 1504 of the second axially extending pin channel 1498b and the second axially extending hole 1500b may extend in adjacent parallel planes at the front end 1036 of the air treatment chamber 1044. In this way, when the air treatment chamber door 1408 is in the closed position and the opening 1502 of each first axially extending pin channel 1498a is aligned with the opening 1504 of a corresponding first axially extending hole 1500a, each first axially extending pin 1496a may be moveable forwardly from the locked position to the unlocked position. At the same time, the opening 1502 of each second axially extending pin channel 1498b may be aligned with the opening 1504 of a corresponding second axially extending hole 1500b such that each second axially extending pin 1496b may be moveable rearwardly from the locked position to the unlocked position.

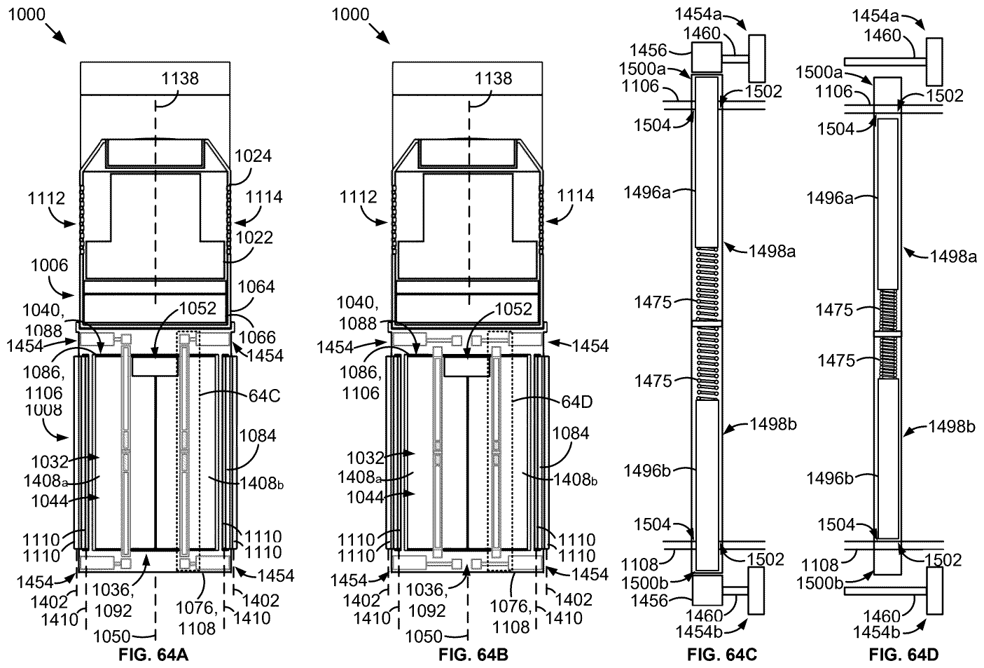

For example, in the example illustrated in FIGS. 64A-64D, the air treatment chamber 1044 has first and second laterally openable air treatment chamber doors 1408 and a lock that secures the air treatment chamber doors 1408 in the closed position. As shown, the lock includes a first axially extending pin 1496a and a second axially extending pin 1496b for each air treatment chamber door 1408. The first axially extending pins 1496a are each slidably positioned in a first axially extending pin channel 1498a within a respective one of the air treatment chamber doors 1408 and the second axially extending pins 1496b are each slidably positioned in a second axially extending pin channel 1498b within a respective one of the air treatment chamber doors 1408. As shown, when the air treatment chamber door 1408 is in the closed position, an opening 1502 of each axially extending pin channel 1498 is aligned with an opening 1504 of a corresponding axially extending hole 1500. When the air treatment chamber door 1408 is in the closed position, each axially extending pin 1496 is moveable between a locked position (see e.g., FIGS. 64A and 64C), in which the axially extending pin 1496 extends from the opening 1502 of the axially extending pin channel 1498 and through the opening 1504 of the axially extending hole 1500, and an unlocked position (see e.g., FIGS. 64B and 64D), in which the axially extending pin 1496 is exterior to the opening 1504 of the axially extending hole 1500.

In the illustrated example, the opening 1504 of each first axially extending hole 1500a is provided in the rear end wall 1106 of the air treatment chamber 1044 and the opening 1502 of each first axially extending pin channel 1498a is correspondingly provided at the rear end of each air treatment chamber door 1408. The opening 1504 of each second axially extending hole 1500b is provided in the front end wall 1108 of the air treatment chamber 1044 and the opening 1502 of each second axially extending pin channel 1498b is correspondingly provided at the front end of each air treatment chamber door 1408. In this way, when the air treatment chamber doors 1408 are in the closed position and the opening 1502 of each axially extending pin channel 1498 is aligned with the opening 1504 of a corresponding axially extending hole 1500, each first axially extending pin 1496a is moveable forwardly from the locked position to the unlocked position and each second axially extending pin 1496b is moveable rearwardly from the locked position to the unlocked position. The openings 1502, 1504 of the first axially extending pin channel 1498a and the first axially extending hole 1500a extend in adjacent parallel planes (out of page transverse to the air treatment chamber axis 1050) at the rear end 1040 of the air treatment chamber 1044 and the openings 1502, 1504 of the second axially extending pin channel 1498b and the second axially extending hole 1500b extend in adjacent parallel planes (out of page transverse to the air treatment chamber axis 1050) at the front end 1036 of the air treatment chamber 1044.

The axially extending pins 1496 may be moved between the locked position and the unlocked position by any suitable means. For example, each axially extending pin 1496 may be biased by a bias 1475 to one of the locked position and the unlocked position. The lock may thus include an actuator (e.g., manual or automatic) to move the axially extending pins 1496 against the biasing force of the bias 1475 to the other of the locked position and the unlocked position.

For example, in the example illustrated in FIGS. 62A-62D, the axially extending pins 1496 are each biased by a bias 1475, shown as a compression spring, to the unlocked position. As shown, the lock includes a manual actuator 1120 to hold the axially extending pins 1496 in the locked position against the biasing force of the biases 1475. The actuator 1120 includes drive rods 1460, which are removably receivable in the axially extending pin channels 1498. The actuator 1120 is biased to a locked position in which the drive rods 1460 each extend into a respective one of the axially extending pin channels 1498 and engage the axially extending pins 1496 therein. The biasing force of the actuator 1120 may be greater than the combined biasing force of the biases 1475 such that the drive rods 1460 may hold the axially extending pins 1496 in the locked position. A user may thus move the axially extending pins 1496 to the unlocked position by actuating the actuator 1120, which may function as a lever to retract the drive rods 1460 from the axially extending pin channels 1498. The bias 1475 of each axially extending pin 1496 may then move the axially extending pins 1496 forwardly from the locked position to the unlocked position.

In the example illustrated in FIGS. 63A-63D, the axially extending pins 1496 are each biased by a bias 1475, shown as a compression spring, to the unlocked position. As shown, the lock includes linear actuators 1430 to hold the axially extending pins 1496 in the locked position against the biasing force of the biases 1475. Each linear actuator 1430 includes a drive rod 1460, which is removably receivable in a corresponding axially extending pin channel 1498. Each linear actuator 1430 is deactivated in a locked position in which the drive rods 1460 each extend into the corresponding axially extending pin channel 1498 and engage the axially extending pin 1496 therein. The force of the linear actuator 1430 may be greater than the biasing force of the bias 1475 such that the drive rods 1460 may hold the axially extending pin 1496 in the locked position. A user or docking station (e.g., a sensor detecting the hand vacuum cleaner has been docked) may activate the linear actuators 1430 to move the axially extending pins 1496 to the unlocked position in which the drive rods 1460 are retracted from the axially extending pin channels 1498. The bias 1475 of each axially extending pin 1496 may then move the axially extending pins 1496 rearwardly from the locked position to the unlocked position.

In the example illustrated in FIGS. 64A-64D, the axially extending pins 1496 are each biased by a bias 1475, shown as a tension spring, to the unlocked position. As shown, the lock includes magnetic actuators 1454 having actuator magnets 1456 to hold the axially extending pins 1496 in the locked position against the biasing force of the biases 1475. The magnetic actuators 1454 corresponding to the first axially extending pins 1496a are positioned rearward of the rear end wall 1106 of the air treatment chamber 1044 and the magnetic actuators 1454 corresponding to the second axially extending pins 1496b are positioned forward of the front end wall 1108 of the air treatment chamber 1044. The magnetic actuators 1454 are positioned such that the actuator magnet 1456 may magnetically couple to the corresponding axially extending pin 1496 from the exterior of the air treatment chamber 1044. The magnetic force of the actuator magnet 1456 may be greater than the biasing force of the bias 1475 such that the actuator magnet 1456 may hold the axially extending pin 1496 in the locked position. A user or docking station (e.g., a sensor detecting the hand vacuum cleaner has been docked) may activate the magnetic actuators 1454, shown as linear actuators, to move the actuator magnets 1456 away from the axially extending pins 1496. The bias 1475 of each first axially extending pin 1496a may then move the axially extending pins 1496a forwardly from the locked position to the unlocked position and the bias 1475 of each second axially extending pin 1496b may then move the axially extending pins 1496b rearwardly from the locked position to the unlocked position.

Any dirt collection chamber 1042 described herein may be used. For example, the dirt collection chamber 1042 may be forward of and/or below air treatment chamber 1044. The dirt collection chamber 1042 may have any dirt collection chamber door(s) 1400 as described herein. Optionally, the dirt collection chamber 1042 may have a lock that secures the dirt collection chamber door(s) 1400 in the closed position. The lock may be configured any way as described herein with respect to the air treatment chamber doors 1408. The lock for the dirt collection chamber door(s) 1400 may be in addition to that for the air treatment chamber door(s) 1408 (i.e., separate locks). Alternatively, a common lock may be used for both the dirt collection chamber door(s) 1400 and the air treatment chamber door(s) 1408. The common lock may directly unlock both the dirt collection chamber door(s) 1400 and the air treatment chamber door(s) 1408. Alternatively, the common lock may directly unlock one of the dirt collection chamber door(s) 1400 and the air treatment chamber door(s) 1408, and the one of the dirt collection chamber door(s) 1400 and the air treatment chamber door(s) 1408 may be drivingly connected to the other of the dirt collection chamber door(s) 1400 and the air treatment chamber door(s) 1408. In this way, unlocking the one of the dirt collection chamber door(s) 1400 and the air treatment chamber door(s) 1408 may indirectly unlock the other of the dirt collection chamber door(s) 1400 and the air treatment chamber door(s) 1408.

In the illustrated examples described in this section, the air treatment chambers 1044 are cyclone chambers, and the air treatment chamber axes 1050 are cyclone axes of rotation. It will be appreciated, however, that any other type of air treatment chamber may be used with the openable portion(s) described herein.

### Ovaloid Air Treatment Assembly

In accordance with this aspect of this disclosure, which may be used by itself or in combination with one or more other aspects of this disclosure, a surface cleaner, such as the hand vacuum cleaner may have an ovaloid air treatment assembly which may have at least one laterally openable air treatment assembly door such as an air treatment chamber having at least one laterally openable air treatment chamber door and/or an external dirt collection chamber having at least one laterally openable dirt collection chamber door.

The air treatment member 1008 may have a first openable portion 1060₁ and a second openable portion 1060₂. The first openable portion 1060₁ may be at least one dirt collection chamber door 1400 operable to open the dirt collection chamber 1042. The second openable portion 1060₂ may be at least one air treatment chamber door 1408 operable to open the air treatment chamber 1044.

Each air treatment chamber door 1408 may be pivotably mounted by a hinge 1110 about an air treatment chamber opening axis 1410. Each air treatment chamber opening axis 1410 may be parallel to the air treatment chamber axis 1050. In this way, when each air treatment chamber door 1408 is pivoted about the air treatment chamber opening axis 1410 between the closed position and the open position, the air treatment chamber door 1408 may move in a lateral direction (as defined previously herein). Where the air treatment chamber 1044 has a first air treatment chamber door 1408a and a second air treatment chamber door 1408b, the air treatment chamber opening axes 1410 may be positioned at opposed lateral sides of the air treatment chamber 1044. In this way, the first air treatment chamber door 1408a may move in a first lateral direction from the closed position to the open position and the second air treatment chamber door 1408b may move in a second lateral direction from the closed position to the open position (as described previously herein).

The sidewall 1084 of the air treatment chamber 1044 may have a stationary portion 1506 and a moveable portion. The moveable portion may include the air treatment chamber door(s) 1408. The sidewall 1084 of the air treatment chamber 1044 may have a perimeter 1508 in a transverse plane that is transverse to the air treatment chamber axis 1050. The stationary portion 1506 of the sidewall 1084 may form a first part of the perimeter 1508 and the air treatment chamber door(s) 1408 may form a second part of the perimeter 1508.

When the air treatment chamber axis 1050 extends horizontally and the dirty air inlet 1002 is at the upper end 1018 of the hand vacuum cleaner 1000, the air treatment chamber door(s) 1408 may form a lower portion of the sidewall 1084 of the air treatment chamber 1044. The moveable portion may therefore be the lower portion of the sidewall 1084 and the stationary portion 1506 may be an upper portion of the sidewall 1084. Similarly, the second part of the perimeter 1508 may be a lower part of the perimeter 1508 and the first part of the perimeter 1508 may be an upper part of the perimeter 1508.

The air treatment chamber 1044 may be ovaloid in the transverse plane. That is, the perimeter 1508 of the sidewall 1084 of the air treatment chamber 1044 may define an ovaloid shape. At least the second part of the perimeter 1508, which is formed by the air treatment chamber door(s) 1408, may be ovaloid. Optionally, the first part of the perimeter 1508, which is formed by the stationary portion 1506 of the sidewall 1084, may also be at least partially ovaloid. In such embodiments, the air treatment chamber 1044 may be generally oval in the transverse plane (i.e., the perimeter 1508 may define an oval shape). Alternatively, the first part of the perimeter 1508 may be generally circular. In such embodiments, the air treatment chamber 1044 may be generally egg-shaped in the transverse plane (i.e., the perimeter 1508 may define an egg shape). It will be appreciated that alternately or in addition, a dirt collection chamber door may be similarly shaped.

An advantage of the second part of the perimeter 1508 formed by the air treatment chamber door(s) 1408 being ovaloid is that it may reduce the degree of curvature of each air treatment chamber door 1408. Accordingly, the air treatment chamber doors 1408 may hang straighter in the open position. This may enable the air treatment chamber doors 1408 to open to a greater extent than generally circular doors.

Optionally, each air treatment chamber door 1408 may be divided into rigid sections 1418 connected by a living hinge 1416 as described previously herein. The living hinge 1416 may allow the air treatment chamber door(s) 1408 to open to a greater extent. That is, the ovaloid shape of the air treatment chamber door(s) 1408 may reduce the degree of curvature of each air treatment chamber door 1408 and thereby allow the air treatment chamber doors 1408 to hang straighter in the open position. By further subdividing the air treatment chamber door(s) 1408 into a first rigid section 1418a and a second rigid section 1418b connected by a living hinge 1416, the second rigid section 1418b may pivot relative to the first rigid section 1418a such that the air treatment chamber doors 1408 may hang even straighter in the open position.

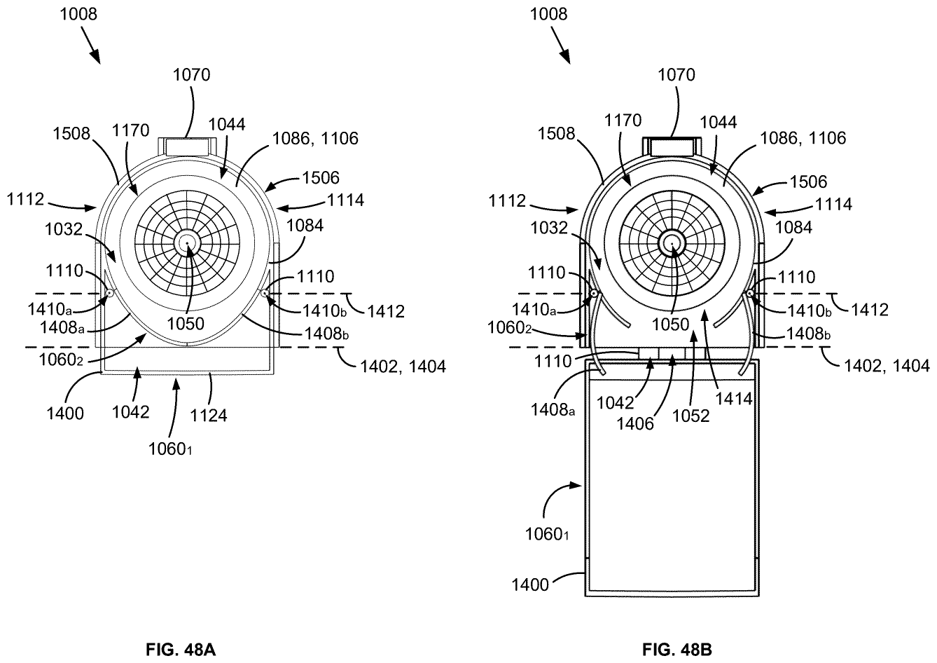

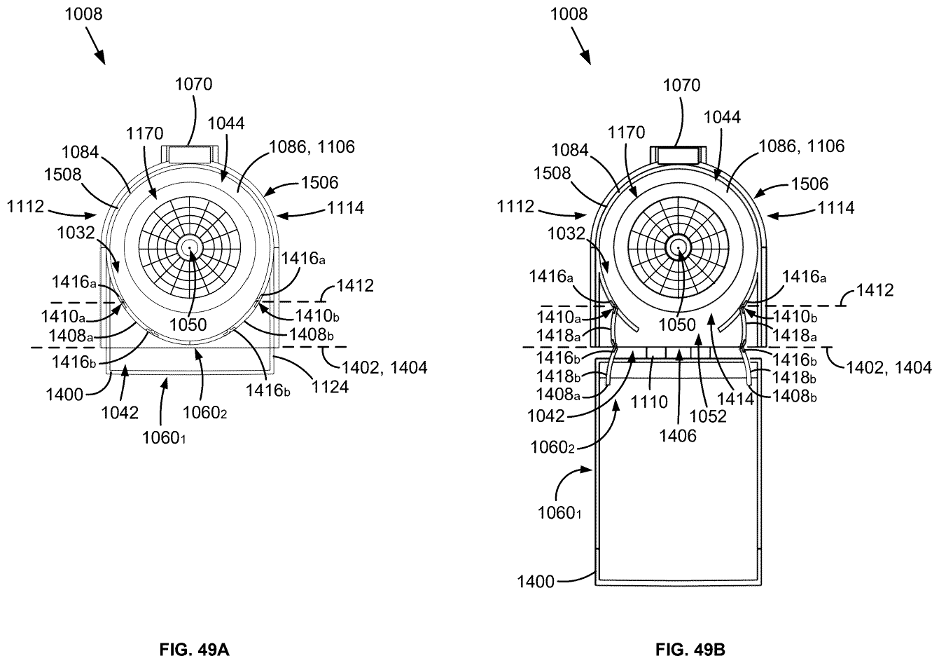

For example, in the example illustrated in FIGS. 48A-48B, the air treatment chamber 1044 has first and second ovaloid air treatment chamber doors 1408 that are rotatably mounted about respective hinges 1110. In the example illustrated in FIGS. 49A-49B, the air treatment chamber 1044 has first and second ovaloid air treatment chamber doors 1408 that are rotatably mounted about respective first living hinges 1416a and divided into first and second rigid sections 1418 by respective second living hinges 1416b. As shown, the air treatment chamber doors 1408 of FIG. 49B open to a greater extent than those of FIG. 48B. The second living hinge 1416b may allow the second rigid section 1418b to rotate relative to the first rigid section 1418a such that each air treatment chamber door 1408 hangs straighter in the open position.

The extent to which the air treatment chamber door(s) 1408 and/or dirt collection chamber door(s) is/are opened may thus be enhanced by the shape of the air treatment chamber door(s) and further enhanced using living hinges 1416. The ovaloid air treatment chamber door(s), alone or in combination with the living hinge 1416, may therefore ensure that the air treatment chamber emptying port 1414 and/or dirt collection chamber emptying port is relatively unobstructed by the air treatment chamber door(s) 1408 when in the open position. This may improve emptying of the air treatment chamber 1044.

In the example illustrated in FIGS. 49A-49B, the air treatment chamber doors 1408 are pivotably mounted to the stationary portion 1506 of the sidewall 1084 by a first living hinge 1416a about a first air treatment chamber opening axis 1410a. The first living hinge 1416a extends along the sidewall 1084 of the air treatment chamber 1044 parallel to the air treatment chamber axis 1050. The air treatment chamber opening axis 1410 is therefore also parallel to the air treatment chamber axis 1050. The air treatment chamber doors 1408 further have a second living hinge 1416b connecting a first rigid section 1418a of the air treatment chamber door 1408 to a second rigid section 1418b of the air treatment chamber door 1408. The second rigid section 1418b of the air treatment chamber door 1408 is pivotably mounted to the first rigid section 1418a by the second living hinge 1416b about a second air treatment chamber opening axis 1410b. The second living hinge 1416b extends along the air treatment chamber door 1408 parallel to the air treatment chamber axis 1050. The second air treatment chamber opening axis 1410b is therefore also parallel to the air treatment chamber axis 1050. In this way, when the air treatment chamber doors 1408 are pivoted about the first air treatment chamber opening axis 1410a between the closed position and the open position, the air treatment chamber doors 1408 may move in the lateral direction. The second rigid section 1418b of the air treatment chamber doors 1408 may move further in the lateral direction relative to the first rigid section 1418a by pivoting about the second air treatment chamber opening axis 1410b.

The dirt collection chamber 1042 may be external to the air treatment chamber 1044 and, in operation, dirt may travel through a dirt outlet 1052 from the air treatment chamber 1044 to the dirt collection chamber 1042. When the air treatment chamber axis 1050 extends horizontally and the dirty air inlet 1002 is at the upper end 1018 of the hand vacuum cleaner 1000, at least a portion of the dirt collection chamber 1042 may underlie the air treatment chamber 1044. Similarly, the portion of the dirt collection chamber 1042 may also underlie the air treatment chamber door(s) 1408. In such embodiments, when each air treatment chamber door 1408 is moved from the closed position to the open position, the air treatment chamber door 1408 may descend through the underlying portion of the dirt collection chamber 1042. An advantage of this design is that, as the air treatment chamber door 1408 descends though the dirt collection chamber 1042, the air treatment chamber door 1408 may push dirt and debris from the dirt collection chamber 1042. This may improve emptying of the dirt collection chamber 1042.

The dirt collection chamber door 1400 may be rotatably mounted by a hinge 1110 about a dirt collection chamber opening axis 1402 that is parallel to the air treatment chamber opening axis 1410 of each air treatment chamber door 1408. Alternatively, the dirt collection chamber door 1400 may be rotatably mounted by a hinge 1110 about a dirt collection chamber opening axis 1402 that extends in a different direction than the air treatment chamber opening axis 1410 of each air treatment chamber door 1408 (i.e., different than the forward/rearward direction). In this way, when the dirt collection chamber door 1400 is moved between a closed position and an open position, the dirt collection chamber door 1400 may move in a different direction than the lateral direction. For example, the dirt collection chamber door 1400 may move between the open and closed position in the forward/rearward direction transverse to the lateral direction.

For example, in the examples illustrated in FIGS. 48A-48B and 49A-49B, the dirt collection chamber 1042 is external to the air treatment chamber 1044 and in communication with the air treatment chamber 1044 through a dirt outlet 1052. As shown, when the air treatment chamber axis 1050 extends horizontally and the dirty air inlet 1002 is at the upper end 1018 of the hand vacuum cleaner 1000, at least a portion of the dirt collection chamber 1042 underlies the air treatment chamber 1044 and the air treatment chamber doors 1408. The dirt collection chamber door 1400 is rotatably mounted by a hinge 1110 about a dirt collection chamber opening axis 1402 that extends in the lateral direction, transverse to the air treatment chamber opening axes 1410. In this way, when the dirt collection chamber door 1400 is moved between the closed position (see e.g., FIGS. 48A and 49A) and the open position (see e.g., FIGS. 48B and 49B), the dirt collection chamber door 1400 moves in the forward/rearward direction transverse to the lateral direction.

Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples but should be given the broadest interpretation consistent with the description as a whole.

### Clause Set A

1. A hand vacuum cleaner comprising:
   (a) an air flow passage extending from a dirty air inlet, which is provided at a front end of the hand vacuum cleaner, to a clean air outlet;
   (b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and a first air treatment chamber door that is rotatably mounted about a first air treatment chamber opening axis that is parallel to the air treatment chamber axis;
   (c) a dirt collection chamber that is external to the air treatment chamber wherein, in operation, dirt travels through the dirt outlet from the air treatment chamber to the dirt collection chamber, the dirt collection chamber having a dirt collection chamber door that is rotatably mounted about a dirt collection chamber opening axis that extends in a different direction to the forward/rearward direction, wherein the dirt collection chamber opening axis extends in a dirt collection chamber emptying plane and, when the dirt collection chamber door is open, a dirt collection chamber emptying port is provided in the dirt collection chamber emptying plane; and,
   (d) a motor and fan assembly provided in the air flow passage.
2. The hand vacuum cleaner of claim 1 wherein the dirt collection chamber opening axis extends generally transverse to the forward/rearward direction.
3. The hand vacuum cleaner of claim 2 wherein the dirt collection chamber emptying plane is generally transverse to the forward/rearward direction.
4. The hand vacuum cleaner of claim 2 wherein the dirt collection chamber opening axis is located at a rear end of the dirt collection chamber.
5. The hand vacuum cleaner of claim 2 further comprising a second air treatment chamber door that is rotatably mounted about a second air treatment chamber opening axis that is parallel to the air treatment chamber axis, the first and second air treatment chamber axes extend in an air treatment chamber emptying plane, wherein, when the first and second air treatment chamber doors are open, an air treatment chamber emptying port is provided in the air treatment chamber emptying plane.
6. The hand vacuum cleaner of claim 5 wherein the first and second air treatment chamber opening axes are laterally spaced apart.
7. The hand vacuum cleaner of claim 6 wherein the first and second air treatment chamber doors rotate away from each other as the first and second air treatment chamber doors rotate open.
8. The hand vacuum cleaner of claim 7 wherein, when the air treatment chamber axis extends horizontally and the dirty air inlet is at an upper end of the hand vacuum cleaner, the dirt collection chamber underlies the first and second air treatment chamber doors.
9. The hand vacuum cleaner of claim 7 wherein, when the air treatment chamber axis extends horizontally and the dirty air inlet is at an upper end of the hand vacuum cleaner, the dirt collection chamber door underlies the first and second air treatment chamber doors.
10. The hand vacuum cleaner of claim 7 wherein the dirt collection chamber emptying port has a larger cross-sectional area than a cross-sectional area of the air treatment chamber emptying port.
11. The hand vacuum cleaner of claim 1 wherein, when the air treatment chamber axis extends horizontally and the dirty air inlet is at an upper end of the hand vacuum cleaner, the dirt collection chamber underlies the first air treatment chamber door.
12. The hand vacuum cleaner of claim 1 wherein, when the air treatment chamber axis extends horizontally and the dirty air inlet is at an upper end of the hand vacuum cleaner, the dirt collection chamber door underlies the first air treatment chamber door.
13. The hand vacuum cleaner of claim 11 wherein the first air treatment chamber opening axis extends in an air treatment chamber emptying plane, wherein, when the first air treatment chamber door is open, an air treatment chamber emptying port is provided in the air treatment chamber emptying plane and, wherein, the dirt collection chamber emptying port has a larger cross-sectional area than a cross-sectional area of the air treatment chamber emptying port.
14. The hand vacuum cleaner of claim 1 wherein the first air treatment chamber opening axis extends in an air treatment chamber emptying plane, wherein, when the first air treatment chamber door is open, an air treatment chamber emptying port is provided in the air treatment chamber emptying plane and, wherein, the dirt collection chamber emptying port has a larger cross-sectional area than a cross-sectional area of the air treatment chamber emptying port.
15. The hand vacuum cleaner of claim 1 wherein the air treatment chamber comprises a cyclone and the air treatment chamber axis is a cyclone axis of rotation.
16. A hand vacuum cleaner comprising:
   (a) an air flow passage extending from a dirty air inlet, which is provided at a front end of the hand vacuum cleaner, to a clean air outlet;
   (b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and a first air treatment chamber door that is moveable in a first direction from a closed position to an open position;
   (c) a dirt collection chamber that is external to the air treatment chamber wherein, in operation, dirt travels through the dirt outlet from the air treatment chamber to the dirt collection chamber, the dirt collection chamber having a dirt collection chamber door that is moveable in a second direction from a closed position to an open position wherein the second direction is different to the first direction, wherein, when the dirt collection chamber door is open, a dirt collection chamber emptying port is provided; and,
   (d) a motor and fan assembly provided in the air flow passage.
17. The hand vacuum cleaner of claim 16 wherein one of the first and second directions is the forward/rearward direction.
18. The hand vacuum cleaner of claim 16 wherein the first direction is the forward/rearward direction.
19. The hand vacuum cleaner of claim 16 wherein the second direction is generally transverse to the first direction.
20. The hand vacuum cleaner of claim 16 further comprising a second air treatment chamber door that is moveable in a third direction from a closed position to an open position, wherein the third direction is opposed to the first direction and wherein, when the first and second air treatment chamber doors are open, an air treatment chamber emptying port is provided.
21. The hand vacuum cleaner of claim 20 wherein the air treatment chamber emptying port has a perimeter having first and second sides that extend in the forward/rearward direction and the first and second sides are laterally spaced apart.
22. The hand vacuum cleaner of claim 21 wherein the first and second air treatment chamber doors move away from each other as the first and second air treatment chamber doors move to their open positions.
23. The hand vacuum cleaner of claim 20 wherein the dirt collection chamber emptying port has a larger cross-sectional area than a cross-sectional area of the air treatment chamber emptying port.
24. The hand vacuum cleaner of claim 16 wherein, when the first air treatment chamber door is open, an air treatment chamber emptying port is provided and the dirt collection chamber emptying port has a larger cross-sectional area than a cross-sectional area of the air treatment chamber emptying port.

### Clause Set B

1. A hand vacuum cleaner comprising:
   (a) an air flow passage extending from a dirty air inlet, which is provided at a front end of the hand vacuum cleaner, to a clean air outlet;
   (b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet, a first air treatment chamber door that is rotatably mounted about a first air treatment chamber opening axis that is parallel to the air treatment chamber axis and a second air treatment chamber door that is rotatably mounted about a second air treatment chamber opening axis that is parallel to the air treatment chamber axis;
   (c) a dirt collection chamber that is external to the air treatment chamber wherein, in operation, dirt travels through the dirt outlet from the air treatment chamber to the dirt collection chamber, the dirt collection chamber having a dirt collection chamber door that is rotatably mounted about a dirt collection chamber opening axis that extends in a different direction to the forward/rearward direction, wherein the dirt collection chamber opening axis extends in a dirt collection chamber emptying plane and, when the dirt collection chamber door is open, a dirt collection chamber emptying port is provided in the dirt collection chamber emptying plane; and,
(d) a motor and fan assembly provided in the air flow passage.
2. The hand vacuum cleaner of claim 1 wherein the first and second air treatment chamber opening axes are laterally spaced apart.
3. The hand vacuum cleaner of claim 2 wherein the first and second air treatment chamber doors rotate away from each other as the first and second air treatment chamber doors rotate open.
4. The hand vacuum cleaner of claim 3 wherein, when the air treatment chamber axis extends horizontally and the dirty air inlet is at an upper end of the hand vacuum cleaner, the dirt collection chamber underlies the first and second air treatment chamber doors.
5. The hand vacuum cleaner of claim 3 wherein, when the air treatment chamber axis extends horizontally and the dirty air inlet is at an upper end of the hand vacuum cleaner, the dirt collection chamber door underlies the first and second air treatment chamber doors.
6. The hand vacuum cleaner of claim 5 wherein the first and second air treatment chamber axes extend in an air treatment chamber emptying plane, wherein, when the first and second air treatment chamber doors are open, an air treatment chamber emptying port is provided in the air treatment chamber emptying plane and wherein the dirt collection chamber emptying port has a larger cross-sectional area than a cross-sectional area of the air treatment chamber emptying port.
7. The hand vacuum cleaner of claim 3 wherein, when the air treatment chamber axis extends horizontally, the dirt collection chamber door is the only door of the dirt collection chamber which is vertically spaced from the first and second air treatment chamber doors.
8. The hand vacuum cleaner of claim 7 wherein the first air treatment chamber opening axis and the second air treatment chamber opening axis extend in an air treatment chamber emptying plane, wherein, when the first and second air treatment chamber doors are open, an air treatment chamber emptying port is provided in the air treatment chamber emptying plane and, wherein, the dirt collection chamber emptying port has a larger cross-sectional area than a cross-sectional area of the air treatment chamber emptying port.
9. The hand vacuum cleaner of claim 1 wherein the dirt collection chamber opening axis extends generally transverse to the forward/rearward direction.
10. The hand vacuum cleaner of claim 9 wherein the dirt collection chamber opening axis extends in a plane that is generally transverse to the forward/rearward direction.
11. The hand vacuum cleaner of claim 10 wherein the dirt collection chamber opening axis is located at the rear end of the dirt collection chamber.
12. The hand vacuum cleaner of claim 11 wherein, when the air treatment chamber axis extends horizontally and the dirty air inlet is at an upper end of the hand vacuum cleaner, the dirt collection chamber underlies the first and second air treatment chamber doors and the first and second air treatment chamber doors comprise a lower portion of the air treatment chamber sidewall.
13. The hand vacuum cleaner of claim 11 wherein the rear end of the air treatment chamber comprises a rear wall and, when the air treatment chamber axis extends horizontally and the dirty air inlet is at an upper end of the hand vacuum cleaner, the dirt collection chamber underlies the first and second air treatment chamber doors and the dirt collection chamber door comprises the rear wall.
14. The hand vacuum cleaner of claim 10 wherein the dirt collection chamber opening axis is located at the front end of the dirt collection chamber.
15. The hand vacuum cleaner of claim 14 wherein, when the air treatment chamber axis extends horizontally and the dirty air inlet is at an upper end of the hand vacuum cleaner, the dirt collection chamber underlies the first and second air treatment chamber doors and the first and second air treatment chamber doors comprise a lower portion of the air treatment chamber sidewall.
16. The hand vacuum cleaner of claim 14 wherein the front end of the air treatment chamber comprises a front wall and the dirt collection chamber door comprises the front wall.
17. The hand vacuum cleaner of claim 10 wherein the first air treatment chamber opening axis and the second air treatment chamber opening axis extend in an air treatment chamber emptying plane, wherein, when the first and second air treatment chamber doors are open, an air treatment chamber emptying port is provided in the air treatment chamber emptying plane and, wherein, the dirt collection chamber emptying port has a larger cross-sectional area than a cross-sectional area of the air treatment chamber emptying port.
18. The hand vacuum cleaner of claim 1 wherein the air treatment chamber comprises a cyclone and the air treatment chamber axis is a cyclone axis of rotation.
19. The hand vacuum cleaner of claim 1 wherein the first air treatment chamber opening axis and the second air treatment chamber opening axis extend in an air treatment chamber emptying plane, wherein, when the first and second air treatment chamber doors are open, an air treatment chamber emptying port is provided in the air treatment chamber emptying plane and, wherein, the dirt collection chamber emptying port has a larger cross-sectional area than a cross-sectional area of the air treatment chamber emptying port.
20. A hand vacuum cleaner comprising:
   (a) an air flow passage extending from a dirty air inlet, which is provided at a front end of the hand vacuum cleaner, to a clean air outlet;
   (b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet, a first air treatment chamber door that is moveable in a first direction from a closed position to an open position and a second air treatment chamber door that is moveable in a second direction from a closed position to an open position, wherein the second direction is opposed to the first direction and wherein, when the first and second air treatment chamber doors are open, an air treatment chamber emptying port is provided;
   (c) a dirt collection chamber that is external to the air treatment chamber wherein, in operation, dirt travels through the dirt outlet from the air treatment chamber to the dirt collection chamber, the dirt collection chamber having a dirt collection chamber door that is moveable in a third direction from a closed position to an open position wherein the third direction is different to the first and second directions wherein, when the dirt collection chamber door is open, a dirt collection chamber emptying port is provided in a dirt collection chamber emptying plane; and,
   (d) a motor and fan assembly provided in the air flow passage.
21. The hand vacuum cleaner of claim 20 wherein the first and second air treatment chamber doors rotate away from each other as the first and second air treatment chamber doors rotate open.
22. The hand vacuum cleaner of claim 21 wherein, when the air treatment chamber axis extends horizontally and the dirty air inlet is at an upper end of the hand vacuum cleaner, the dirt collection chamber underlies the first and second air treatment chamber doors.
23. The hand vacuum cleaner of claim 21 wherein, when the air treatment chamber axis extends horizontally and the dirty air inlet is at an upper end of the hand vacuum cleaner, the dirt collection chamber door underlies the first and second air treatment chamber doors.
24. The hand vacuum cleaner of claim 22 wherein the dirt collection chamber emptying port has a larger cross-sectional area than a cross-sectional area of the air treatment chamber emptying port.
25. The hand vacuum cleaner of claim 20 wherein, when the air treatment chamber axis extends horizontally, the dirt collection chamber door is the only door of the dirt collection chamber which is vertically spaced from the first and second air treatment chamber doors.
26. The hand vacuum cleaner of claim 25 wherein the dirt collection chamber emptying port has a larger cross-sectional area than a cross-sectional area of the air treatment chamber emptying port.
27. The hand vacuum cleaner of claim 20 wherein the first and second air treatment chamber doors move in a lateral direction to their open positions and the dirt collection chamber door moves in a direction that is generally transverse to the lateral direction to its open position.
28. The hand vacuum cleaner of claim 27 wherein the dirt collection chamber door moves rearwardly.
29. The hand vacuum cleaner of claim 28 wherein a rear end of the dirt collection chamber door is moveably mounted.
30. The hand vacuum cleaner of claim 29 wherein, when the air treatment chamber axis extends horizontally and the dirty air inlet is at an upper end of the hand vacuum cleaner, the dirt collection chamber underlies the first and second air treatment chamber doors and the first and second air treatment chamber doors comprise a lower portion of the air treatment chamber sidewall.
31. The hand vacuum cleaner of claim 20 wherein the dirt collection chamber emptying port has a larger cross-sectional area than a cross-sectional area of the air treatment chamber emptying port.
32. The hand vacuum cleaner of claim 20 wherein the air treatment chamber comprises a cyclone and the air treatment chamber axis is a cyclone axis of rotation.
33. The hand vacuum cleaner of claim 20 wherein the dirt collection chamber opening axis is located at the rear end of the dirt collection chamber, the rear end of the air treatment chamber comprises a rear wall and, when the air treatment chamber axis extends horizontally and the dirty air inlet is at an upper end of the hand vacuum cleaner, the dirt collection chamber underlies the first and second air treatment chamber doors and the dirt collection chamber door comprises the rear wall.
34. The hand vacuum cleaner of claim 20 wherein the dirt collection chamber opening axis is located at the front end of the dirt collection chamber and, when the air treatment chamber axis extends horizontally and the dirty air inlet is at an upper end of the hand vacuum cleaner, the first and second air treatment chamber doors comprise a lower portion of the air treatment chamber sidewall.
35. The hand vacuum cleaner of claim 20 wherein the dirt collection chamber opening axis is located at the front end of the dirt collection chamber, the front end of the air treatment chamber comprises a front wall and the dirt collection chamber door comprises the front wall.

### Clause Set C

1. A hand vacuum cleaner comprising:
   (a) an air flow passage extending from a dirty air inlet, which is provided at a front end of the hand vacuum cleaner, to a clean air outlet;
   (b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and at least a first air treatment chamber door, the first air treatment chamber door is rotatably mounted about a first air treatment chamber opening axis that is parallel to the air treatment chamber axis, the first air treatment chamber axis extends in an air treatment chamber emptying plane, wherein, when the at least a first air treatment chamber door is open, an air treatment chamber emptying port is provided in the air treatment chamber emptying plane;
   (c) a dirt collection chamber that is external to the air treatment chamber wherein, in operation, dirt travels through the dirt outlet from the air treatment chamber to the dirt collection chamber, the dirt collection chamber having a dirt collection chamber door that is rotatably mounted about a dirt collection chamber opening axis, wherein the dirt collection chamber opening axis extends in a dirt collection chamber emptying plane and, when the dirt collection chamber door is open, a dirt collection chamber emptying port is provided in the dirt collection chamber emptying plane, wherein the dirt collection chamber emptying port has a larger cross-sectional area than a cross-sectional area of the air treatment chamber emptying port; and,
   (d) a motor and fan assembly provided in the air flow passage.
2. The hand vacuum cleaner of claim 1 further comprising a second air treatment chamber door that is rotatably mounted about a second air treatment chamber opening axis that is parallel to the air treatment chamber axis, the second air treatment chamber axis extends in the air treatment chamber emptying plane.
3. The hand vacuum cleaner of claim 2 wherein the first and second air treatment chamber opening axes are laterally spaced apart.
4. The hand vacuum cleaner of claim 3 wherein the first and second air treatment chamber doors rotate away from each other as the first and second air treatment chamber doors rotate open.
5. The hand vacuum cleaner of claim 4 wherein, when the air treatment chamber axis extends horizontally and the dirty air inlet is at an upper end of the hand vacuum cleaner, the dirt collection chamber underlies the first and second air treatment chamber doors.
6. The hand vacuum cleaner of claim 5 wherein, when the air treatment chamber axis extends horizontally and the dirty air inlet is at an upper end of the hand vacuum cleaner, the dirt collection chamber door underlies the first and second air treatment chamber doors.
7. The hand vacuum cleaner of claim 6 wherein the dirt collection chamber opening axis extends in a different direction to the forward/rearward direction
8. The hand vacuum cleaner of claim 7 wherein the dirt collection chamber opening axis extends generally transverse to the forward/rearward direction.
9. The hand vacuum cleaner of claim 8 wherein the dirt collection chamber opening axis is located at a rear end of the dirt collection chamber.
10. The hand vacuum cleaner of claim 1 wherein, when the air treatment chamber axis extends horizontally and the dirty air inlet is at an upper end of the hand vacuum cleaner, the dirt collection chamber underlies the first air treatment chamber door.
11. The hand vacuum cleaner of claim 1 wherein, when the air treatment chamber axis extends horizontally and the dirty air inlet is at an upper end of the hand vacuum cleaner, the dirt collection chamber door underlies the first air treatment chamber door.
12. The hand vacuum cleaner of claim 1 wherein the air treatment chamber comprises a cyclone and the air treatment chamber axis is a cyclone axis of rotation.
13. The hand vacuum cleaner of claim 1 wherein the dirt collection chamber opening axis extends in a different direction to the forward/rearward direction
14. The hand vacuum cleaner of claim 13 wherein the dirt collection chamber opening axis extends generally transverse to the forward/rearward direction.
15. The hand vacuum cleaner of claim 14 wherein the dirt collection chamber opening axis is located at a rear end of the dirt collection chamber.
16. The hand vacuum cleaner of claim 2 wherein the dirt collection chamber opening axis extends in a different direction to the forward/rearward direction.
17. The hand vacuum cleaner of claim 16 wherein the dirt collection chamber opening axis extends generally transverse to the forward/rearward direction.
18. The hand vacuum cleaner of claim 17 wherein the dirt collection chamber opening axis is located at a rear end of the dirt collection chamber.
19. A hand vacuum cleaner comprising:
   (a) an air flow passage extending from a dirty air inlet, which is provided at a front end of the hand vacuum cleaner, to a clean air outlet;
   (b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet, at least a first air treatment chamber door, the first air treatment chamber door is moveable in a first direction from a closed position to an open position wherein, when the at least a first air treatment chamber door is open, an air treatment chamber emptying port is provided;
   (c) a dirt collection chamber that is external to the air treatment chamber wherein, in operation, dirt travels through the dirt outlet from the air treatment chamber to the dirt collection chamber, the dirt collection chamber having a dirt collection chamber door that is moveable in a second direction from a closed position to an open position wherein the second direction is different to the first direction wherein, when the dirt collection chamber door is open, a dirt collection chamber emptying port is provided in a dirt collection chamber emptying plane, wherein the dirt collection chamber emptying port has a larger cross-sectional area than a cross-sectional area of the air treatment chamber emptying port; and,
   (d) a motor and fan assembly provided in the air flow passage.
20. The hand vacuum cleaner of claim 19 further comprising a second air treatment chamber door that is moveable in a third direction from a closed position to an open position, wherein the third direction is opposed to the first direction and wherein, when the first and second air treatment chamber doors are open, the air treatment chamber emptying port is provided.
21. The hand vacuum cleaner of claim 27 wherein the air treatment chamber emptying port has a perimeter having first and second sides that extend in the forward/rearward direction and the first and second sides are laterally spaced apart.
22. The hand vacuum cleaner of claim 28 wherein the first and second air treatment chamber doors move laterally away from each other as the first and second air treatment chamber doors move to their open positions.
23. The hand vacuum cleaner of claim 27 wherein, when the air treatment chamber axis extends horizontally and the dirty air inlet is at an upper end of the hand vacuum cleaner, the dirt collection chamber underlies the first and second air treatment chamber doors.
24. The hand vacuum cleaner of claim 27 wherein, when the air treatment chamber axis extends horizontally and the dirty air inlet is at an upper end of the hand vacuum cleaner, the dirt collection chamber door underlies the first and second air treatment chamber doors.
25. The hand vacuum cleaner of claim 27 wherein, when the air treatment chamber axis extends horizontally, the dirt collection chamber door is the only door of the dirt collection chamber which is vertically spaced from the first and second air treatment chamber doors.
26. The hand vacuum cleaner of claim 19 wherein the first and second air treatment chamber doors move in a lateral direction to their open positions and the dirt collection chamber door moves in a direction that is generally transverse to the lateral direction to its open position.
27. The hand vacuum cleaner of claim 33 wherein the dirt collection chamber door moves rearwardly.
28. The hand vacuum cleaner of claim 34 wherein a rear end of the dirt collection chamber door is moveably mounted.
29. The hand vacuum cleaner of claim 19 wherein the air treatment chamber comprises a cyclone and the air treatment chamber axis is a cyclone axis of rotation.

### Clause Set D

1. A hand vacuum cleaner comprising:
   (a) an air flow passage extending from a dirty air inlet, which is provided at a front end of the hand vacuum cleaner, to a clean air outlet;
   (b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and a first air treatment chamber door that is rotatably mounted about a first living hinge which has an axis that is parallel to the air treatment chamber axis;
   (c) a dirt collection chamber that is external to the air treatment chamber wherein, in operation, dirt travels through the dirt outlet from the air treatment chamber to the dirt collection chamber, the dirt collection chamber having a dirt collection chamber door that is openable; and,
   (d) a motor and fan assembly provided in the air flow passage.
2. The hand vacuum cleaner of claim 1 wherein the first living hinge biases the first air treatment chamber door to a closed position.
3. The hand vacuum cleaner of claim 2 further comprising an actuator which, upon actuation, causes the first air treatment chamber door to open.
4. The hand vacuum cleaner of claim 3 wherein the first air treatment chamber door and the dirt collection chamber door are concurrently openable.
5. The hand vacuum cleaner of claim 2 wherein the first air treatment chamber door and the dirt collection chamber door are concurrently openable.
6. The hand vacuum cleaner of claim 5 further comprising an actuator that is drivingly connected to the first air treatment chamber door whereupon, upon actuation of the actuator the first air treatment chamber door and the dirt collection chamber door open.
7. The hand vacuum cleaner of claim 5 further comprising an actuator that is drivingly connected to the dirt collection chamber door whereupon, upon actuation of the actuator the first air treatment chamber door and the dirt collection chamber door open.
8. The hand vacuum cleaner of claim 1 further comprising a second air treatment chamber door that is rotatably mounted about a second living hinge which has an axis that is parallel to the air treatment chamber axis.
9. The hand vacuum cleaner of claim 8 wherein the first living hinge biases the first air treatment chamber door to a closed position and the second living hinge biases the second air treatment chamber door to a closed position.
10. The hand vacuum cleaner of claim 9 further comprising an actuator which, upon actuation, moves each of the first and second air treatment chamber doors to an open position.
11. The hand vacuum cleaner of claim 10 wherein, when the air treatment chamber axis extends horizontally and the dirty air inlet is at an upper end of the hand vacuum cleaner, the dirt collection chamber underlies the air treatment chamber door.
12. The hand vacuum cleaner of claim 10 wherein, when the air treatment chamber axis extends horizontally and the dirty air inlet is at an upper end of the hand vacuum cleaner, the dirt collection chamber underlies the first and second air treatment chamber doors.
13. A combination of the hand vacuum cleaner of claim 1 and a dock wherein the dock comprises an actuator and, as or subsequent to the hand vacuum cleaner being docked to the dock, the actuator causes the first air treatment chamber door to open.
14. The hand vacuum cleaner of claim 13 wherein the actuator is drivingly connected to the first air treatment chamber door wherein, as or subsequent to the hand vacuum cleaner being docked to the dock, the first air treatment chamber door and the dirt collection chamber door open.
15. The hand vacuum cleaner of claim 13 further comprising an actuator that is drivingly connected to the dirt collection chamber door wherein, as or subsequent to the hand vacuum cleaner being docked to the dock, the first air treatment chamber door and the dirt collection chamber door open.
16. A surface cleaner comprising:
   (a) an air flow passage extending from a dirty air inlet, which is provided at a front end of the surface cleaner, to a clean air outlet;
   (b) an air treatment chamber having an air treatment chamber air inlet, an air treatment chamber air outlet, a dirt outlet and a first air treatment chamber door that is rotatably mounted about a first living hinge;
   (c) a dirt collection chamber that is external to the air treatment chamber wherein, in operation, dirt travels through the dirt outlet from the air treatment chamber to the dirt collection chamber, the dirt collection chamber having a dirt collection chamber door that is openable; and,
   (d) a motor and fan assembly provided in the air flow passage.
17. The surface cleaner of claim 16 wherein the first living hinge biases the first air treatment chamber door to a closed position.
18. The surface cleaner of claim 17 further comprising an actuator which, upon actuation, causes the first air treatment chamber door to open.
19. The surface cleaner of claim 18 wherein the first air treatment chamber door and the dirt collection chamber door are concurrently openable.
20. The surface cleaner of claim 17 wherein the first air treatment chamber door and the dirt collection chamber door are concurrently openable.
21. The surface cleaner of claim 20 further comprising an actuator that is drivingly connected to the first air treatment chamber door whereupon, upon actuation of the actuator the first air treatment chamber door and the dirt collection chamber door open.
22. The surface cleaner of claim 20 further comprising an actuator that is drivingly connected to the dirt collection chamber door whereupon, upon actuation of the actuator the first air treatment chamber door and the dirt collection chamber door open.
23. The surface cleaner of claim 1 further comprising a second air treatment chamber door that is rotatably mounted about a second living hinge which has an axis that is parallel to an axis of the first living hinge.
24. The surface cleaner of claim 23 wherein the first living hinge biases the first air treatment chamber door to a closed position and the second living hinge biases the second air treatment chamber door to a closed position.
25. The surface cleaner of claim 23 further comprising an actuator which, upon actuation, moves each of the first and second air treatment chamber doors to an open position.

### Clause Set E

1. A hand vacuum cleaner comprising:
   (a) an air flow passage extending from a dirty air inlet, which is provided at a front end of the hand vacuum cleaner, to a clean air outlet;
   (b) an air treatment chamber axis that intersects the first and second ends, an air treatment chamber air inlet, an air treatment chamber air outlet provided at the second end, a dirt outlet and a first air treatment chamber door that is rotatably mounted about a first air treatment chamber opening axis that is parallel to the air treatment chamber axis wherein the first air treatment chamber door defines at least a portion of a perimeter of the dirt outlet;
   (c) a dirt collection chamber that is external to the air treatment chamber wherein, in operation, dirt travels through the dirt outlet from the air treatment chamber to the dirt collection chamber, the dirt collection chamber having a dirt collection chamber door that is openable; and,
   (d) a motor and fan assembly provided in the air flow passage.
2. The hand vacuum cleaner of claim 1 wherein the air treatment chamber axis extends in a forward/rearward direction.
3. The hand vacuum cleaner of claim 2 wherein the dirt collection chamber door is rotatably mounted about a dirt collection chamber opening axis that extends in a different direction to the forward/rearward direction.
4. The hand vacuum cleaner of claim 3 wherein the dirt collection chamber opening axis extends generally transverse to the forward/rearward direction.
5. The hand vacuum cleaner of claim 3 wherein the dirt collection chamber opening axis extends in a dirt collection chamber emptying plane that is generally transverse to the forward/rearward direction.
6. The hand vacuum cleaner of claim 5 wherein the dirt collection chamber opening axis is located at a rear end of the dirt collection chamber.
7. The hand vacuum cleaner of claim 2 further comprising a second air treatment chamber door that is rotatably mounted about a second air treatment chamber opening axis that is parallel to the air treatment chamber axis wherein the first air treatment chamber door defines a first portion of a perimeter of the dirt outlet and the second air treatment chamber door defines a second portion of a perimeter of the dirt outlet.
8. The hand vacuum cleaner of claim 7 wherein the first and second air treatment chamber opening axes are laterally spaced apart.
9. The hand vacuum cleaner of claim 8 wherein the first and second air treatment chamber doors rotate away from each other as the first and second air treatment chamber doors rotate open.
10. The hand vacuum cleaner of claim 1 wherein, when the air treatment chamber axis extends horizontally and the dirty air inlet is at an upper end of the hand vacuum cleaner, the dirt collection chamber underlies the first and second air treatment chamber doors.
11. The hand vacuum cleaner of claim 1 wherein the air treatment chamber comprises a cyclone and the air treatment chamber axis is a cyclone axis of rotation.
12. The hand vacuum cleaner of claim 7 wherein the perimeter of the dirt outlet comprises first and second axially extending sides and first and second lateral sides, each of which extends from the first axial side to the second axial side and the first and second air treatment chamber doors define the first and second axially extending sides and the first lateral side.
13. The hand vacuum cleaner of claim 12 wherein the second end of the air treatment chamber comprises a second end wall and the second end wall defines the second lateral side.
14. The hand vacuum cleaner of claim 13 wherein the dirt outlet has a width in a direction transverse to the air treatment chamber axis and the width at the first lateral side is less than the width at the second lateral side.
15. The hand vacuum cleaner of claim 7 wherein the first and second air treatment chamber doors define the perimeter of the dirt outlet.
16. The hand vacuum cleaner of claim 1 wherein the dirt outlet has a perimeter comprising a plurality of sides having an included angle that is other than a 90° angle.
17. The hand vacuum cleaner of claim 15 wherein the included angle is from 30° to 80°, or 45° to 75°.
18. The hand vacuum cleaner of claim 1 wherein the second end of the air treatment chamber comprises a second end wall which forms a portion of the perimeter of the dirt outlet, the dirt outlet has a width in a direction transverse to the air treatment chamber axis and the width of the dirt outlet at the second end wall is greater than the width at an axially inward end of the dirt outlet.
19. The hand vacuum cleaner of claim 18 wherein the width increases continuously from the axial inner end of the dirt outlet to the second end wall.
20. A surface cleaner comprising:
   (a) an air flow passage extending from a dirty air inlet, which is provided at a front end of the surface cleaner, to a clean air outlet;
   (b) an air treatment chamber having a first end, an axially spaced apart second end, an air treatment chamber axis that intersects the first and second ends, an air treatment chamber air inlet, an air treatment chamber air outlet provided at the second end, a dirt outlet, a first air treatment chamber door that is moveable in a first direction from a closed position to an open position and a second air treatment chamber door that is moveable in a second direction from a closed position to an open position, wherein the second direction is opposed to the first direction and wherein each of the first and second air treatment chamber doors defines at least a portion of a perimeter of the dirt outlet;
   (c) a dirt collection chamber that is external to the air treatment chamber wherein, in operation, dirt travels through the dirt outlet from the air treatment chamber to the dirt collection chamber, the dirt collection chamber having a dirt collection chamber door that is openable; and,
   (d) a motor and fan assembly provided in the air flow passage.
21. The surface cleaner of claim 20 wherein the air treatment chamber axis extends in a forward/rearward direction.
22. The surface cleaner of claim 21 wherein the collection chamber door is moveable in a third direction from a closed position to an open position wherein the third direction is different to the first and second directions.
23. The surface cleaner of claim 20 wherein the first and second air treatment chamber doors move away from each other as each of the first and second air treatment chamber doors move to their open positions.
24. The surface cleaner of claim 20 wherein the air treatment chamber comprises a cyclone and the air treatment chamber axis is a cyclone axis of rotation.
25. The surface cleaner of claim 20 wherein the perimeter of the dirt outlet comprises first and second axially extending sides and first and second lateral sides, each of which extends from the first axial side to the second axial side and the first and second air treatment chamber doors define the first and second axially extending sides and the first lateral side.
26. The surface cleaner of claim 25 wherein the second end of the air treatment chamber comprises a second end wall and the second end wall defines the second lateral side.
27. The surface cleaner of claim 20 wherein the first and second air treatment chamber doors define the perimeter of the dirt outlet.
28. The surface cleaner of claim 20 wherein the dirt outlet has a perimeter comprising a plurality of sides having an included angle that is other than a 90° angle.
29. The surface cleaner of claim 28 wherein the included angle is from 30° to 80°, or 45° to 75°.
30. The surface cleaner of claim 20 wherein the second end of the air treatment chamber comprises a second end wall which forms a portion of the perimeter of the dirt outlet, the dirt outlet has a width in a direction transverse to the air treatment chamber axis and the width of the dirt outlet at the second end wall is greater than the width at an axially inward end of the dirt outlet.
31. The surface cleaner of claim 31 wherein the width increases continuously from the axial inner end of the dirt outlet to the second end wall.

### Clause Set F

1. A surface cleaner comprising:
   (a) an air flow passage extending from a dirty air inlet to a clean air outlet;
   (b) an air treatment chamber having a first end, an axially spaced apart second end, an air treatment chamber axis which intersects the first and second ends, an air treatment chamber sidewall extending between the first and second ends, an air treatment chamber air inlet, an air treatment chamber air outlet, a dirt outlet and a first air treatment chamber door that is moveable between an open position and a closed position;
   (c) a dirt collection chamber that is external to the air treatment chamber wherein, in operation, dirt travels through the dirt outlet from the air treatment chamber to the dirt collection chamber, the dirt collection chamber having a dirt collection chamber door that is openable;
   (d) a motor and fan assembly provided in the air flow passage; and,
   (e) an actuator whereby, upon actuation by the actuator, the first air treatment chamber door is moved between the open position and the closed position, wherein the actuator comprises a first magnet that is exterior to the air treatment chamber.
2. The surface cleaner of claim 1 wherein a second magnet is provided on the first air treatment chamber door which, when the first air treatment chamber door is moved between the closed and open positions, is magnetically coupled to the first magnet.
3. The surface cleaner of claim 2 wherein the first and second magnets are magnetically coupled to each other when the door is moved from the closed position to the open position and when the door is moved from the open position to the closed position.
4. The surface cleaner of claim 1 wherein the first air treatment chamber door is biased to the closed position.
5. The surface cleaner of claim 2 wherein the first air treatment chamber door is biased to the closed position.
6. The surface cleaner of claim 5 wherein the first and second magnets are magnetically decoupled prior to the door being moved from the open position to the closed position.
7. The surface cleaner of claim 1 further comprising a second air treatment chamber door that is openable.
8. The surface cleaner of claim 7 wherein the actuator is drivingly connected to the second air treatment chamber door by a linkage.
9. The surface cleaner of claim 8 wherein a second magnet is provided on at least one of the first and second air treatment chamber doors which, when the first and second air treatment chamber doors are moved between the open and closed positions, is magnetically coupled to the first magnet.
10. The surface cleaner of claim 9 wherein at least one of the first and second air treatment chamber doors is biased to the closed position.
11. The surface cleaner of claim 10 wherein the first and second magnets are magnetically decoupled prior to the doors moving from the open position to the closed position.
12. A hand vacuum cleaner comprising:
   (a) an air flow passage extending from a dirty air inlet, which is provided at a front end of the hand vacuum cleaner, to a clean air outlet;
   (b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and a first air treatment chamber door that is rotatably mounted about an axis that is parallel to the air treatment chamber axis;
   (c) a dirt collection chamber that is external to the air treatment chamber wherein, in operation, dirt travels through the dirt outlet from the air treatment chamber to the dirt collection chamber, the dirt collection chamber having a dirt collection chamber door that is openable;
   (d) a motor and fan assembly provided in the air flow passage; and,
   (e) an actuator that is drivingly connected to the first air treatment chamber door by a linkage whereby, upon actuation by the actuator, the first air treatment chamber door is moved between an open and a closed position, wherein the actuator comprises a first magnet that is exterior to the air treatment chamber.
13. The hand vacuum cleaner of claim 12 wherein a second magnet is provided on the first air treatment chamber door which, when the first air treatment chamber door is moved between the closed and open positions, is magnetically coupled to the first magnet.
14. The hand vacuum cleaner of claim 13 wherein the first and second magnets are magnetically coupled to each other when the door is moved from the closed position to the open position and when the door is moved from the open position to the closed position.
15. The hand vacuum cleaner of claim 12 wherein the first air treatment chamber door is biased to the closed position.
16. The hand vacuum cleaner of claim 13 wherein the first air treatment chamber door is biased to the closed position.
17. The hand vacuum cleaner of claim 16 wherein the first and second magnets are magnetically decoupled prior to the door being moved from the open position to the closed position.
18. The hand vacuum cleaner of claim 12 further comprising a second air treatment chamber door that is openable.
19. The hand vacuum cleaner of claim 18 wherein the actuator is drivingly connected to the second air treatment chamber door by the linkage.
20. The hand vacuum cleaner of claim 19 wherein a second magnet is provided on at least one of the first and second air treatment chamber doors which, when the first and second air treatment chamber doors are moved between the open and closed positions, is magnetically coupled to the first magnet.
21. The hand vacuum cleaner of claim 20 wherein at least one of the first and second air treatment chamber doors is biased to the closed position.
22. The hand vacuum cleaner of claim 21 wherein the first and second magnets are magnetically decoupled prior to the doors moving from the open position to the closed position.
23. A combination comprising:
   (a) a hand vacuum cleaner comprising:
      i) an air flow passage extending from a dirty air inlet to a clean air outlet;
      ii) an air treatment chamber having a first end, an axially spaced apart second end, an air treatment chamber axis which intersects the first and second ends, an air treatment chamber sidewall extending between the first and second ends, an air treatment chamber air inlet, an air treatment chamber air outlet, a dirt outlet and a first air treatment chamber door that is moveable between an open position and a closed position;
      iii) a dirt collection chamber that is external to the air treatment chamber wherein, in operation, dirt travels through the dirt outlet from the air treatment chamber to the dirt collection chamber, the dirt collection chamber having a dirt collection chamber door that is openable; and,
      iv) a motor and fan assembly provided in the air flow passage,
   (b) a dock comprising a receptacle, the combination is operable in a docking mode in which dirt from the dirt collection chamber is transferred to the receptacle; and,
   (c) an actuator comprising a first magnet wherein, upon actuation by the actuator, the first air treatment chamber door is moved between the open position and the closed position.
24. The combination of claim 23 wherein the first magnet is provided on the hand vacuum cleaner and the actuator is actuated as the hand vacuum cleaner is docked with the dock.
25. The combination of claim 23 wherein the first magnet is provided on one of the air treatment chamber and the dirt collection chamber and the actuator is actuated as the dirt collection chamber door is connected to an inlet port of the dock.
26. The combination of claim 24 wherein the dock has an engagement member that actuates the actuator as the hand vacuum cleaner is docked with the dock.
27. The combination of claim 23 wherein the first magnet is provided on the dock and the actuator is actuated as the hand vacuum cleaner is docked with the dock.
28. The combination of claim 23 wherein the actuator is actuated as the docking mode is commenced.
29. The combination of claim 23 wherein a second magnet is provided on the first air treatment chamber door which, when the first air treatment chamber door is moved between the closed and open positions, is magnetically coupled to the first magnet.
30. The combination of claim 29 wherein the first air treatment chamber door is biased to the closed position.
31. The combination of claim 30 wherein the first and second magnets are magnetically decoupled prior to the door being moved from the open position to the closed position.

### Clause Set G

1. A surface cleaner comprising:
   (a) an air flow passage extending from a dirty air inlet to a clean air outlet;
   (b) an air treatment chamber having a first end, an axially spaced apart second end, an air treatment chamber axis which intersects the first and second ends, an air treatment chamber sidewall extending between the first and second ends, an air treatment chamber air inlet, an air treatment chamber air outlet, a dirt outlet and a first air treatment chamber door that is moveable between an open position and a closed position;
   (c) a dirt collection chamber that is external to the air treatment chamber wherein, in operation, dirt travels through the dirt outlet from the air treatment chamber to the dirt collection chamber, the dirt collection chamber having a dirt collection chamber door that is openable;
   (d) a motor and fan assembly provided in the air flow passage; and,
   (e) a transmission comprising at least a first gear whereby, upon actuation of the transmission by an actuator, the first air treatment chamber door is moved between the open position and the closed position.
2. The surface cleaner of claim 1 wherein the transmission further comprises a worm gear drivingly connected to the first gear.
3. The surface cleaner of claim 1 wherein the transmission comprises a rack and pinion wherein the first gear is the pinion.
4. The surface cleaner of claim 1 wherein the air treatment chamber further comprises a second air treatment chamber door that is moveable between an open position and a closed position.
5. The surface cleaner of claim 4 wherein the first gear is drivingly connected to the first door and the transmission further comprises a second gear that is drivingly connected to the second door.
6. The surface cleaner of claim 5 wherein, upon actuation of the transmission, the first and second doors rotate in opposite directions.
7. The surface cleaner of claim 1 wherein at least a portion of the transmission is housed within the dirt collection chamber.
8. The surface cleaner of claim 7 wherein a wall of a transmission housing defines a wall of the dirt collection chamber.
9. A combination comprising the surface cleaner of claim 1 and a dock wherein the transmission is actuated as the surface cleaner is docked with the dock.
10. A hand vacuum cleaner comprising:
   (a) an air flow passage extending from a dirty air inlet, which is provided at a front end of the hand vacuum cleaner, to a clean air outlet;
   (b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and a first air treatment chamber door that is rotatably mounted about a first air treatment chamber opening axis that is parallel to the air treatment chamber axis;
   (c) a dirt collection chamber that is external to the air treatment chamber wherein, in operation, dirt travels through the dirt outlet from the air treatment chamber to the dirt collection chamber, the dirt collection chamber having a dirt collection chamber door that is openable;
   (d) a motor and fan assembly provided in the air flow passage; and,
   (e) a transmission comprising at least a first gear whereby, upon actuation of the transmission by an actuator, the first air treatment chamber door is moved between the open position and the closed position.
11. The hand vacuum cleaner of claim 10 wherein the transmission further comprises a worm gear drivingly connected to the first gear.
12. The hand vacuum cleaner of claim 10 wherein the transmission comprises a rack and pinion wherein the first gear is the pinion.
13. The hand vacuum cleaner of claim 10 wherein the air treatment chamber further comprises a second air treatment chamber door that is moveable between an open position and a closed position.
14. The hand vacuum cleaner of claim 13 wherein the first gear is drivingly connected to the first door and the transmission further comprises a second gear that is drivingly connected to the second door.
15. The hand vacuum cleaner of claim 14 wherein, upon actuation of the transmission, the first and second doors rotate in opposite directions.
16. The hand vacuum cleaner of claim 10 wherein at least a portion of the transmission is housed within the dirt collection chamber.
17. The hand vacuum cleaner of claim 16 wherein a wall of a transmission housing defines a wall of the dirt collection chamber.
18. A combination comprising the hand vacuum cleaner of claim 10 and a dock wherein the transmission is actuated as the hand vacuum cleaner is docked with the dock.

### Clause Set H

1. A hand vacuum cleaner comprising:
   (a) an air flow passage extending from a dirty air inlet, which is provided at a front end of the hand vacuum cleaner, to a clean air outlet;
   (b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and a first air treatment chamber door that is rotatably mounted about a first air treatment chamber opening axis that is parallel to the air treatment chamber axis;
   (c) a dirt collection chamber that is external to the air treatment chamber wherein, in operation, dirt travels through the dirt outlet from the air treatment chamber to the dirt collection chamber, the dirt collection chamber having a dirt collection chamber door that is rotatably mounted about a dirt collection chamber opening axis, wherein the dirt collection chamber door is drivingly connected to the first air treatment chamber door whereby opening the dirt collection chamber door opens the first air treatment chamber door; and,
   (d) a motor and fan assembly provided in the air flow passage.
2. A hand vacuum cleaner comprising:
   (a) an air flow passage extending from a dirty air inlet, which is provided at a front end of the hand vacuum cleaner, to a clean air outlet;
   (b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and a first air treatment chamber door that is moveable in a first direction from a closed position to an open position;
   (c) a dirt collection chamber that is external to the air treatment chamber wherein, in operation, dirt travels through the dirt outlet from the air treatment chamber to the dirt collection chamber, the dirt collection chamber having a dirt collection chamber door that is moveable from a closed position to an open position wherein the dirt collection chamber door is drivingly connected to the first air treatment chamber door whereby opening the dirt collection chamber door opens the first air treatment chamber door; and,
   (d) a motor and fan assembly provided in the air flow passage.
3. The hand vacuum cleaner of claim 1 or claim 2 further comprising a mechanical linkage connecting the dirt collection chamber door to the first air treatment chamber door.
4. The hand vacuum cleaner of claim 3 wherein a portion of the mechanical linkage is located exterior to the dirt collection chamber.
5. The hand vacuum cleaner of claim 4 wherein all of the mechanical linkage is located exterior to the dirt collection chamber.
6. The hand vacuum cleaner of claim 3 wherein a portion of the mechanical linkage is located at the rear end of the air treatment chamber.
7. The hand vacuum cleaner of claim 6 wherein the portion of the mechanical linkage is located exterior to the dirt collection chamber.
8. The hand vacuum cleaner of claim 7 wherein at least one of the first air treatment chamber door and the dirt collection chamber door is biased to the closed position.
9. The hand vacuum cleaner of claim 1 or claim 2 wherein at least one of the first air treatment chamber door and the dirt collection chamber door is biased to the closed position.
10. The hand vacuum cleaner of claim 9 wherein each of the first air treatment chamber door and the dirt collection chamber door is biased to the closed position.
11. The hand vacuum cleaner of claim 1 further comprising a second air treatment chamber door that is rotatably mounted about a second air treatment chamber opening axis that is parallel to the air treatment chamber axis.
12. The hand vacuum cleaner of claim 11 wherein the dirt collection chamber door is drivingly connected to the second air treatment chamber door.
13. The hand vacuum cleaner of claim 11 wherein the first and second air treatment chamber opening axes are laterally spaced apart.
14. The hand vacuum cleaner of claim 12 wherein the first and second air treatment chamber doors rotate away from each other as the first and second air treatment chamber doors rotate open.
15. The hand vacuum cleaner of claim 1 or claim 2 wherein the air treatment chamber comprises a cyclone and the air treatment chamber axis is a cyclone axis of rotation.
16. The hand vacuum cleaner of claim 1 further comprising a second air treatment chamber door that is moveably mounted between a closed and an open position.
17. The hand vacuum cleaner of claim 16 wherein the dirt collection chamber door is drivingly connected to the second air treatment chamber door.

### Clause Set I

1. A hand vacuum cleaner comprising:
   (a) an air flow passage extending from a dirty air inlet, which is provided at a front end of the hand vacuum cleaner, to a clean air outlet;
   (b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and a first air treatment chamber door that is rotatably mounted about a first air treatment chamber opening axis that is parallel to the air treatment chamber axis;
   (c) a dirt collection chamber that is external to the air treatment chamber wherein, in operation, dirt travels through the dirt outlet from the air treatment chamber to the dirt collection chamber, the dirt collection chamber having a dirt collection chamber door that is rotatably mounted about a dirt collection chamber opening axis that is parallel to the air treatment chamber axis; and,
   (d) a motor and fan assembly provided in the air flow passage.
2. The hand vacuum cleaner of claim 1 wherein, when the air treatment chamber axis extend horizontally, the air treatment chamber has an upper end, a lower end and opposed lateral sides and a portion of the dirt collection chamber is positioned on one of the lateral sides of the air treatment chamber.
3. The hand vacuum cleaner of claim 2 wherein one of the first air treatment chamber door and the dirt collection chamber door is drivingly connected to the other of the first air treatment chamber door and the dirt collection chamber door.
4. The hand vacuum cleaner of claim 2 wherein the dirt collection chamber door extends from the first air treatment chamber door.
5. The hand vacuum cleaner of claim 4 wherein the dirt collection chamber door and the first air treatment chamber door are integrally molded as a single part.
6. The hand vacuum cleaner of claim 2 wherein the air treatment chamber air outlet is provided at the rear end of the air treatment chamber.
7. The hand vacuum cleaner of claim 1 wherein the air treatment chamber air outlet is provided at the rear end of the air treatment chamber.
8. The hand vacuum cleaner of claim 7 wherein one of the first air treatment chamber door and the dirt collection chamber door is drivingly connected to the other of the first air treatment chamber door and the dirt collection chamber door.
9. The hand vacuum cleaner of claim 1 wherein one of the first air treatment chamber door and the dirt collection chamber door is drivingly connected to the other of the first air treatment chamber door and the dirt collection chamber door.
10. The hand vacuum cleaner of claim 1 wherein the air treatment chamber comprises a cyclone and the air treatment chamber axis is a cyclone axis of rotation.
11. A surface cleaner comprising:
   (a) an air flow passage extending from a dirty air inlet to a clean air outlet;
   (b) a cyclone chamber having a cyclone axis of rotation, a cyclone chamber air inlet, a cyclone chamber air outlet, a dirt outlet and a first cyclone chamber door that is rotatably mounted about a first air treatment chamber opening axis that is parallel to the cyclone axis of rotation;
   (c) a dirt collection chamber that is external to the air treatment chamber wherein, in operation, dirt travels through the dirt outlet from the cyclone chamber to the dirt collection chamber, the dirt collection chamber having a dirt collection chamber door that is rotatably mounted about a dirt collection chamber opening axis that is parallel to the cyclone axis of rotation; and,
   (d) a motor and fan assembly provided in the air flow passage.
12. The surface cleaner of claim 11 wherein, when the cyclone axis of rotation extends horizontally, the cyclone chamber has an upper end, a lower end and opposed lateral sides and a portion of the dirt collection chamber is positioned on one of the lateral sides of the cyclone chamber.
13. The surface cleaner of claim 12 wherein one of the first cyclone chamber door and the dirt collection chamber door is drivingly connected to the other of the first cyclone chamber door and the dirt collection chamber door.
14. The surface cleaner of claim 12 wherein the dirt collection chamber door extends from the first cyclone chamber door.
15. The surface cleaner of claim 14 wherein the dirt collection chamber door and the first cyclone chamber door are integrally molded as a single part.
16. The surface cleaner of claim 12 wherein the cyclone chamber air outlet is provided at the rear end of the cyclone chamber.
17. The surface cleaner of claim 11 wherein the cyclone chamber air outlet is provided at the rear end of the cyclone chamber.
18. The surface cleaner of claim 17 wherein one of the first cyclone chamber door and the dirt collection chamber door is drivingly connected to the other of the first cyclone chamber door and the dirt collection chamber door.
19. The surface cleaner of claim 11 wherein one of the first cyclone chamber door and the dirt collection chamber door is drivingly connected to the other of the first cyclone chamber door and the dirt collection chamber door.

### Clause Set J

1. A hand vacuum cleaner comprising:
   (a) an air flow passage extending from a dirty air inlet, which is provided at a front end of the hand vacuum cleaner, to a clean air outlet;
   (b) an air treatment chamber having a front end comprising a front wall, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet wherein the front wall of the air treatment chamber translates forwardly from a closed position to an open position;
   (c) a dirt collection chamber that is external to the air treatment chamber wherein, in operation, dirt travels through the dirt outlet from the air treatment chamber to the dirt collection chamber, the dirt collection chamber having a dirt collection chamber door that is rotatably mounted about a dirt collection chamber opening axis that extends at an angle to the air treatment chamber axis; and,
   (d) a motor and fan assembly provided in the air flow passage.
2. The hand vacuum cleaner of claim 1 wherein the dirt collection chamber opening axis extends generally transverse to the forward/rearward direction.
3. The hand vacuum cleaner of claim 2 wherein the air treatment chamber opening axis extends in an air treatment chamber emptying plane, and the air treatment chamber emptying plane is generally transverse to the forward/rearward direction.
4. The hand vacuum cleaner of claim 2 wherein the dirt collection chamber opening axis is located at a rear end of the dirt collection chamber.
5. The hand vacuum cleaner of claim 1 wherein, when the air treatment chamber axis extends horizontally and the dirty air inlet is at an upper end of the hand vacuum cleaner, the dirt collection chamber underlies the air treatment chamber.
6. The hand vacuum cleaner of claim 1 wherein the dirt collection chamber door is openable when the front wall is in a closed position.
7. The hand vacuum cleaner of claim 1 wherein the dirt collection chamber door is openable independently of the front wall translating forwardly.
8. The hand vacuum cleaner of and of claims 1-7 wherein the air treatment chamber comprises a cyclone and the air treatment chamber axis is a cyclone axis of rotation.

### Clause Set K

1. A hand vacuum cleaner comprising:
   (a) an air flow passage extending from a dirty air inlet, which is provided at a front end of the hand vacuum cleaner, to a clean air outlet;
   (b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and a first air treatment chamber door;
   (c) a dirt collection chamber that is external to the air treatment chamber wherein, in operation, dirt travels through the dirt outlet from the air treatment chamber to the dirt collection chamber, the dirt collection chamber having a dirt collection chamber door that is openable; and,
   (d) a motor and fan assembly provided in the air flow passage,
   wherein at least one of the first air treatment chamber door and the dirt collection chamber door is rotatably mounted about an opening axis that is parallel to the air treatment chamber axis and,
   wherein a lock secures the at least one of the first air treatment chamber door and the dirt collection chamber door in a closed position, wherein the lock comprises an axially extending member.
2. The hand vacuum cleaner of claim 1 wherein the axially extending member comprises an axially extending pin that is removably receivable in an opening that extends in a plane that is transverse to the air treatment chamber axis.
3. The hand vacuum cleaner of claim 2 wherein the axially extending member comprises an axially extending pin that is removably receivable in an axially extending hole and the opening is an inlet port of the hole.
4. The hand vacuum cleaner of claim 1 wherein the axially extending member comprises an axially extending pin that is removably receivable in an axially extending hole through an opening that extends in a plane that is transverse to the air treatment chamber axis, the opening being an inlet port of the hole.
5. The hand vacuum cleaner of claim 2 wherein the pin is moveable forwardly from a locked position in which the pin is received in the opening to an unlocked position in which the pin is exterior to the opening.
6. The hand vacuum cleaner of claim 2 wherein the pin is moveable rearwardly from a locked position in which the pin is received in the opening to an unlocked position in which the pin is exterior to the opening.
7. The hand vacuum cleaner of claim 1 wherein the axially extending member comprises a first axially extending pin that is removably receivable in a first opening that extends in a first plane that is transverse to the air treatment chamber axis and a second axially extending pin that is removably receivable in a second opening that extends in a second plane that is transverse to the air treatment chamber axis.
8. The hand vacuum cleaner of claim 7 wherein the first pin is moveable forwardly from a locked position in which the first pin is received in the first opening to an unlocked position in which the pin is exterior to the first opening and wherein the second pin is moveable rearwardly from a locked position in which the second pin is received in the second opening to an unlocked position in which the pin is exterior to the second opening.
9. The hand vacuum cleaner of any of claims 1-8 wherein the air treatment chamber comprises a cyclone and the air treatment chamber axis is a cyclone axis of rotation.

### Clause Set L

1. A hand vacuum cleaner comprising:
   (a) an air flow passage extending from a dirty air inlet, which is provided at a front end of the hand vacuum cleaner, to a clean air outlet;
   (b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet a first air treatment chamber door that is rotatably mounted about a first air treatment chamber opening axis that is parallel to the air treatment chamber axis and a second air treatment chamber door that is rotatably mounted about a second air treatment chamber opening axis that is parallel to the air treatment chamber axis, wherein, the air treatment chamber is ovaloid in a transverse plane transverse to the air treatment chamber axis.
2. The hand vacuum cleaner of claim 1 wherein at least one of the first and second air treatment chamber doors forms at least a portion of the air treatment chamber that is ovaloid.
3. The hand vacuum cleaner of claim 2 wherein the sidewall of the air treatment chamber comprises a stationary portion and the first and second air treatment chamber doors, the air treatment chamber has a perimeter in the transverse plane, the stationary portion forms a first part of the perimeter and the first and second air treatment chamber doors also form a second part of the perimeter, and the second part is ovaloid.
4. The hand vacuum cleaner of claim 3 wherein the first part is generally circular.
5. The hand vacuum cleaner of claim 4 further comprising a dirt collection chamber that is external to the air treatment chamber wherein, in operation, dirt travels through the dirt outlet from the air treatment chamber to the dirt collection chamber.
6. The hand vacuum cleaner of claim 5 wherein the dirt collection chamber has a dirt collection chamber door.
7. The hand vacuum cleaner of claim 5 wherein the dirt collection chamber door is rotatably mounted about a dirt collection chamber opening axis that extends in a different direction to the forward/rearward direction.
8. The hand vacuum cleaner of claim 1 further comprising a dirt collection chamber that is external to the air treatment chamber wherein, in operation, dirt travels through the dirt outlet from the air treatment chamber to the dirt collection chamber.
9. The hand vacuum cleaner of claim 8 wherein the dirt collection chamber has a dirt collection chamber door.
10. The hand vacuum cleaner of claim 9 wherein the dirt collection chamber door is rotatably mounted about a dirt collection chamber opening axis that extends in a different direction to the forward/rearward direction.
11. The hand vacuum cleaner of claim 8 wherein, when the air treatment chamber axis extends horizontally, the air treatment chamber air inlet is at an upper end of the air treatment chamber and the first and second air treatment chamber doors are at a lower end of the air treatment chamber.
12. The hand vacuum cleaner of claim 11 wherein the sidewall of the air treatment chamber comprises a stationary portion and the first and second air treatment chamber doors, the air treatment chamber has a perimeter in the transverse plane, the stationary portion forms a first part of the perimeter and the first and second air treatment chamber doors also form a second part of the perimeter, and the second part is ovaloid.
13. A hand vacuum cleaner comprising:
   (a) an air flow passage extending from a dirty air inlet, which is provided at a front end of the hand vacuum cleaner, to a clean air outlet;
   (b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet, a first air treatment chamber door that is moveable in a first direction from a closed position to an open position and a second air treatment chamber door that is moveable in a second direction from a closed position to an open position, wherein, the air treatment chamber is ovaloid in a transverse plane transverse to the air treatment chamber axis.
14. The hand vacuum cleaner of claim 13 wherein at least one of the first and second air treatment chamber doors forms at least a portion of the air treatment chamber that is ovaloid.
15. The hand vacuum cleaner of claim 14 wherein the sidewall of the air treatment chamber comprises a stationary portion and the first and second air treatment chamber doors, the air treatment chamber has a perimeter in the transverse plane, the stationary portion forms a first part of the perimeter and the first and second air treatment chamber doors also form a second part of the perimeter, and the second part is ovaloid.
16. The hand vacuum cleaner of claim 15 wherein the first part is generally circular.
17. The hand vacuum cleaner of claim 16 further comprising a dirt collection chamber that is external to the air treatment chamber wherein, in operation, dirt travels through the dirt outlet from the air treatment chamber to the dirt collection chamber.
18. The hand vacuum cleaner of claim 17 wherein the dirt collection chamber has a dirt collection chamber door.
19. The hand vacuum cleaner of claim 17 wherein the dirt collection chamber door is moveable in a third direction from a closed position to an open position wherein the third direction is different to the first and second directions.
20. The hand vacuum cleaner of claim 13 further comprising a dirt collection chamber that is external to the air treatment chamber wherein, in operation, dirt travels through the dirt outlet from the air treatment chamber to the dirt collection chamber.
21. The hand vacuum cleaner of claim 20 wherein the dirt collection chamber has a dirt collection chamber door.
22. The hand vacuum cleaner of claim 21 wherein the dirt collection chamber door is moveable in a third direction from a closed position to an open position wherein the third direction is different to the first and second directions.
23. The hand vacuum cleaner of claim 22 wherein, when the air treatment chamber axis extends horizontally, the air treatment chamber air inlet is at an upper end of the air treatment chamber and the first and second air treatment chamber doors are at a lower end of the air treatment chamber.
24. The hand vacuum cleaner of claim 23 wherein the sidewall of the air treatment chamber comprises a stationary portion and the first and second air treatment chamber doors, the air treatment chamber has a perimeter in the transverse plane, the stationary portion forms a first part of the perimeter and the first and second air treatment chamber doors also form a second part of the perimeter, and the second part is ovaloid.

1. A hand vacuum cleaner comprising:
(a) an air flow passage extending from a dirty air inlet, which is provided at a front end of the hand vacuum cleaner, to a clean air outlet;
(b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and a first air treatment chamber door that is rotatably mounted about a first air treatment chamber opening axis that is parallel to the air treatment chamber axis;
(c) a dirt collection chamber that is external to the air treatment chamber wherein, in operation, dirt travels through the dirt outlet from the air treatment chamber to the dirt collection chamber, the dirt collection chamber having a dirt collection chamber door that is rotatably mounted about a dirt collection chamber opening axis that extends in a different direction to the forward/rearward direction, wherein the dirt collection chamber opening axis extends in a dirt collection chamber emptying plane and, when the dirt collection chamber door is open, a dirt collection chamber emptying port is provided in the dirt collection chamber emptying plane; and,
(d) a motor and fan assembly provided in the air flow passage.

2. The hand vacuum cleaner of claim 1 wherein the dirt collection chamber opening axis extends generally transverse to the forward/rearward direction.

3. The hand vacuum cleaner of claim 2 wherein the dirt collection chamber emptying plane is generally transverse to the forward/rearward direction.

4. The hand vacuum cleaner of claim 2 wherein the dirt collection chamber opening axis is located at a rear end of the dirt collection chamber.

5. The hand vacuum cleaner of claim 2 further comprising a second air treatment chamber door that is rotatably mounted about a second air treatment chamber opening axis that is parallel to the air treatment chamber axis, the first and second air treatment chamber axes extend in an air treatment chamber emptying plane, wherein, when the first and second air treatment chamber doors are open, an air treatment chamber emptying port is provided in the air treatment chamber emptying plane.

6. The hand vacuum cleaner of claim 5 wherein the first and second air treatment chamber opening axes are laterally spaced apart.

7. The hand vacuum cleaner of claim 6 wherein the first and second air treatment chamber doors rotate away from each other as the first and second air treatment chamber doors rotate open.

8. The hand vacuum cleaner of claim 7 wherein, when the air treatment chamber axis extends horizontally and the dirty air inlet is at an upper end of the hand vacuum cleaner, the dirt collection chamber underlies the first and second air treatment chamber doors.

9. The hand vacuum cleaner of claim 7 wherein, when the air treatment chamber axis extends horizontally and the dirty air inlet is at an upper end of the hand vacuum cleaner, the dirt collection chamber door underlies the first and second air treatment chamber doors.

10. The hand vacuum cleaner of claim 7 wherein the dirt collection chamber emptying port has a larger cross-sectional area than a cross-sectional area of the air treatment chamber emptying port.

11. The hand vacuum cleaner of claim 1 wherein, when the air treatment chamber axis extends horizontally and the dirty air inlet is at an upper end of the hand vacuum cleaner, the dirt collection chamber underlies the first air treatment chamber door.

12. The hand vacuum cleaner of claim 1 wherein, when the air treatment chamber axis extends horizontally and the dirty air inlet is at an upper end of the hand vacuum cleaner, the dirt collection chamber door underlies the first air treatment chamber door.

13. The hand vacuum cleaner of claim 11 wherein the first air treatment chamber opening axis extends in an air treatment chamber emptying plane, wherein, when the first air treatment chamber door is open, an air treatment chamber emptying port is provided in the air treatment chamber emptying plane and, wherein, the dirt collection chamber emptying port has a larger cross-sectional area than a cross-sectional area of the air treatment chamber emptying port.

14. The hand vacuum cleaner of claim 1 wherein the first air treatment chamber opening axis extends in an air treatment chamber emptying plane, wherein, when the first air treatment chamber door is open, an air treatment chamber emptying port is provided in the air treatment chamber emptying plane and, wherein, the dirt collection chamber emptying port has a larger cross-sectional area than a cross-sectional area of the air treatment chamber emptying port.

15. The hand vacuum cleaner of claim 1 wherein the air treatment chamber comprises a cyclone and the air treatment chamber axis is a cyclone axis of rotation.

16. A hand vacuum cleaner comprising:
(a) an air flow passage extending from a dirty air inlet, which is provided at a front end of the hand vacuum cleaner, to a clean air outlet;
(b) an air treatment chamber having a front end, an axially spaced apart rear end, an air treatment chamber axis extending in a forward/rearward direction between the front and rear ends, an air treatment chamber sidewall extending between the front end and the rear end, an air treatment chamber air inlet, an air treatment chamber air outlet, a dirt outlet and a first air treatment chamber door that is moveable in a first direction from a closed position to an open position;
(c) a dirt collection chamber that is external to the air treatment chamber wherein, in operation, dirt travels through the dirt outlet from the air treatment chamber to the dirt collection chamber, the dirt collection chamber having a dirt collection chamber door that is moveable in a second direction from a closed position to an open position wherein the second direction is different to the first direction, wherein, when the dirt collection chamber door is open, a dirt collection chamber emptying port is provided; and,
(d) a motor and fan assembly provided in the air flow passage.

17. The hand vacuum cleaner of claim 16 wherein one of the first and second directions is the forward/rearward direction.

18. The hand vacuum cleaner of claim 16 wherein the first direction is the forward/rearward direction.

19. The hand vacuum cleaner of claim 16 wherein the second direction is generally transverse to the first direction.

20. The hand vacuum cleaner of claim 16 further comprising a second air treatment chamber door that is moveable in a third direction from a closed position to an open position, wherein the third direction is opposed to the first direction and wherein, when the first and second air treatment chamber doors are open, an air treatment chamber emptying port is provided.

21. The hand vacuum cleaner of claim 20 wherein the air treatment chamber emptying port has a perimeter having first and second sides that extend in the forward/rearward direction and the first and second sides are laterally spaced apart.

22. The hand vacuum cleaner of claim 21 wherein the first and second air treatment chamber doors move away from each other as the first and second air treatment chamber doors move to their open positions.

23. The hand vacuum cleaner of claim 20 wherein the dirt collection chamber emptying port has a larger cross-sectional area than a cross-sectional area of the air treatment chamber emptying port.

24. The hand vacuum cleaner of claim 16 wherein, when the first air treatment chamber door is open, an air treatment chamber emptying port is provided and the dirt collection chamber emptying port has a larger cross-sectional area than a cross-sectional area of the air treatment chamber emptying port.
